(19) United States
(12) Patent Application Publication
(10) Pub. No.: US 2011/0210931 A1
(43) Pub. Date: Sep. 1, 2011

(54) FINGER-WORN DEVICE AND INTERACTION METHODS AND COMMUNICATION METHODS

(75) Inventor: Saar SHAI, Kochav Yair (IL)

(73) Assignee: RINGBOW LTD., Kochav Yair (IL)

(21) Appl. No.: 13/049,925

(22) Filed: Mar. 17, 2011

Related U.S. Application Data
(63) Continuation-in-part of application No. 12/673,584, filed on Feb. 16, 2010.
(60) Provisional application No. 60/956,708, filed on Aug. 19, 2007.
(60) Provisional application No. 61/016,635, filed on Dec. 26, 2007.
(60) Provisional application No. 61/028,194, filed on Feb. 13, 2008.
(60) Provisional application No. 61/041,931, filed on Apr. 3, 2008.
(60) Provisional application No. 61/042,245, filed on Apr. 3, 2008.
(60) Provisional application No. 61/044,486, filed on Apr. 13, 2008.
(60) Provisional application No. 61/052,176, filed on May 10, 2008.
(60) Provisional application No. 61/054,833, filed on May 21, 2008.
(60) Provisional application No. 61/076,673, filed on Jun. 29, 2008.

(51) Int. Cl. G06F 3/01; G06F 3/033; G10L 15/20; G06F 3/041

(52) U.S. Cl. 345/173; 345/156; 345/179; 704/233; 704/E15.039

(57) ABSTRACT

Disclosed herein are finger-worn devices in various embodiments, and related systems, interfaces and methods of use. In some embodiments, a finger-worn device may be connected and disconnected from other devices. In some embodiments, a finger-worn device may relay tactile information to a finger wearing said finger-worn device, and/or to a finger operating said finger-worn device. In some embodiments, a finger-worn device may be operated to generate sound, whereas in some embodiments, a finger-worn device may be operated to generate visual output. In some embodiments, interfaces are intended to react, or be controlled or influenced by a finger-worn device or plurality thereof. In some methods, a finger-worn device may be operated for registering input in systems which can sense and process sounds, whereas in other methods a finger-worn device may be operated for registering input in systems which can sense and process light.

### CROSS REFERENCE TO RELATED APPLICATIONS

The present invention claims priority from U.S. Provisional Patent Applications No. 61/098,764 filed Sep. 20, 2008, 61/147,775 filed Jan. 28, 2009, 61/148,127 filed Jan. 29, 2009, the content of all of which is incorporated herein by reference.

### FIELD OF THE INVENTION

The invention relates in general to human-computer interaction (HCI) and in particular to input device and user interfaces (UIs).

### BACKGROUND OF THE INVENTION

There are known in the art finger-worn devices (or “ring devices”) for a variety of functions or uses. Several are known as substituting a computer mouse or a so-called “trackball”, for navigating graphic user interfaces (GUIs). However, such devices include unnecessary elements and features which render them bulky and uncomfortable to use, whereas some of said features find better alternatives in other technologies such as touch-screens and visual-recognition which, as the invention suggests, may be adapted to be used (or “interacted with”) in collaboration with operating finger-worn devices.

The rapid development of small electronic, optical and mechanical components (as

### SUMMARY OF THE INVENTION

The invention provides, in various embodiments, devices which can be worn on a finger (or otherwise “finger-worn devices”). There are provided such devices which may be utilized as input device, such as to facilitate certain types of interactions by being operated. Further provided are methods of operating (or “using”) such devices. Further provided are methods of interaction which utilize such finger-worn devices.

The invention further provides various embodiments of devices which include finger-worn devices and connectors or adapters which facilitate connecting said finger-worn device to other devices, such as for a physical attachment, transferring of power and/or transferring of data. In some embodiments, finger-worn devices may be operated while connected to other devices, specifically for interacting with said other devices. Said other devices may include, by way of example, so-called “host-devices” for which finger-worn devices may serve as a scroll-wheel. Another example for other devices may be styluses.

The invention further provides, in various embodiments, finger-worn devices which include sections which facilitate fingers of different sizes wearing said finger-worn devices. In some embodiments, said sections may be replaced by one another for similar purposes. Further provided by the invention is a finger-worn section which facilitates wearing devices on fingers by connecting said devices to said finger-worn section.

The invention further provides, in various embodiments, finger-worn devices which may include tangible marks (or “feel marks”) which can be felt when users operate said finger-worn devices, such as for distinguishing between different sections and/or different states of said finger-worn devices. Further provided by the invention are finger-worn devices including dynamic tactile indicators which may generate different tactile output, such as correspondingly to interface or program events. Said tactile output may be provided to fingers wearing said finger-worn devices and/or to fingers operating said finger-worn devices. Further provided by the invention are finger-worn devices including dynamic sections which may facilitate fingers of different sizes wearing said finger-worn devices and which may facilitate generating tactile output, and/or haptic feedback, to fingers wearing said finger-worn devices. Further provided by the invention are various methods in which tactile output may be utilized in interactions.

The invention further provides, in various embodiments, sound generating finger-worn devices which may be operated to generate sound, whereas said sound may be sensed and identified for registering input. Further provided by the invention, in various embodiments, finger-worn devices which can distort sounds of voices when users speak near or through said finger-worn devices, such as for said finger-worn devices to be utilized to interact with speech-recognition and/or voice-recognition systems. Further provided by the invention are methods in which finger-worn devices distorting sounds of voice are utilized to interact with speech-recognition and/or voice recognition systems.

The invention further provides, in various embodiments, touch-screens, finger-worn devices, and interfaces and/or programs wherein said finger-worn devices may be utilizes for interactions. In some embodiments, finger-worn devices may be operated to change between states, whereas interface or program elements or states may be affected by said finger-worn devices changing between states. Further provided by the invention are various interfaces and programs which may be interacted with, for different functions, by operating finger-worn devices and/or by touching touch-screens. Further provided by the invention are methods in which finger-worn devices are used in collaboration to interacting with touch-screens, such as by being operated while performing touch on touch-screens.

The invention further provides, in various embodiments, systems which include visual-recognition systems, and specifically gesture-recognition systems, and finger-worn devices which may be utilized in interactions with said visual-recognition systems (and specifically gesture-recognition systems). Further provided by the invention are specifically finger-worn devices which can generate visual output (or otherwise “light output”), for communicating with visual-recognition systems, and for visually indicating operations of said finger-worn devices to users.

The invention further provides, in various embodiments, finger-worn devices which include two or more accelerometers, for registering input from rotating said finger-worn devices (or a section thereof) around a finger, and for registering input from motion of hands, or specifically fingers (which are wearing said finger-worn devices).

The invention further provides, in various embodiments, finger-worn devices including controls, or otherwise any operable sections, which can be operated to change between states, and specifically be operated to be repositioned, such as between any number of positions. In some embodiments, controls of finger-worn devices may have a feature of being so-called “half pressed” or “half depressed”, as commonly known for cameras shooting buttons. Further provided by the invention are various methods in which said feature may be utilized in interactions.

The invention further provides, in various embodiments, systems in which finger-worn devices may be utilized to control or influence interfaces of touch-screens without fingers touching said touch-screens. More specifically, in some embodiments, finger-worn devices may be utilized for interactions which may precede or follow touch-interactions. Further provided by the invention are various systems in which finger-worn devices may be utilized to estimate the general locations of tips of fingers wearing said finger-worn devices. Further yet provided by the invention are various systems which include touch-screens, and methods for interacting with touch-screens, which can facilitate results similar to utilizing finger-worn devices to estimate the general locations of fingers.

The invention further provides, in various embodiments, interfaces for games and interfaces for graphic-editing applications and CAD applications.

### BRIEF DESCRIPTION OF THE DRAWINGS

The invention is herein described, by way of example only, with reference to the accompanying drawings, wherein:

FIG. 1A shows a perspective view of an embodiment of the invention;

FIG. 1B shows a perspective view of a plug of the invention and an adapter of the invention;

FIG. 1C shows a perspective view of another embodiment of the invention;

FIG. 1D shows a perspective view of another embodiment of the invention;

FIG. 1E shows a perspective view of another embodiment of the invention ready to be connected to a device of the invention;

FIG. 1F shows a perspective view of the embodiment shown in FIG. 1E;

FIG. 1G shows a perspective view of another embodiment of the invention ready to be connected to a device of the invention;

FIG. 1H shows a perspective view of another embodiment of the invention;

FIGS. 1I and 1J show a perspective view of another embodiment of the invention;

FIG. 1K shows a perspective view of the embodiment shown in FIGS. 1I and 1J as connected to a keychain;

FIG. 1L shows a perspective view of yet another embodiment of the invention;

FIGS. 2A and 2B show a perspective view of another embodiment of the invention;

FIG. 2C shows a finger-worn device of the invention being worn and operated;

FIG. 2D shows the finger-worn device shown in FIG. 2C being disconnected from a device of the invention;

FIGS. 3A and 3B show a perspective view of another embodiment of the invention;

FIG. 3C shows the embodiment shown in FIGS. 3A and 3B as being operated;

FIG. 3D shows a connection mechanism of the invention;

FIGS. 3E through 3G show a cross-section view of a finger-worn device of the invention being connected to a device of the invention;

FIGS. 4A and 4B show a perspective view of another embodiment of the invention;

FIGS. 4C and 4D show a perspective view of another embodiment of the invention;

FIGS. 5A and 4B show a perspective view of another embodiment of the invention;

FIG. 5C shows a perspective view of a section of the invention of a finger-worn device;

FIG. 5D shows a perspective view of an embodiment of the invention including a finger-worn section and a device;

FIG. 6A shows a perspective view of another embodiment of the invention;

FIG. 6B shows a perspective view of another embodiment of the invention;

FIG. 6C shows a perspective view of yet another embodiment of the invention;

FIGS. 7A and 7B show a perspective view of a finger-worn device of the invention in two different states;

FIGS. 7C and 7D show a perspective view of another finger-worn device of the invention in two different states;

FIG. 7E shows the finger-worn device shown in FIGS. 7C and 7D being operated;

FIG. 8A shows a perspective view of another finger-worn device of the invention;

FIGS. 8B through 8D show a cross-section view of the finger-worn device shown in FIG. 8A;

FIGS. 8E through 8H show a cross-section view of another finger-worn device of the invention;

FIG. 9A shows a perspective view of an embodiment of the invention utilized for interaction;

FIG. 9B shows a perspective view of another embodiment of the invention utilized for interaction;

FIG. 9C shows a perspective view of a finger-worn device of the invention being worn and operated, and a cross-section close-up view of said finger-worn device;

FIGS. 10A and 10B show a cross-section view of a finger-worn device of the invention;

FIG. 10C shows a cross-section view of the finger-worn device shown in FIGS. 10A and 10B being operated;

FIG. 11 shows a cross-section view of a system of the invention wherein two finger-worn devices are communicating;

FIG. 12 shows a flow-chart of a method of the invention;

FIGS. 13A through 13D show a cross-section view of a finger-worn device of the invention;

FIG. 13E shows a cross-section of a finger-worn device of the invention, similar to the finger-worn device shown in FIGS. 13A through 13D, communicating by sound;

FIG. 14A shows a cross-section view of a finger-worn device of the invention;

FIG. 14B shows a cross-section view of another finger-worn device of the invention;

FIG. 15 shows a perspective view of a finger-worn device of the invention being operated, and sound being generated for registering input;

FIG. 16 shows a perspective view of a finger-worn device of the invention being utilized to distort sound of voice;

FIG. 17 shows a flow-chart of a method of the invention;

FIGS. 18A through 18D show a cross-section view of a finger-worn device of the invention;

FIG. 18E shows a cross-section view of another finger-worn device of the invention;

FIGS. 18F through 18H show a perspective view of a system of the invention wherein a finger-worn device is being utilized for interaction;

FIGS. 18I through 18K show a perspective view of a system of the invention wherein the finger-worn device shown in FIGS. 7A and 7B is being utilized for interaction;

FIGS. 18L through 18N show a perspective view of another system of the invention wherein another finger-worn device is being utilized for interaction;

FIGS. 19A and 19B show a depiction of a game of the invention;

FIGS. 19C and 19D show a depiction of a graphic editing interface of the invention and the finger-worn device shown in FIGS. 7A and 7B in different states;

FIGS. 20A through 20D show a perspective view of a system of the invention wherein a finger-worn device is being utilized for interaction;

FIG. 20E shows a perspective view if the system shown in FIGS. 20A through 20D, wherein two finger-worn devices are being utilized for interaction;

FIG. 20F shows a flow-chart of a method of the invention;

FIGS. 21A and 21B show a perspective view of a system of the invention wherein a finger-worn device is being utilized for interaction;

FIG. 21C shows a perspective view of another system of the invention wherein a finger-worn device is being utilized for interaction;

FIG. 21D shows a perspective view of hand performing interactions by simulating operating a finger-worn device;

FIG. 21E shows a perspective view of a system of the invention wherein two finger-worn devices are being utilized for interaction;

FIG. 22A shows a perspective view of a system of the invention wherein a finger-worn device is being utilized for visual indication;

FIG. 22B shows a flow-chart of a method of the invention;

FIG. 23A shows a perspective view of a system of the invention wherein a finger-worn device is communicating with a touch-screen;

FIG. 23B shows a general side-view of the finger-worn device and the touch-screen shown in FIG. 23A;

FIGS. 24A and 24B show a cross-section view of a finger-worn device of the invention being moved;

FIGS. 24C and 24D, respectively to FIGS. 24 and 24B, show a perspective view of the finger-worn device shown in FIGS. 24A and 2413 being worn on a hand and moved;

FIG. 25A shows a cross-section view of a finger-worn device of the invention;

FIG. 25B shows a perspective view of a switch of the finger-worn device shown in FIG. 24A;

FIG. 25C shows a perspective view of the finger-worn device shown in FIG. 24A being assembled;

FIG. 25D shows a perspective view of the finger-worn device shown in FIG. 24A being operated;

FIGS. 25E through 25G show a depiction of an interface of the invention;

FIGS. 26A through 26C show a cross-section view of a finger-worn device of the invention;

FIG. 26D shows a perspective view of a switch of the invention connected to a ring;

FIG. 26E shows a different perspective view of the switch shown in FIG. 26D;

FIGS. 27A through 27C show a cross-section view of a finger-worn device of the invention;

FIGS. 27D through 27F, respectively to FIGS. 27A through 27C, show a depiction of an interface of the invention being influenced by operating the finger-worn device shown in FIGS. 27A through 27C;

FIG. 27G shows a flow-chart of a method of the invention;

FIG. 27H shows a flow-chart of another method of the invention;

FIG. 28A shows a perspective view of a finger-worn device of the invention;

FIG. 28B shows a perspective view of a system of the invention in which the finger-worn device shown in FIG. 28A is utilized for interaction;

FIG. 28C shows a perspective view of another system of the invention in which a finger-worn device is utilized for interaction;

FIG. 28D shows a depiction of a program of the invention;

FIGS. 28E through 28I show a general side-view of a finger-worn device of the invention utilized for interaction;

FIG. 28J shows a general side-view of a finger-worn device of the invention utilized for interaction;

FIG. 28K shows a general front-view of a hand wearing several finger-worn devices of the invention;

FIGS. 29A and 29B show a perspective view of a hand interacting with a touch-screen for different functions;

FIGS. 30A and 30B show a general side-view of a finger interacting with a proximity sensing touch-screen;

FIGS. 31A and 31B show flow-charts of methods of the invention;

The drawings constitute a part of this specification and include exemplary embodiments to the invention, which may be embodied in various forms. It is to be understood that in some instances various aspects of the invention may be shown exaggerated or enlarged to facilitate an understanding of the invention

### DETAILED DESCRIPTION OF THE INVENTION

It is to be understood that dashed lines in certain figures may have a different purposes of depiction, or a different illustrative functions. For example, in a certain figure, dashed lines may be guide lines for connection (such as common in explosion diagrams), whereas in another figure, dashed lines may illustrate or depict background elements which are supposedly obscured by elements in the foreground.

Note that any finger-worn device of the invention may, after being introduced in the description below as “finger-worn device”, be later referred to simply as “device”. Further note that it is made clear that finger-worn devices of the invention as described herein may be input devices (i.e. devices which may be operated, such as for registering input).

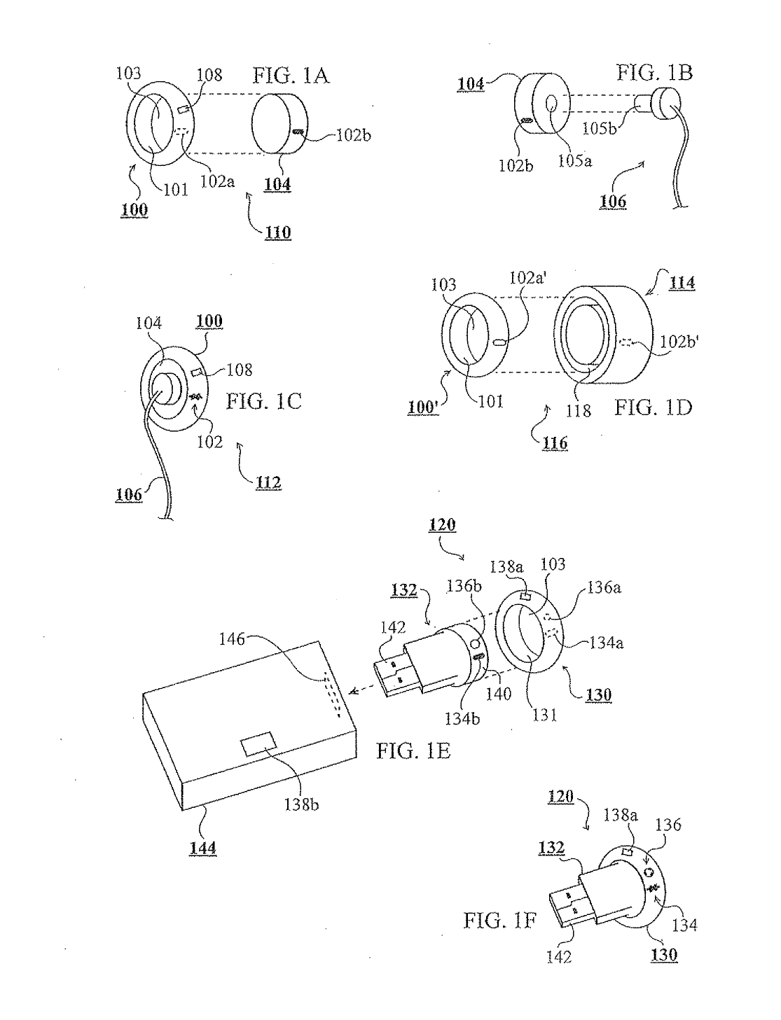

FIG. 1A shows an embodiment 110 of the invention which may include a device 100 and a plug 104 which may fit into device 100 (shown in the figure device 100 and plug 104 as separated, yet it is made clear that plug 104 may fit into device 100). Plug 104 may be a device, or a section thereof, shaped as a plug. For example, plug 104 may be an adapter generally shaped as a plug. Device 100 may be a device which may be worn on a finger (or simply a “finger-worn device”). More specifically, device 100 may be an input device (e.g. remote-control) that can be worn on a human finger by having a cavity 103 that is fitted for a human finger, such as a hole in an enclosure of device 100 into which a finger can be inserted for wearing the device on said finger.

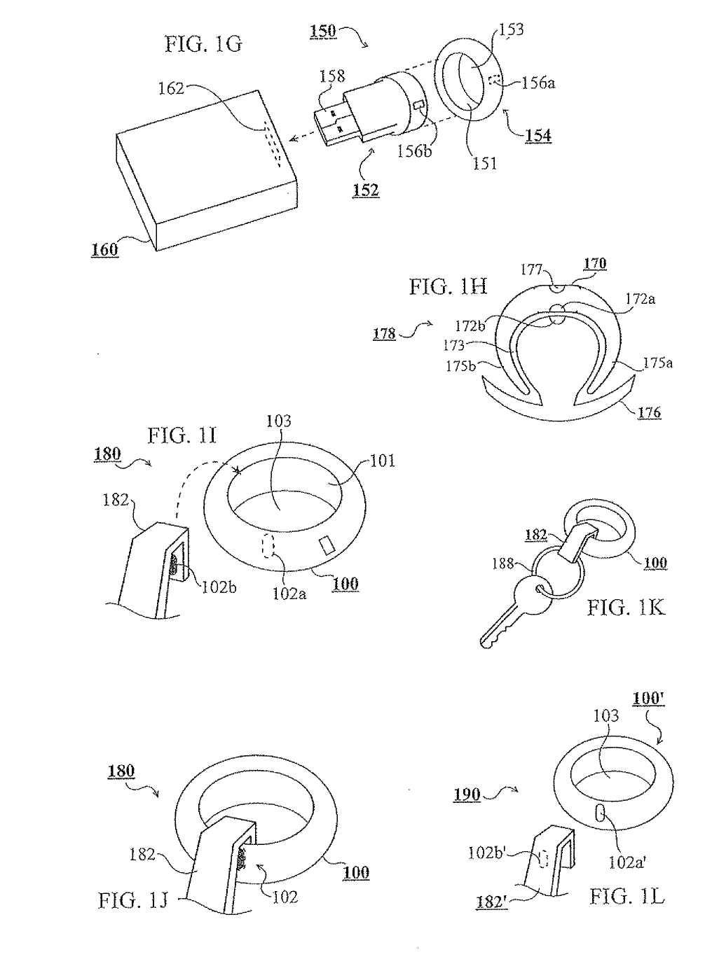

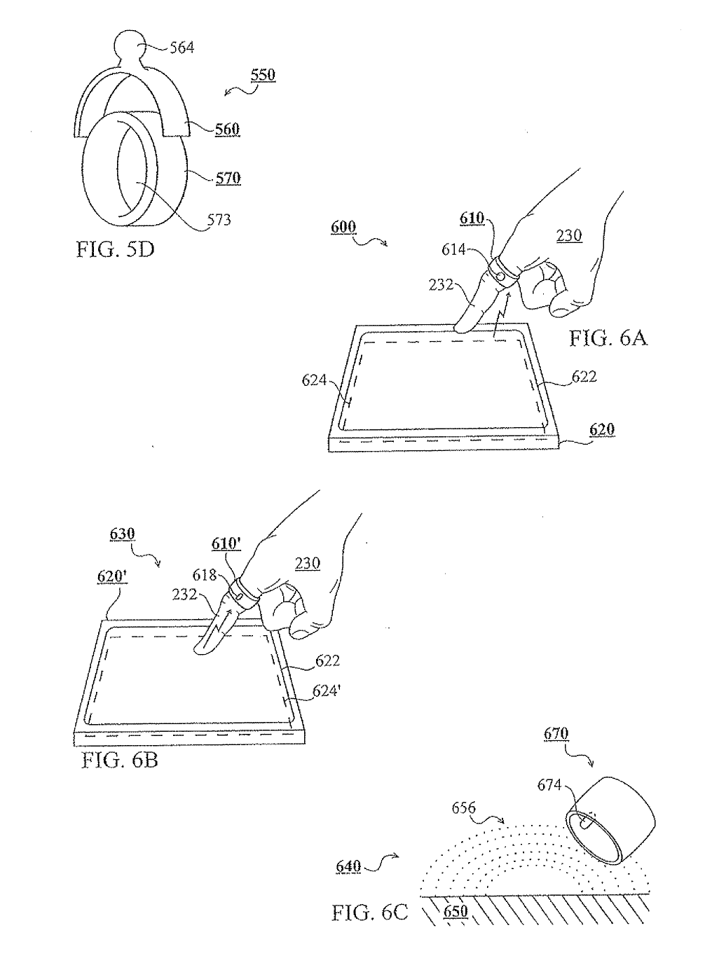

In some embodiments, device 100 can be operated, such as for registering input, by a thumb of the same hand of the finger wearing the device (see ref. FIG. 2C for a thumb 234 operating a finger-worn device 200). For example, a thumb may rotate or move a section of device 100, such as rotate a rotatable section (e.g. an external ring or knob) of device 100 around a stationary section (e.g. a base ring) of device 100 (see e.g. a rotatable section 702 and a stationary section 704 of a finger-worn device 700 in FIGS. 7A and 7B), similarly to rotation of a mechanical bearing. For another example, touch and/or motion of a thumb may be sensed on a surface (by any means for sensing) of device 100 (see e.g. a touch surface 714 of a finger-worn device 710 in FIGS. 7C and 7D), such as by including a touch sensor in device 100 (optionally coupled to said surface). For yet another example, device 100 may include controls (or “controllers”) that can be operated by a thumb, such as a switch, a key (a key as included in common keyboards), or plurality thereof.

In FIG. 1A, plug 104 is specifically shown ready to be inserted into device 100, specifically into cavity 103 of the device (insertion guidelines illustrated in the figure as dashed lines from device 100 to plug 104). Accordingly, plug 104 may be any section of embodiment 110 that may fit into cavity 103.

Further shown in FIG. 1A is device 100 including a connection unit 102a located on a surface 101 which may be facing (or otherwise surrounding) cavity 103. Connection unit 102a may be any number of means for facilitating connection between device 100 and plug 104. Accordingly, connection unit 102a may facilitate a connection between device 100 and plug 104.

Note that connection unit 102a is illustrated by dashed lines in FIG. 1A, suggesting it is located on surface 101, specifically on a side of the surface that is not shown from the point of view of the figure.

In some embodiments, as further shown in FIG. 1A, plug 104 may include a connection unit 102b designed to connect to connection unit 102a, such that a connection between connection unit 102b and connection unit 102a (see ref. a connection 102 in FIG. 1C) may facilitate a connection between device 100 and plug 104. Accordingly, when plug 104 is inserted into cavity 103 of device 100, connection units 102a,b may connect to each other, such as by mechanically interlocking, so that a connection between device 100 and plug 104 is facilitated.

Note that it is made clear that any of both of connection units 102a,b may include any number of means for facilitating a connection between device 100 and plug 104.

In some embodiments, connection unit 102a and/or connection unit 102b, or a connection between connection units 102a,b, may facilitate physical attachment between device 100 and plug 104. For example, connection unit 102a may include any number of mechanical clips which can clip device 100 to plug 104, specifically when the plug occupies cavity 103 (i.e. is inserted into the cavity). For another example, connection unit 102b may include a mechanism of springs which may press on device 100, by applying force, when device 100 is connected to plug 104, whereby said force may fasten the plug to the device.

In some embodiments, data (such as digital information or such as coded signals) may transfer (or be transferred) between device 100 and plug 104 (i.e. from device 100 to plug 104, and/or from plug 104 to device 100). Otherwise, device 100 and plug 104 may communicate (with each other) when connected. Optionally, data transfer (or otherwise communication) between the device and the plug may be facilitated by any or both of connection units 102a,b, or by a connection between connection units 102a,b. For example, device 100 may include a first memory unit (see e.g. a memory unit 138a of a device 130 in FIGS. 1E and 1F), whereas plug 104 may include a second memory unit, so that data (from the memory units) may be exchanged between said first and second memory units, or otherwise transmitted from said first memory unit to said second memory unit, such as by utilizing a connection between connection units 102a,b. Note that a connection facilitating data transfer may be referred to as a “data connection”.

In some embodiments, power (such as electricity) may transfer (or be transferred) between device 100 and plug 104 (i.e. from device 100 to plug 104, and/or from plug 104 to device 100). Optionally, power transfer between the device and the plug may be facilitated by connection unit 102a and/or connection unit 102b, or by a connection between connection units 102a,b. For example, device 100 may include a power source 108, as shown in FIG. 1A, whereas power from plug 104 (e.g. power originating from a device connected to plug 104, such as from a power adapter or from a computer) may transfer to device 100 to recharge power source 108, such as in case power source 108 is a rechargeable battery. Note that a connection facilitating power transfer may be referred to as a “power connection”.

Note that it is made clear that embodiment 110 may include device 100 and plug 104 as separated (also “disconnected”) or as connected, so that embodiment 110 may be modular, whereas device 100 and plug 104 may be modules of the embodiment.

FIG. 1B shows plug 104 (from a different point of view than shown in FIG. 1A) into which an adapter 106 (or a section thereof) is ready to be inserted (illustrated in the figure guidelines of insertion as dashed lines between adapter 106 and plug 104). For example, as shown in FIG. 1B, plug 104 may include a connection unit 105a, whereas adapter 106 may include a connection unit 105b. Connection units 105a,b may be joining connectors, or any means for facilitating connection between plug 104 and adapter 106, such as in case connection 105a unit is a socket fitted for the size of connection unit 105b which may be shaped as a plug of an appropriate size to fit into said socket. It is made clear that connection unit 105a may be of a standard size for facilitating connection to any common adapter, such as of a size which accommodates a common power adapter (and by that facilitates a connection thereto).

Note that in FIG. 1B, adapter 106 is illustrated as generally including a plug (connection unit 105b) and a cable, yet it is made clear that the scope of the invention includes any adapter known in the art.

FIG. 1C shows an embodiment 112 of the invention, which may include device 100, plug 104 and adapter 106. In FIG. 1C, plug 104 is inserted into device 100, specifically into cavity 103 of device 100. Otherwise, plug 104 is shown occupying cavity 103 of device 100. Together, device 100 and plug 104 may form embodiment 110, as described above and shown in FIG. 1A. Shown in FIG. 1C is a connection 102 as a connection between connection units 102a,b (connection 102 is illustrated as the joining of connection unit 102a and connection unit 102b, yet it is made clear that connection 102 is not supposed to be visible, or is supposedly obscured, from the point of view of FIG. 1C (as it may generally be located between device 100 and plug 104), and is illustrated for the purpose of depiction only). Further shown in FIG. 1C is adapter 106 connected to plug 104.

Note that whereas device 100 is shown connected to plug 104 and plug 104 is shown connected to adapter 106 in FIG. 1C, it is made clear that any of device 100, plug 104 and adapter 106 may be modules of embodiments 112 which can disconnect (or be disconnected) from each other (and reconnect or be reconnected to each other), and so embodiment 112 may be modular.

In some embodiments, data (e.g. coded information) may transfer (or be transferred) between adapter 106 and plug 104 (i.e. from the adapter to the plug and/or from the plug to the adapter). Otherwise, a data connection may be formed between adapter 106 and plug 104. Optionally, said data connection may be formed by utilizing any or both of connection units 105a,b, such as in case any or both of the connection units may facilitate data transfer between the adapter and the plug. In some embodiments, adapter 106 may, additionally to being connected to plug 104, be connected to a device (e.g. a computer), whereas data may be transferred from said device to plug 104, and/or from plug 104 to said device, such as by utilizing the aforementioned data connection.

In some embodiments, power (e.g. electric current) may transfer between adapter 106 and plug 104. Otherwise, a power connection may be formed between adapter 106 and plug 104. Optionally, said power connection may be formed by utilizing any or both of connection units 105a,b, such as in case the connection units include electric contacts which come into contact with each other when adapter 106 is connected to plug 104. In some embodiments, adapter 106 may, in addition to being connected to plug 104, be connected to a power source, such as to a common electric socket.

In some embodiments, data and/or power may transfer between adapter 106 and device 100 by utilizing plug 104, when the adapter, device and plug are connected (as shown in FIG. 1C). Otherwise, plug 104 may facilitate data and/or power transfer from adapter 106 to device 100, and/or from device 100 to adapter 106. For example, data and/or power may be transferred from adapter 106 (such as in case adapter 106 includes a memory unit and/or a power source, or in case the adapter is connected to a computer) to plug 104 and subsequently from plug 104 to device 100. Optionally, data and/or power transfer may be facilitated by connection 102, and/or by a connection between connection units 105a,b.

Note that it is made clear that in some embodiments, a finger-worn device of the invention (e.g. device 100) may directly connect to an adapter, without a plug (e.g. plug 104) being inserted a cavity (e.g. cavity 103) of said finger-worn device. Optionally, data and/or power may transfer between said adapter and said finger-worn device, such as by utilizing a connection data connection and/or power connection. For example, a cavity of a finger-worn device of the invention may be of a size which can fully accommodate a certain type of an adapter, or section thereof, such as an adapter having a round extruding part which can fully occupy said cavity.

FIG. 1D shows an embodiment 116 of the invention which may include a finger-worn device 100′ similar to device 100, and an adapter 114. Adapter 114 is shown including a socket 118 fitted for device 100′, so that device 100′ may be inserted into socket 118 (guidelines for insertion illustrated by dashed lines from the device to the socket). For example, adapter 114 may include an enclosure wherein there is socket 118 which can accommodate device 100′.

In FIG. 1D there is shown device 100′ including a connection unit 102a′ similar to connection unit 102a of device 100 (see ref. FIG. 1A), whereas adapter 114 is shown including a connection unit 102b′ (illustrated by dashed lines suggesting connection unit 102b′ is located inside socket 118) similar to connection unit 102b. Connection unit 102a′ may be located on an external surface of device 100′ (i.e. a surface not facing cavity 103 of device 100′, as shown in the figure) as opposed to connection unit 102a of device 100 shown in FIG. 1A located on surface 101 of device 100 which may be facing cavity 103 of device 100.

In some embodiments, adapter 114 may include a section which fits into cavity 103 of device 100′, specifically a section located inside socket 118 of the adapter into which the device may be inserted. See e.g. a section 212 of a device 210 in FIGS. 2A and 213.

In some embodiments, connection unit 102a′ of device 100′ and/or connection unit 102b′ of adapter 114 may facilitate a connection between device 100′ and adapter 114 (see e.g. connection 102 between device 100 and plug 104 as shown in FIG. 1C). Specifically, any or both of connection units 102a′ and 102b′ may facilitate a physical attachment, a data connection and/or a power connection between device 100′ and adapter 114, when the device is connected to the adapter.

FIG. 1E shows an embodiment 120 of the invention which may include a finger-worn device 130 and an adapter 132. FIG. 1E further shows a device 144 which may be any device known in the art, such as a computer or a mobile phone. Similarly to device 100, device 130 is shown having a cavity 103 into which a finger may be inserted. As shown in FIG. 1E, adapter 132, or a section thereof (e.g. a plug 140 which me be included in adapter 132, as shown in FIG. 1E), may be inserted into cavity 103 of device 130 when cavity 103 is not occupied by a finger (otherwise when a finger is not wearing device 130). For example, adapter 132 may have a section, such as plug 140 as shown in FIG. 1E, which can fit into cavity 103 of device 130. The width of plug 140 may be similar to that of a common human finger so that it is fitted to occupy cavity 103.

In some embodiments, as shown in FIG. 1E, adapter 132 may include a connector 142 for connecting to device 144, whereas device 144 may include a connector 146 for connecting to adapter 132. Connectors 142 and 146 may be any means for facilitating a connection between device 144 and adapter 132. Accordingly, connector 142 of adapter 132 and/or connector 146 of device 144 may facilitate a connection between the adapter and device 144. Said connection may be a physical attachment, a data connection and/or a power connection. For example, connector 142 of adapter 132 may be a plug (e.g. a universal serial bus (USB) plug), whereas connector 146 of device 144 may be a socket (e.g. a USE socket) into which connector 142 may be inserted, such that a connection (e.g. a USB connection) may be formed between device 144 and adapter 132. Accordingly, when connector 142 is connected to connector 146, adapter 132 and device 144 may be connected by any type of connection known in the art.

Note that in FIG. 1E, adapter 132, specifically plug 140 of the adapter, is shown ready to be inserted into device 130, specifically into cavity 103 (guidelines illustrated as dashed lines), whereas adapter 132, specifically connector 142 of the adapter, is shown ready to connect to device 144, specifically to connector 146 (connection direction illustrated in the figure as a dashed arrow).

In FIG. 1E there is shown device 130 including a data connector 134a and a power connector 136a, both may be located on a surface 131 facing cavity 103 of device 130 (data connector 134a and power connector 136a illustrated in the figure by dashed lines, suggesting they are not shown (otherwise obscured) from the point of view of the figure). Further shown in the figure is adapter 132, specifically plug 140, including a data connector 134b and a power connector 136b. Data connector 134a may connect (or be connected) to data connector 134b for facilitating a data connection (see ref. a data connection 134 in FIG. 1F) between adapter 132 and device 130 (otherwise for facilitating communication between the adapter and device 130), whereas power connector 136a may connect to power connector 136b for facilitating a power connection (see ref. a power connection 136 in FIG. 1F) between adapter 132 and device 130 (e.g. electricity may transfer, or be transferred, from adapter 132 to device 130, and/or from device 130 to adapter 132, by utilizing a connection between power connectors 136a,b).

Similarly to the described above for a power connection and data connection between adapter 132 and device 130, a power connection and/or data connection may be facilitated between adapter 132 and device 144, such as in case adapter 132 includes an additional data connector (i.e. additional to data connector 134b) and an additional power connector (i.e. additional to power connector 136b), and in case device 144 includes similar connectors. For example, connector 142 of adapter 132 may specifically include a data connector and a power connector (optionally in addition to plug 140 of adapter 132 including data connector 134b and power connector 136b), whereas connector 146 may specifically include a data connector and a power connector, and whereas the data and power connectors of connector 142 may specifically connect to the data and power connectors of connector 146, when connector 142 is connected to (e.g. inserted into) connector 146.

In some embodiments, as shown in FIG. 1E, device 130 may include a memory unit 138a, whereas device 144 may include a memory unit 138b. Memory units 138a,b may be any means or capacity for storing data (e.g. Flash memory). Additionally, adapter 132 may facilitate data transfer between device 130 and device 144. More specifically, adapter 132 may facilitate data transfer between memory unit 138a of device 130 and memory unit 138b of device 144. Accordingly, data may transfer from device 130, specifically from memory unit 138a of device 130, to device 144, specifically to memory unit 138b of device 144, and/or transfer from device 144, specifically from memory unit 138b of device 144, to device 130, specifically to memory unit 138a of device 130. Data may transfer (or be transferred) by utilizing adapter 132, such as in case the adapter can facilitate data exchange (or communication) between device 130 and device 144.

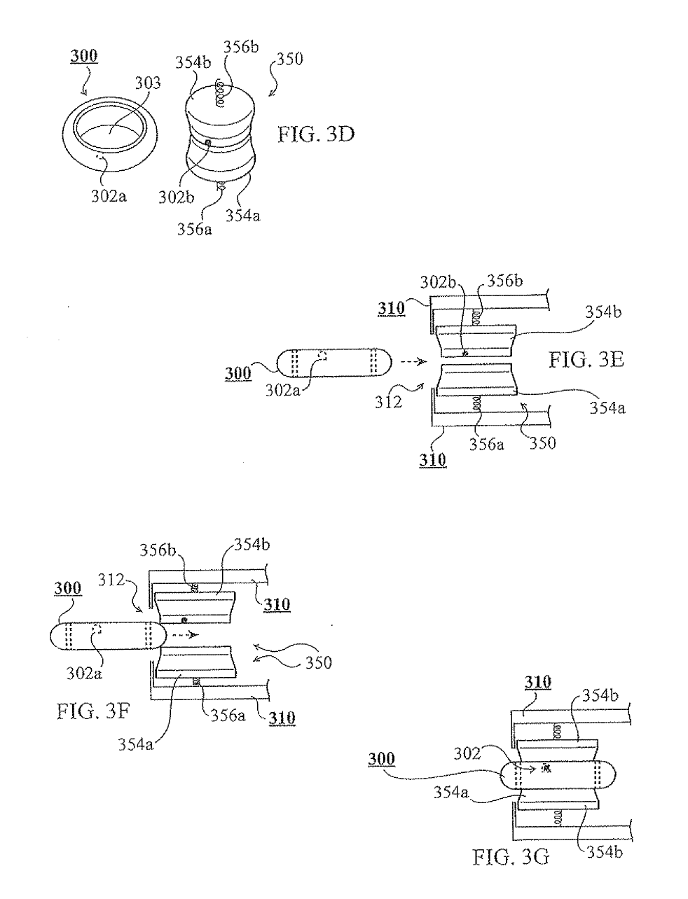

In some embodiment, device 130 may be operated while connected to adapter 132 which may optionally be connected to device 144. For example, device 130 may include a rotatable section and a stationary section (see e.g. a rotatable section 702 and a stationary section 704 of a device 700 as shown in FIGS. 7A and 7B), whereas said stationary section can directly connect to adapter 132 and remain stationary while device 130 is being operated by rotating said rotatable section relative to said stationary section and relative to adapter 132. Rotating said rotatable section may be for registering input which may be relayed (as exemplary data) to device 144 when adapter 132 is connected to device 144 (in addition to being connected to device 130). For example, device 130 may include an input unit (see e.g. an input unit 514 of a device 500 as shown in FIG. 5A) which may be interacted with to register input and to transfer said input to device 144, optionally by utilizing adapter 132 to transfer data from device 130 to device 144.

Note that it is made clear by the described herein that any finger-worn device of the invention may be operated while connected to another device, to an adapter or to a connector.

FIG. 1F shows embodiment 120 such that adapter 132 is connected to device 130. More specifically, plug 140 of adapter 132 may be inserted into device 130 (occupying cavity 103 of device 130), do that a connection between the device and the adapter may be formed. Note that embodiment 120, when adapter 132 is connected to device 130, can connect to another device (e.g. device 144), such as by utilizing connector 142 (of adapter 132).

In FIG. 1F there is shown data connector 134a connected to data connector 134b (e.g. contacts of the connectors may be overlapping and in contact with each other) forming a data connection 134. Further shown in the figure is power connector 136a connected to power connector 136b, forming a power connection 136 (data connection 134 and power connection 136 are illustrated in FIG. 1F for depiction purposes only, as they may be generally located between device 130 and adapter 132, not visible from the point of view of FIG. 1F).

FIG. 1G shows an embodiment 150 of the invention which may include a finger-worn device 154 and an adapter 152. Similarly to the described for device 130 and adapter 132, adapter 152, or a section thereof, may fit into (or be inserted into) a cavity 153 of device 154 which may also be a cavity into which a human finger may be inserted (or into which a finger may fit). Similarly to the described for connector 142 of adapter 132, adapter 152 may include a connector 158 for connecting adapter 152 to a device 160, and accordingly for connecting embodiment 150 to device 160 when adapter 152 is connected to device 154.

In some embodiments, device 154 may include a physical connector 156a (illustrated by dashed lines) whereas adapter 152 may include a physical connector 156b. Physical connector 156a and/or physical connector 156b may facilitate a physical connection (also “attachment”) between adapter 152 and device 154, specifically when adapter 152 (or a section thereof) is inserted into device 154. For example, physical connector 156a may connect to physical connector 156b by coming in contact with it when adapter 152 is inserted into cavity 153 of device 154. For another example, physical connector 156b of adapter 152 may include a magnet, whereas device 154 may include an enclosure made of a ferromagnetic material, so that a magnetic attachment may be formed between the adapter and the device when physical connector 156b comes in contact with said enclosure.

As shown in FIG. 1G, physical connector 156b may be located on a section of adapter 152 which may fit into cavity 153, whereas physical connector 156a may be located on a surface 151 of device 154. Surface 151 may surround (or otherwise face) cavity 153 of device 154, such that when said section of adapter 152 is inserted into the cavity, physical connectors 156a,b come in contact with each other, or otherwise connect in any way.

In some embodiments, physical connector 156a may connect to physical connector 156b magnetically, such as in case one of the connectors includes a magnet and the other connector includes a ferromagnetic material. For example, physical connector 156b may be made of a ferromagnetic material (e.g. iron), whereas physical connector 156a may include a magnet, such that when device 154 is attached to adapter 152 (e.g. a section of adapter 152 is inserted into cavity 153 of device 154), a magnetic attraction may be facilitated between the adapter and the device.

In FIG. 1G, device 160 is shown including a connector 162. Connector 162 may facilitate a physical connection of adapter 152, specifically of connector 158 of the adapter, to device 160. For example, connector 162 and connector 158 may be designed such that any of the connectors may accommodate the other connector.

FIG. 1H shows an embodiment 178 of the invention, which may include a finger-worn device 170 and an adapter 176. Device 170 is shown including a gap 173, as opposed to a cavity as described for other finger-worn devices of the invention. Gap 173 may be any opening in an enclosure or body of device 170. Accordingly, device 170 may be worn on a finger by utilizing gap 173, which can accommodate a human finger.

In some embodiments, as shown in FIG. 1H, gap 173 may be formed by arms 175a,b. For example, device 170 may include a section (e.g. enclosure) which extends arms 175a,b such that the arms may be clipped on a finger (or any similarly shaped object, e.g. adapter 176 or a section thereof).

In FIG. 1H, adapter 176 (specifically a round section thereof) is shown occupying gap 173 of device 170. Accordingly, adapter 176 (or a section thereof) may be inserted into gap 173. Otherwise, device 170 may be mounted (also “installed”, “placed” or “situated”) on adapter 176 or specifically on a section thereof (e.g. a plug of the adapter). For example, arms 175a,b of device 170 may be clipped on adapter 176 or on a section thereof.

Further shown in FIG. 1H is device 170 including a connection unit 172a (e.g. a connector, or any means for facilitating a connection), whereas adapter 176 is shown including a connection unit 172b. Connection unit 172a and/or connection unit 172b may facilitate a connection between device 170 and adapter 176, such as a physical connection (e.g. an attachment), a power connection and/or a data connection (i.e. a connection utilized for transferring data). Note that in FIG. 1H, connection units 172a,b are not shown in contact with each other, yet it is made clear that a connection between connection units 172a,b may require, in some embodiments, for the connection units to be in contact with each other.

In FIG. 1H, device 170 is shown including an input unit 177 for registering input, or otherwise for operating the device. Accordingly, device 170 may be an input device which can be operated to register input. For example, input unit 177 may be a touch sensor (i.e. a sensor which can sense touch), such that touching input unit 177 may register input. For another example, input unit 177 may be a switch, or plurality thereof.

FIGS. 1I and 1J show an embodiment 180 of the invention which may include device 100 and a connector 182. Connector 182 may be any device (or section thereof), apparatus or means which can facilitate a connection between device 100 and another device which may be connected to connector 182 or which includes connector 182. For example, connector 182 may be a section of a certain device, which may facilitate connecting device 100 to said certain device. For another example, connector 182 may be an adapter which facilitates connection of device 100 to another device, such as by connecting to device 100 and to said another device.

Connector 182 is shown in FIGS. 1I and 1J as hook-shaped (i.e. generally shaped as a hook), for facilitating gripping device 100 through cavity 103. Accordingly, in some embodiments, the shape of connector 182 may facilitate gripping device 100 or interlocking with the device, such as through cavity 103 of the device.

In FIG. 1I, connector 182 is specifically shown ready to connect to device 100 (guide to connection is illustrated in the figure by a curved dashed arrow).

In FIG. 1J, connector 182 is specifically shown connected to device 100. Following the above, connector 182 may connect to device 100 by gripping the device or interlocking with the device, utilizing cavity 103 of the device. Otherwise, connector 182 may physically attach to device 100 by any means known in the art, specifically by utilizing cavity 103.

In some embodiments, connector 182 may include a connection unit 102b (see ref. connection unit 102b of plug 104 in FIGS. 1A and 1B), for facilitating connection to device 100. For example, connection unit 102b of connector 182 may connect to connection unit 102a of device 100 when the connector is gripping the device, so that a connection 102 may be formed between the connector and the device. Note that whereas connection 102 is shown in FIG. 1J, it is suggested to be obscured from the point of view of the figure as it may be generally located between connector 182 and device 100.

In some embodiments, device 100 may be operated while connected to connector 182 (such as described herein for finger-worn devices of the invention being operable while connected to another device).

FIG. 1K shows device 100 connected to connector 182, whereas connector 182 is shown connected to a keychain 188. Accordingly, device 100 (or any finger-worn device of the invention) may be generally connected to a keychain (e.g. keychain 188), such as by utilizing a connector or an adapter (e.g. adapter 176 as shown in FIG. 1H).

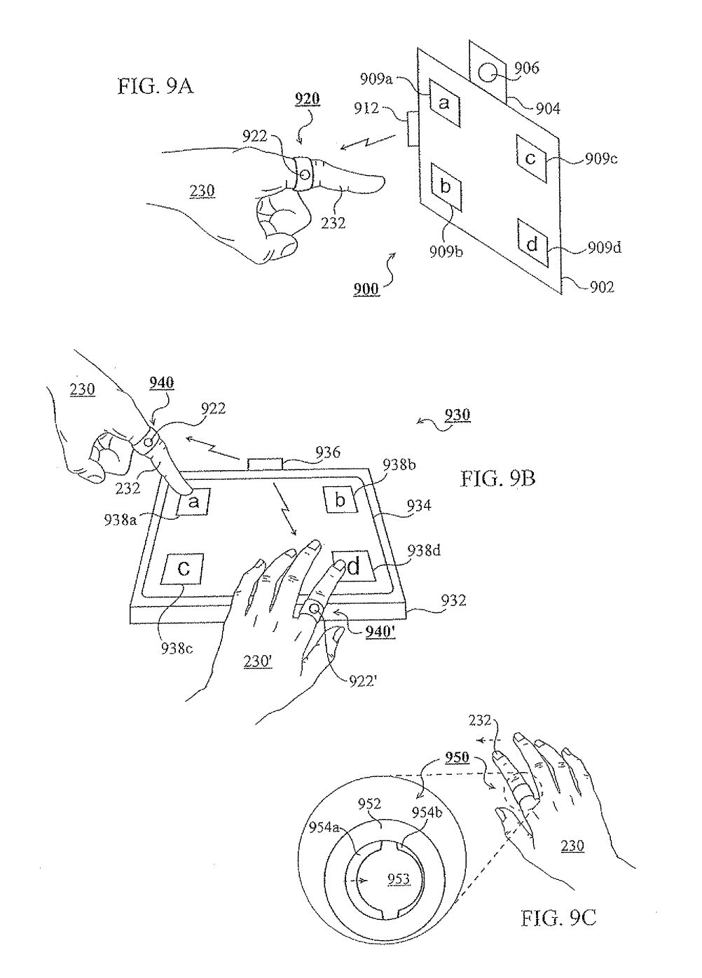

In some embodiments, a finger-worn device of the invention may directly connect to a keychain, such as by including a connection unit which can facilitate a connection between said finger-worn device and said keychain. Accordingly, an embodiment of the invention may include a finger-worn device and a keychain, wherein said finger-worn device may be connected to and disconnected from said keychain, optionally by utilizing a connector or an adapter. For example, an embodiment of the invention may include device 154 (see ref. FIG. 10) and keychain 188 (see ref. FIG. 1K), wherein device 154 may be physically attached to a keychain by utilizing physical connector 156a of the device.

FIG. 1L shows an embodiment 190 of the invention which may include device 100′ (see ref. FIG. 1D) and a connector 182′ similar to connector 182. In FIG. 1L, connector 182′ is shown including a connection unit 102W (see ref. connection unit 102W of adapter 114 in FIG. 1D) located such that it may come in contact with connection unit 102a′ of device 100′ when the device and the connector are connected. Accordingly, a connector of the invention may connect to a finger-worn device of the invention regardless of where any or both of their connection units are located.

Note that whereas described above are connections formed or facilitated by two connectors or two connection units (e.g. connection 102 fainted by connection units 102a,b, or connection 134 formed by connectors 134a,b), it is made clear that in some embodiments, any number of connectors or connection units may facilitate a connection. For example, a connection between a finger-worn device (e.g. device 130) and an adapter (e.g. adapter 176) or section thereof (e.g. plug 140 of adapter 132), or between a finger-worn device and a plug (e.g. plug 104), may be facilitated by a single connector or a single connection unit.

Further note that connectors and connection units described herein may facilitate physical connection, power connection and/or data connection, such as by including any number of means for attachment, power transfer and/or data transfer. Accordingly, connections described herein (e.g. connection 102) may be any type of connections, i.e. physical, power and/or data.

Further note that in some embodiments, no connectors or connection units may be required to facilitate physical connection (also “attachment”) between a finger-worn device of the invention and a connector, a plug or an adapter. Specifically, in some embodiments, the shape of a finger-worn device of the invention, and/or the shape of a connector, an adapter or a plug, may facilitate a physical connection between said finger-worn device and said connector, adapter or plug. For example, device 170 (FIG. 1H) may be of a shape which facilitates physical connection to a plug of an adapter (e.g. by including sections which may clip on said plug, such as arms). Accordingly, in some embodiments, device 170 may physically connect to an adapter (or a section thereof) without including a connector or a connection unit.

Further note that a cavity or gap of a finger-worn device of the invention may be formed by the shape of a section of said finger-worn device, specifically of an enclosure or body of said finger-worn device.

FIG. 2A shows an embodiment 220 of the invention which may include a finger-worn device 200 and a device 210. Device 200 may be an input device (i.e. a device which can be operated to register input) and is shown such that it includes a cavity 203 through which a finger may be inserted (so that the device may be worn on a finger). Preferably, device 200 may be operated by a thumb when worn on a finger (see ref. FIG. 2C), or operated when connected to another device (see ref. FIG. 2B). Device 210 may be any device known in the art, such as a computer, a portable digital assistant (PDA) or a handheld console.

In FIG. 2A device 210 is shown including a display 214 for displaying visual output. Alternatively or additionally, device 210 may include any means for generating or providing output (e.g. sound speakers for audio output).

In some embodiments, device 210 may include a processor 216 which may facilitate its operation (e.g. for executing programs or so-called “running” software).

In some embodiments, device 210 may include controls 218 which may facilitate operating the device or interacting with the device. Otherwise, device 210 may be operated by utilizing controls 218.

In embodiment 220, device 210 may include a section 212 which may facilitate connection of device 210 to device 200. More specifically, section 212 may fit into cavity 203 of device 200 such that device 200 may be mounted (also “installed”, “placed” or “situated”) on device 210 (mounting guidelines illustrated as dashed lines in the figure). Accordingly, device 210 may connect to device 200 by inserting section 212 of device 210 to cavity 203 of device 200, or otherwise by mounting device 200 specifically on section 212.

In some embodiments, and similarly to the described above for connectors or connection units in devices and embodiment of the invention, device 200 may include a connector 202a, whereas section 212 may include a connector 202b, such that any or both of the connectors (i.e. of connectors 202a,b) may facilitate a connection between device 210 and device 200. Said connection may be a physical connection, a power connection and/or a data connection. For example, device 200 may be connected to device 210 by inserting section 212 of device 210 into cavity 203 of device 200, whereas the insertion may be performed such that connector 202b of device 210 grips device 200 or a section thereof, or such that connector 202b connects to connector 202a of device 200 (e.g. physically attaches itself to connector 202a, such as by magnetic means or mechanical means). For another example, data may transfer between device 200 and device 210, such as by utilizing a connection between connectors 202a,b.

FIG. 2B shows embodiment 220 such that device 200 is connected to device 210, specifically mounted on section 212 of device 210. Following the above, device 200 may be an input device which may be operated while connected to device 210. For example, device 200, or a rotatable section thereof, may be rotated for registering input in device 200 and/or in device 210. For another example, a finger (e.g. thumb) may touch and move (also “slide”) on a surface of device 200, for registering input. In FIG. 2B there is illustrated a curved dashed line having arrowheads, suggesting rotation or sliding directions for operating device 200.

Note that in some embodiments, device 210 may be a docking device (or station), a host device or a cradle device for device 200 such as known in the art (e.g. as known for docking devices for laptops or cradle devices for handheld devices). For example, device 210 may be used to recharge device 200 (specifically a power source included in device 200) or to retrieve and utilize data stored on device 200 (specifically in a memory unit of device 200).

Further note that embodiment 220 may be modular, wherein device 210 and device 200 may be modules which can connect and disconnect.

In FIG. 2B there is further shown display 214 of device 210 displaying an interface element 222 (e.g. a graphic bar or slider). Note that interface element 222 may be any element (visual or otherwise) of an interface or program of device 210. In the figure there is illustrated a straight dashed line having arrowheads, suggesting directions by which interface element 222 (of a section thereof) may be controlled or manipulated (e.g. moving directions for a handle of the interface element). In some embodiments, rotating device 200 or a section thereof, or sliding on a surface of device 200 (in directions suggested by the aforementioned curved dashed line in the figure), or in any way operating device 200, may be for controlling or manipulating interface element 222 (or a section thereof). More specifically, directions of rotation of device 200 (or a section thereof), or of sliding on a surface of device 200, may correspond to directions of control (or manipulation) of interface element 222 (or a section thereof). For example, rotating a rotatable section of device 200 may increase or decrease properties or variables of interface element 222, and/or move interface element 222 or a section thereof, preferably correspondingly to the direction of rotating said rotatable section of device 200. Optionally, for the same example, rotating said rotatable section may be for registering input which may transfer (or be transferred) from device 200 to device 210, such as by utilizing a connection of connectors 202a,b.

Note that whereas the described above specifically refers to rotation of device 200 (or a section thereof), or sliding on a surface of device 200, it is made clear that the described may similarly refer to any other operation performed by (or “with”, or “on”) device 200. For example, device 200 may include a so-called thumb-stick as known in the art, which may be tilted in two or more directions (such that the described above for directions of rotating or sliding may apply to directions of tilting).

FIG. 2C shows device 200 being worn on a finger 232 of a hand 230. Note that whereas finger-worn devices of the invention are mostly shown herein (and described herein) when worn on a finger, as being worn on an index finger, it is made clear that finger-worn devices of the invention may be worn on any finger of a hand.

As shown in FIG. 2C, device 200 can be operated by a thumb 234 of hand 230, when the device is worn on finger 232, or on any other finger of the same hand. For example, device 200, or a section thereof, may be rotated by thumb 234 in directions illustrated in FIG. 2C by a curved dashed line having arrowheads. Said curved dashed line may otherwise suggest directions of sliding thumb 234 on a surface of device 200.

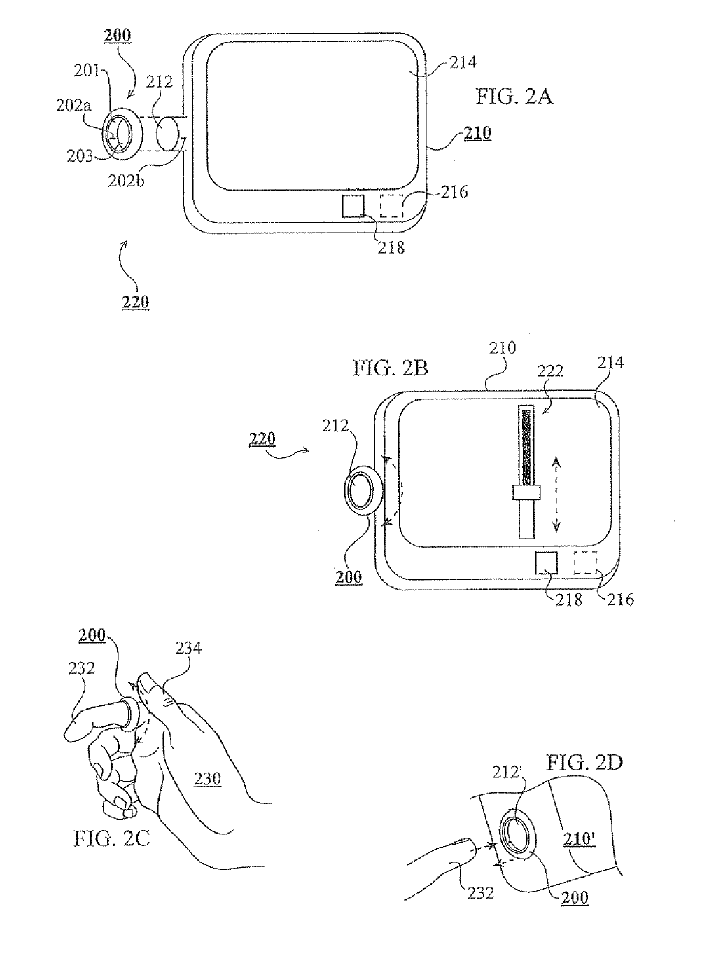

In some embodiments, operating device 200 (e.g. rotating a section of the device) when device 200 is worn on a finger may be for registering input, specifically in device 210. Otherwise, operating device 200 when device 200 is worn on a finger may be for communicating input (wirelessly) to device 210 (e.g. for controlling interface elements of device 210, such as interface element 222). Accordingly, operating device 200 may control or manipulate (also “influence”) device 210 (or specifically an interfaces or programs of device 210) remotely (i.e. device 200 may not be physically connected to device 210, yet may be communicating with it, such as by sending signals). For example, device 200 may include a transceiver (see e.g. a transceiver 315b in FIG. 3A) whereas device 210 may include a transceiver (see e.g. a transceiver 315a in FIG. 3A), facilitating wireless communication (in which input data may be transmitted or sent from device 200 to device 210). Said transceivers may alternatively be a transmitter and a receiver, for so-called one-way communication.

Following the above, in some embodiments, device 200 may be operated when worn on a finger (FIG. 2C) and when connected to device 210 (FIG. 2B), for controlling an interface (or program), or elements thereof, in device 210. See ref. a device 300 operated by finger 232 when connected to a device 310, in FIG. 3C.

In some embodiments, operating device 200 while it is worn on a finger may be for registering the same input as when operating device 200 while it is physically connected to device 210. Alternatively, operating device 200 when it is worn on a finger or connected to device 210 yields (or registers) different input (even though operated similarly, e.g. rotating in the same direction).

In some embodiments, operating device 200 (either when worn on a finger or when connected to device 210) may substitute operating device 210, such as specifically providing an alternative to operating controls 218. Similarly, in some embodiments, operating device 200 may be performed in collaboration of operating device 210. For example, controls 218 may include a scrolling input control (e.g. a section of a touchpad which is designated for executing scrolling functions in an interface or program) which may facilitate a scrolling function of an interface element (e.g. moving of a handle of a scroll-bar) of an interface (or program) of device 210, whereas a rotatable section of device 200 may facilitate the same scrolling function, so that said scrolling function may be executed by operating said scrolling input control of control 218, and/or by operating (e.g. rotating) said rotatable section of device 200. For another example; controls 218 may include a button which may be operated (e.g. pressed) for a prompting a specific interface event, whereas operating said button while operating device 200 (e.g. by two hands, one pressing on said button and another operating device 200) may be for prompting a different interface event.

In some embodiments, disconnecting (also “detaching”, “releasing” or “removing”) device 200 from device 210 may be facilitated by operating device 210 (e.g. pressing a button or rotating a knob of device 210).

In some embodiments, disconnecting device 200 from device 210 may be by operating section 212 of device 210. For example, when device 200 is mounted on section 212 of device 210 (i.e. section 212 occupies cavity 203 of device 200), a finger may press on section 212, whereas by pressing on section 212 a mechanism of device 210 may be actuated for removing device 200 from device 210. More specifically, pressing on section 212 may release (or disconnect) a physical connection between connectors 202a,b (in case they facilitate a connection between the two devices) so that device 200 can be removed from section 212, or such that device 200 automatically “pops out” from its position on the section. Alternatively or additionally, disconnecting device 200 from device 210 may be by manually pulling device 200 from its position on section 212.

FIG. 2D shows device 200 being disconnected from a device 210′ by finger 232. Device 210′ is similar to device 210 by having a section 212′ (similar to section 212 of device 210) which is fitted to occupy a cavity of a finger-worn device (e.g. a cavity of device 200, as shown in the figure). In device 210′, section 212 is shown located inside a socket (see e.g. socket 118 in FIG. 1D) of device 210′, into which device 200 can fit when connected to device 210′. Accordingly, when device 200 is connected to device 210′, section 212′ of device 210′ fits inside cavity 203 of device 200, whereas device 200 fits inside said socket of device 210′. Optionally, device 200 cannot be pulled manually when it is inserted inside said socket. Accordingly, in some embodiments, a finger (e.g. finger 232 as shown in FIG. 2D) can press on section 212′ (illustrated a direction of pressing by a dashed arrow directed from the finger to the section) to disconnect device 200 from device 210′, specifically from the aforementioned socket of device 210′. Device 200 may “pop out” (optionally automatically, such as by means for mechanically pushing it) of the socket of device 210′ when a finger presses (or otherwise in any way operates) section 212′ of device 210′ (illustrated a direction of “popping out” by a dashed arrow directed away from device 210′).

FIG. 3A shows an embodiment 320 of the invention which may include a finger-worn device 300 similar to device 200 (and to other finger-worn devices of the invention, e.g. device 100), and a device 310 similar to device 210. Device 310 is shown including controls 308, for operating device 310 (or otherwise for interacting with device 310). In FIG. 3A, device 300 is shown ready to be connected to device 310. Specifically, device 300 is shown ready to be inserted into a slot 312 of device 310. Slot 312 may be any socket, or otherwise cavity, gap or opening of device 310. Preferably, when device 300 is not connected to device 310 (such as when worn on a finger), the devices can communicate wirelessly, such as by establishing a wireless data connection (whereby data may be transferred wirelessly from device 300 to device 310 and/or from device 310 to device 300). For example, as shown in FIG. 3A for a device 300′ similar to device 300 and including a transceiver 315b, signals may be transferred from device 310 to device 300′ and from device 300′ to device 310 which may include a transceiver 315a. Further note that alternatively, any of devices 310 and 300′ may include a transmitter whereas the other device may include a receiver, for a so-called one-way communication. Further note that any device of the invention may include and/or utilize a transmitter and/or a receiver (or otherwise a transceiver), for wireless communication. Further note that embodiment 320 may not include device 300′ which is shown to depict wireless communication.

Following the above, and similarly to the described for devices 200 and 210 (of embodiment 220), device 300 may be operated while (also “when”) connected to device 310 and while not connected to device 310 (e.g. by utilizing wireless communication), such as when worn on a finger. In some cases (e.g. some interfaces or programs of device 310), operating device 300 may be for the same functions when it is connected to device 310 and when it is not. In other cases, operating device 300 when it is connected to device 310 may be for different functions than when device 300 is disconnected from device 310. For example, sliding a finger (e.g. a thumb 234 of hand 230) on an external surface of device 300 may be for scrolling through a text or web document displayed by device 310 (in case device 310 includes a display, see e.g. display 214 of device 210 in FIGS. 2A and 2B) either when device 300 is physically connected to device 310 (e.g. by occupying slot 312) or when device 300 is worn on another finger (e.g. finger 232) and wirelessly communicates with device 310 (e.g. by sending transmissions). When device 300 is physically connected to device 310 by being inside (also “occupying”) slot 312, the aforementioned external surface of device 300, on which a finger can slide for a scrolling function, may preferably be exposed through slot 312 (see in FIGS. 3B and 3C a section of device 300 protruding from the slot). Accordingly, any operable element or section of device 300 is suggested to be exposed (or otherwise reachable or accessible) when device 300 is inside slot 312, or otherwise in any way connected to device 310.

FIG. 3B shows device 300 connected to device 310, generally (i.e. to a certain extent) being inside slot 312 (shown partially protruding from the slot). In some embodiments, similarly to the described for device 200 and device 210 (of embodiment 220, see ref. FIGS. 2A and 2B) device 300 may be operated when (also “while”) connected to device 310 and when not connected to device 310, such as when worn on a finger (see e.g. device 200 being operated when worn on finger 232 in FIG. 2C). In FIG. 3B there is illustrated a curved dashed line having arrowheads, suggesting directions of operating device 300 when connected to device 310 (e.g. directions for rotating device 300 or a section thereof, or directions of sliding a finger on a surface of device 300).

In some embodiments, device 300 may be disconnected (also “released”, or “removed”) from device 310, such as by “popping out” of slot 312 by pressing on device 300 towards the inside of slot 312 (in case connection between the devices is facilitated by device 300 occupying slot 312), similarly to disconnecting common memory cards from laptops having slots for said common memory cards (e.g. SD cards as known in the art), whereby pressing on said common memory cards, the cards are removed by “popping out” of said slots. In some embodiments, device 300 may similarly be connected to device 310 by being pressed into slot 312 (also similarly to inserting common memory cards into slots of laptops). For example, force may be applied on a mechanism inside slot 312 (see e.g. a mechanism 350 in FIG. 3D) when pressing device 300 into the slot, for locking the device inside the slot. Then, when the device is in the slot, force may be applied on said mechanism (by pressing on device 300) such that said mechanism unlocks device 300 and device 300 is released from the slot (optionally by “popping out” of the slot). In alternative embodiments, a control on device 310 may be operated for releasing device 300 from slot 312. Note that the described above may be beneficial for when device 300 cannot be manually pulled from slot 312 to disconnect it from device 310.

FIG. 3C shows embodiment 320 being operated by hand 230. Specifically, thumb 234 may be operating controls 308 of device 310 (or otherwise interacting with device 310), whereas finger 232 may be operating device 300. Devices 300 and 310 of embodiment 320 are shown connected in FIG. 3C.

In some embodiments, operating device 300 when it is connected to device 310 may be similar to operating a scroll-wheel, as known in the art (e.g. a computer mouse scroll-wheel). In FIG. 3C there are illustrated dashed arrows, suggesting directions of moving finger 232 to operate device 300, such as specifically for rotating the device or a section thereof (similarly to rotating a scroll-wheel), or for sliding the finger on the protruding section of device 300 (i.e. the section of the device which is outside slot 312 of device 310, and accordingly visible from the point of view of FIG. 3C).

Following the above, device 300 may be utilized to register input in device 310, or otherwise to control device 310, remotely or otherwise, similarly to device 200 being operated to register input in device 210, as described above (see ref. FIGS. 2A through 2C).

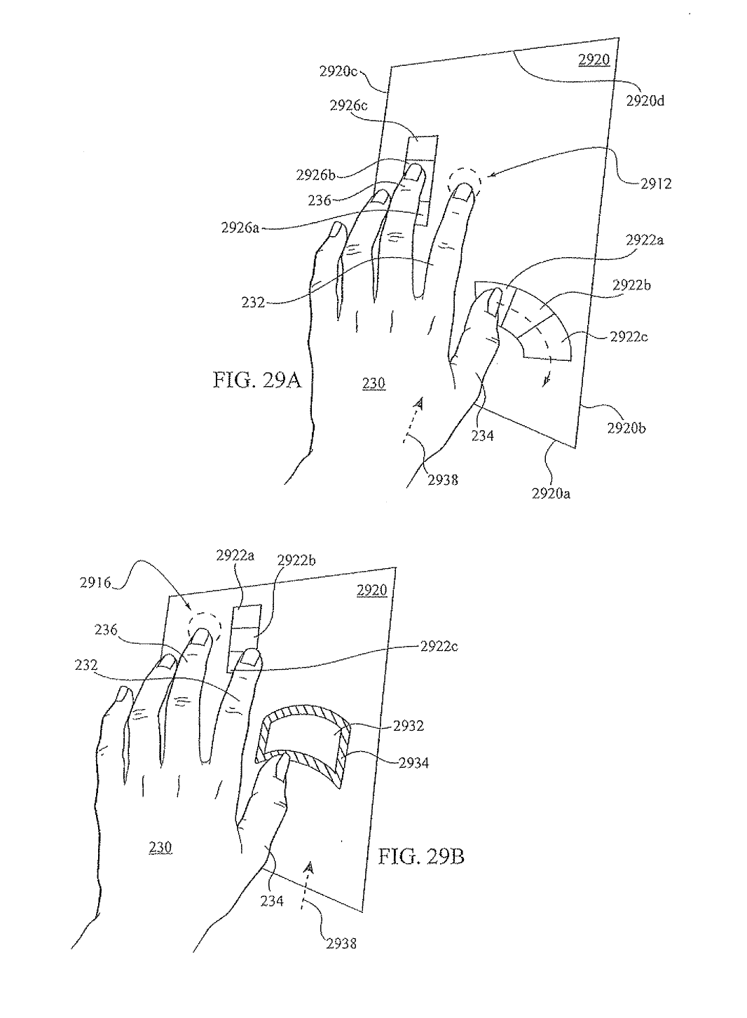

FIG. 3D shows device 300 and a mechanism 350 as an exemplary apparatus inside a device 310, specifically inside slot 312, for connecting device 300 to device 310. Device 300 is shown in FIG. 3D including a cavity 303 and a connection unit 302a (illustrated by dashed lines, suggesting the connection unit is facing cavity 303 and being obscured from the point of view of FIG. 3D) similar to connection units or connectors as described above. Mechanism 350 is shown in the figure generally including a section 354a and a section 354b installed on a spring 356a and a spring 356b, respectively. The mechanism is further shown including a connection unit 302b located on section 354b. Sections 354a,b may fit inside a cavity 303 of device 300, for a physical connection facilitated by mechanism 350. Optionally, a power and/or data connection between device 300 and device 310 may be facilitated by a connection (see ref. a connection 302 in FIG. 30) between connection unit 302a of device 300 and connection unit 302b of mechanism 350.

FIGS. 3E through 3G show from a cross-section point of view device 300 and mechanism 350, whereas the mechanism is shown included in device 310, specifically inside slot 312. The figures show a process of connecting device 300 to mechanism 350 and accordingly to device 310 which may include the mechanism.

FIG. 3E specifically shows device 300 approaching mechanism 350 (e.g. a user holding device 300 may push it towards the mechanism). Mechanism 350, generally including sections 354a,b installed on springs 356a,b, is shown inside device 310, specifically in an internal side of slot 312 (into which device 300 can be inserted). Cavity 303 of device 300 is suggested to be located between the four straight dashed lines illustrated inside device 300 (in FIGS. 3E through 3G).

FIG. 3F specifically shows device 300 partially inserted into slot 312, while sections 354a and 354b are partially pressed downward and upward, respectively, by device 300 being inserted into the slot. Sections 354a and 354b are shown installed on springs 356a and 356b, respectively, such that they can be dynamically pressed to allow for device 300 to be inserted into slot 312.

FIG. 3G specifically shows device 300 generally inserted into slot 312 (whereas partially protruding out of the slot, such as to facilitate operating device 300 while it is connected to device 310). In FIG. 3G, sections 354a,b fit inside cavity 303 of device 300, whereas connection unit 302b (located on section 354b) is connected to connection unit 302a (located on device 300 facing the cavity) for a connection 302 (which can be any of a physical connection, a power connection and a data connection). From the position of device 300 in FIG. 3G, as connected to device 310, a finger can operate device 300 (see e.g. the connected devices being operated in FIG. 3C), such as by rotating or sliding a finger on device 300 where it is protruding from the slot.

Note that whereas the described herein for FIGS. 3E through 36 is for a specific apparatus of connection (i.e. mechanism 350), any other means known in the art may be utilized for connecting device 300 to device 310.

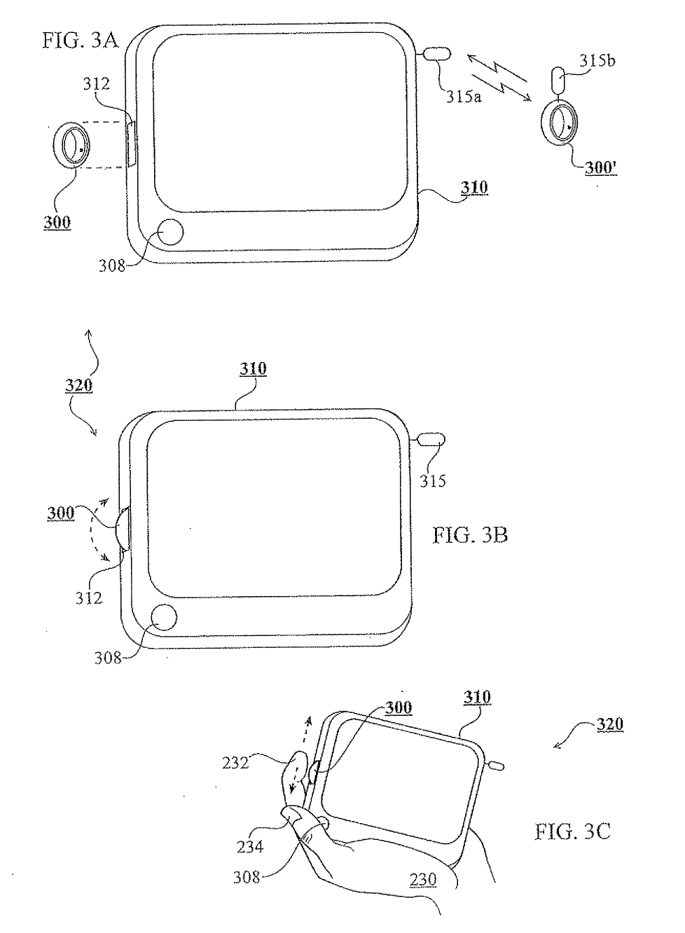

Following the above (and also the shown in and described for FIGS. 4A and 4B), a finger-worn device of the invention may connect (also “be connected”) to devices, specifically devices including interfaces or programs which may be controlled (or otherwise influenced) by said finger-worn device. Preferably, a finger-worn device of the invention may connect to another device by utilizing a cavity of said finger-worn device, such as a cavity fitted for a finger to be inserted through and for facilitating connections.

FIGS. 4A and 4B show an embodiment 420 of the invention which may include a finger-worn device 400 and a stylus 410 which can connect to each other (and disconnect from each other), similarly to the described above for finger-worn devices connecting to other devices. Device 400 is shown including a cavity 403 (fitted or designed for a human finger), a connection unit 402a, a power source 408 and an output unit 406, whereas stylus 410 is shown including a power source 418, a connection unit 402b and an output unit 416. Device 400 may be an input device as described herein for other finger-worn devices. Stylus 410 may be any stylus known in the art, such as an electronic pen to be operated with so called tablet-PCs.

FIG. 4A specifically shows device 400 ready to be connected to stylus 410. Specifically, stylus 410 may include an elongated body 411, which may be a section facilitating grip of a hand (as known for common styluses). Body 411 may be designed such that device 400 can fit on it (otherwise be mounted on it, whereas mounting guidelines are illustrated in FIG. 4A as dashed lines from device 400 to stylus 410). Otherwise, cavity 403 is shown fitted to be accommodate the width of body 411 of stylus 410.

FIG. 4B specifically shows device 400 mounted on body 411 of stylus 410. Optionally, connection unit 402a of device 400 and/or connection unit 402b of stylus 410 may facilitate a connection between the device and the stylus, such as an attachment (also “physical connection”), power connection and/or data connection. Accordingly, a connection between device 400 and stylus 410 may be facilitated by any or both of connection units 402a,b. In some embodiments, connection unit 402a may connect to connection unit 402b when device 400 is mounted on body 411 of stylus 410. A connection between connection units 402a,b may facilitate transfer of data and/or power from stylus 410 to device 400 and/or from device 400 to stylus 410.

In some embodiments, power may transfer (or be transferred) from power source 408 of device 400 to power source 418 of stylus 410, and/or from power source 418 to power source 408, such as by a connection between connection units 402a,b. For example, power source 408 may be recharged by power source 418, whereas alternatively or additionally, power source 418 may be recharged by power source 408. Note that power source 408 and/or power source 418 may be, in some embodiments, recharged by other means. For example, power source 418 may be recharged by a power supply from a computer, such as when stylus 410 is connected (e.g. docked) to said computer.

In some embodiments, data may transfer (or be transferred) from device 400 to stylus 410, and/or from the stylus to the device. For example, device 400 may include a first memory unit (see e.g. a memory unit 404 of a finger-worn device 430 in FIG. 4C), whereas stylus 410 may include a second memory unit (see e.g. a memory unit 414 of a stylus 450 in FIG. 4C), such that data may transfer (e.g. by a connection between connection units 402a,b) from said first memory unit to said second memory unit, and/or from said second memory unit to said first memory unit.

In some embodiments, data transferred from device 400 to stylus 410 may prompt output unit 418 to generate output (e.g. visual output such as colored light), whereas data transferred from stylus 410 to device 400 may prompt output unit 408 to generate output (note that output units 408 and 418 may be any number of means for generating or producing output, such as light emitting diodes or sound speakers). For example, device 400 may be operated while being mounted on stylus 410, whereas input registered by operating the device (as exemplary data) may be transferred from the device to the stylus, such as to control or manipulate (also “affect”) elements included in the stylus (e.g. to prompt output unit 416 of stylus 410 to generate output), or such as to prompt the stylus to relay said data to another device. Note that data may be, in some embodiments, transferred to and/or from device 400 to and/or from another device, and that data may be, in some embodiments, transferred to and/or from stylus 410 to and/or from another device. For example, data from stylus 410 may be transferred to a computer, such as by a wireless communication between the stylus and said computer. For another example, device 400 may receive transmissions or signals from a computer.

In some embodiments, connection unit 402a and/or connection unit 402b (or otherwise a connection between the connection units) may facilitate a physical connection (also “attachment”) between device 400 and stylus 410. For example, a magnetic connection (i.e. an attachment by means for magnetic attraction) may be facilitated between connection units 402a,b. For another example, a springs mechanism (optionally included in connection unit 402h) pressing on device 400 when it is mounted on body 411 may fasten (to a certain extent) device 400 to stylus 410.

In some embodiments, stylus 410 may be a non-electronic product (also “item” or “object”) on which device 400 can be mounted for convenience purposes of using the stylus and/or operating the device (e.g. using the stylus while operating the device). In other embodiments, either or both of stylus 410 and device 400 may not include a power source, yet may modulate signals originating from a separate device (e.g. by including a so-called “passive” radio-frequency or resonant circuit, as known in the art), such as for tracking the location of either the stylus or the device (or both) by said separate device.

In some embodiments, device 400 may be operated while mounted on body 411 of stylus 410 (additionally or alternatively to being operable while worn on a finger). For example, device 400 (or a section thereof) may be rotated generally around body 411 for registering input, as suggested rotation direction illustrated in FIG. 4B by a curved dashed line having arrowheads.

FIGS. 4C and 4D show an embodiment 440 of the invention which may include a finger-worn device 430 and a stylus 450, such that the device and the stylus may connect and disconnect from each other (i.e. may be modules of the embodiment, which may accordingly be modular). Device 430 is shown including a memory unit 404, whereas stylus 450 is shown including a memory unit 414 and a socket 412 (similar to slot 312 of device 300 as shown in FIGS. 3A and 3B). Socket 412 may be fitted for insertion of device 430 (into the socket). Otherwise, socket 412 may accommodate device 430.

FIG. 4C specifically shows device 430 ready to be connected to stylus 450. More specifically, device 430 is shown ready to be inserted into socket 412 of stylus 450, whereas insertion guidelines are illustrated in FIG. 4C as dashed lines from the device to the stylus (and specifically to the socket).

FIG. 4D specifically shows device 430 connected to stylus 450 by being partially inside socket 412 (otherwise occupying the socket). Device 430 may be operated while connected to stylus 450, or otherwise while occupying socket 412 of stylus 450. In FIG. 4D, device 430 is shown protruding from stylus 450 from two sides of the stylus (specifically of the body of the stylus), in case the body of the stylus (see e.g. body 411 of stylus 410 in FIGS. 4A and 4B) is thin enough, and in case socket 412 has two openings (otherwise in case the stylus may include two sockets sharing a hollow section inside the body of stylus 450).

In some embodiments, device 400 (or a section thereof) can be rotated while inside socket 412, from one or two sides of stylus 450 (or specifically of the body of the stylus). Similarly, in some embodiments, device 430 may include one or more two touch-sensitive surfaces (surfaces which can sense touch), such that any touch-sensitive surface exposed from stylus 450 when device 430 is inside socket 412 may be interacted with (i.e. touched for registering input). Otherwise, device 430 may include any input unit (see e.g. an input unit 514 of a finger-worn device 500 in FIG. 5A) which is exposed or otherwise accessible when the device is inside socket 412 of stylus 450, so that it may be operated (or interacted with) when the device is connected to the stylus.

Following the above, it is made clear that a finger-worn device of the invention may connect to a stylus, such as specifically by being mounted on a body of said stylus, and may be operated while connected to said stylus.

FIG. 5A shows an embodiment of the invention as a finger-worn device 500 which may include a section 510 and an input unit 514. Section 510 may essentially be the body of device 500, whereas input unit 514 may be any means for facilitating registering input (e.g. controls). Otherwise, input unit 514 may be operated or interacted with, such as by including a sensor or plurality thereof.

As shown in FIG. 5A, device 500 may further include a section 520 which surrounds a cavity 503 (otherwise in which cavity 503 is located), through which a finger may be inserted. Section 520 may be made of (or include) a comfortable material, to facilitate comfortable wearing of device 500 by a finger. Said comfortable material may be, additionally or alternatively, flexible (e.g. silicone rubber material, as known in the art), such as to facilitate accommodation of a range of different finger sizes (e.g. by flexing for larger sized fingers) inside cavity 503. Accordingly, a finger (specifically a finger of a size within a certain range of finger sizes) may be inserted into section 520 (whereat cavity 503 is located), while section 520 is connected to section 510.

In some embodiments, device 500 may be modular, such that section 520 may be connect to and disconnect from section 510. Additionally, device 500 may include a plurality of sections, similar to section 520 (otherwise any number of sections similar to section 520), of different sizes, for facilitating accommodation of different ranges of finger sizes. Each of said plurality of sections may be connected and disconnected from section 510. Connecting a specific section from said plurality of section may be to best fit (or facilitate accommodation of) a specific size of a finger which is within the range of finger sizes which may be accommodated by said specific section (such as by said specific section flexing to different extents for different finger sizes within said range). Otherwise, each section from said plurality of sections may have a different cavity size through which a finger may be inserted, whereas any section from said plurality of sections may be connected to section 510 for changing the size of cavity 503 of device 500. For example, device 500 may include a first section 520 which can accommodate fingers in sizes ranging from 46.5 mm to 54 mm in width (ring size 4 to 7 as known by a certain common scale), a second section 520 which can accommodate fingers in sizes ranging from 55.3 mm to 61.6 mm in width (ring size 7.5 to 10) and a third section 520 which can accommodate fingers in sizes ranging from 62.8 mm to 69.1 mm in width (ring size 10.5 to 13), such that any of said first, second and third section 520 may be connected to section 510 to facilitate wearing device 500 on a finger, the size of which is within the accommodation range of the connected section, as specified for this example.

FIG. 5B shows device 500 such that section 520 is disconnected from section 510 (as opposed to the shown in FIG. 5A wherein section 520 is connected to section 510).

FIG. 5C shows a section 540 which may be included in an embodiment of device 500 (in addition or alternatively to section 520). As shown, section 540 may accommodate a range of different finger sizes than section 520. Specifically, section 540 may include a cavity 503′ different in size than cavity 503 of section 520 (so that by considering extents by which sections 520 and 540 can flex, each of the section may accommodate a different range of sizes of fingers). Following the above, section 520 may be replaced by section 540, such that a cavity of device 510 (cavity 503 is substituted by cavity 503′ by the replacement) is different in size when section 540 is connected to section 510 than when section 520 is connected to section 510.

Note that it is made clear that within the scope of the invention is an embodiment which includes a finger-worn device and any number of sections which can be connected and disconnected from said finger-worn device, whereas each of said sections may accommodate a finger of a size within a range of finger sizes (and whereas said range of finger sizes may be different than any range within which a finger may be accommodated by any other section). Such an embodiment may be marketed as a product including said finger-worn device and said any number of sections, whereas a user having a certain size of a finger may connect any of said sections which best accommodates said size to said finger-worn device, and not use (e.g. discard or store) the rest of said sections.

In FIG. 5D shows an embodiment 550 of the invention which may include a device 560 and a finger-worn section 570. Device 560 may be any device, such as a compact input device which can be operated to register input. Specifically, device 560 is shown in FIG. 5D including an input unit 564 which can be operated (such as in case the input unit includes controls). Finger-worn section 570 may be any item or object which can be worn on a finger. Specifically, finger-worn section 570 is shown including a cavity 573 through which a finger may be inserted, for wearing the finger-worn section on a finger.

In some embodiments, device 560 may connect (or be connected) to, and disconnect (or be disconnected) from, finger-worn section 570 (note that whereas in FIG. 5D device 560 and finger-worn section 570 are shown as separated, it is made clear that they be connected to each other). Connecting device 560 to finger-worn section 570 may facilitate wearing the device on a finger, such as in case the device cannot be directly worn on a finger (in which can a user may wear finger-worn section 570 on a finger and connect device 560 to the finger-worn section, such that the device is essentially worn on said finger). For example, cavity 573 may accommodate a finger so that finger-worn section 570 can be worn on a finger, whereas the finger-worn section may include a first connector (or connection unit) which facilitates connecting the finger-worn section to another device which includes a second connector, whereas device 560 may include said second connector, so that the device may be connected to the finger-worn section, and essentially be worn on a finger (while the finger-worn section is worn on a finger and connected to the device).

Note that it is made clear the within the scope of the invention is an item or object which can be worn on a finger (e.g. finger-worn section 570) and to which a device (e.g. device 560) may be connected, for facilitating wearing said device on a finger. Specifically, said item or object may be marketed as a product which facilitates wearing certain devices, specifically devices which can connect to said item or object. Otherwise, an embodiment of the invention may include a device and a finger-worn section to which said device may connect, so that said device may essentially be worn on a finger.

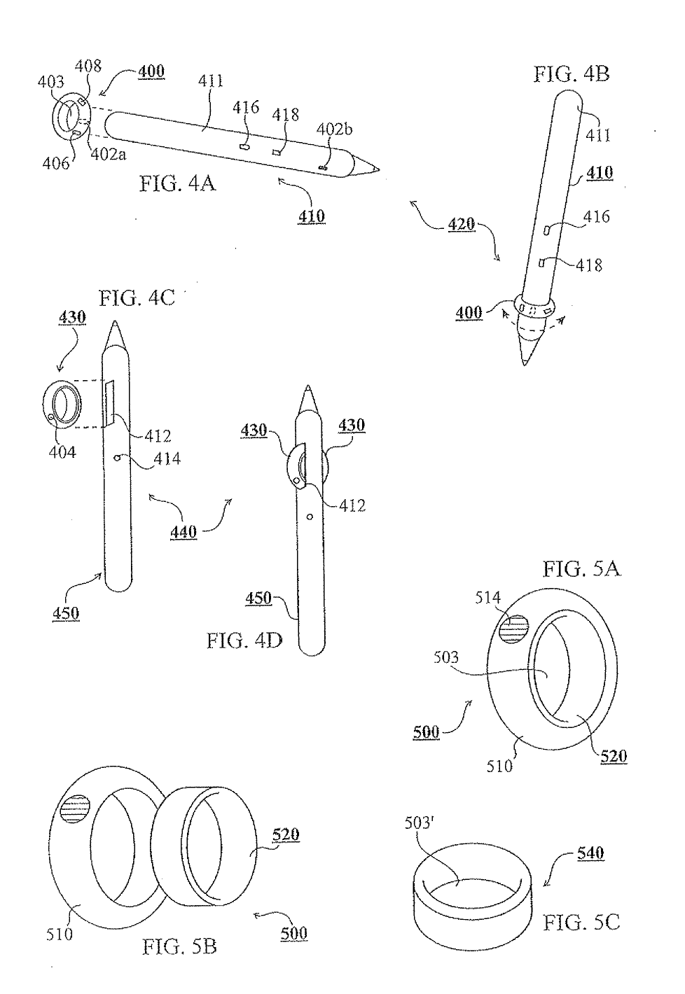

FIG. 6A shows an embodiment 600 which may include a finger-worn device 610 (shown worn on finger 232 of hand 230) and a device 620. Device 620 may be any input device, such as a device including a keyboard or a touch-screen. Device 620 may specifically be operated, or interacted with, by fingers. As shown in FIG. 6A, device 620 may include an input surface 622 which may be operated or interacted with to register input (such as by being an apparatus for sensing touch). Device 610 may be any finger-worn input device.

In some embodiments, device 610 may be operated while interacting with device 620. Otherwise, devices 610 and 620 may be operated collaboratively, such as by a finger touching device 620 (in case device 620 is a touch-screen) while a thumb is operating device 610. For example, device 620 may have an interface (e.g. a graphic user interface displayed by a display of device 620) which can be manipulated by operating device 620 and/or by operating device 610. Note that it is made clear that in some embodiments, devices 610 and 620 may communicate with each other, such as to transmit input from device 610 to device 620. Otherwise, data may transfer (or be transferred), in some embodiments, from device 610 to device 620 and/or from device 620 to device 610.

In some embodiments, device 620 may include a wireless power-transfer unit 624 (illustrated by dashed lines in the figure). Wireless power-transfer unit 624 may be (or include) any means for transferring power without requiring physical contact, such as without direct electrical conductive contact between contacts, as known in the art (see ref. U.S. Pat. No. 7,042,196 and U.S. patent application Ser. Nos. 10/514,046, 11/585,218 and 11/810,917). Accordingly, device 620 may transfer power to device 610 (e.g. by induction), such as to facilitate operation of electronic components of device 610 (see e.g. a power activated unit 618 of a finger-worn device 610′ in FIG. 6B) which require power to operate. For example, device 610 may include an output unit (see e.g. output unit 406 of device 400 in FIG. 4A) which may require power to generate output, so that power may be transferred from device 620, specifically from wireless power-transfer unit 624, to device 610, specifically to said output unit, so that output may be generated by said output unit.

In some embodiments, device 610 may include, as shown in FIG. 6A, a power source 614 which may be any means for storing and/or supplying power, such as to components of device 610 which require power to operate (e.g. a microprocessor). Following the above, power source 614 of device 610 may be recharged by power being transferred from device 620, specifically from wireless power-transfer unit 624 (see ref. U.S. patent application Ser. No. 10/170,034).

FIG. 6B shows an embodiment 630 of the invention, similar to embodiment 600 (FIG. 6A). Embodiment 630 is shown including a finger-worn device 610′ similar to device 610, and a device 620′ similar to device 620. Accordingly, device 610′ may be a finger-worn input device, whereas device 620′ may be any input device (shown including input unit 622), specifically a device which may be operated or interacted with by fingers (e.g. by touch of fingers, or by fingers operating controls of device 620′). Device 610′ is shown including a power activated unit 618 which may be any component of device 610′ which requires power to Operate (or otherwise to be activated). Device 620′ is shown including a power-transfer unit 624′.

In some embodiments, power-transfer unit 624′ may transfer power to device 610′, such as to power activated unit 618 of device 610′, so that the power activated unit may operate. Specifically, power-transfer unit 624′ may utilize a finger wearing device 610′ (or any other finger of the same hand) to transfer power to device 610′ and specifically to power activated unit 618. More specifically, when a finger wearing device 610′ (shown finger 232 wearing the device in FIG. 6B), or any other finger of the same hand (shown hand 230 in FIG. 6B), comes in contact with input unit 622 of device 620′ (such as to interact with device 620′), power may be conducted through said finger (as a human finger is generally a conductive body), preferably from power-transfer unit 624′ to device 610′. Optionally, when a finger of a hand on which device 610′ is worn (the device may be worn on the same finger or any other finger of the same hand) comes in contact with input unit 622 (e.g. touches input unit 622 or any section thereof), said finger may also be in contact with power-transfer unit 624′, such as in case electrodes or contacts of the power-transfer unit are integrated into input unit 622, or otherwise located along input unit 622. Alternatively, power-transfer unit 624′ may generate an electromagnetic field (see e.g. an electromagnetic field 656 in FIG. 6C), as known in the art, which when a finger is inside of (otherwise when said electromagnetic field reaches a finger), power may be transferred from the field through said finger (whereas said power may reach device 610′ worn on said finger or on another finger of the same hand).

Note that it is made clear that power transferred (or conducted) through a finger of a user, as described for FIG. 6B, may be such that said power is generally not felt by said user (or otherwise not noticed while transferring through said finger). For example, said power may be a low electric current of low voltage.

FIG. 6C shows an embodiment 640 which may include a finger-worn device 670 and a power-transfer unit 650 which can transfer power to device 670 when the device is near the power-transfer unit. Device 670 is shown including a power receiver 674 which may receive (e.g. absorb) power, specifically power transferred from power-transfer unit 650, and may facilitate device 670 utilizing the received power.

In some embodiments, power-transfer unit 650 may generate an electromagnetic field 656 to facilitate transferring power to devices within a certain range (of distance) from the power-transfer unit, specifically in reach of the electromagnetic field. Accordingly, when device 670 is within said certain range, such as in case a finger wearing the device approaches power-transfer unit 650, power receiver 674 of device 670 may receive power from electromagnetic field 656 generated by the power-transfer unit.

Following the above, it is made clear that within the scope of the invention is a finger-worn device which may wirelessly receive power from an input device which can transfer power wirelessly, such as an input device including wireless power-transfer unit 624. In some embodiments, said finger-worn device may utilize received power for operations of components (or units) of said finger-worn device, and/or for recharging a power source of said finger-worn device. Further made clear is that within the scope of the invention is an input device which can be operated (or interacted with) by fingers (e.g. by fingers touching a surface of said device), and which can wirelessly transfer power to a finger-worn device worn by a finger operating said input device, or by a finger of the same hand. It is further made clear that an embodiment of the invention may include an input device which can be operated by fingers and a finger-worn device, such that when said finger-worn device is worn on a finger which operates said input device (or on a finger of the same hand), said finger-worn device may receive power from said input device.

FIGS. 7A and 7B show an embodiment of the invention as a finger-worn device 700. Device 700 may be an input device that can be worn on a finger and that may include a stationary section 704 (or simply “section”) whereat there is a cavity 703 through which a finger may be inserted. Device 700 may further include a rotatable section 702 (or simply “section”) as an exemplary control (also “controller”) which can be rotated (e.g. by a thumb applying force on it, such as pushing it) around section 704, and accordingly (and generally) around a finger (otherwise relative to a finger) on which the device is worn. Preferably, section 704 remains stationary while section 702 is being rotated, such that there is a relative rotation between the two sections.

Note that in some embodiments, a finger-worn device of the invention may include only a rotatable section (e.g. section 702), excluding a stationary section (e.g. section 704). Said rotatable section may be rotated around a finger wearing the device similarly to rotating section 702 around section 704 in device 700.

In some embodiments, rotating section 702 may be for registering input. Accordingly, rotating section 702 may be for controlling (also “manipulating”, or “influencing”) an interface (or element thereof) or program (or element thereof), such as an interface of another device communicating with device 700. Optionally, specific rotated positions of section 702 may correspond to specific inputs, or otherwise to interface or program elements or events. In other words, rotating section 702 to specific rotated positions may facilitate registering different inputs (such as in device 700 or in another device communicating with device 700), such as for influencing different interface elements (or program elements). For example, different rotated positions of section 702 may correspond to registering input related to different interface objects such as files, menu items, graphic symbols (e.g. icons) and tools, different interface functions such as executing commands or operations, or different interface states or modes. For a more specific example, rotating section 702 to a first rotated position may be for prompting a first command or activating a first state of an interface, whereas rotating section 702 to a second rotated position may be for prompting a second command or activating a second interface state. For another example, device 700 may be communicating with another device (e.g. a computer) which includes (otherwise “runs”) an interfacing program (e.g. an operating system, or OS), whereas a different input may be communicated to said another device (or registered at said another device by means of communication) correspondingly to different rotated positions of section 702. Otherwise, different signals may be communicated (from device 700) to said another device and registered as different inputs thereat, correspondingly to different positions (i.e. different angles of rotation) of section 702, whereas said different inputs registered at the other device may prompt different interface operations (e.g. interface functions or commands).

Note that rotated positions of rotatable sections of finger-worn devices of the invention may be referred to as “input positions”, suggesting that each of the positions corresponds to a specific input. Further note that different rotated positions of a finger-worn device may correspond to different states of said finger-worn device. In other words, a finger-worn device wherein a rotatable section is in different rotated positions may be regarded as being in different states.

In FIG. 7A there are further shown feel marks 706a-c on (or included in) section 702 of device 700. Specifically, feel marks 706a-e may be located at an external surface of section 702, such that they are exposed (or otherwise accessible) and can be felt by a finger touching the section. Feel marks 706a-c may be any tactile features known in the art (e.g. Braille characters). Feel marks 706a-c are specifically shown in FIG. 7A as protruding and/or indented (also “sunken”, “incised”, “recessed”, “engraved” or “notched”) elements (e.g. shapes or marks embossed or so-called debossed from an external surface of section 702) that can be felt by a finger (e.g. a thumb operating device 700, such as specifically placed on an external surface of section 702). More specifically, feel marks 706a,b are shown protruded, such as by being dot bumps, whereas feel mark 706c is shown indented into section 702, such as by being a small hole.

Preferably, the aforementioned external surface of section 702 is a surface which a finger is required to touch (e.g. for pushing or pulling section 702 to rotate it, or in any way apply force on the section) for operating device 700. For example, as shown in the figure, feel mark 706a may be a bulging dot (also “raised dot”) similar to raised dots known in Braille language. Also as shown, feel marks 706b may be a couple of raised dots, whereas feel mark 706c may be a sunken dot (as opposed to a raised dot).

In FIG. 7B there are shown feel marks 706b-d on section 702 (from the point of view of the figure) suggesting the section is at a different rotated position (also “input position”) than in FIG. 7A, such as rotated clockwise from a position shown in FIG. 7A (suggested rotation direction illustrated as a curved dashed arrow in FIG. 7A). Feel marks 706d may be (by way of example), as shown in FIG. 7B, raised lines (as opposed to raised dots), similar to raised lines in certain keyboard keys (commonly on the keys of letters F and J in keyboards).

Preferably, each of feel marks 706a-d (FIGS. 7A and 7B) may represent (or otherwise mark) an input position (i.e. a rotated position which may corresponds to a specific input, or otherwise to a specific interface or program element or event) of section 702 of device 700. Accordingly, when a user of device 700 feels any of the feel marks, said user may then know which input position section 702 of the device is in. For example, as shown in FIG. 7A, when section 702 is positioned such that feel marks 706b are facing a specific direction (direction illustrated by a small arrowhead on section 704), a first input may be registered, whereas when section 702 is positioned such that feel mark 706d is facing the same specific direction (as shown in FIG. 7B feel mark 706d facing the direction illustrated by the small arrowhead on section 704), a second input may be registered. Accordingly, different inputs (e.g. said first input and said second input) may be registered by rotating section 702 of device 700 to different input positions. Further accordingly, a user operating device 700 may distinguish between different input positions of section 702 by feeling any of feel marks 706a-d, such as feeling which of the marks is facing a specific direction at any given time. For example, a thumb may feel which of the feel marks is facing it (i.e. facing the thumb) when device 700 is worn on a finger of the same hand, and may rotate section 702 of the device, until a preferred feel mark is facing the thumb, for registering input which may correspond to said preferred feel mark (or otherwise correspond to the position to which section 702 was rotated for said preferred feel mark to face said thumb). Following the above, a user may know how to rotate section 702 to a preferred input position simply by feeling an external surface of section 702, preferably by the finger that performs the rotation of the section.

In FIGS. 7A and 7B there is further shown device 700 including a connection unit 708 (similar to previously described connection units and connectors), located on an internal surface (or side) of section 704 (i.e. a surface which comes in contact with a finger wearing device 700 through cavity 703). Connection unit 708 may facilitate physical connection, power connection and/or data connection between device 700 and another device. For example, connection unit 708 may form a connection with another connection unit which is included in a “hosting device”, specifically on a part or section of said “hosting device” that is inserted (or that fits) into cavity 703 of device 700, wherein said another connection unit may come in contact with connection unit 708 when said part or section is inserted into the cavity, for connecting device 700 to the “hosting device”.

Note that while the described above for a finger-worn device having a section rotatable around another section for multiple input positions, it is made clear that a finger-worn device of the invention may have any number of dynamic elements or sections which can be relocated (or otherwise repositioned) to any number of input positions, not necessarily by a rotation operation. For example, a finger-worn device of the invention may include a stationary section 704 (as shown in FIGS. 7A and 7B for device 700) on which a knob may be installed, which can be pushed or pulled along a track, wherein different locations (or positions) of said knob along said track may correspond to different inputs.

FIGS. 7C through 7E show an embodiment of the invention as a finger-worn device 710. Device 710 may be an input device that can be worn on a finger, and that includes a section 712 which facilitates wearing the device on a finger, and a touch surface 714 (or simply “surface”) on section 712. Touch surface 714 may be a surface that can sense touch and/or touch motion (e.g. sensing sliding of a thumb along the surface), or otherwise be coupled to a means for sensing touch and/or touch motion, so that operating device 710 (e.g. for registering input) may be by touch, and/or touch motion, on surface 714. For example, by sliding a thumb on surface 714 in two opposite directions, a user may scroll (as an exemplary interface function) a text document or web page (as an exemplary interface element) up and down (e.g. in a graphic user-interface), whereas each direction of sliding may correspond to each direction of scrolling (i.e. the aforementioned two opposite directions).

In FIGS. 7C through 7E, device 710 is shown further including tactile indicators 716a-c (or simply “indicators”) located on (or at, or near) surface 714, so that they can be felt when touching the surface (e.g. by a thumb touching surface 714). Tactile indicators 716a-c may be any number of elements (optionally dynamic elements, as described below) which may facilitate tactile output (i.e. output which can be felt, or is otherwise tangible), or otherwise generate or produce tactile output, such as for relaying information. Accordingly and similarly to the described for feel marks 706a-d (of device 700, shown in FIGS. 7A and 7B), indicators 716a-c can be felt when operating device 710.

In some embodiments, tactile indicators 716a-c may be dynamic (also “changeable”) and may have two or more states, so that they feel different (e.g. to a thumb touching surface 714, and accordingly touching the indicators) when in each state. Accordingly, indicators 716a-c may change between two or more states, whereas each state may have a different feel when touched. For example, each of indicators 716a-c may be a socket containing a pin (supposedly installed on or connected to an actuator), and may have a first state in which said pin is retracted into (or otherwise “is inside of”) said socket, and a second state in which said pin is extended (also “sticking out”) of said socket.

In FIG. 7C, indicators 716a-c are specifically shown all being in a similar state, such as a state in which a pin of each indicator is retracted in a socket.

In FIG. 7D, indicators 716a,b are specifically shown being in a different state than in FIG. 7C, such as a state in which a pin is protruding from a socket. Indicator 716c is shown in FIG. 7D being in the same state as shown in FIG. 7C.

Note that the described herein for indicators 716a-c being (by way of example) dynamic pins inside sockets may be facilitated similarly to raising dots in refreshable Braille displays (or “Braille terminals”), as known in the art (see e.g. U.S. Pat. No. 6,700,553).

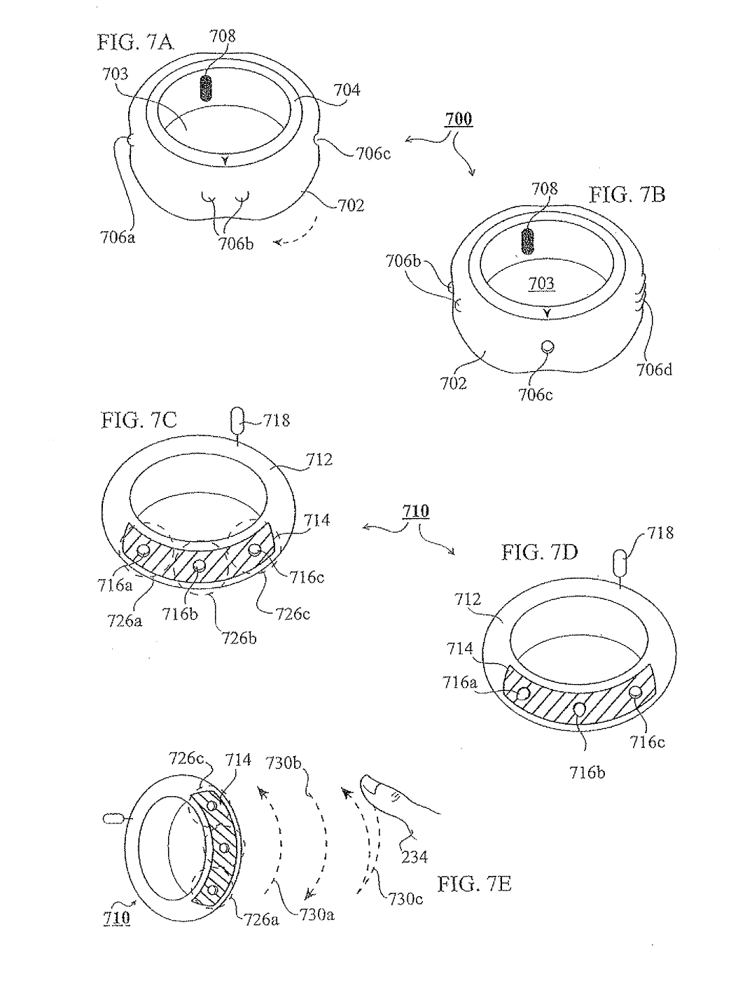

Further note that any change between states of tactile indicators (which may be any means for generating tactile indications) of finger-worn devices of the invention may be facilitated electronically and/or mechanically (also “facilitated by any electronic and/or mechanical means”), such as by a microprocessor of a finger-worn device controlling (or otherwise “sending signals to”) actuators (see e.g. actuators 806a,b in FIGS. 8B through 8C) that can change the shapes and/or positions of said tactile indicators, of sections thereof or of elements included therein. For example, a finger-worn device of the invention may include an electroactive polymer (also known in the art as “electroactive polymer actuator”), which can be coupled to touch sensors (e.g. cover a touch sensing apparatus) for sensing touch and/or pressure), whereas said electroactive polymer can change its shape by electric voltage or current applied to it, and so by changing its shape may generate tactile indications.

In some embodiments, states of indicators 716a-c may indicate interface or program states, or states of elements thereof, to a user (preferably coming in contact with any of the indicators, such as by touching touch surface 714) of device 710. Similarly, changes between states of indicators 716a-c may facilitate notifying a user about interface or program events, and/or about changes in interface or program elements (such as known in the field of haptic technology, or as known in the art for tactile feedback). In other words, states of indicators 716a-c, and/or changes between states of indicators 716a-c, may be utilized to relay information or feedback to a user of device 710, preferably information about an interface or program (e.g. a program of a device communicating with device 710). Said information may be relayed to said user by said user utilizing sense of touch to notice (and preferably identify) states of indicators 716a-c and changes thereof. For example, in case indicators 716a-c are pins and sockets (as described above by way of example), a state in which said pins are protruding from said sockets may be for relaying certain information, whereas a state in which said pins are retracted into said sockets may be for relaying different information. For a similar example, a change between a state in which the aforementioned pins are protruding from, said sockets and a state in which said pins are retracted into said sockets may relay certain information, such as in case a user touching surface 714 notices said change. For yet another similar example, a sequence of extending and retracting pins from and into sockets (in dynamic tactile indicators of a finger-worn device of the invention) may be felt by a user and identified as a certain message, such as a notification that an interface event is occurring, or that an interface function is executed.

Note that changes between states of indicators 716a-c, such as for relaying information, may be prompted (also “triggered”) by an interface (or elements or events thereof) or program (or elements or events thereof), such as in case a program directs commands to means for changing states of indicators 716a-c (e.g. actuators). Accordingly, an interface or program may control or manipulate changes in states of indicators 716a-c. For example, device 710 may include means for changing states of indicators 716a-c, and may communicated with (or otherwise “receive signals from”) another device having an interface or “running” a program, such that commands for changing states of the indicators may be sent from said another device (preferably being directed by said interface or program) to prompt said means for changing states to change states of the indicators. For another example, an interface event, in an interface of a device (e.g. a change in state of said interface, or an initiation of a procedure) may prompt said device to transmit signals to device 710, so that the receiving of said signals by device 710 may initiate a sequence of changes of states of any of indicators 716a-c, whereas said sequence may be a tactile message corresponding to said interface event.

In some embodiments, tactile indicators 716a-c may mark specific areas of touch surface 714 that correspond to specific inputs. For example, touch surface 714 may be divided to areas, whereas touch on each of said areas may correspond to a different input (e.g. for a different function in an interface), and whereas indicators 716a-c may be distributed among said areas to facilitate distinguishing between the areas by feeling the indicators. For another example, any of indicators 716a-c may be located at a middle point of surface 714, essentially dividing the surface to two areas, touching each of said areas may correspond to registering a different input.

In FIG. 7C there are shown areas 726a-c of touch surface 714 (generally circled in the figure by illustrated dashed circles). Touch on any of areas 726a-c may be for registering a different input, so that touching area 726a may register a different input than touching area 726b and also different than touching area 726c (whereas touching area 726b may register a different input than touching area 726c). Optionally, moving touch (e.g. sliding on surface 714) from any of areas 726a-c to another may be for registering a different input than moving touch to any other area (see ref. FIG. 7E for touch gestures).

In some embodiments, states of tactile indicators 716a-c may indicate (also “denote”) contexts for operating device 710 to control an interface or program (or any number of elements thereof), or specifically contexts for input registered by touching (and/or moving touch on) touch surface 714 (as exemplary operation of a finger-worn device which includes the indicators). Otherwise, different states of indicators 716a-c may correspond to different contexts for registering inputs, so that different inputs may be registered from similar operation (performed on, by or with device 710) while indicators 716a-c are in different states. Said contexts may correspond to states in which an interface or program (or any number of elements thereof) is in, so that different states of an interface or program (or any number of elements thereof) may set different contexts for registering input (or otherwise for processing input), whereas states of indicators 716a-c may accordingly be set (e.g. by an interface commanding actuators to set any of the indicators to specific states). For example, when indicator 716a is in a first state, a first input may be registered when operating device 710 in a specific way (e.g. sliding a thumb on touch surface 714), whereas when indicator 716a is in a second state, a second input may be registered when operating device 710 in the same way (i.e. the same as said specific way). Otherwise, the same input (e.g. said first input) may be registered from operating the device in the same way, whereas said same input may be processed (or otherwise in any way regarded) in different contexts, depending on (or otherwise “correspondingly to”) which state indicator 716a is in when said same input was registered. Accordingly, a user may operate device 710 in similar ways (also “fashions”, or “manners”), or otherwise perform similar operations with (or on) the device, whereas different inputs may be registered correspondingly to different states of indicators. Otherwise, when operating device 710 in similar ways, registered input may be processed differently or correspondingly to which state a tactile indicator of device 710 is in when said input is registered. For a specific example, in case indicators 716a-c are pins installed in sockets, sliding a thumb on touch surface 714 (of device 710) when indicators 716a-c are in a state of said pins retracted into said sockets may be for initiating or executing a first function (e.g. scrolling through a first document in an interface), whereas when the indicators are in a state of the pins extended from the sockets, sliding said thumb on the surface may be for initiating or executing a second function (e.g. browsing through open applications), or for initiating or executing the same function yet on a different interface element (e.g. scrolling through a second document, as opposed to scrolling through the aforementioned first document). Specifically in the same example, change between states of the indicators may be prompted by change in an interface or program, such as by an operating system switching “focus” (as known in common “windows” operating systems) from one open document to another open document (as an exemplary interface or program event, or as an exemplary change in an interface or program). For another example, a user may slide a thumb on touch surface 714 when a suggested pin of any of indicators 716a-b is retracted into a suggested socket of the indicator, for browsing through options of a menu of an interface, whereas when reaching a “restricted” option (or otherwise an option which requires consideration, such as a delete option), the pin of that indicator may be extended from the socket of the indicator, notifying the aforementioned user about two possible operations which said user may further perform on touch surface 714. Specifically, said pin of the indicator may be located at the middle of touch surface 714, dividing the touch surface to a first area and a second area (i.e. two halves of touch surface 714 from either side of the pin), whereas touching said first area may be for selecting or approving said “restricted” option, and whereas touching said second area may be for returning to (or remaining in) a previous option in the aforementioned menu of an interface.

Following the above, tactile indicators 716a-c may change states (also “change between states”), whereas each state can be identified (or differentiated) by a user touching the indicators. Each state of indicators 716a-c may preferably be indicative of an interface or program element (or a state thereof), or interface or program event. Accordingly, each of indicators 716a-c may be felt by a user for receiving tactile information (also “tactile feedback”, or “tactile indication”) related to an interface or program element (e.g. an object of a program) or interface or program event (e.g. a procedure or process in an interface). For example, indicators 716a-c may include pins which can be retracted into or extended from sockets, whereas sliding a thumb (by a user) on surface 714, while said pins are retracted, may be for scrolling through a document, and whereas the pins may be extended from the sockets to notify that said scrolling has reached the end or the beginning of said document. This may be beneficial for saving display space in a device which may be controlled by operating device 710 (e.g. a device having a small screen, such as a mobile phone), as feedback from an interface may be relayed by tactile indicators as opposed to being relayed visually by a display.

In FIGS. 7C through 7E, device 710 is further shown including a communication unit 718 (e.g. a transceiver) facilitating communication between device 710 and any number of other devices. Optionally, said other devices may include any number of interfaces or programs for which input may be registered by operating device 710, or which may utilized input from device 710 (e.g. input communicated to any of said other devices, such as by sending signals from device 710). Said interface or programs may prompt changes in states of tactile indicators 716a-e.

Note that any tactile indicators (dynamic or otherwise) included in finger-worn devices of the invention may, in some cases (e.g. in some interfaces or programs) and in some embodiments, generate tactile feedback of Braille language (i.e. relay tactile information in the form of Braille language). Accordingly, tactile indicators of some embodiments of finger-worn devices of the invention may form different characters of Braille language, such as for relaying information by utilizing Braille language. For example, device 710 may include any number of dots which can be raised or retracted for form combinations of dots for different Braille characters.

Further note that any tactile indicators included in finger-worn device of the invention may, in some cases and in some embodiments, generate tactile feedback of Morse code (i.e. relay tactile information in the form of Morse code). Accordingly, tactile indicators of some embodiments of finger-worn devices of the invention may relay information by utilizing Morse code, whereas the relaying may be facilitated by said tactile indicators changing states.

FIG. 7E specifically shows device 710 and thumb 234 operating the device, such as by touching and moving along touch surface 714 of the device. Touch gestures 730a-c (or simply “gestures”) of thumb 234 (i.e. movement of thumb 234 while touching surface 714), are illustrated by curved dashed arrows in FIG. 7E, suggesting paths of motion. Accordingly, any of touch gestures 730a-c may be a path according to which thumb 234 may move, specifically while touching surface 714. Gesture 730a is shown as sliding thumb 234 in a first direction (illustrated upward in the figure, respectively to the position of device 710 in the figure, or otherwise from area 726a to area 726c on surface 714), whereas gesture 730b is shown as sliding thumb 234 in a second direction (illustrated downward, or otherwise from area 726c towards area 726a). Gesture 730c is shown as a downward and then upward sliding motion (i.e. a combination of first sliding downward and then sliding upward, while touching surface 714, or otherwise sliding from area 726c to area 726a and then back to area 726c).

In some embodiments, different touch gestures may be for registering different inputs. In other words, different inputs may be registered by performing different touch motions (i.e. gestures), specifically on touch surface 714 of device 710. Specifically, different touch gestures may be for controlling different interface or program elements, or for executing different interface or program functions, or for prompting different interface or program events. For example, performing gesture 730a (on surface 714) may be for registering a first input, whereas performing gesture 730b may be for registering a second input, such as inputs to be utilizes in an interface or program of a device communicating with device 710. For a another example, an interface may be controlled by performing touch gestures on touch surface 714, such as in case said interface includes an element which can be navigated (e.g. graphically on a display) by performing said touch gestures. In some cases, performing gesture 730a on surface 714 may be for navigating said element upward, whereas performing gesture 730b may be for navigating said element downward. For yet another example, performing touch gesture 730c on surface 714 may be for prompting a first event in a program (e.g. changing a state of said program or an element thereof), whereas rapidly tapping twice (with thumb 234) on surface 714 (commonly known as a “double tap” in computing, specifically on touch-pads and touch-screens) may be for prompting a second event (e.g. activating or executing a function in the aforementioned program).

Note that directions of touch gestures performed on touch surface 714 may not necessarily correspond to directions in an interface or program. For example, sliding a finger upward on surface 714 (in accordance with the position of device 710 in FIG. 7E) may be for browsing a list of options, whereas sliding a finger downward may be for executing a function not associated with directions, such as loading a file.

In some embodiments, different contexts for inputs registered by performing touch gestures on surface 714 may correspond to different states of indicators 716a-c. Specifically, any touch gesture performed on surface 714 may be for prompting a different interface or program event (or otherwise for registering a different input), correspondingly to different states of indicators 716a-c. In other words, states of indicators 716a-c and contexts for input (registered by operating device 710, specifically by performing touch gestures of surface 714) may correspond to each other. For example, performing gesture 730a while (or “when”) indicator 716a is in a first state may yield a different influence on an interface or program, or may otherwise prompt registration of a different input, than performing gesture 730a while indicator 716a is in a second state.

Note that some states of indicators 716a-c may be static conditions of said tactile indicators, whereas other states may be changing conditions (e.g. changes in positions), such as repeating sequences of change. For example, a state of a tactile indicator may be a pin extended and retracted repeatedly (e.g. from a socket), whereas another state of said tactile indicator may be said pin remaining extended.

Further note that whereas exemplified and shown in FIGS. 7C through 7E are tactile indicators 716a-c as optionally including pins and sockets, it is made clear that any dynamic elements which can generate or provide tactile indications may be utilized and are in the scope of the invention (see e.g. a section 1004 of a device 1000 in FIGS. 10A through 10C). Further note that whereas tactile indicators are described for device 710, any finger-worn device of the invention may include tactile indicators as described herein, and that the scope of the invention may include any finger-worn device with tactile indicators. Further note that any operation or sequence of actions performed on a finger-worn device (specifically on an operable element or section, or plurality thereof, of the device) may be regarded as gestures similar to touch gestures as described above, so that the described above for touch gestures may also apply to any operation or sequence of actions. For example, a finger-worn device of the invention may include a first switch and a second switch, and may be operable by interacting with said first switch and said second switch. Optionally, interacting with the aforementioned first and second switches may be by pressing on any or both, whereas pressing on the first switch and then on the second switch may be regarded as a first gesture (for registering a first input), and whereas pressing on both switches simultaneously may be regarded as a second gesture (for registering a second input). Accordingly, a gesture (or plurality thereof), as described herein, may be any operation or action (or sequence thereof) performed on a finger-worn device.

Further note that whereas the described above is for dynamic tactile indicators (i.e. indicators 716a-c) positioned (or located) on (or at, or near) a touch surface (i.e. surface 714), it is made clear that similar indicators may be included in finger-worn devices of the invention, on (or at, or near) any operable element or section, or plurality thereof, such as controls, buttons, rotatable sections, so called “thumb-sticks”, scroll-wheels, etc. Such dynamic tactile indicators are preferably utilized to facilitate generating or producing dynamic tactile feedback (also “to relay information by tactile means”) for users of finger-worn devices.

Further note that whereas the described above is for feel marks 706a-d and tactile indicators 716a-c, it is made clear that any number of feel marks and tactile indicators may be included in a finger-worn device of the invention for facilitating similar results or for similar purposes, such as distinctions between different sections of a device of the invention, and/or positions thereof, which optionally correspond to different inputs.

In some embodiments, touch surface 714 can sense pressure, additionally or alternatively to sensing touch and/or touch motion. Accordingly, input may be registered from sensing pressure on the touch surface, or on specific areas thereof. Following the above, tactile feedback (e.g. change of states of dynamic tactile indicators) may indicate context for pressure sensing (or otherwise for input registered from pressing), such as indicate which interface element or event is associated with sensed pressure. Additionally, context for pressure sensing may change (e.g. an interface or program event may occur which may prompt a change is context), in which case appropriate tactile feedback may be prompted (e.g. tactile indicators may change between states). By utilizing pressure sensing in touch surface 714, a user may receive tactile indications (also “tactile feedback”) by touching the touch surface (whereby input may not be registered), after which said user may choose whether to press (also “apply pressure”) on the touch surface (or on an area thereof) or not, such as according to said tactile indications. Optionally, touching the touch surface (while not applying pressure on it) may be for receiving tactile indications and not for registering input (e.g. in case touch surface 714 is only sensitive to pressure, and not sensitive to touch), whereas applying pressure on the touch surface (or on areas thereof) may be for registering input. For example, each of indicators 716a-b may corresponds to a specific area on which touch surface 714 can be pressed for registering a specific input. Specifically, indicator 716a may correspond to an area that can be pressed for closing or opening a first application, whereas indicators 716b and 716c may correspond to areas that can be pressed for closing or opening a second and third application, respectively. Additionally, indicator 716a, 716b or 716c may have a first state indicating that said first application, said second application or said third application, respectively, is open, and may have a second state indicating that the first, second or third application (respectively to indicator 716a, 716b or 716c) is closed. In such cases, a user may slide a thumb on touch surface 714 for knowing which of indicators 716a-c is in a first state and which is in a second state, and accordingly for knowing which of the aforementioned first, second and third applications is opened and which is closed. Said user may then choose to press on areas of touch surface 714, which correspond to indicators indicating a closed application (by being in a second state), for opening said closed application. Said user may similarly choose to press on areas which correspond to indicators indicating an open application, for closing said open application. For the above example, touching touch surface 714, preferably for receiving indications from indicators 716a-c, may not for registering input, whereas pressing on areas corresponding to the indicators is for registering input. This may be beneficial when it is desired for a user to receive tactile indications for a finger which can operate a finger-worn device, so that be receiving said tactile indications said user may choose whether to operate said finger-worn device, and in what way (or “manner”)

FIGS. 8A through 8D show an embodiment of the invention as a finger-worn device 800. In FIG. 8A there is shown a perspective view of device 800, whereas in FIGS. 8B through 8C there is shown a cross section view of the device. Device 800 is shown including a section 802 whereat there is a cavity 803 fitted for a finger. In other words, section 802 is shaped to facilitate wearing the device on a finger. Device 800 is further shown including sections 804a,b, preferably located generally adjacently to cavity 803 or positioned facing the cavity, or otherwise in any way and to any extent exposed to cavity 803.

In some embodiments, sections 804a,b may be dynamic (also “changeable”, or specifically “moveable”) to generally influence or control the size of cavity 803 (or otherwise “to generally change the size of the cavity”). In other words, sections 804a,b may be dynamic (i.e. may be changed or moved) to facilitate cavity 803 accommodating different sizes of a human finger (so that fingers of different sizes may be inserted into the cavity). Specifically, sections 804a,b may be moved (also “relocated”, or “repositioned”) or changed, for increasing and decreasing the size of cavity 803, such that larger sized fingers and smaller sized fingers, respectively, may fit into the cavity and be properly gripped in the cavity (to prevent device 800 from slipping off). More specifically, in some embodiments, sections 804a,b may be generally extended from section 802 towards cavity 803, or retracted into section 802. In other words, 804a,b may generally protrude into cavity 803 or recede from cavity 803, such as suggested by directions illustrated in FIGS. 8A and 8B.

In FIGS. 8B through 8C there are shown actuator 806a and actuator 806b (illustrated by dashed circles suggesting they are located inside section 802) connected to section 804a and section 804b, respectively. Actuator 806a,b may facilitate movement or change of sections 804a,b as described above. Note that it is made clear that the actuators may be supplied with power to operate, such as from a power supply included in device 800.

In FIG. 8B there are shown sections 804a,b partly receded (also “retracted”) into section 802 (receded parts of sections 804a,b illustrated by dashed lines) and partly extended into cavity 803.

In FIG. 8D there are shown sections 804a,b generally (or mostly) extended into cavity 803, i.e. at a different position (or location) than shown in FIG. 8B.

In some embodiments, each of sections 804a,b may move or change individually, such as exemplified in FIG. 8C. In FIG. 8C there is shown section 804a generally (or mostly) extended from section 802 (into cavity 803), whereas section 804b is shown generally retracted into section 802. Accordingly, sections 804a,b may be moved individually in two different directions (illustrated by dashed arrows in FIG. 8C) to be in positions (or locations), as shown in FIG. 8C.

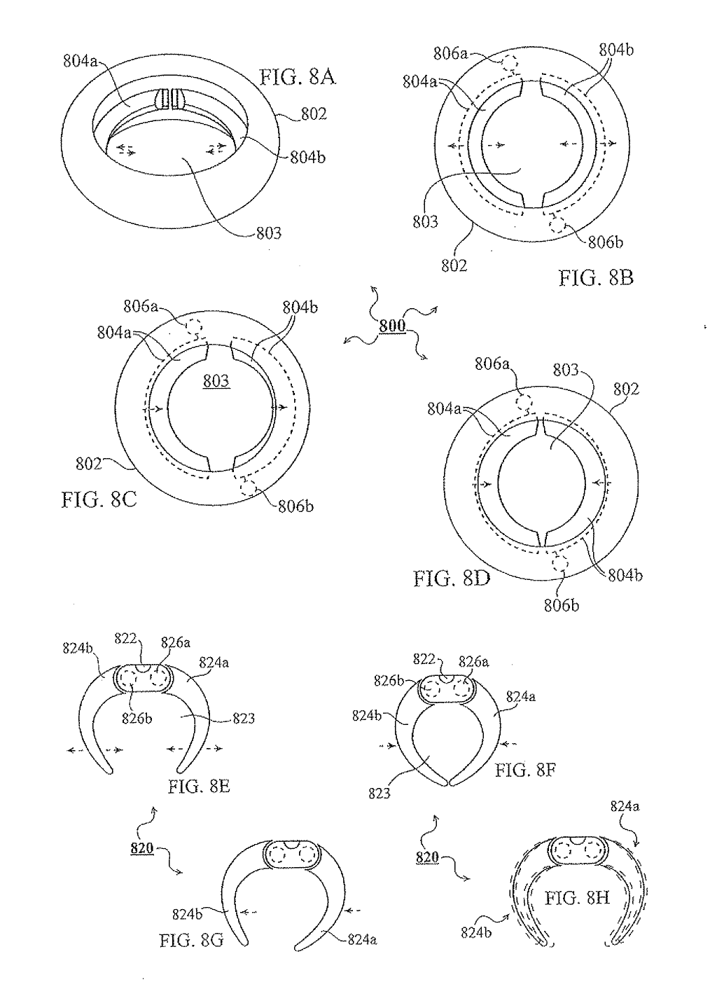

In some embodiments, and similarly to the described for dynamic indicators of device 710 (see ref. FIGS. 7C through 7E), sections 804a,b, additionally or alternatively to facilitating grip and accommodation of fingers of different sizes in cavity 803 of device 800, may facilitate relaying tactile information, or may generate tactile feedback, specifically to a finger wearing device 800. Accordingly, information may be relayed to a user of device 800 (i.e. a person wearing the device on a finger, optionally operating the device) by sections 804a,b changing, moving or switching between physical states or positions. Note that as opposed to the described for tactile indicators of device 710 relaying information by tactile means directly to a finger placed on the device (e.g. a thumb touching surface 714 of the device to operate the device), in device 800, information may be relayed (by tactile means, specifically by sections 804a,b) to a finger wearing the device (i.e. a finger occupying cavity 803). See e.g. haptic feedback applied on finger 232 in FIG. 9C. For example, section 804a,b may extend and retract from section 802 in a certain sequence, to apply pressure on, and release pressure from, a finger wearing device 800, so that said certain sequence may be felt by a user (of which said finger is wearing device 800), and optionally identified by said user, in case said sequence is relaying a certain message (e.g. a notification encoded by the sequence, such as known in Morse code).

FIGS. 8E through 8H show an embodiment of the invention (from a cross section view) as a finger-worn device 820. Similarly to device 170 (see ref. FIG. 1H), device 820 does not include a closed cavity, yet includes a gap 823 which may be filled by a finger when device 820 is worn. Further similarly, device 820 is shown including arms 824a,b which may define gap 823 and grip a finger inside gap 823, to facilitate wearing the device on said finger. For example, device 820 may be “clipped on” a finger by utilizing arms 824a,b to hold the device on said finger.

In FIGS. 8E through 8H, device 820 is further shown including an input unit 822 which may be any number of means for operating device 820, such as for registering input by manipulating the input unit, or such as by the input unit sensing actions performed on (or with) device 820.

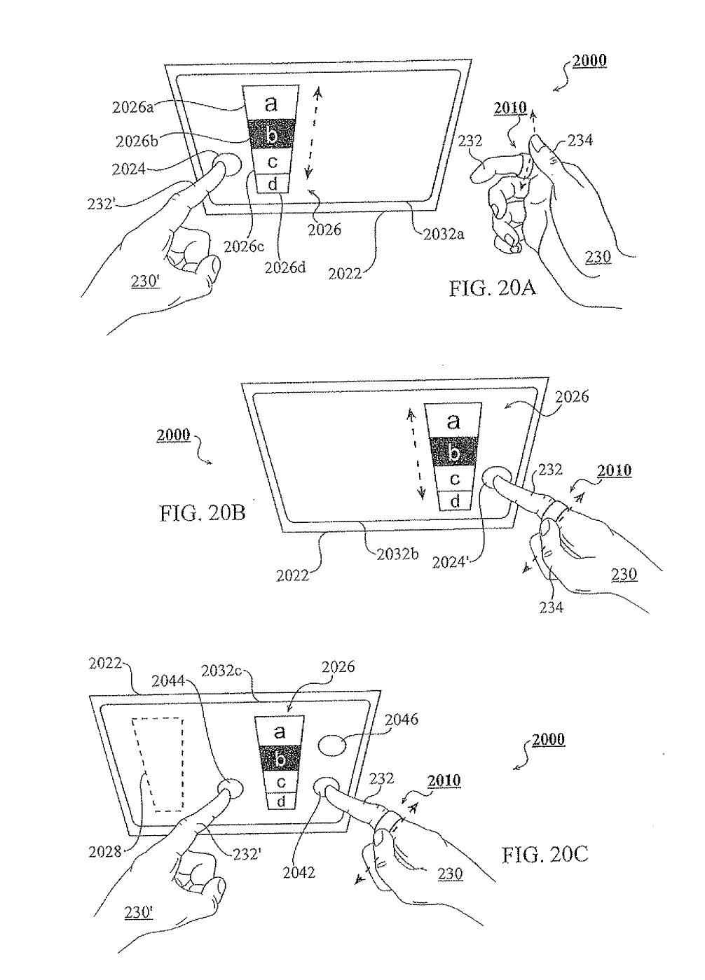

In some embodiments, aims 824a,b may be dynamic so that they can move or change positions (or otherwise in any way change between physical states). Shown in FIGS. 8E through 8H is an actuator 826a and an actuator 826b for moving or repositioning arm 824a and arm 824b, respectively (similarly to actuators 806a,b for sections 804a,b of device 800, as shown in FIGS. 18A through 18D).

In FIG. 8E, arms 824a,b are specifically shown in a position from which they may move rightward or leftward (from the point of view of the figure, as suggested by illustrated dashed arrows).

In FIG. 5F, arms 824a,b are specifically shown as contracted from their position in FIG. 8E (as suggested by directions of repositioning illustrated dashed arrows in FIG. 8F). A finger wearing device 820 may then feel pressure by both arms contracting on said finger while the finger occupies gap 823.

In FIG. 8G, arm 824a is shown extended outward from gap 823, whereas arm 824b is shown contracted into gap 823. Accordingly, it is made clear that each of arms 824a,b may be repositioned independently from (and specifically differently than) the other. Optionally, individual (specifically different) repositioning of each of arms 824a,b may be for relaying specific tactile information. For example, a user wearing device 810 on a finger may feel pressure on a certain side of said finger (e.g. pressure applied by one of arms 824a,b), whereas said pressure may be for indicating a first interface event (which may occur while said pressure is applied on said finger). Similarly, applying pressure on a different side of said finger (e.g. by a different arm) may be for indicating a second interface event. Accordingly, by a user feeling and distinguishing which of aims 824a,b applies pressure on a finger of said user, the user may receive indications of interface (or program) events. Note that arms 824a,b may move (or reposition) in certain sequences, similarly to the described above for sections 804a,b of device 800 and indicators 716a-c of device 710, where said sequence may be indicative of information.

In FIG. 8H, arms 824a,b are specifically shown vibrating (vibration suggested by illustrated dashed lines in the figure). Accordingly, in some embodiments, device 810 may relay tactile feedback by arms 824a,b of the device vibrating.

FIG. 9A shows a gesture recognition system 900 (or simply “system”) communicating with a finger-worn device 920. Specifically, device 920 is shown worn on finger 232 of hand 230, whereas hand 230 may be interacting with system 900 by performing hand gestures (in the figure hand 230 is shown performing a pointing gesture), whereas system 900 may be transmitting signals (or otherwise any type of information) to device 920, such as by utilizing a communication unit 912, as shown in the figure.

System 900 may be any system with which hands (or specifically fingers) may interact by utilizing means of sensing said hands (or fingers). In other words, system 900 may include any means which facilitate sensing hands (or specifically fingers) for interactions (e.g. for the purpose of controlling an interface or program by sensing actions of said hands), or which facilitate interactions by sensing hands. Specifically, gesture recognition system 900 may facilitate interactions by sensing and recognizing (also “identifying”) postures, positions and/or actions of hands and/or fingers, or otherwise recognizing gestures of hands and/or fingers (which may relate to postures, positions and/or actions of said hands and/or fingers). For example, system 900 may be a gesture identification computer system which can sense gestures by utilizing a camera (see e.g. U.S. Pat. No. 6,788,809 and U.S. patent application Ser. No. 12/242,092). Note that it is made clear that because there are known in the art gesture recognition means which do not utilize sensing of light, the described herein for gesture recognition systems may refer to any systems which can sense and recognize gestures of hands, or specifically fingers.

In FIG. 9A, system 900 is shown including sensing means 904 for sensing a hand (or plurality thereof) and/or a finger (or plurality thereof). In some embodiments, sensing means 904 may specifically include visual sensing means 906, such as a camera or optical sensor. Note that while the described for and shown in FIG. 9A refers to sensing means 904 including visual sensing means 906, sensing means 904 may include or be any means known in the art for sensing gestures, not necessarily visually or even optically. Further shown in FIG. 9A is system 900 including or coupled to a display 902 in which there are displayed interface elements 909a-d.

In some embodiments, system 900 may sense and recognize pointing gestures of hand 230, and optionally deduce towards which of interface elements 909a-d a pointing gesture is pointing (shown in FIG. 9A hand 230, and specifically finger 232, pointing towards interface element 909b).

In FIG. 9A, device 920 is shown including an output unit 922 for generating (or “producing”) output, such as tactile output or visual output. In some embodiments, output unit 922 may generate output when finger 232 is pointing towards any of interface elements 909a-d, such as by system 900 deducing which of the interface elements a pointing gesture performed by hand 230 is directed towards, and sensing corresponding signals to device 920 for output unit 922 to generate corresponding output. Optionally, pointing towards any of interface elements 909a-d may prompt output unit 922 to generate a different output from output generated by pointing towards any other interface element (from interface elements 909a-d). Accordingly, by pointing towards different locations in display 902, preferably by a finger wearing device 920, a user of device 920 may receive indications for whether pointing is directed towards an interface element, and optionally indications for which interface element pointing is directed to.

FIG. 9B shows a system 930 of the invention, which may include a finger-worn device 940 (shown worn on finger 232 of hand 230) and a device 932 which can be interacted with by using hands and specifically fingers. Device 932 is shown including a touch-screen 934 for sensing touch of hands and specifically fingers. Touch-screen 934 is shown displaying interface elements 938a-d.

In some embodiments, device 932 may communicate to device 940 where a finger is touching on touch-screen 934, preferably a finger wearing device 940, such as by utilizing a communication unit 936 which may be included in device 932. Specifically, device 932 may communicate to device 940 which interface element is displayed where a finger is touching touch-screen 934. Alternatively, device 932 may transmit signals, which correspond to which interface element is displayed by touch-screen 934 where the touch screen is touched, to device 940. In FIG. 9B, finger 232 is shown touching touch-screen 934 where interface element 938a is displayed, so that signals which correspond to interface element 938a may be transmitted to device 940 from device 932, specifically from communication unit 936.

In FIG. 9B, device 940 is shown including an output unit 922 (see ref. FIG. 9A) for generating output, such as tactile output or visual output. Similarly to the described for FIG. 9A, output unit 922 may generate output which corresponds to which of interface element 938a-d is displayed where touch-screen 934 is touched. This may be facilitated by device 932 communicating with device 940 as described above.

Further shown in FIG. 98 is a hand 230′ other than hand 230, whereas hand 230′ is shown wearing a finger-worn device 940′ similar to device 940 (shown including an output unit 922′ similar to output unit 922) on one of its fingers which is shown touching touch-screen 934 where interface element 938d is displayed. Accordingly, output unit 922′ of device 940′ may generate output corresponding to which interface element is displayed where a finger of hand 230′ is touching touch-screen 934 (such as by device 932 further communicating with device 940′ (in addition to communicating with device 940) by utilizing communication unit 936).

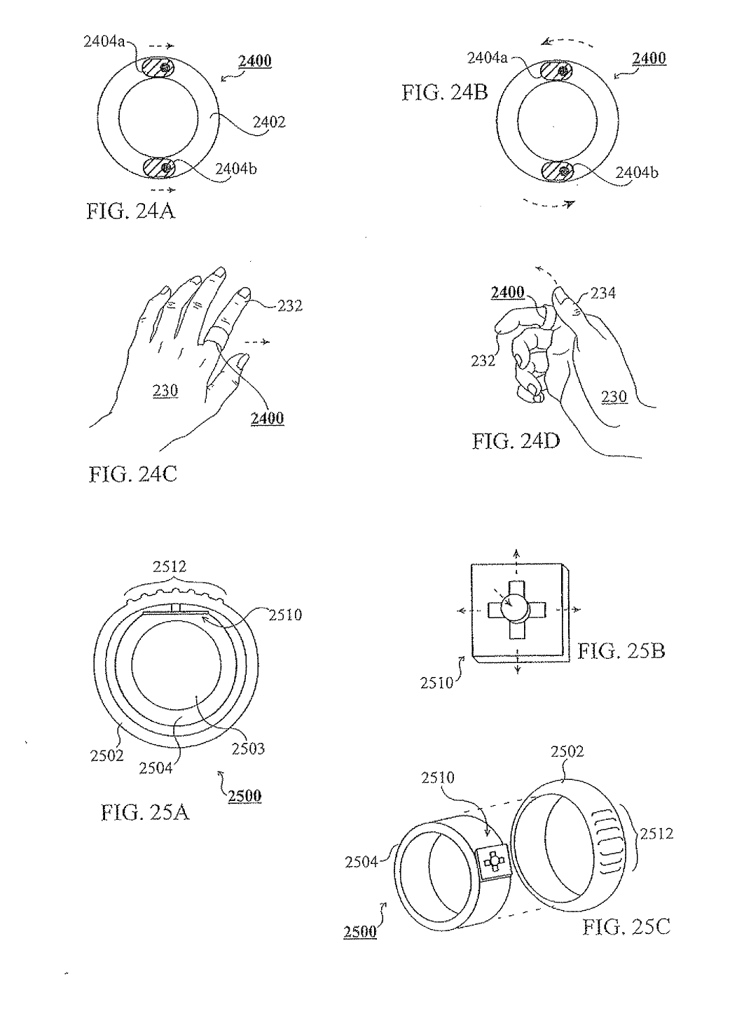

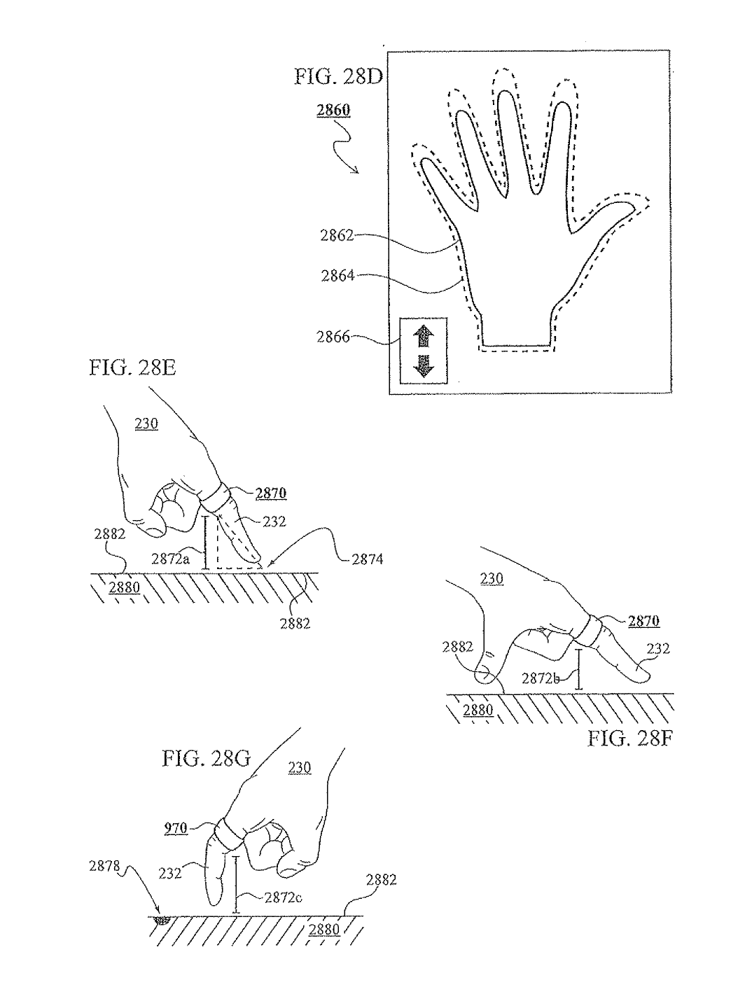

Following the above, a system of the invention may include any number of finger-worn devices which may generate output which corresponds to interface elements displayed by a touch-screen where fingers wearing said finger-worn devices are touching. Distinguishing between fingers and finger-worn devices (i.e. knowing which fingers are touching which interface elements, or specifically touching said touch-screen where said interface elements are displayed) may be facilitated by any means known in the art (see e.g. the described for FIGS. 23A and 23B, in case touch-screen 934 is an “integrated sensing display” as known in the art, and also see e.g. obtaining the location of a finger-worn device as described for FIGS. 28A through 28J).

Note that it is made clear that following the above, a finger-worn device of the invention which include tactile indicators (see e.g. device 800 including sections 804a,b in FIGS. 5A through 8D) may, in some embodiments and for some interactions, serve as an alternative to a touch-screen which can generate tactile output (as known in the art), such as when said finger-worn device is included in a system which further includes a touch-screen which cannot generate tactile output or which otherwise does not have any dynamic tactile features. In such a system, tactile output may be provided by said finger-worn device instead of by said touch-screen (alternatively to interacting with a touch-screen which can generate tactile output, without wearing and/or operating a finger-worn device).

FIG. 9C shows a perspective view of hand 230 wearing a finger-worn device 950 (which may be similar to device 800 as shown in FIGS. 8A through 8D) on finger 232. In FIG. 9C, hand 230 is shown generally moving to the left, from the point of view of the figure (illustrated dashed arrow above finger 232, suggesting direction of movement).

FIG. 9C further shows a close-up cross-section view of device 950, to depict the device when hand 230 is generally moving left. Device 950 is suggested to be worn on finger 232 in the close-up cross-section view. Device 950 is shown including a section 952 having a cavity 953 through which a finger may be inserted, and haptic units 954a,b. Any of both of haptic units 954a,b may generate haptic feedback from device 950 when a hand, or specifically a finger, wearing the device is moving. In FIG. 9C, haptic unit 954a is specifically shown applying a force towards the right (illustrated dashed arrow, suggesting direction of applying force), oppositely to the direction of movement of finger 232 (according to the movement of hand 230) wearing device 950, so that finger 232 may feel a resisting force (or “a counter force”, or otherwise “a feedback force”) applied from a direction towards which finger 232 is moving.

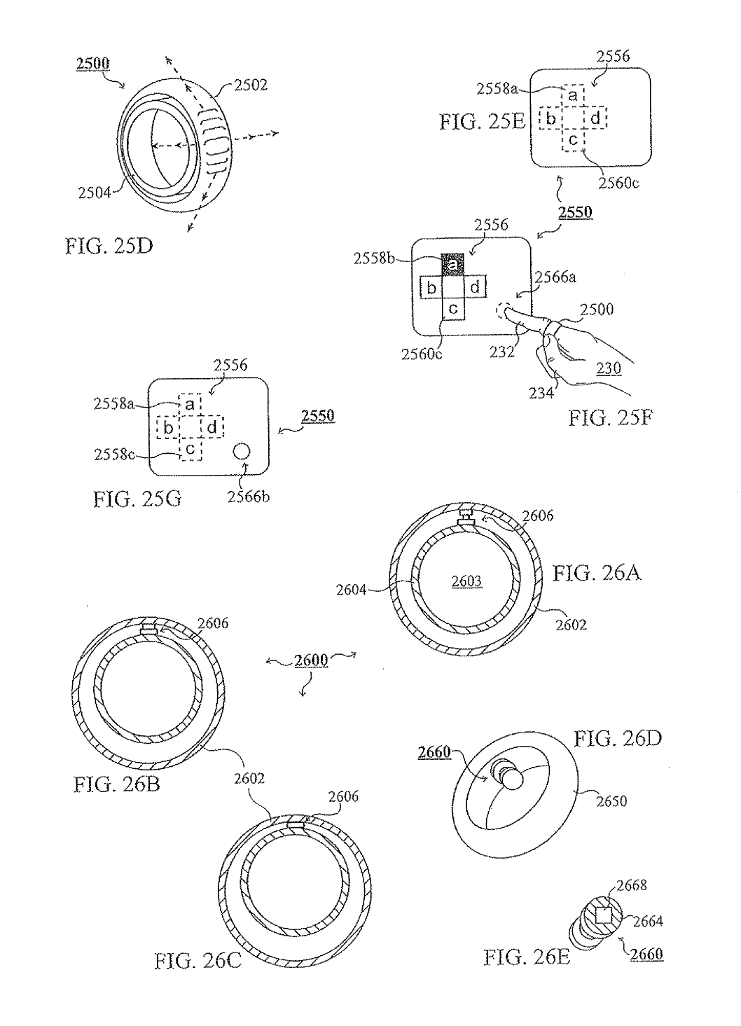

Note that sensing of movement of device 950 (in accordance with the movement of hand 230 and finger 232) may be facilitated by any means known in the art, such as by device 950 including any number of accelerometers (see e.g. accelerometers 2404a,b in FIGS. 24A and 24B).

FIGS. 10A through 10C show, from a cross section point of view, an embodiment of the invention as a finger-worn device 1000. A finger can wear device 1000 by being inserted into a cavity 1003 in a section 1002 of the device. Device 1000 is shown including a touch surface 1006 which, similarly to touch surface 714 of device 710 (as shown in FIGS. 7C through 7D), can sense touch and/or touch motion (e.g. motion of a finger touching the touch surface), so that device 1000 can be operated by touching (and optionally by moving while touching) the touch surface. For example, input may be registered when touch surface 1006 is touched (see e.g. FIG. 10C).

In FIGS. 10A through 10C, touch surface 1006 of device 1000 is shown divided to areas 1006a-c, such that area 1006b is located on a dynamic section 1004 (or simply “section”) whereas the rest of the parts (i.e. parts 1006a,c) are located on section 1002. Dynamic section 1004 can change between physical states, such as change in shape or position. Specifically, section changing between physical states may be for relaying tactile information. More specifically, the physical state of section 1004 at any given time may indicate a state of an interface or program (or of an element thereof). In other words, an interface or program may control section 1004 to determine which physical state the section is in at a given time, optionally correspondingly to which state said interface or program (or element thereof) is in at said given time. For example, section 1004 may be coupled to an actuator that can extend it from an alignment with section 1002 (as shown in FIG. 10A area 1006b on section 1004 aligned with areas 1006a,c on section 1002). In FIG. 10B, dynamic section 1004 is shown as extended (or “sticking out”) from section 1002, such that areas 1006a-c are not aligned.

In some embodiments, section 1004 may be in an “aligned state” (i.e. a physical state wherein area 1006b is aligned with areas 1006a,c) for facilitating performing touch and touch motion along touch surface 1006. Similarly, section 1004 may be in an “extended state” (i.e. a physical state wherein the section is extending from section 1002) for obstructing motion of a finger along the touch surface, to prevent registering input which corresponds to touch motion, such as in case a function in an interface, which corresponds to input of touch motion on surface 1006, may be inaccessible, and so cannot be executed. Accordingly, a user wishing to register input by touch motion is then (when section 1004 is extended) notified that functions which correspond to touch motion cannot be executed.

In some embodiments, when section 1004 is extending from section 1002, section 1004 can serve as a control of device 1000 (see e.g. a control 1804 of a finger-worn device 1800 in FIGS. 18A through 18D), such as a button. Optionally, section 1004 may be operated to change between multiple states, such as pressed to any of multiple extents or positions. Following the above, device 1000 may switch between a state (or plurality thereof) in which it is operable by touching touch surface 1006, and a state (or plurality thereof) in which it is operable by operating section 1004.

In some embodiments, each of areas 1006a-c may individually sense touch, such as in case different inputs are registered when each of the areas is touched. Accordingly, touch motion on surface 1006 (i.e. any movement of touch along the surface) may be detected by two or more of areas 1006a-c sequentially sensing touch, such as when a finger touching surface 1006 is moving from one area to another. For example, each of areas 1006a-c may include a single touch sensor, whereas input from two or more sensors of the areas sensing touch sequentially may be interpreted as touch motion.

FIG. 10C specifically shows thumb 234 (i.e. a thumb of a hand 230, as shown in previous figures) touching touch surface 1006 (suggesting device 1000 is worn on a finger of hand 230) for operating device 1000, or otherwise for registering input. While touching surface 1006, thumb 234 may move left or right (from the point of view of the figure) as suggested by dashed arrows illustrated near the thumb). Note that any touch motion on surface 1006 (i.e. motion of a finger touching the surface) may be regarded similarly to the described for gestures (and specifically touch gestures), such as described for gestures 730a-c shown in FIG. 7E.

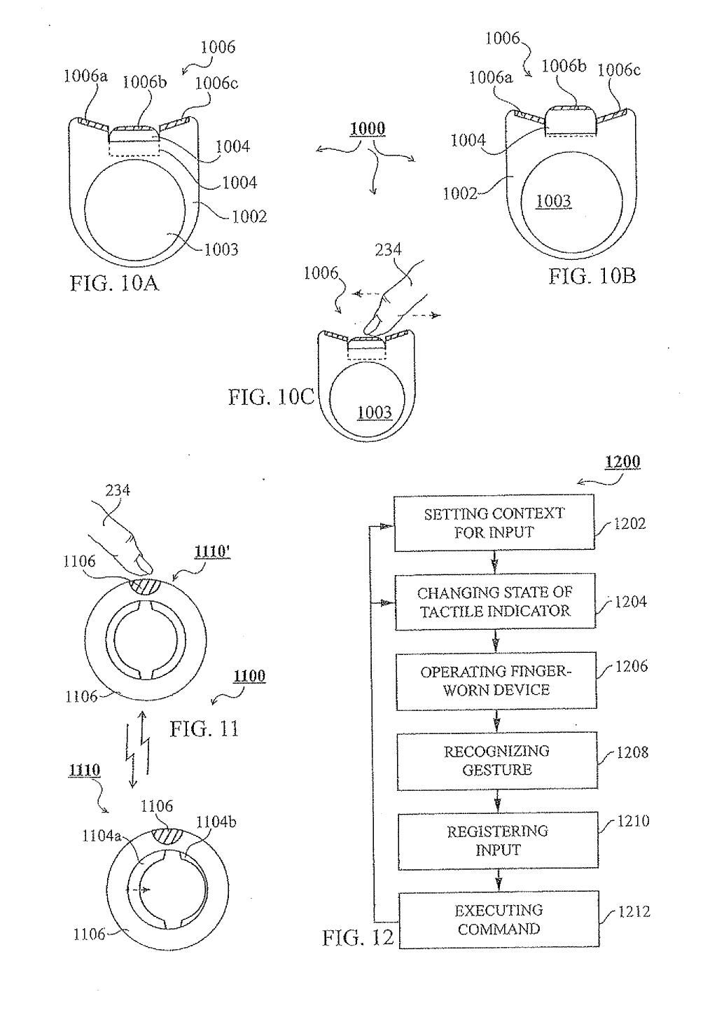

FIG. 11 shows a system 1100 of the invention which may include a finger-worn device 1110 and a finger-worn device 1110′. Each of devices 1110 and 1110′ is shown including an input unit 1106 which can be operated to register input, or which can sense each of the devices being operated. Each of devices 1110 and 1110′ is further shown including a section 1106 which can be mounted on a finger. Device 1110 is shown including indicators 1104a,b which may be dynamic tactile indicators (see e.g. indicators 716a-c of device 710 in FIGS. 7C through 7E) or haptic indicators (see e.g. haptic units 954a,b of device 950 in FIG. 9C). Note that indicators 1104a,b may generate tactile or haptic output which can be sensed by a finger wearing device 1110 and/or by a finger operating device 1110.

In some embodiments, devices 1110 and 1110′ may communicate between each other, such as by including a communication unit (see e.g. communication unit 718 of device 710 in FIGS. 7C and 7D). Optionally, communication sent from any of devices 1110 and 1110′ may correspond to input from that device being operated (shown device 1110′ operated in FIG. 11 by thumb 234). Further optionally, communication received by any of devices 1110 and 1110′ may prompt any of both of indicators 1104a,b to generate tactile or haptic output (shown indicator 1104a of device 1110 generating a haptic output in a direction illustrated by a dashed arrow). Said tactile or haptic output may correspond to how the other device is being operated. Accordingly, a user wearing and/or operating any of devices 1110 and 1110′ may be indicated how the device is being operated. This may be beneficial for exchanging tactile messages (i.e. tactile indications which may form meaningful messages) between users of devices 1110 and 1110′, such as when other means of communication are not available or not preferred. For example, a user of device 1110 and a user of device 1110′ may be sitting in a business meeting wherein they may not verbally communicate between each other. Accordingly and following the above, any of said users may operate any of devices 1110 and 1110′ which that user wears, for relaying a message (being relayed by tactile means) to the other user which is wearing the other device.

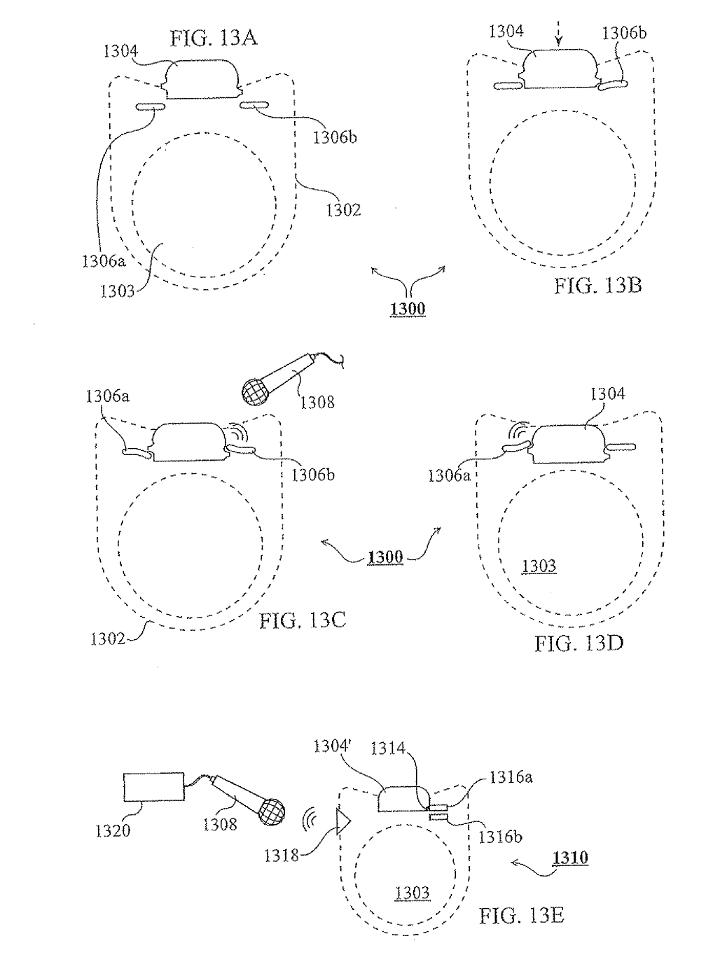

FIG. 12 shows a flowchart of a method 1200 of the invention, which generally follows the described above for indicators.

In some methods, at a step 1202, context may be set for input registered by operating a finger-worn device. Said context may refer to which interface element or event an operation (performed on or by the finger-worn device) corresponds, or to which interface element or event registered input (supposedly from operating the finger-worn device) corresponds. For example, sliding a thumb on a touch-sensitive surface of a finger-worn device (see e.g. touch surface 714 of device 710, shown in FIGS. 7C and 7D) may be an exemplary gesture by which input is registered at a step 1210 (see below). Determining which input is registered at step 1210 may be facilitated or influenced by setting context at step 1202. Accordingly, context for the same gesture may change at step 1202 (from a previous context to a context set at step 1202), such that further sliding the aforementioned thumb on the aforementioned touch-sensitive surface may register a different input, and/or may prompt a different interface event.

In some methods, at a step 1204, the state of a tactile indicator (see e.g. indicator 716a of device 710 in FIGS. 7C and 7E), or plurality thereof, may be changed.

In some methods, at a step 1206, the finger-worn device mentioned for step 1202 is operated in a certain manner. Said certain manner may refer to a gesture performed on (or with) the finger-worn device, or on (or with) a section thereof (e.g. a control).

In some methods, at a step 1208, gesture performed at step 1206 may be recognized, such as in a device which is communicating with the finger-worn device previously mentioned, and which may include gesture recognition features.

In some methods, at a step 1210, input corresponding to gesture recognized at step 1208 may be registered.

In some methods, at a step 1212, a command is executed correspondingly to input registered at step 1210.

At a step 546, context is changed for any further operation performed on (or by) the finger-worn device in method 540, or for further input registered from operating the finger-worn device. At a step 548, tactile feedback is prompted in (or at) the finger-worn device of method 540; otherwise the finger-worn device operated to register input (step 542) and/or to prompt a certain interface event (step 544). Said tactile feedback may be indicative of said interface event prompted at step 544, such as to notify a user that the interface event occurred. For example, an interface event may be “non-visual”, or may not be shown visually, such as by being a change in state of an interface element that doesn't have any visual representation. Additionally or alternatively, the tactile feedback (of step 548) may be indicative of the changing of context at step 546. Specifically, the tactile feedback may be any change in the finger-worn device (e.g. in a control of the finger-worn device, or near said control) that can be felt, such that it notifies a user touching the finger-worn device that certain further operations on the finger-worn device will correspond to a different interface event than the interface event prompted by previous operations, similar or otherwise. For example, sliding a thumb on a touch-sensitive surface of a finger-worn device may prompt a function (as an exemplary interface event), and may prompt a context change for further sliding of said thumb on said touch-sensitive surface, whereas a tactile change may occur in (or at, or near) the touch-sensitive surface, such as plugs “popping out” along its length (see e.g. indicators 516a,b of device 510 shown in FIG. 5D, suggested to be in a state where their plugs are “popped out”), for notifying a user (which touches the touch-sensitive surface) that the aforementioned functioned was prompted, and/or that any further sliding of the thumb on the touch-sensitive surface will prompt a different function (as an exemplary context change for further input from the touch-sensitive surface).

Note that whereas the described for method 540 refers to tactile feedback, it is made clear that the method may refer (or apply) to any feedback (e.g. visual; see e.g. FIG. 7A showing a visual indicator 706 of a device 700) which can indicate (or notify about) context change for input. For example, a finger-worn device may have a button and a multi-color light-emitting diode (LED), whereas pressing said button may initiate (from input registered from the pressing, at step 542) a first process of rendering graphics (as an exemplary interface event of step 544) in an interface for editing graphics (e.g. a graphic editing application). Preferably, while said first process of rendering graphics is executed (otherwise during the rendering of graphics in that process)—a second rendering process may not be initiated (e.g. due to hardware limitations), until the first rendering process is completed. Accordingly, context for input received from pressing the aforementioned button (of the aforementioned finger-worn device) while the first process is executed (as an exemplary “further input”) is changed, so that no other processes are initiated by receiving such input (during the first rendering process). Optionally, the aforementioned light-emitting diode (of the finger-worn device) may change its color to red during the execution of the first rendering process, indicating that pressing the button will not initiate a second rendering process. After the first rendering process is complete, the color of the light-emitting diode may change to green, indicating that a second process for rendering graphics may be initiated by pressing the button of the finger-worn device.

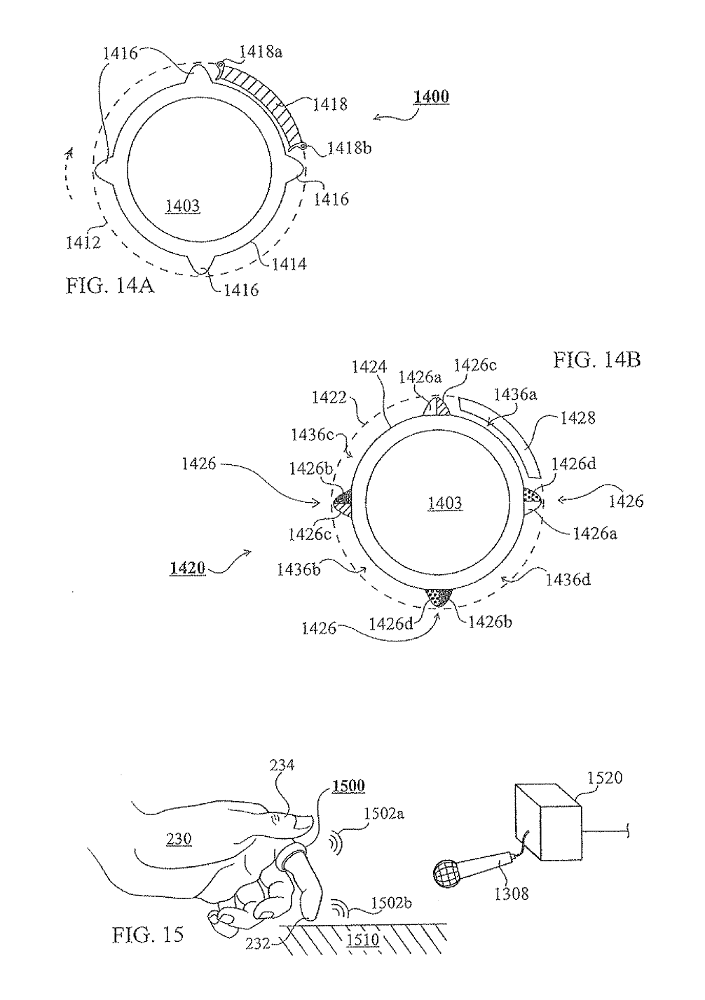

FIGS. 13A through 13D show (from a cross section point of view) an embodiment of the invention as a finger-worn device 1300. Device 1300 is shown including a section 1302 (illustrated in the figures by dashed lines for the purpose of revealing the inside of the section) in which there is a cavity 1303 through which a finger can be inserted. Device 1300 is shown further including a control 1304 for operating the device, such as a knob. In FIGS. 13A through 13D, control 1304 is shown (by way of example) as a button which can be pressed. By operating control 1304 of device 1300, sound (illustrated in FIGS. 13C and 13D as curved and generally concentric lines) may be produced (or generated). Accordingly, control 1304 may include or control (e.g. by being connected to) any means known in the art for mechanically generating sound (see e.g. U.S. Pat. Nos. 4,836,822, 3,102,509 and 6,954,416).

In some embodiments, sound generated by (otherwise originating from) device 1300 (e.g. by operating control 1304) may be sensed by a sound sensor 1308 (specifically shown in FIG. 13C, illustrated as a microphone), or by any other means of sensing sound known in the art. Sound sensor 1308 may be connected to any means for identifying (otherwise “recognizing”) sound (otherwise sound input, or otherwise sound as sensed by the sound sensor). Identified sound, or sound input (i.e. input registered by sensed sound which may have additionally been identified), may prompt an interface of program event, or may influence or manipulate (or otherwise control) an interface or program event, or otherwise be utilized for interaction with an interface or program. For example, sound sensor 1308 may be connected to a computer including sound recognition means (see e.g. a sound recognition system 1320 in FIG. 13E), wherein identification (or recognition) of sound originating from device 1300 (by said sound recognition means) may facilitate registering input corresponding to said sound. Specifically, different sounds generated by device 1300 may be sensed and identified to prompt different interface or program events, such as in the aforementioned computer.

In FIGS. 13A through 13D, control 1304 can be pressed into section 1302 (shown pressing direction as a dashed arrow in FIG. 13B). Specifically, as suggested by the positions of control 1304 in FIGS. 13C and 13D, control 1304 can be “half-pressed” (i.e. partially pressed or partially clicked into the section, as shown in FIG. 13C) and fully pressed (i.e. pressed all the way into section 1302, as shown in FIG. 13D) depending on how hard (and far) it is pressed (e.g. by a thumb pressing on it, otherwise applying force on it).

In FIG. 13B, control 1304 is shown influencing a plate 1306b during the pressing of the control into section 1302. Plate is shown in FIG. 13B as bent (by control 1304). Pressing control 1304 further (from its position in FIG. 13B to a position shown in FIG. 13C), plate 1306b may be released from force applied by plate control 1304 (which caused the bending of the plate), generating (or “producing”) sound, such as by vibrating.

In FIG. 13C, control 1304 is shown in a “half pressed” position, whereas following the above, pressing the control (from a default position, or “un-pressed” position as shown in FIG. 13A) to said “half-pressed” position may cause plate 1306b to generate a specific sound.

Further in FIG. 13C, control 1304 is shown influencing a plate 1306a, as the plate is shown bent. By pressing control 1304 from its position in FIG. 13C (wherein the control is in a “half-pressed” position) further, to a position shown in FIG. 6D wherein the control is fully pressed into the section, plate 1306a may be released (from its bent state) and generate a specific sound.

In some embodiments, sound generated from the releasing of plate 1306b may be different from sound generated from the releasing of plate 1306a, so that the sounds may be distinguishable (e.g. when detected by a microphone and processed by a sound recognition system). Accordingly, pressing control 1304 to a first position (e.g. a “half pressed” position) may be for generating a sound different from pressing the control to a second position (e.g. a fully pressed position), whereas the different sounds may be distinguishable by being sensed and identified (or recognized).

Following the above, operating control 1304 may be for generating different sounds, each of which may be distinguishable from sounds produced by operating the control differently. Additionally, each of said sounds may correspond to (or may be registered as) a different input when sensed and identified, such as by a sound recognition system including sound sensing means. More specifically, such as shown in FIGS. 13A through 13D, pressing control 1304 (as an exemplary way of operating the control) to a certain position may generate a first sound (e.g. by a mechanical reaction), whereas pressing the control to a different position may generate a second sound. Sensing said first sound may facilitate registering a specific input, whereas sensing Said second sound may facilitate registering a different input. For example, a computer having a microphone and a program for capturing sound and converting it to commands of an interface may execute a specific interface function when said microphone detects the aforementioned first sound, whereas said computer may execute a different function when said microphone detects the aforementioned second sound. Accordingly, device 1300 may be operated to prompt different interface or program events by generating sound, optionally depending on how control 1304 of the device is pressed (e.g. to which position).

Note that whereas the described above is for two positions (“half pressed” and fully pressed) of control 1304, control 1304 may have any number of positions, or may specifically be manipulated to be repositioned to any number of positions, each of said positions may correspond to device 1300 (or means included therein) generating a different sound.

Further note that whereas the described above for generating sound is by a specific mechanism (which includes plates control 604 and plates 606a,b), it is made clear that any other means of generating (or producing) sound, specifically mechanically may be included in a finger-worn device of the invention, such that said finger-worn device may be operated (e.g. by force is applied by a finger on a control of the finger-worn device) to generate sound (see e.g. U.S. Pat. Nos. 6,264,527 and 4,550,622). For example, an apparatus may be connected to a control of a finger-worn device of the invention, such that operating said control may induce audible friction (which may be sensed as sound or vibrations) in said apparatus, whereas by operating the device differently different audible frictions may be induced. Preferably, different sounds generated by differently operating a finger-worn device of the invention may be distinguishable and may correspond to different inputs, such that they may be sensed to register different inputs.

Further note that whereas the described above refers to sound generated by a mechanical reaction (or plurality thereof), it is made clear that sound, as generated by some embodiments of the invention, may alternatively be generated by any means known in the art (see e.g. audio output unit 1318 of a device 1310 in FIG. 13E). Otherwise, it is made clear that sound may be generated by finger-worn device of the invention by including and/or utilizing any means known in the art, preferably for registering different inputs, or otherwise for the purpose of communicating with other devices (which may include sound sensing and recognizing means), or for relaying indications of use of said finger-worn devices. For example, sound may be generated by compact electronic means (see e.g. U.S. Pat. No. 5,063,698) which can be included in a finger-worn device and controlled by a user operating said finger-worn device.

FIG. 13E shows an embodiment of the invention as a finger-worn device 1310 similar to device 1300 (FIGS. 13A through 13D). Device 1310 is shown including a control 1304′ similar to control 1304. As opposed to device 1300, wherein sound may be generated by mechanical means, in device 1310 sound may be generated by electronic means.

In FIG. 13E there is shown device 1310 including electronic contacts 1316a,b (or simply “contacts”), whereas specifically control 1304′ is shown including an electronic contact 1314. Electronic contact 1314 may come in contact with contact 1316a when control 1304′ is in a first position (e.g. pressed to a certain extent), whereas electronic contact 1314 may come in contact with contact 1316b when control 1304′ is in a second position (e.g. pressed to a different extent). By electronic contact 1314 coming in contact with contact 1316a, a first sound may be generated, whereas by contact 1314 coming in contact with contact 1316b, a second sound may be generated. Said first sound and said second sound may be generated by audio output unit 1318 which can generate different sounds, as known in the art, such as by an electronic sound generating device (see ref. U.S. Pat. No. 5,275,285). Accordingly, device 1310 may be operated differently to output different sounds.

Further shown in FIG. 13E is sound recognition system 1320 connected to a sound sensor 1308 (see ref. FIGS. 13A through 13D), so that sounds from device 1310, specifically generated by audio output unit 1318 of the device, may be sensed by the sound recognition system and recognized (or “identified”), to register input which corresponds to recognized sound.

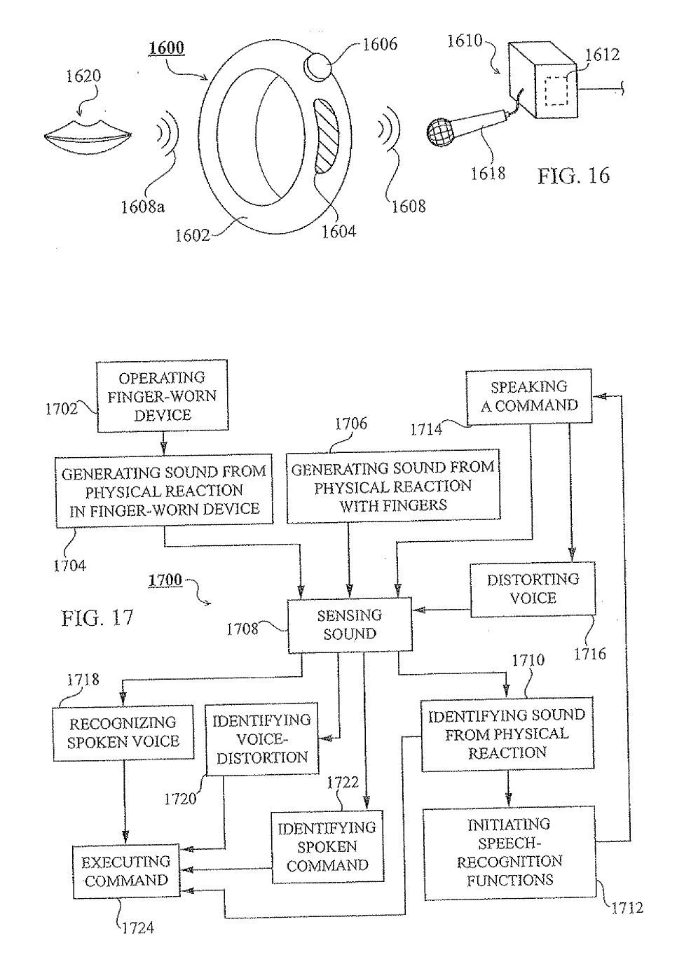

FIG. 14A shows a cross section of an embodiment of the invention as a finger-worn device 1400. Similarly to device 1300 (FIGS. 13A through 13D), device 1400 can also generate sound when operated. Shown in FIG. 14A is device 1400 having a rotatable section 1412 (illustrated by a dashed circle outline) and a stationary section 1414 which has a cavity 1403 (for finger insertion, as described for other finger-worn device of the invention). Section 1412 can be rotated relatively to section 1414, similarly to the described for section 702 of device 700 as rotatable around section 704 of the device (see ref. FIGS. 7A and 7B). Section 1412 is shown in the figure including a plug 1418 which includes clickers 1418a,b on either side. Section 1414 is shown in the figure including bumps 1416 (four bumps are shown) distributed along a track of rotation of section 1412.

In some embodiments, plug 1418 of section 1412 may fit between a couple of bumps 1416, whereas by rotating section 1412, the plug shifts from being between any certain couple of bumps to another couple of bumps. Additionally, by rotating section 1412 (and accordingly plug 1418, which is included in the section) in a certain direction may influence one of clickers 1418a,b of plug 1418, whereas rotating the section in an opposite direction may influence the other clicker. More specifically, by rotating section 1412 clockwise (from the point of view of the figure, whereas clockwise rotation suggested by illustrated curved dashed arrow in FIG. 14A) clicker 1418b may be clicked by the bumps (i.e. bumps 1416) along the track of rotation, whereas by rotating section 1412 counter-clockwise clicker 1418a may be clicked by the plugs. Clicking of clicker 1418a may sound differently than clicking of clicker 1418b. Accordingly, rotating section 1412 of device 1400 in a certain direction may be for generating a certain sound, whereas rotating the section in an opposite direction may be for generating a different sound. Similarly to the described for device 1300 (FIGS. 13A through 13D), sound generated by operating device 1400 may be sensed and registered as input, so that device 1400 may be operated in different ways (i.e. rotating section 1412 of the device in two opposite directions) for registering different inputs (e.g. in a system detecting sounds from device 1400 and distinguishing between them).

FIG. 14B shows a cross section of an embodiment of the invention as a finger-worn device 1420. Similarly to device 1400 including sections 1412 and 1414, device 1420 includes a stationary section 1424 (shown including cavity 1403) and a rotatable section 1422 which can rotate (or be rotated) relatively to section 1424 (and accordingly relative to a finger wearing device 1420 through cavity 1403 of section 1424). Section 1422 is shown including a plug 1428 which can be positioned to be in any of gaps 1436a-d (or to occupy any of the gaps) by rotating section 1422 to a corresponding one of four rotated positions. Gaps 1436a-d may be formed between bumps 1426. Each of bumps 1426 may have two different sections, whereas each gap may be formed by two bumps, each of which having a similar section located oppositely to that gap. More specifically, as shown in FIG. 14B, gap 1436a may be formed by a couple of bumps 1426, each having a section 1426a facing away from the gap (otherwise positioned oppositely to the gap). Similarly, each of gaps 1436b, 1436c and 1436d may be formed by a couple of bumps 1426 having sections 1426b, 1426c or 1426d, respectively, positioned such that they are facing away from that gap.

In some embodiments, by rotating section 1422, plug 1428 may influence (e.g. click on) any of sections 1426a-d located along a rotation track (otherwise along the path of rotation) and coming in contact with the plug as it approached it during rotation of section 1422. More specifically, when plug 1428 is moved or shifted (by rotating section 1422) from a first gap to a second gap, the plug influences a section of a bump which is positioned to face away from said second gap. As similar sections are positioned oppositely to any gap, any section influenced by moving or shifting plug 1428 to that gap in a certain direction (i.e. clockwise or counter-clockwise) may be identical to any other section which would have been influenced in case the plug was moved or shifted in a different direction. For example, shifting plug 1428 from gap 1436a (plug is shown positioned in gap 1436a in the figure) to gap 1436d can be performed by rotating section 1422 clockwise, whereas during rotation the plug must come in contact with section 1426d (illustrated as filled with a dots pattern; shown in the figure as a section of the rightmost bump). Similarly, by shifting plug 1428 from gap 1436b to gap 1436d (by rotating section 1422 counter-clockwise from its position in FIG. 14B), the plug must come in contact with another section 1426d (also illustrated filled with a dots pattern, as a section of the bottom bump). Note that plug 1428 can also be moved from gap 1436a to gap 1436d by rotating section 1422 counter-clockwise, in which case the plug is subsequently shifted from gap 1436a to gap 1436c and then to gap 1436b and finally to gap 1436d. Accordingly, the last shifting between gaps is from gap 1436b to gap 1436d, at which, as described above, a section 1426d is influenced.

In some embodiments, influencing any of sections 1426a-d (by plug 1428 being shifted from one gap to another) may produce a sound different from influencing any other section of sections 1426a-d. Following the above, shifting plug 1428 to a specific gap may produce the same sound (eventually, i.e. at the end of the shifting operation), regardless of the direction of shifting (as determined by rotating section 1422), whereas shifting the plug to a different gap produces a different sound (at the end of the shifting operation. Note that regardless of which gap the plug is being moved from (and the direction of rotating section 1422 which facilitates the shifting), the last gap to which the plug is being moved is defined by plugs which include two identical sections facing away from the plug and preferably generate the same sound when influenced by plug 1428 (whereas other sounds may be generated during the shifting of the plug between gaps, as the plug influences different sections along the path of rotating section 1422). Accordingly, when plug 1428 is in any of gaps 1436a-d, the last sound to be generated from shifting or moving the plug to that gap is the same, regardless of the direction of rotation of section 1422 (to shift or move the plug). Accordingly, section 1422 may be rotated to any one of four different positions in which plug 1428 is in any one of four different gaps (i.e. any of gaps 1436a-d), whereas the final position of the rotation of section 1422 may generate, at the end of the rotation operation, a distinct sound (the last sound being generated, specifically just before section 1422 entering said final position, and plug 1428 entering the corresponding gap) which is different for each of said four different positions. As described above for sensing sound and registering sound input, sensing the last sound originating from device 1420 may facilitate registering input which corresponds to a rotated position of section 1428 and to a position of plug 1428 after said last sound was generated, whereas distinguishing between different sounds may facilitate obtaining information about said last position, and registering corresponding input. For example, when plug 1428 is in gap 1436d, the last sound to originate from device 1420 is a sound generated by the plug influencing any section 1426d (two are shown in FIG. 14B facing away from gap 1436d) regardless of whether section 1422 was being rotated clockwise or counter-clockwise for moving the plug to gap 1436d. Said sound may be captured by a microphone for registering corresponding input which may be different from input registered by capturing other sounds. Said other sounds may be generated by the plug influencing any of sections 1426a-c which corresponds to moving the plug to any of gaps 1436a-c, respectively.

Note that by section 1422 of device 1420 having four rotated positions in which plug 1428 is in a gap, and by having each rotated position correspond to a different input (as described above for plug 1428 being in any of gaps 1436a-d), said four rotating positions may be referred to as “input positions”, similarly to the described above for input positions regarding device 700 (FIGS. 7A and 713).

Further note that whereas described herein are four input positions of device 1420 it is made clear that a finger-worn device of the invention may have any number of input positions.

Further note that whereas the described above refers to generating (or producing) sound, it is made clear that it may also refer to any non-audible vibrations which can be detected by vibrations sensors. Otherwise, sound as described herein may be of any frequency, wavelength, pitch, amplitude or intensity which isn't necessarily heard by humans, or that humans cannot hear, yet which can be detected by high sensitivity microphones, so-called “pick-ups” or similar sensing means.

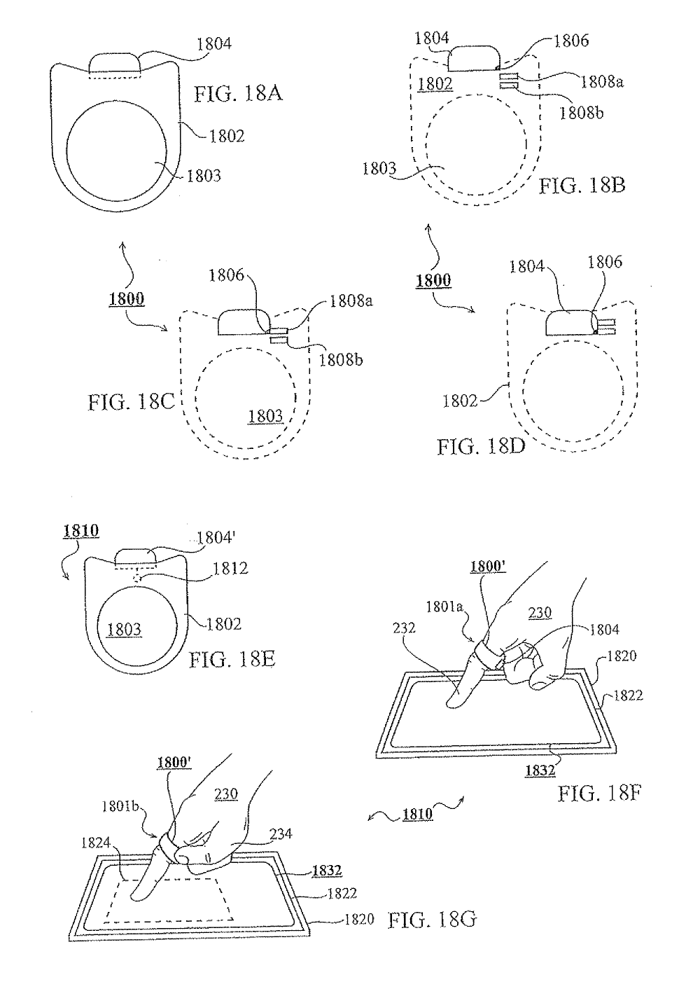

FIG. 15 shows a finger-worn device 1500 which may output sound (or otherwise vibrations), specifically by being operated, such as described above for audio output of finger-worn devices of the invention. In FIG. 15, device 1500 is shown outputting a sound 1502a, such as sound generated by thumb 234 of hand 230 (also shown in the figure) operating the device (e.g. rotating a rotatable section of the device). Further shown in FIG. 15 is a sound recognition system 1520 similar to sound recognition system 1320 (see ref. FIG. 13B), including a sound sensor 1308.

In some embodiments, sound recognition system 1520 may register input by sensing sound originating from device 1500 (e.g. sound generated by operating the device), and register input by sensing other sounds. Said other sounds may specifically be sounds generated by operations (or actions) performed by hand 230 not on (or “with”) device 1500. For example, hand 230 may perform so-called “snapping” of fingers (i.e. creating a cracking or clicking sound by building tension between a thumb and another finger, such as between thumb 234 and finger 232). For another example, finger 232 may tap on a surface 1510 for generating a tapping sound. For yet another example, as shown in FIG. 15, finger 232 may drag on a surface 1510 for generating a sound 1502b, such as a scratching sound from the friction between a nail of the finger and the surface. Following the above, sound recognition system 1520 may sense and recognize sound 1502a (originating from device 1500) for registering a first input, whereas the sound recognition system may sense and recognize sound 1502b for registering a second input. Said first and second inputs may be utilized in an interface or program, such as to execute different functions or prompt different interface events. Accordingly, a user may operate a finger-worn device of the invention and perform actions which generate sound (specifically actions performed by a hand on a finger of which said finger-worn device is worn), to register different input and accordingly interact with an interface or program (e.g. an interface of a device which includes sound recognition system 1520). This may be beneficial to increase the number of inputs which may be registered by sounds, either by a hand only performing actions which generate sound or by a hand only operating a finger-worn device of the invention. And so a user can utilize a finger-worn device of the invention in collaboration with hand (or specifically fingers) actions, to communicate more information to a device, such as to control a program of said device, whereas said information may correspond to different inputs registered in said device.

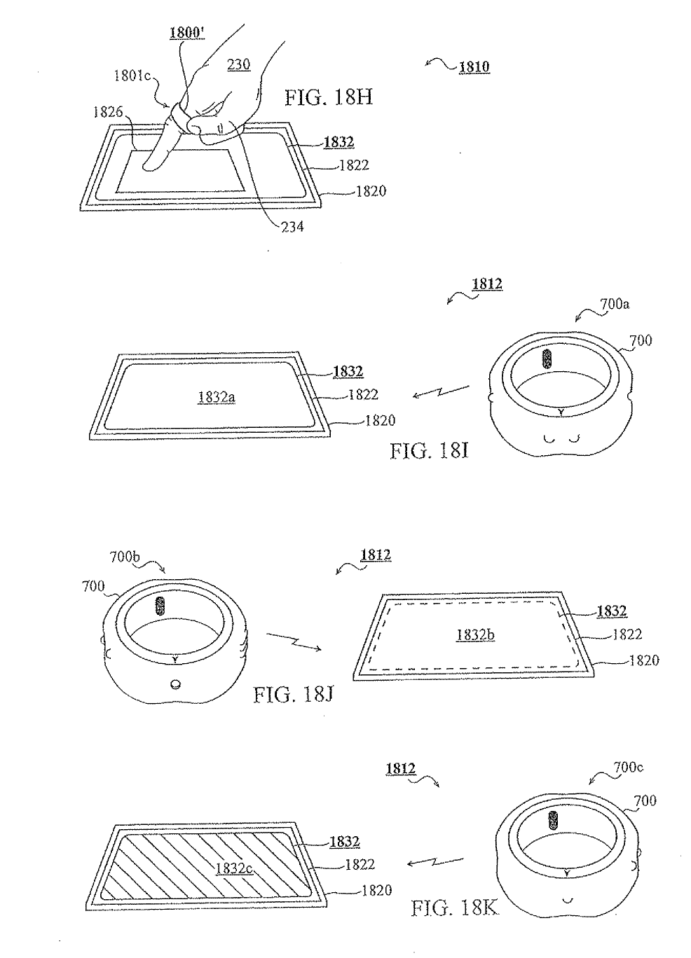

FIG. 16 shows an embodiment of the invention as a finger-worn device 1600. Device 1600 may include a section 1602 which facilitates wearing the device of a finger, such as an enclosure in which there is cavity (through which a finger may be inserted). Device 1600 is further shown in the figure including a voice distorter 1604 (or simply “distorter”). Voice distorter 1604 may be any means known in the art for distorting sound waves, specifically voice (see e.g. U.S. Pat. Nos. 5,963,907, 4,823,380, 5,127,870, 5,278,346, 4,652,699, 7,027,832 and 5,428,688). Accordingly, voice of a user speaking “through” or near device 1600 may be somewhat distorted. Note that alternatively, distorter 1604 may be any mechanism or apparatus which generates a specific noise when wind passes through it (see e.g. U.S. Pat. Nos. 4,998,456, 2,219,434, 4,962,007, 3,308,706, 1,447,919, 4,034,499, 4,104,610, 3,883,982, 4,392,325, 6,319,084 and 4,398,491). For example, voice distorter 1604 may be a so-called wind instrument, or “woodwind”, or “kazoo” as known in the art. Accordingly, when a user speaks through or near distorter 1604, wind from the mouth of said user may pass through distorter 1604 and a distinct noise may be generated. Further accordingly, voice of a user speaking through or near voice distorter 1604, to which noise may be added by the voice distorter, may be regarded as distorted voice.

In FIG. 16 there is further shown a mouth 1620 (of a user) speaking. Specifically, mouth 1620 is shown generating (also “producing”) a sound 1608a through (or near) voice distorter 1604 of device 1600. Sound 1608a is of the original voice of mouth 1620, more specifically of a user which has mouth 1620.

In some embodiments, as shown in FIG. 16, sound 1608a may be distorted to a sound 1608b. Optionally, sound 1608b may be of a distorted voice, i.e. being a distorted sound 1608a which is of an original voice. Alternatively, sound 1608b may be of the original voice of mouse 1620, to which noise may have been added (such as by voice distorter 1604). Sound 1608b is shown in the figure reaching a speech-recognition system 1610, specifically reaching a microphone 1618 connected to (or included in) the speech-recognition system (note that microphone 1618 may be, or include, any means for sensing sound). Speech-recognition system 1610 may be any system or device (or unit thereof) known in the art for recognizing voice (or otherwise identifying words in sounds), for registering input from speech (whereas some speech-recognition systems known in the art are utilized for biometric identification). Accordingly, speech-recognition system 1610 may sense sounds for registering input according to speech (or specifically words or sentences in said speech).

In some embodiments, sound 1608b as sensed (or otherwise “captured”) by microphone 1618 may be analyzed or processed by speech-recognition system 1610, such as by a program or function of the speech-recognition system. Processing or analyzing the captured sound may be for recognizing (or identifying) words (or any vocal elements, cues, combinations or audible information) and for registering input which corresponds to said words, such as specifically “converting” words (as captured and recognized) to commands in an interface or program. Optionally, processing or analyzing the captured sound may be, additionally, for identifying the person which speaks the voice recognized in said captured sound. Identifying the person which speaks may be for biometric identification of the speaker (i.e. the person which speaks). Accordingly, input may be registered only when the voice of a specific person is identified in captured sounds.

In some embodiments, speech-recognition system 1610 can identify (or otherwise “measure”, or “obtain information about”) voice distortion or noise in sound captured by microphone 1618 (by processing or analyzing the captured sound). Accordingly, speech-recognition system 1610 may detect whether a sound of voice is distorted (and optionally the amount of distortion in said sound of voice), and/or whether noise is present in said sound of voice (and optionally the amount of said noise). For example, speech-recognition system 1610 may identify distortion by identifying voice in captured sound and by comparing it to a known voice of a user, such as by utilizing algorithms of patterns recognition, and/or accessing a database for comparing (or otherwise “matching”) the captured sound to stored information about voices. Similarly, speech-recognition system 1610 may detect the presence of a specific noise (and optionally measure said specific noise) in captured sound, such as by identifying noise which is known (e.g. preprogrammed to the speech-recognition system) to be generated by air passing through distorter 1604. Detecting a specific noise may be facilitated by recognizing voice in captured sound and distinguishing between said voice and other audible elements in said captured sound. Otherwise, detecting a specific noise may be facilitated by applying speech-recognition methods to recognize a distinct noise.

Note that it is made clear that in some embodiments, speech-recognition system 1610 may identify a person speaking even in case the voice of said person is distorted or added noise to, as the distortion profile of voice distorter 1604 (i.e. the way the voice distorter distort voices or adds noise to) may be taken in account when the speech-recognition system analyzes or processes sensed sound.

In some embodiments, input may be registered by speech-recognition system 1610 only when distortion of a voice (and/or the presence of a specific noise) is identified in captured sound. For example, a person (or “user”) may speak with mouth 1620 near speech-recognition system 1610, producing sound 1608a, whereas when device 1600 is far from the mouth, sound 1608a (being of the original voice of said person) may be captured by microphone 1618 of system 1610, whereas input is not registered because distortion is not identified in sound 1608a which is of the original voice. However, when said person speaks while device 1600 is near mouth 1620, sound 1602a (produced by the person speaking) may be distorted to sound 682b by voice distorter 1604 of the device (otherwise, noise may be added to sound 1608a by distorter 1604, for composing sound 1608b), whereas by sound 1608b being captured by microphone 1618 and by distortion and/or noise in sound 1608b is identified or detected (e.g. by speech-recognition program of speech-recognition system 1610, comparing voice in sound 1608b to an original voice of the aforementioned person, as stored in a database, or as coded in the program), input may be registered. Said input may optionally correspond to words (or any other vocal elements) in sound 1608b, preferably words (Or vocal elements) which remained recognizable after sound 1608a was distorted to sound 1608b, such as patterns of sound which can still be identified even after being distorted. Note that as known in the art, words and combinations thereof may correspond to functions of interfaces or programs, or to interface or program elements or events, so that by recognizing words in sounds, input may be registered which is for executing interface or program functions, or for influencing interface or program elements, or for prompting interface or program events.

In some embodiments, input may be registered by speech-recognition system 1610 only when distortion of a voice (and/or the presence of a specific noise) is identified in captured sound, whereas voice of a specific person is recognized in said captured sound (as opposed to only identifying distortion and/or noise). Accordingly, input may be registered only when a specific person is speaking through or near device 1600, whereas other people speaking near or through device 1600 may not prompt registration of input.

In FIG. 16, device 1600 is shown including a control 1606 which may be any means by which the device can be operated. Optionally, control 1606 controls whether voice distorter 1604 is activated or deactivated, so that by operating the control (or not operating the control), a user may determine whether voice (which may be produced through or near the voice distorter) will be distorted or not, or whether noise will be generated or not. Alternatively, control 1606 may be a sound generating unit as known in the art (see e.g. U.S. Pat. Nos. 6,669,528 and 4,662,858), for generating specific sounds, whereas by speech-recognition system 1610 detecting said sounds (e.g. by microphone 1618 sensing the sounds and speech-recognition system 1610 identifying the sounds), a function for registering input from sensing a voice and identifying voice distortion, noise and/or the person speaking in said voice, may be activated or deactivated, such as in case operating control 1606 in a certain way is for generating a first sound commanding speech-recognition system 1610 to stop executing a certain function, whereas operating control 1606 in a different way is for generating a second sound commanding the speech-recognition system to start executing said certain function (said first and second sounds may be distinct and recognizable by the speech-recognition system). The described alternative may yield similar results in which a user operating (or not operating) control 1606 determines whether input is registered when voice in sound, voice distortion and/or noise reaches speech-recognition system 1610, or specifically microphone 1618. So following the above, determining whether input is registered may be by either activating or deactivating distorter 1604, or by generating a sound which (by being detected) activates or deactivates a function (or plurality thereof) of speech-recognition system. Note that said function may be a function (or plurality thereof) for any of sensing sound, recognizing voice of a speaker in sensed sound, identifying voice distortion and detecting noise. Further note that the described above for a function for registering input (from sensing a voice and identifying voice distortion, noise and/or the person speaking in said voice) may similarly be for a function for sensing sounds, such that by deactivating said function for sensing sounds, input (from sensing) cannot be registered, and such that by activated said function for sensing sounds, registering input from sound sensing may be facilitated. Similarly, operating control 1606 of device 1600 may be for activating and/or deactivating the operation of microphone 1618 of speech-recognition system 1610.

In some embodiments, a finger-worn device of the invention may not necessarily include a voice distorter, yet may include a sound generating unit, or any means for generating sound, so that sound (or otherwise any audio output) may be generated by operating said finger-worn device, whereas a sound generated by operating said finger-worn device (or otherwise “sound originating from the finger-worn device”) may be detected (e.g. sensed and identified by speech-recognition system 1610) for prompting the start of a function (e.g. a function of speech-recognition system 1610) for sensing sound, and/or a function for recognizing voice is sensed sound, and/or a function for recognizing words (or combinations or sequences thereof), and/or for registering input correspondingly to said words (or correspondingly to said combinations or sequences). Similarly, the finger-worn device may be operated after any of the aforementioned functions had begun, to generate an identical sound, for prompting the end of any of said functions. Alternatively, a different sound may be generated by operating the finger-worn device in a different way, for prompting the end of any of said functions. See e.g. device 1300 is FIGS. 13A through 13D operated in different ways (specifically repositioning control 1304 of the device to any of two different positions) for generating different sounds. For example, a finger-worn device of the invention may include a control which, when operated, generates a specific noise which, when detected by speech-recognition system 1610, may prompt the speech-recognition system to register corresponding input, such as to initiate a function of speech-recognition system 1610 for sensing sound and recognizing words in said sound as commands for an interface or program. Similarly, said control may be operated differently to generate a different noise which, when detected by speech-recognition system 1610, may prompt the speech-recognition system to register corresponding input, such as to cease or disable said function of speech-recognition system 1610.

Following the above, a user may speak in the vicinity of (also “near”) speech-recognition system 1610 which does not register input when said user is speaking, such as either by not sensing sounds, or by not processing sensed sound (e.g. to recognize words). Said user may operate a finger-worn device of the invention and then speak words in a sound of voice (or otherwise speak while operating said finger-worn device), whereas said sound of voice may accordingly be sensed and processed (or “analyzed”), such as by a speech-recognition system, so that certain words (or combinations or sequences thereof) may be recognized to control or influence an interface or program, such as in case said certain words include preprogrammed commands of an interface or program, so that recognizing them may be for executing said preprogrammed commands. Said user may later operate the aforementioned finger-worn device, either in a different or similar way, so that no input is then registered when said user is speaking. This may be beneficial for when a user wishes for spoken words to be recognized (e.g. from sensing sound of speech) for prompting interface or program events, or for executing interface or program functions, or for controlling interface or program elements, and for when said user wishes to speak without words (spoken by said user, or otherwise by any person said user) prompting interface or program events, executing interface or program functions or controlling interface or program elements.

Note that it is made clear that speech-recognition system 1610 may utilize any number of programs (e.g. software or applications) for processing or analyzing sound, or specifically for recognizing voice, and/or identifying (also “detecting”) voice distortion and/or noise, and/or for recognizing words (or combinations or sequences thereof). For example, the voice recognition system may utilize a program which implements any number of voice analysis algorithms for recognizing words in sound captured by microphone 1618, whereas the speech-recognition system may utilize another program for detecting distortion in a voice, or noise present in the captured sound.

Further note the described for noise which may be generated by distorter 1604 of device 1600 may be audible sound or any non-audible waves or vibrations (e.g. induced by wind passing through the distorter). Optionally, non-audible waves or vibrations may be sensed by the same sensing means utilized by speech-recognition system 1610 to sense sound (e.g. microphone 1618), in case said same sensing means are sensitive enough to sense audible sound (specifically sound of voice) and non-audible waves or vibrations.

Note that whereas some voice distorting means known in the art are designed for users to speak directly “through” them (or through a section of them, e.g. through a membrane or mouth-covering installation), it is made clear that for the invention it may be enough for users to speak near such means (e.g. voice distorter 1604), as only a limited amount of distortion may be required for the results described herein, specifically for FIG. 16. For example, a speech-recognition system (e.g. voice recognition system 1610), or any means for detecting voice distortion or noise, may be sensitive enough to recognize or detect mild distortions. Further note that whereas not speaking “through” a voice distorter, sound of an original voice (i.e. undistorted voice) may still reach a microphone (e.g. sound waves not passing through said voice distorter), yet for the described herein, a speech-recognition system (or any means for detecting voice distortion or noise) may register input correspondingly to recognized or detected distortion or noise, disregarding undistorted sounds of voice (and any other background noise). Similarly, whereas some means for generating noise by utilizing wind may require a user to blow directly on or through them (e.g. a whistle having a mouthpiece) for maximum results, it may be enough for the invention for a small amount of noise to be generated when a user's mouth is only near such means, such as in case detecting said small amount of noise is facilitated by high sensitivity detection and/or recognition means. Accordingly, a speech-recognition system, or any means for detecting voice distortion or noise, may be adapter, set or calibrated (or otherwise “programmed”) to relate only to a specific range or amount of voice distortion or noise, so that input may be registered only when a user speaks in a specific range of distances from a voice distorter (or any means for generating distortion of voice and/or noise).

Note that it is made clear that a voice distorter of a finger-worn device of the invention may, in some embodiments, facilitate distorting a voice in any of a plurality of ways (also “manners”, or “fashions”), whereas by operating said finger-worn device, a user may select (also “choose”) which way from said plurality of ways said voice distorter is to distort a voice (preferably the voice of said user). In other words, a user may operate some embodiments of a finger-worn device of the invention which includes a voice distorter, for selecting between multiple ways in which said voice distorter can distort a voice, such as in case said voice distorter may be in any of multiple states, whereas each of said multiple states corresponds to distorting a voice in a different way, and whereas operating said finger-worn device is for changing between said multiple states. For example, in some embodiments, voice distorter 1604 of device 1600 may have a first state in which the voice distorter does not distort voices (e.g. a state in which the voice distorter is deactivated), a second state in which the voice distorter distorts voices (i.e. any voice spoken near device 1600) in a first way, and a third state in which the voice distorter distort voices in a second way. Additionally, operating control 1606 of device 1600 may be for changing between said first, second and third states of voice distorter 1604, to determine whether voice spoken near device 1600 is not distorted, is distorted in said first way or is distorted in said second way.

Note that the described above for a plurality of ways in which voice may be distorted may similarly describe a plurality of different noises which can be generated and added to sound of voice.

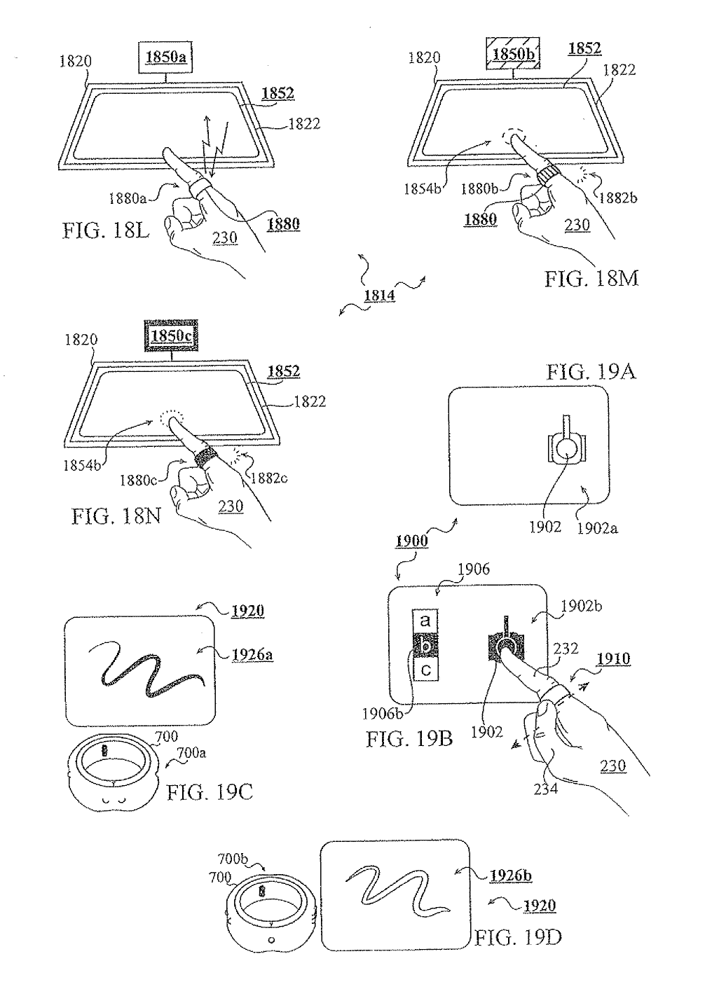

FIG. 17 shows a flowchart of a method 1700 of the invention.

At a step 1702, a finger-worn device is operated. In some method, said finger-worn device may generate sound when being operated (see e.g. device 1300 in FIGS. 13A through 13D). Note that sound, as described for method 1700, may be audible or non-audible (i.e. sound which can be heard by a human, or otherwise which cannot be heard by a human), and may include any number of elements and properties of sound. Said sound may be generated by any means known in the art. In some embodiments, said sound may specifically be generated by a physical (or otherwise “mechanical”) reaction (or plurality thereof). Accordingly, in some methods, sound is generated by a physical reaction at a step 1704. Said sound may be generated by the aforementioned finger-worn device being operated (step 1702), such as described for generating sounds by operating finger-worn devices of the invention.

At some methods, sound may be generated by performing an action with fingers (or otherwise “generated by fingers performing an action”). By performing said action, a physical reaction may generate said sound at a step 1706. Said physical reaction (of step 1706) may be any physical (or otherwise “mechanical”) reaction (i.e. reaction from items, objects, bodies, etc.) to an action (or plurality thereof) of a finger (or plurality thereof), from which (i.e. from the reaction) sound may be generated (or produced). For example, a hand may be snapping fingers (e.g. as known for snapping a thumb and a middle finger), so that a snapping sound may be generated by the snapping action. For another example, a finger may tap on a surface, so that a reaction from said surface may be vibrations (which may be audible or otherwise).

Sound is sensed at a step 1708. In some embodiments, sound sensed at step 1708 may be of a physical reaction from operating a finger-worn device (step 1704). Additionally or alternatively, sound sensed at step 1708 may be of a physical reaction from an action performed by fingers (step 1706).

In some methods, sound from any number of physical reactions may be identified at a step 1710. Accordingly, sound generated by a physical reaction at step 1704 and/or sound generated by a physical reaction at step 1706 may be identified at step 1710. Identifying sound may be performed by any means known in the art which facilitate identification of sounds. For example, a speech-recognition software and/or hardware (otherwise a “speech-recognition system”) may be adapted to identify sound generated by hand actions and/or sound generated by operating a finger-worn device, whereas such sounds may be distinct so that they can be isolated or distinguished from other sounds that may have been sensed (e.g. background sound that may inevitably be with sounds from physical reactions), such as by said speech-recognition software being preprogrammed to detect certain distinct sound among different sensed sounds.

In some methods, by identifying sound (or plurality thereof) generated by a physical reaction (a physical reaction from performing an action with fingers, and/or a physical reaction from operating a finger-worn device), a command (or plurality thereof) may be executed at a step 1724. Said command may be any controlling or manipulation (or otherwise “any influence or affect on”) an interface or program, such as for performing certain functions in said interface or program. Specifically, sound generated by specific physical reactions (e.g. from a specific action performed by fingers and/or from operating a finger-worn device in a specific way) may be distinct, and may correspond to a command (or plurality thereof), such that identifying said sound may facilitate executing said command. For example, a system may sense sounds (e.g. by utilizing a microphone or sound sensor) and identify within said sounds a specific distinct sound which was generated by operating a finger-worn device, whereas by identifying said specific distinct sound, said system may prompt an interface or program event (as an exemplary command), such as by programming said system to prompt said interface or program event when identifying said specific distinct sound. Accordingly, a system may be programmed (or otherwise in any way adapted or designed) to identify distinct sounds generated specifically by performing actions with fingers and/or by operating a finger-worn device, and execute corresponding commands in any case said distinct sounds are identified.

In some methods, speech-recognition functions may be initiated at a step 1712, specifically from identifying sound from a physical reaction (or plurality thereof), i.e. from the result of step 1710. Accordingly, by identifying sound which was generated by a specific physical reaction (e.g. a distinct sound generated from finger performing a certain action, and/or a distinct sound generated from operating a finger-worn device), speech-recognition functions may be initiated. For example, speech-recognition system (i.e. hardware and/or software which facilitate speech-recognition, as known in the art) may be programmed to be activated (as an exemplary initiation of a speech-recognition function) by identifying a specific sound (or plurality thereof), such as by sensing sounds and applying an algorithm for speech-recognition to identify said specific sound. Note that similarly, said speech-recognition system may additionally be programmed to be deactivated (or otherwise to cease any speech-recognition function) by identifying a different sound (i.e. a sound different than said specific sound), or by identifying the aforementioned specific sound when said speech-recognition is active (or otherwise when any speech-recognition function is being executed), as described above for FIG. 16.

Note that speech-recognition functions of step 1712 may include any of steps 1718, 1720 and 1722 as described below. Accordingly, initiating speech-recognition functions at step 1712 may be for initiating any number of functions which facilitate any of steps 1718, 1720 and 1722.

In some methods, a person, preferably the user of the finger-worn device operated at step 1702, may speak a command (or plurality thereof) at step 1714. Speaking a command at step 1702 may be speaking (also “saying”) any word (or combination or sequence of words, such as a sentence) which corresponds to an interface or program command, such that when said word (or combination or sequence of words) is identified (e.g. by a speech-recognition system sensing sound of voice and identifying words spoken in said sound of voice), said interface or program command is executed (e.g. in a program of a device which includes a speech-recognition system).

In some methods, voice of a person speaking a command at step 1714 may be distorted by a finger-worn device of the invention at a step 1716. As described above for voice distorter 1604 of device 1600 in FIG. 16, the aforementioned person may be speaking near or through a finger-worn device of the invention which may utilize any voice distorting means to distort the voice of said person, such as by adding distinct noise to sound waves passing through said finger-worn device (as described above for a finger-worn device generating noise). A finger-worn device of the invention may be operated to perform distortion of voice, such as by operating a control of said finger-worn device which may activate or deactivate a voice distorted of said finger-worn device.

Following the above, at step 1708, a spoken command (step 1714) or a distorted voice (step 1716) may be sensed as sound. Note that distorted voice from step 1716 may be of a voice speaking a command, such as in case sound of a spoken command (as a result of step 1714) is distorted at step 1716.

In some methods, spoken voice may be recognized at a step 1718, specifically the voice in which a command is spoken at step 1714 (as sensed at step 1708). Recognizing spoken voice may be for biometric identification of a person speaking in said spoken voice, as known in the art for voice-recognition.

In some methods, voice distortion may be identified at a step 1720, specifically voice distortion performed at step 1716 (whereas distorted voice may have been sensed at step 1708). Accordingly, information about whether a voice is distorted, and optionally how it is distorted and/or to what extent (i.e. the amount of distortion), may be obtained at step 1720, such as by a voice-recognition system adapted (e.g. a software of said voice-recognition system being programmed) to specifically identify distortions generated by a finger-worn device, which may be applied to any words spoken near said finger-worn device in any voice. Note that in some methods, a step of determining whether distortion is present in sound of voice, may substitute step 1720. In such methods, a command may be executed at step 1724 only if distortion is determined to be present in sound of voice (e.g. sound of voice in sound sensed at step 1708).

In some methods, spoken command may be identified at step 1722, specifically a command spoken at step 1714. Identifying spoken commands may be facilitated by any means known in the art for speech-recognition. Note that step 1722 relates to speech-recognition, in which spoken words may be converted to machine-readable input, whereas step 1718 related to voice-recognition, in which a speaker (i.e. a person speaking) may be recognized by the sound of voice of said speaker.

Note that as described above, any of steps 1718, 1720 and 1722 may be facilitated by initiating speech-recognition functions at step 1712. Alternatively, in some methods, step 1712 may not be included and any of steps 1718, 1720 may be performed regardless.

In some methods, a command (or plurality thereof) may be executed at step 1724 correspondingly to results from any of steps 1718, 1720 and 1722 (and also step 1710 as described above). Accordingly, results from any of steps 1718, 1720 and 1722 may facilitate (or otherwise “prompt”) execution of a command, or plurality thereof, such as in an interface or program. For example, a specific command may be executed (step 1724) if a distinct sound from a physical reaction (preferably from operating a finger-worn device and/or from performing an action with fingers) is identified, such as by being sensed (step 1708) by a microphone and processed (optionally with other sensed sounds) by a sound processing program which identifies said distinct sound (step 1710) and registers corresponding input to execute the aforementioned specific command. For another example, a person speaking a spoken command in a certain voice may be recognized (step 1718), such as in case recognizing said certain voice is facilitated by a specific sound from a physical reaction is identified (step 1710) to initiate a function for recognizing voice of a speaker (as part of step 1712 as noted above to optionally include initiating any number of function which facilitates any of steps 1718, 1720 and 1722). Additionally, a function for identifying spoken commands may be initiated (optionally at step 1712), so that the aforementioned spoken command (spoken by the aforementioned speaker) is identified (step 1722) and registered as input. Further additionally, a program may execute a function (as an exemplary command of step 1724) in case said speaker is recognized and said spoken command is identified, so consequently said function is executed at step 1724. For a similar example, a speaker may be speaking a spoken command (step 1714) near a finger-worn device which includes a voice distorted (see e.g. voice distorter 1604 in FIG. 16) and may be operating said finger-worn device so that the voice of said speaker, in which said spoken command is spoken, is distorted (step 1716). A sound of said spoken command in a distorted voice (of said speaker) may be sensed (step 1708) by a sound sensor and processed by a program, wherein distortion in said distorted voice may be identified (step 1720) and said spoken command may be identified (step 1722), so that corresponding input may be registered which may prompt the execution of a specific command (step 1724).

Note that any of steps 1710, 1718, 1720 and 1722 may result in registered input which may prompt an execution of a command, or otherwise which may facilitate step 1724.

FIGS. 18A through 18D show a cross-section an embodiment of the invention as a finger-worn device 1800. Device 1800 may be a user-input device having a cavity 1803 in a section 1802 (illustrated in FIGS. 18B through 18D by dashed lines to reveal internal elements) through which a finger can be inserted, for wearing the device on the finger. As shown in the figures, device 1800 may include a control 1804 which can be operated by a finger, such as by a thumb, when the device is worn on a finger of the same hand (see e.g. a finger-worn device 1800′ worn on hand 232 in FIG. 18F). Control 1804 may be any element or unit which can be operated to register input. Specifically, control 1804 may have two or more states (i.e. may be in any one of two or more states), whereas operating the control may be for switching between states (i.e. changing which state, or plurality thereof, the control is in). Control 1804 is shown in FIGS. 18A through 18D by way of example as a button which can be pressed by a finger (e.g. a thumb) into section 1802 of device 1800. Specifically, control 1804 may be pressed to two or more specific positions or extents (as exemplary states), such as a halfway pressed position (also “half-pressed position”, i.e. pressed generally halfway into section 1802) and a fully pressed position. Accordingly, in some embodiments, control 1804 may be similar to a shooting button of common digital cameras, wherein pressing said shooting button halfway may be for an auto-focus function, and fully pressing the shooting button is for taking a picture (also “shooting”).

In FIG. 18B (and in FIGS. 18C and 18D) there is specifically shown an exemplary mechanism facilitating two positions of pressing control 1804, whereas a different input may be obtained (or otherwise “registered”) by pressing the control to any of said two positions. Control 1804 is shown in the figures having a contact 1806, whereas inside section 1802 are shown contacts 1808a,b. In FIG. 18B, control 1804 may be at a default position of being “un-pressed”, such as when the control is not being operated, similarly to the shown in FIG. 18A.

In FIG. 18C there is specifically shown device 1800, wherein the position of control 1804 is halfway into section 1802, suggesting a “half-pressed” position of the control, for a first input (i.e. for registering a first input). Said first input may be registered by contact 1806 coming in contact with contact 1808a, as shown in the figure, facilitated by a “half-pressing” control 1804 (i.e. pressing the control to a “half-pressed” position). Contacts 1806 and 1808a may, by coming in contact with each other, close an electric circuit for facilitating detection of the “half-pressed” position of control 1804. Said detection may be processed (in device 1800 or in any device communicating with device 1800) for registering the aforementioned first input.

FIG. 18D specifically shows device 1800 wherein control 1804 is fully pressed (i.e. pressed into section 1802 as far as possible), for a second input. Said second input may be different than input for an “un-pressed” position of control 1804 (i.e. a default position of the control not being operated, as shown in FIGS. 18A and 18B), and different than input for a “half-pressed” position (shown in FIG. 18C). Said second input may be registered by contact 1806 corning in contact with contact 1808b, as shown in FIG. 18D.

In some embodiments, physical feedback may be utilized in device 1800, for a tactile distinction between half-pressing and fully pressing control 1804. For example, control 1804 may be installed on a mechanism of springs such that half-pressing control 1804 may require minimal pressing force (e.g. from a thumb pressing on the control), whereas fully pressing the control may require a substantially larger amount of pressing force (for pressing the control from a “half-pressed” position to a fully pressed position). For another example, a small bump may be obstructing the control 1804 from being fully pressed, so that for fully pressing the control, a user may need to apply a considerably increased amount of pressure on the control, whereas half-pressing the control may require said user to press the control until reaching a position where the control is obstructed from being fully pressed (i.e. to a “half-pressed” position corresponding the aforementioned small bump). Optionally, physical feedback may be dynamic, so that it can change correspondingly to an interface or program, such as in response to interface events. For example, device 1800 may be an input device for a computer (with which it can communicate wirelessly) that has an interface controllable by device 1800. An input registered from half-pressing control 1804 of device 1800 may be for executing a first function of said interface, whereas fully pressing the control may be for executing a second function of said interface. In case said second function is disabled in the interface (e.g. a delete function not executable on a so-called read-only file in the interface), a lock may be actuated in device 1800 for preventing a user from fully pressing control 1804, so that said user can only half-press the control, until the second function becomes enabled. Accordingly, a finger-worn device of the invention may include a control which can be repositioned (or otherwise “operated to change states”) for registering input, whereas any repositioning (or otherwise “operating”) of said control may be influenced by physical feedback, specifically dynamic physical feedback which may correspond to interface or program events or elements, or states of interface or program elements.

In some embodiments, control 1804 of device 1800 may remain in a position (e.g. in a “half-pressed” position or a fully pressed position) after being operated (e.g. after being pressed), whereas in some embodiments, control 1804 may return to a position in which it was before being operated (e.g. a default “un-pressed” position, as shown in FIGS. 18A and 18B). For example, a finger may press on control 1804 to position it halfway into section 1802 of device 1800, whereas by removing said finger from control 1804 may be for returning the control to a default (or “un-pressed”) position, in which it was before being pressed. Alternatively or additionally, the aforementioned finger may press on control 1804 to position it fully inside section 1802 (otherwise “to position the control in a fully pressed position”), whereas by removing said finger from control 1804, the control may remain fully inside section 1802 (otherwise “remain in a fully pressed position”), optionally until further pressure is applied to release the control from being inside section 1802 (otherwise “from its fully pressed position”).

Note that whereas the described herein for FIGS. 18A through 18D is for two specific positions of pressing a control of a finger-worn device (i.e. two possible “pressed” positions of the control and one “un-pressed” position as described above), a finger-worn device of the invention may utilize any number of controls which can be repositioned to (otherwise “can be operated to change between”) any number of positions. Otherwise, a finger-worn device of the invention may utilize any number of controls having any number of states (e.g. “pressed” positions) which may be changed by operating said finger-worn device. Similarly, a finger-worn device of the invention may be operated to change between any number of states of said finger-worn device itself, such as by operating a control which does not change positions or states, yet by being operated may change states of said finger-worn device.

FIG. 18E shows another embodiment of the invention as a finger worn device 1810 similar to device 1800, wherein a control 1804′ similar to control 1804 may be installed on, or connected or coupled to a pressure sensor 1812 (illustrated in FIG. 18E by a dashed circle connected to the control, suggesting being inside section 1802 of device 1810), for facilitating detection of multiple pressing positions of control 1804′, each corresponding to a specific and a different (also “distinct”) input. In other words, control 1804′ may be operated for registering different inputs, each of which corresponds to a different value of pressure which can be sensed by pressure sensor 1812 when applied on control 1804′.

FIGS. 18F through 18H show a system 1810 of the invention, which may include a finger-worn device 1800′ and a device 1820. In the figures, hand 230 is shown wearing device 1800 and interacting with (also “operating”) device 1820. Device 1820 may include a touch-screen 1822 so that hand 230 may interact with device 1820 by touching touch-screen 1822 with finger 232 (specifically shown wearing device 1800′ similar to device 1800 by way of example). Touch-screen 1822 is shown displaying an interface 1832, which may be any user interface (UI), such as a graphic user interface (GUI), or any virtual environment (e.g. an operating system (OS), or a computer application) which can be presented visually. Interface 1832 may be a visual representation of a program, such as being the front-end of a web-page or any software, whereas said program may be the back-end. For example, device 1820 may be a desktop computer or a portable computer (e.g. laptop) which includes a touch-screen (i.e. touch-screen 1822) for displaying an interface (i.e. interface 1832), so that a user may interact with the device, and specifically with said interface, by touching said touch-screen.

In FIGS. 18F through 18H, device 1800′ is shown worn on finger 232 of hand 230 while the hand, or specifically the finger, is interacting with device 1820, such as by touching touch-screen 1820. Note that any other finger of hand 230 (such as a finger not wearing device 1800′) may be interacting with device 1820, additionally or alternatively to finger 232 which is shown wearing device 1800′. Similarly to the described above for device 1800 (specifically for control, 1804 of device 1800), device 1800′ may be in any of states 1801a-c (see e.g. a different pressed position of control 1804 of device 1800 in each of FIGS. 18B through 18D, for exemplary states of the control, or generally of the device), whereas operating device 1800′ may be for changing between states. Device 1800′ is specifically shown in FIG. 18F being in state 1801a, in FIG. 18G being in state 1801b and in FIG. 18H being in state 1801c. For example, device 1800′ may include a control 1804 (see ref. control 1804 of device 1800 in FIGS. 18A through 18D) which may be not pressed (also “un-pressed”, or otherwise being in a default position) in FIG. 18F, as shown, whereas the control may be “half-pressed” (see ref. control 1804 of device 1800 in a “half-pressed” position in FIG. 18C) in FIG. 18G and fully pressed in FIG. 18H (in FIGS. 18G and 18H control 1804 of device 1800′ is obscured by thumb 234 which is suggested to be pressing on it).

In some embodiments, by changing states of device 1800′, interface 1832 may be controlled (or “influenced”, “manipulated” or “affected”). In other words, controlling interface 1832 may be by changing (or “toggling”, or “switching”) between states of device 1800′, specifically by operating the device (or a control thereof). As specifically shown in FIG. 18G, by pressing control 1804 of device 1800′ halfway (i.e. to a “half-pressed” position), so that device 1800′ is in state 1800b, an interface element 1824 (illustrated by dashed lines) may be displayed by touch-screen 1822, specifically in interface 1832. As specifically shown in FIG. 18H, by fully pressing control 1804 (i.e. to a fully pressed position), so that device 1800′ is in state 1800c, an interface element 1826 may be displayed by touch-screen 1822, specifically in interface 1832. For example, interface element 1824 may be a virtual keyboard (i.e. graphically displayed keyboard) of characters (e.g. English characters), the displaying of which (by touch-screen 1822, in interface 1832) may be prompted by pressing control 1804 of device 1800′ to a “half-pressed” position, so that device 1800′ is in state 1800b (FIG. 18G). For the same example, interface element 1826 may be a virtual keyboard of punctuation marks and/or numbers, the displaying of which may be prompted by fully pressing control 1804 of device 1800′ to a fully pressed position, so that device 1800′ is in state 1800c (FIG. 18H). Also for the same example, when device 1800′ is in state 1800a, such as when control 1804 is not pressed (otherwise “is in a default position”), elements 1824 and 1826 may not be displayed by touch-screen 1822, so that in some embodiments, removing a finger from control 1804 (or in other words releasing any pressure applied on the control) may be for changing the state of device 1800′ to state 1800a and consequently to remove interface elements 1824 and 1826 may from interface 1832, such as for the elements not to be displayed. Accordingly, a finger-worn device of the invention (e.g. device 1800′) may be operated to prompt the displaying of a virtual keyboard of characters, and/or the displaying of a virtual keyboard of punctuation marks and/or numbers, by switching states of the device, such as by repositioning a control of the device to any of two or more positions. Said virtual keyboards may be interacted with by touching touch-screen 1822 when any of said virtual keyboards may be displayed by a touch-screen, such as in an interface. Further accordingly, a user may operate some embodiments of finger-worn devices of the invention, such as by changing states of said finger-worn devices (e.g. rotating a rotatable section of a finger-worn device to any of several rotated positions) to prompt the displaying of different types of virtual keyboards (e.g. a virtual keyboard of a first language and a virtual keyboard of a second language), whereas the displaying of each of said virtual keyboards may correspond to a different state of said finger-worn device. Said displaying of virtual keyboards may specifically be by a touch-screen in an interface, so that the aforementioned user may interact with any virtual keyboard displayed by said touch-screen by touching said touch-screen (optionally while, before or after operating said finger-worn device, such as by holding pressure on a control of said finger-worn device to hold said a control of said finger-worn device in a pressed position).

In some embodiments or in some cases (e.g. in some interfaces displayed by touch-screen 1822), following the example above (of virtual keyboards), interface elements displayed by operating a finger-worn device of the invention (specifically for changing states thereof), such as interface elements 1824 and 1826, may be different control-panels, menus, tool-bars, libraries, lists of options, so-called “dash-boards” or dialog boxes, as known in the art for user interfaces. For example, interface element 1824 may be a tool-bars of a set of tools, such as graphic editing tools or music playback control tools, whereas interface element 1826 may be a menu related to said set of tools, such as a color-swatches menu or a playlist of songs (respectively to the examples of set of tools of interface element 1824). Accordingly, and following the above, a finger-worn device of the invention may be operated to prompt the displaying of any of two or more control-panels, menus, tool-bars, libraries, lists of options, dash-boards or dialog boxes, such as by changing states of said finger-worn device. Said displaying may be by a touch-screen, so that a user operating said finger-worn device may interact with said control-panels, menus, tool-bars, libraries, lists of options, dash-boards or dialog boxes, by registering touch input (i.e. touching said touch-screen), optionally while operating said finger-worn device (or before or after operating said finger-worn device).

In some embodiments, a displaying of interface elements in an interface of a touch-screen, by operating a finger-worn device of the invention, may be related (otherwise “contextual” or “corresponding”) to touch input (i.e. input registered by sensing touch on said touch-screen), such as corresponding to a location on said touch-screen where a finger wearing said finger-worn device is touching, or specifically corresponding to an interface element displayed at said location on said touch-screen. For example, touch-screen 1822 may be displaying a media-player as known in the art, and a photo-editing application as known in the art. By finger 232 touching said media-player (i.e. touching touch-screen 1822 where said media-player is displayed) and thumb 234 half-pressing control 1804 of device 1800′, a playback control-panel may be displayed by touch-screen 1822 (so that finger 232, or any other finger, may interact with said playback control-panel), whereas by finger 232 touching said media-player and thumb 234 fully pressing control 1804, a playlist may be displayed (so that finger 232, or any other finger, may interact with said playlist, such as touch a name of a song in said playlist to play said song). Similarly, by finger 232 touching said photo-editing application and thumb 234 half-pressing control 1804, a photo-editing dialog-box may be displayed by touch-screen 1822 (to be interacted with by any finger), whereas by finger 232 touching said photo-editing application and thumb 234 fully pressing control 1804, a color swatches menu (i.e. a menu of colors swatches to be utilized for functions of said photo-editing application) may be displayed by touch-screen 1822.

In some embodiments, repositioning a control of a finger-worn device of the invention (e.g. pressing control 1804 of device 1800′, or rotating rotatable section 702 of device 700 shown in FIGS. 7A and 7B), or otherwise changing between states of said finger-worn device, may be for associating touch input (i.e. touch as sensed by a touch-screen) with specific functions in an interface, such that each position of said control may correspond to a different function. For example, half-pressing control 1804 of device 1800′ (as an exemplary repositioning of the control) may be for associating touch on touch-screen 1822 of device 1820 (otherwise “for associating touch input as obtained or registered by touch-screen 1822”) with a common “delete” function in interface 1832 (which may be displayed by the touch-screen), so that while the control is “half-pressed”, touching the touch-screen where an interface element is displayed may be for deleting said interface element, or removing it from interface 1832. Similarly, fully pressing control 1804 may be for associating touch on touch-screen 1822 with a common “paste” function, so that while the control is fully pressed, touching a location in interface 1832, as displayed by touch-screen 1822, may be for pasting an interface element (supposedly an interface element previously “copied” or “cut”, as known for common software functions) specifically to said location in interface 1832.

The described above for associating touch input with specific functions in an interface may be similar to selecting tools in interfaces (such as in interfaces of certain software, e.g. tools in tool-bar of a graphic-editing software). Accordingly, changing states of a finger-worn device of the invention may be for changing tools between tools of an interface. Specifically, said tools may be associated with touch input, such that touching a touch-screen of systems of the invention may be for using a tool set by a state of a finger-worn device of the invention. For example, repositioning a control of a finger-worn device of the invention for associating a specific function with touch input may be similar to associating a specific function with a mouse cursor, such as by selecting a specific tool from a tool-bar (e.g. by pressing a button of a mouse as said mouse cursor is positioned above, or pointing at, said specific tool as it is displayed in said tool-bar). For another example, when playing a war game (as an exemplary interface) by interacting with a touch-screen, rotating a rotatable section of a finger-worn device to a first rotated position may be for selecting a first ammunition type (as an exemplary function in said war game, or as an exemplary tool), whereas rotating said rotatable section of said finger-worn device to a second rotated position may be for selecting a second ammunition type, so that touching said touch-screen while said finger-worn device is in said first rotated position may be for firing said first ammunition type, whereas touching said touch-screen while said finger-worn device is in said second rotated position may be for firing said second ammunition type.

Following the above, a finger-worn of the invention may be operated in collaboration to interacting with a touch-screen, such that changing states of said finger-worn device may be for prompting the displaying of interface elements contextually to where on said touch-screen a finger is touching, and optionally to what is displayed where said finger is touching.

Note that it is made clear that device 1800′ may be communicating with touch-screen device 1820 (which may include touch-screen 1822) for the described above. For example, device 1800′ may include a communication unit (see e.g. communication unit 718 of device 710 in FIGS. 7C and 7D) which can transmit signals to device 1820, whereas said signals may indicate the state in which device 1800′ is in at any given time, or otherwise may indicate how device 1800′ is being operated at a given time (e.g. whether control 1804 of device 1800′ is “half-pressed” or fully pressed).

Further note that whereas interface element 1824 and interface element 1826 are shown in FIG. 18G and FIG. 18H (respectively) displayed by touch-screen 1822 of device 1820 specifically where finger 232 is touching the touch-screen, it is made clear that in some cases (e.g. some interfaces), interface element 1824 and/or interface element 1826 may be displayed by the touch-screen anywhere on the touch-screen (e.g. anywhere in interface 1832), regardless of where finger 232 is touching the touch-screen. In other cases, interface element 1824 and/or interface element 1826 may be displayed correspondingly to the location on touch-screen 1822 where finger 232, or any other finger, is touching (otherwise “correspondingly to coordinates of touch input as sensed by the touch-screen”).

FIGS. 18I through 18K show a system 1822 of the invention, in which device 700 (see ref. FIGS. 7A and 7B) communicating with device 1820, such as sending signals which indicate which state device 700 is in, or such as inputs corresponding to states of device 700.

In FIG. 18I, device 700 is specifically shown in a state 700a, whereas in FIG. 18J and FIG. 18K device 700 is specifically shown in a state 700b and a state 700c, respectively. States of device 700 may correspond to rotated positions of rotatable section 702 of the device. For example, rotatable section 702 of device 700 may be in a different rotated position (also “input position” as noted above) in each of the figures. As shown in the figures, rotatable section 702 may be in a first rotated position in FIG. 18I, whereas in FIG. 18J rotatable section 702 is shown in a second rotated position, specifically a position of rotating the section ninety degrees clockwise from said first rotated position. In FIG. 18K, rotatable section 702 is shown in a third rotated position, specifically a position of rotating the section ninety degrees counter-clockwise from said first rotated position (see ref. FIG. 18I). Note that the rotation of rotatable section 702 may be relative to stationary section 704 of device 700 (and accordingly relative to a finger wearing the device, in case the device is worn on a finger). Further note that a finger-worn device of the invention may include only a rotatable section (excluding a stationary section), whereas rotated positions of said rotatable section may correspond to states of said finger-worn device.

In some embodiments, operating device 700, such as by changing states of the device, or specifically by rotating section 702 to different rotated positions, may be for changing states (or “toggling between states”) of interface 1832 displayed by touch-screen 1822 of device 1820. This may be similarly to displaying different interface elements, as described for FIGS. 18F through 18H. Accordingly, states of device 700 (or of any finger-worn device of the invention which can be in any of multiple states) may correspond to states of interface 1832. In FIG. 18I, interface 1832 is shown in a state 1832a, whereas in FIG. 18J and FIG. 18K interface 1832 is shown in a state 1832b and a state 1832c, respectively. As shown in the figures and following the above, states 1832a-c of interface 1832 may respectively correspond to states 700a-c of device 700.

States of interface 1832 (i.e. states 1832a-e), or any other interface or program of the invention, may be any states, modes or conditions known for interfaces or virtual environments. For example, an interface (e.g. computer application) may have a first workspace (e.g. a first set of tool-bars accessible to a user) and a second workspace (e.g. a second set of tool-bars, or a different arrangements of tools in said first set of tool-bars), whereas when said interface is in a first state said interface may be displaying said first workspace, and whereas when said interface is in a second state, said interface may be displaying said second workspace. Accordingly, operating a finger-worn device of the invention (specifically by changing states of said finger-worn device, or of any element or section thereof, such as a control) may be for toggling between modes of view (as exemplary states) of an interface. Toggling between modes of view may be described similarly to the descried above for changing between states of an interface by operating a finger-worn device of the invention to change states of said finger-worn device. Said modes of view may be any visual states of an interface, such as showing and hiding so-called “tool-tips” (each of the showing and hiding may be an exemplary mode of view). For example, a graphic editing software may have a work-board (i.e. an area in which graphics are edited) which may and may not display a grid or rulers (which may assist in graphic editing), so that the described above for toggling between modes of view by operating a finger-worn device may similarly describe showing (or “displaying”) and hiding (or “not displaying”) said grid or rulers.

Note that in some embodiments, a first rotated position of rotatable section 702 of device 700, or in other words a first state of device 700, may correspond to displaying interface element 1824 (FIG. 18F), whereas a second rotates position of section 702, or in other words a second state of device 700, may correspond to displaying interface element 1826 (FIG. 18G), so that accordingly, section 702 may be rotated to specific rotated positions to display interface element 1824 and/or interface element 1826 (in interface 1832, or otherwise by touch-screen 1822 of device 1820), similarly to pressing control 1804 of device 1800′ to specific pressed positions, as described for FIGS. 18F through 18H.

Further note that in some embodiments, similarly to the described for rotated positions of rotatable section 702 of device 700, a “half-pressed” position of control 1804 of device 1800′ may correspond to state 1832a (FIG. 18I) of interface 1832, whereas a fully pressed position of the control may correspond to state 1832b (FIG. 18J), so that control 1804 of device 1800′ may be pressed to different positions for changing states of interface 1832. Accordingly, a control of a finger-worn device of the invention may be repositioned to any number of different positions for changing between any number of different states of an interface, specifically an interface displayed by a touch-screen (e.g. touch-screen 1822 of device 1820).

Further note that states of an interface may set contexts for touch input (i.e. determine how touch, as sensed by a touch-screen displaying said interface, influences said interface, or elements or events thereof). Accordingly, changing states of a finger-worn device may be for setting contexts for touch input (by changing states of an interface displayed by a touch-screen, such as by transmitting indications of states of said finger-worn device to a device which includes said touch-screen).

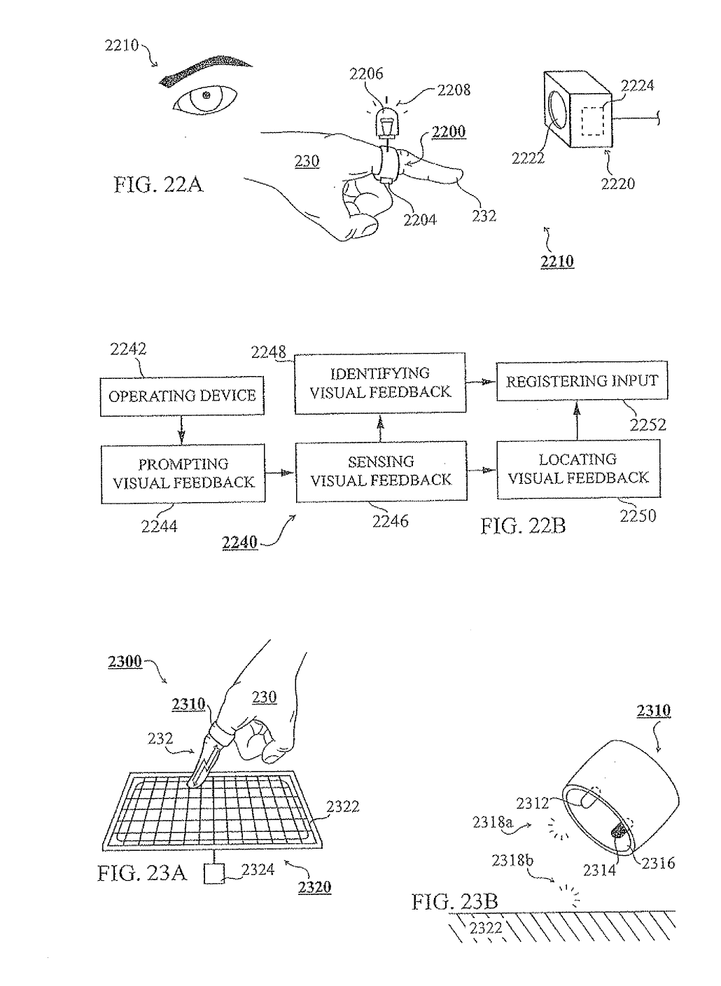

Further note that whereas the described above refers to an interface of a touch-screen (i.e. interface 1832 of touch-screen 1822), it is made clear that it may similarly refer to any interface of a gesture recognition system or otherwise a visual recognition system (see e.g. a visual recognition system 2220 in FIG. 22A).

Further note that the described above for interface elements and states of an interface may refer to visual and non-visual elements and states in a program, or otherwise program elements and states which are not necessarily represented visually.

FIGS. 18L through 18N show a system 1814 of the invention in which a finger-worn device 1880 may be communicating with device 1820. In the figures, touch-screen 1822 of device 1820 is shown displaying an interface 1852 which may be an interface of a program 1850.

Device 1880 is specifically shown in FIG. 18L as being in a state 1880a, and specifically shown in FIG. 18M and FIG. 18N as being in a state 1880b and in a state 1880c, respectively. A state in which device 1880 is in at a given time may be determined by operating the device, or a section or element thereof. In other words, operating device 1880 may be for changing between states of the device.

Program 1850 is specifically shown in FIG. 18L as being in a state 1850a, and specifically shown in FIG. 18M and FIG. 18N as being in a state 1880b and in a state 1880c, respectively. A state in which program 1850 is in at a given time may be determined by operating device 1880, or a section or element thereof, such as changing between states of the device which correspond to states of program 1850. In other words, operating device 1880 may be for changing between states of program 1850 (preferably additionally to changing between states of the device). For example, device 1880 may be rotated to any of a first rotated position, a second rotated position and a third rotated position (each of which may be exemplary states of the device), whereas by communicating information (specifically “indications”) from device 1880 to device 1820 about which position device 1880 is in (or similarly about which state the device is in) at a given time, input may be registered which may set (otherwise “may facilitate setting”) program 1850 to any of states 1850a-c, correspondingly to any of said first, second and third rotated positions.

In some embodiments, for each of states 1880a-c of device 1880, the device may output (or “generate”, or produce”) a different visual output. As specifically shown in FIG. 18L, device 1880 may not output any visual output while the device is in state 1880a, whereas specifically shown in FIG. 18M and FIG. 18N, device 1880 may output a visual output 1882b and a visual output 1882c, respectively. Visual outputs 1882b,e, or lack of any visual output (as shown in FIG. 18L) may indicate to a user which state device 1880 is in (at any given time), and accordingly which state program 1850 is in. In some embodiments, any state in which program 1850 is in may be indicated only by output (specifically visual) from device 1880. For example, in some embodiments, interface 1852 of program 1850 may not include any visual indications about which state program 1850 is in, whereas states of program 1850 may be visually indicated by device 1880, specifically by visual outputs from device 1880 corresponding to states of the program (in FIGS. 18M and 18N, visual output 1882b and visual output 1882c are shown corresponding to state 1850b and state 1850c, respectively, of program 1850). Not utilizing interface 1852 to indicate which state program 1850 is in may be beneficial for saving display space of touch-screen 1822, such that small touch-screens may utilize said display space (which is saved) for other purposes.

Similarly to the described for visual output from device 1880, states of program 1850 may be indicated by tactile information (or “tactile feedback”, or “tactile output”), such as described for tactile indicators 716a-c of device 710 shown in FIGS. 7A through 7C. For example, when program 1850 is in state 1850b, a dynamic tactile indicator (or plurality thereof) of a finger-worn device of the invention may be in a first state, whereas when program 1850 is in state 1850c, said dynamic tactile indicator may be in a second state, so that a user may feel said dynamic tactile indicator to know in which state program 1850 is in.

In some embodiments, states of program 1850 may determine (or “set”) contexts for touch input, such that when program 1850 is in each of states 1850a-c, a different function may be performed (or similarly “a different event is prompted”, or “a different element is controlled”) in interface 1852, or generally by program 1850, when touch-screen 1822 is touched (e.g. by a finger). For example, as shown in FIGS. 18L through 18N, when program 1850 is in state 1850a (FIG. 18L), no function may be performed by touching touch-screen 1822 (such as in case it is desired to touch the surface of the touch-screen without any input being registered, or otherwise without prompting any interface event), whereas when program 1850 is in state 1850b (FIG. 18M), a function 1854b may be performed (preferably in interface 1852) by a finger (or plurality thereof) touching touch-screen 1822, and whereas when program 1850 is in state 1850c (FIG. 18N), a function 1854c may be performed by a finger touching the touch-screen. Note that in embodiments in which states of program 1850 are not indicated visually by touch-screen 1822, a user may know which state the program is in, and accordingly which function is to be performed by touching the touch-screen, by receiving output from a finger-worn device of the invention (e.g. device 1880), specifically visual and/or tactile output.

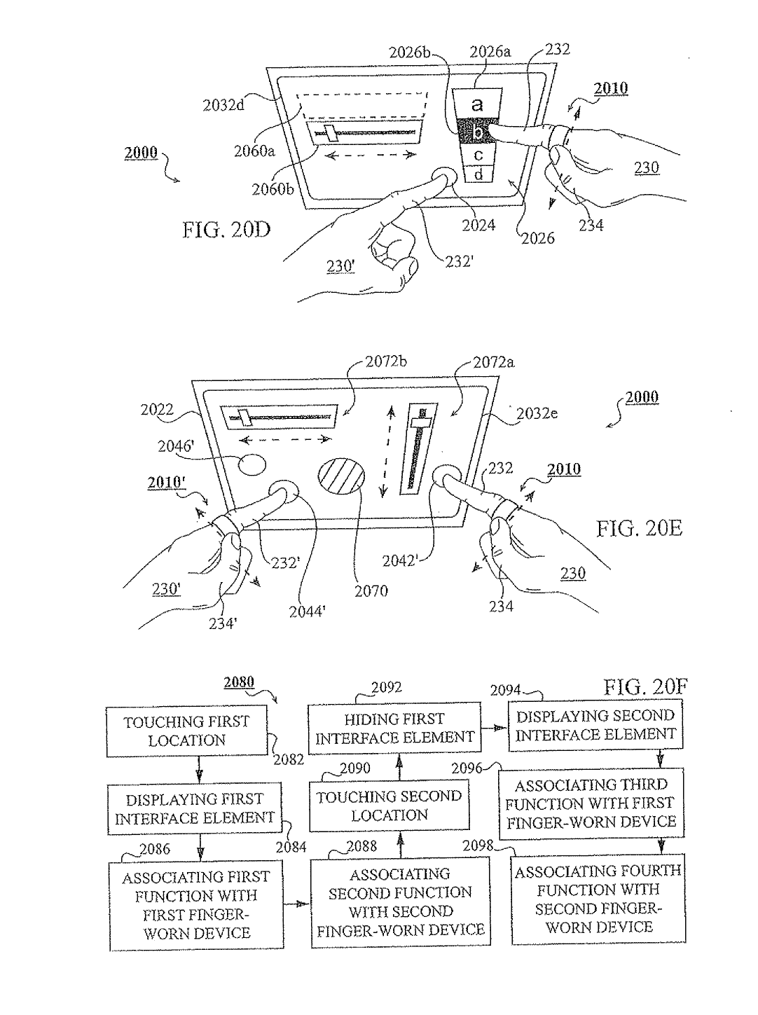

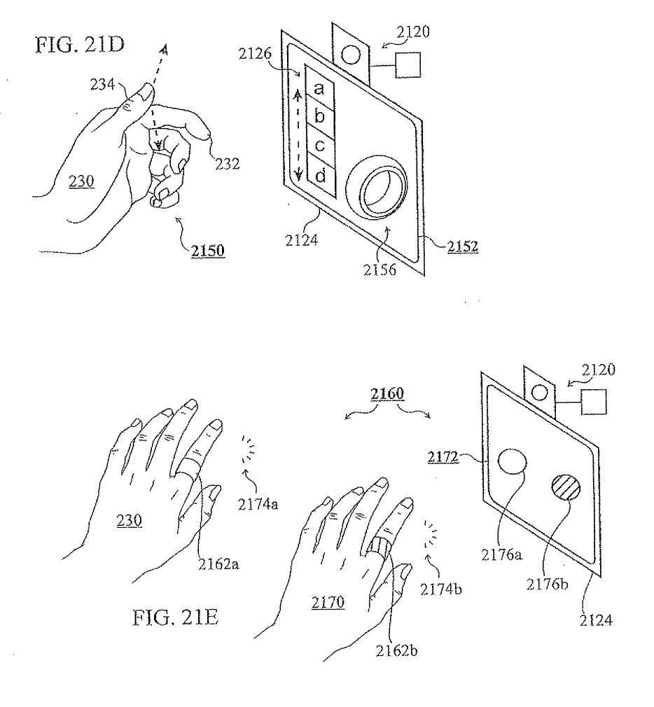

FIGS. 19A and 19B show a depiction of an interface 1900 of the invention. Interface 1900 is specifically an interface of a game (specifically a video game or a computer game, or otherwise any other game run by an electronic system) which may be displayed on a touch-screen (see e.g. touch-semen 1822 of device 1820 in FIGS. 18F through 18N) or on a display which is coupled to a gesture recognition system (see e.g. a gesture recognition system 2120 in FIGS. 21A through 21E) so that a user (or plurality thereof) may play said game by touching said touch-screen or by performing gestures within the field of vision of said gesture recognition system.

In FIGS. 19A and 19B, interface 1900 is shown including an interface element 1902 (illustrated generally as a tank unit) which may be any element in a game, such as a character (e.g. an three dimensional avatar), a non-player character (NPC) as known in the art for games, an aiming mark or an object in a destructible environment as known in the art for games.

In some embodiments, interface element 1902 may be controlled or influenced by touch input (e.g. touch sensed on a touch-screen suggesting to displaying interface 1900) or by gesture recognition (e.g. hand gestured sensed and recognized by a gesture recognition system suggested to be coupled to a display which may be displaying interface 1900). Additionally or alternatively, interface element 1902 may be controlled or influenced by operating a finger-worn device 1910 (shown in FIG. 19B worn on finger 232 of hand 230 and being operated by thumb 234 of the same hand).

In FIGS. 19A and 19B, interface element 1902 is shown changed between states by finger 232 touching a touch-screen which is suggested to be displaying interface 1900 and by operating device 1910 (note that the described for finger 232 touching a touch-screen may similarly refer to finger 232 pointing towards a display, specifically to where interface element 1902 may be displayed, whereas the pointing of the finger may be sensed and recognized by a gesture recognition system). In FIG. 19A, interface element 1902 is specifically shown being in a state 1902a, such as a default state when a touch-screen displaying interface 1900 is not touched where the interface element is displayed, and/or when device 1910 is not operated. In FIG. 19B, interface element 1902 is specifically shown being in a state 1902b when a touch-screen displaying interface 1900 is touched where interface element 1902 is displayed, and when device 1910 is operated in a certain manner (e.g. a control of the device is pressed to a “half-pressed” position). Note that it is made clear that in some embodiments, interface element 1902 may be controlled or influenced by operating device 1910 without the suggested above touch-screen being touched where the interface element is displayed.

In some embodiments, device 1910 may control or influence any number of interface elements of interface 1900 which may be displayed where the aforementioned touch-screen (suggested to display interface 1900) is not touched. For example, when device 1910 is operated, and/or when the aforementioned touch-screen is touched at a certain location, an interface element 1906 may be displayed in interface 1900 (or otherwise “may be set to a displayed state, such as opposite to a hidden display in which interface element 1906 may be when device 1910 is not operated, and/or when the aforementioned touch-screen is not touched at said certain location”).

In some embodiments, operating device 1910 and/or touching the touch-screen at said certain location may be, additionally or alternatively to the described above, for controlling or influencing interface element 1906. For example, a section 1906b of interface element 1906 is shown selected (by being illustrated as black), which may optionally be the result of finger 232 touching the aforementioned touch screen where interface element 1902 is displayed, and/or of device 1910 being operated in a certain manner.

In some embodiments, interface elements controlled or influenced by operating a finger-worn device, and/or by touching the aforementioned touch-screen where interface element 1902 is displayed, may correspond to interface element 1902. For example, interface element 1906 may be a window dialog box of attributes or stats of interface element 1902, or an “ammunition bag” or “special abilities” list of interface element 1902, so that controlling or influencing interface element 1906 (e.g. selecting a preferred ammunition from said “ammunition bag”, or activating a special ability from said “special abilities” list) may be for controlling or influencing interface element 1902, or any section thereof.

Following the above, within the scope of the invention are games, or interfaces thereof, which can be controlled or influenced (or which elements thereof may be controlled or influenced) by operating a finger-worn device.

FIGS. 19C and 19D show a depiction of an interface 1920 of the invention. Interface 1900 is specifically a graphic editing interface, such as an interface of a photo-editing application which facilitates photo-editing, or such as an interface of a computer-assisted design (CAD) program.

In some embodiments, by changing states of a finger-worn device, a different function may be associated with location related input, such as touch input or input from obtaining a direction to which a hand is pointing (e.g. by utilizing a gesture recognition system). In FIG. 19C there is shown a function 1926a performed in interface 1920, correspondingly to device 700 (see ref. FIGS. 7A and 7B and FIGS. 18I through 18K) being in state 700a. In FIG. 19D there is shown a function 1926b performed in interface 1920, correspondingly to device 700 being in state 700b.

Following the above, within the scope of the invention is a graphic editing interface, or an interface of any graphic editing application, which can be influenced or controlled by operating a finger-worn device, specifically by changing states of said finger-worn device.

Note that in some embodiments, an interface of the invention (or a state of an interface of the invention) may include only a so-called “work-hoard”, or only a so-called “stage”, or otherwise may only include an area in which functions work or a document may be edited, or in which a game may be played, excluding supporting interface elements such as menus, options lists, tool-bars, control panels, dialog-boxes, etc. This may be facilitated by a finger-worn device providing similar or identical features to said supporting interface elements (such as by being operated alternatively to interacting with said supporting interface element, for similar or identical results). For example, as show in FIGS. 19C and 19D, interface 1920 may exclude any interface elements which serves to choose between functions (e.g. for selecting between function 1926a and function 1926b), as device 700 may be utilized to substitute such interface elements, as described for FIGS. 19C and 19D. For another example, as show in FIGS. 19C and 19D, interface 1900 may be a game in which there is interface element 1902 which may be a character in said game, whereas the interface may exclude any virtual controls (which may have been displayed in the interface) which can be used to interact with said character. Accordingly, interacting with said character may be by touching a touch-screen where said character is displayed, and/or by operating device 1910. Optionally, when device 1910 is not operated, any virtual controls may be excluded from interface 1900, whereas by operating device 1910, a virtual control (as an exemplary interface element 1906 as shown in FIG. 19B), or plurality thereof, may be created, displayed on otherwise included then in the interface.

Following the above, within the scope of the invention may be any graphic application, or interface thereof, or a state of said interface thereof, which includes only an area designated for direct graphic editing, excluding any interface elements which may support said direct graphic editing. Further within the scope of the invention may be any game, or interface thereof, or a state of said interface thereof, which includes only an area designated for actual game-play, excluding any interface elements which may support actual game-play or which may be peripheral to said actual game-play, such as options menus or items inventories.

Note that an interface not being required to display or include certain interface elements (which may be substituted by operating a finger-worn device) may be beneficial for small touch-screens, in which space in a display may be freed when said certain interface elements are not displayed.

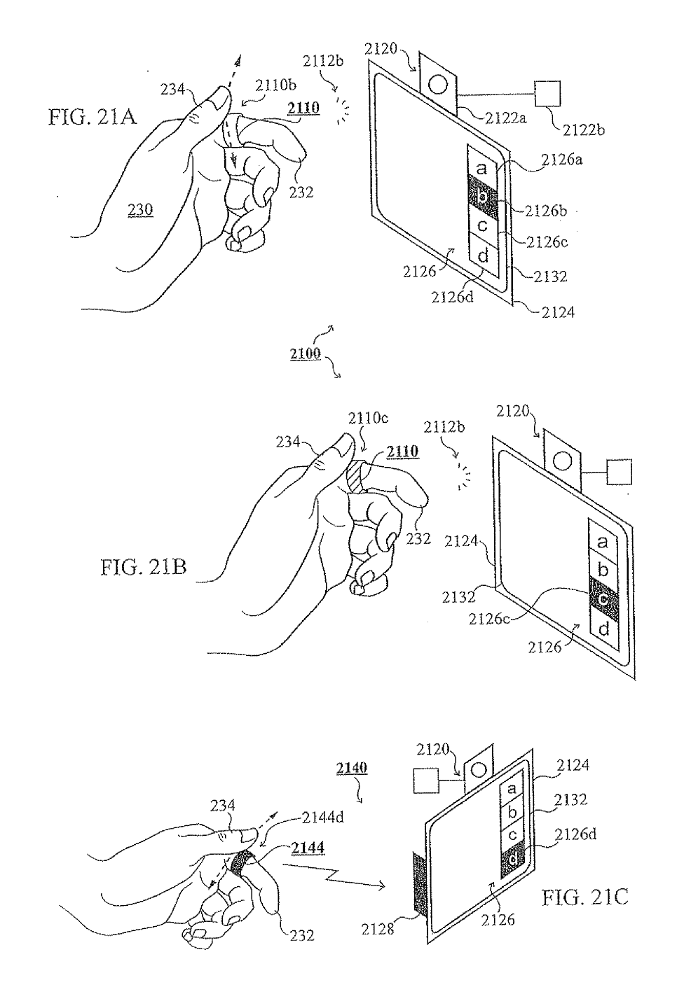

FIGS. 20A through 20E show a system 2000 of the invention which may include a touch-screen 2022 (similar to touch-screen 1822 as shown in FIGS. 18F through 18N, so that it is made clear that touch-screen 2022 may be included in a device, specifically as means for output and input) and may include a finger-worn device 2010 (which may be communicating with touch-screen 2022, or otherwise with a device which includes touch-screen 2022). By operating device 2010, a user may control (or “influence”, “manipulate” or “affect”) an interface displayed by touch-screen 2022 and/or a program which utilizes touch-screen 2022 for receiving (or otherwise “registering” or “obtaining”) input and/or for outputting (or “generating” or “producing”) output (specifically visual output, yet as known in the art, some touch-screens may generate tactile output (or “tactile feedback”), so that in some embodiments touch-screen 2022 may be utilized to generate tactile output).

Specifically shown in FIG. 20A is touch-screen 2022 displaying an interface 2032a, such as in case a program of a device (which includes the touch-screen) is utilizing the touch-screen to display the interface. In interface 2032a there is shown displayed an interface element 2024 which may be any visual object (also “item”) which can be displayed by touch-screen 2022, such as a graphic-element (e.g. a so-called “icon”). Optionally, interface element 2024 may represent a function of a program, such as a program of which interface 2023a may be the user interface. Otherwise, interface element 2024 may correspond to an interface (or program) function which may be executed when input is registered from a finger (or plurality thereof) is touching the interface element, or may correspond to an interface (or program) event which may be prompted by when input from a finger touching the interface element is registered (such as by touch-screen 2022 sensing touch on a location generally where the interface element is displayed, specifically on a surface of the touch-screen which can sense touch and through which or on which interface 2023a is displayed).

In some embodiments, touching touch-screen 2022 where interface element 2024 is displayed (shown a finger 232′ of hand 230′ touching the touch-screen where the interface element is displayed) may be for prompting the displaying of an interface element 2026 by touch-screen 2022. Interface element 2026 is shown including sections 2026a-d which may be “sub-elements” of the interface elements. For example, interface element 2026 may be a menu of options or a list of options, whereas each of sections 2026a-d may be an Option in said menu or in said list. For a similar example, interface element 2026 may be a tool-bar of tools, so that sections 2026a-d may be tools which may be selected from.

In some embodiments, when interface element 2026 is displayed, operating device 2010 may be for selecting any of sections 2026a-d (in FIG. 20A there is shown section 2026b as “selected” by being illustrated as black). Optionally, browsing in interface element 2026, specifically between sections 2026a-d, for selecting any of sections 2026a-d, may be by operating device 2010 in any way related to directions, such as by rotating the device or a section thereof, or by sliding a thumb on a surface of the device, in any of two or more directions. In FIG. 20A there is shown device 2010 which may be operated correspondingly to any of two directions (herein “operating directions”) illustrated by dashed arrows extending from thumb 234 (which may be operating the device), such as by thumb 234 rotating device 2010 in any of said two directions, or such as by thumb 234 sliding on a surface of the device in any of said two directions. Two other directions (herein “browsing directions”), which may be directions in which interface element 2026 may be browsed, are illustrated by dashed arrows near interface element 2026 (it is made clear that said two other directions may not be displayed by touch-screen 2022), whereas the browsing directions may correspond to the aforementioned operating directions, such that operating device 2010 in any of the operating directions may be for browsing interface element 2026 in any of the browsing directions. For example, interface element 2026 may be a menu in which sections 2026a-d may be items, whereas section 2026b may be selected (as shown in FIG. 20A) among the sections. Additionally, rotating device 2010 (or a section thereof) in a first direction may be for selecting a previous item (otherwise “for selecting section 2026a”), whereas rotating device 2010 in a second direction may be for selecting a next item (otherwise “for selecting section 2026c”), as shown in the figure section 2026a and section 2026e located “before” and “after” section 2026b, respectively, in accordance with the aforementioned browsing directions (i.e. directions illustrated by dashed arrows near interface element 2026).

Note that in FIG. 20A there is shown finger 232′ (of hand 230′) touching touch-screen 2022 where interface element 2024 is displayed, whereas finger 232 (of hand 230) is shown wearing device 2010. Accordingly, touching touch-screen 2022 where interface element 2024 is displayed may not be by a finger wearing device 2010, or even not by a finger of the same hand (on a finger of which the device is worn).

Specifically shown in FIG. 20B is touch-screen 2022 displaying an interface 2032b. In interface 2032b, similarly to interface 2032b (in FIG. 20A), there is shown an interface element 2024′ (similar to interface element 2024) displayed by touch-screen 2022. In some embodiments, touching touch-screen 2022 where interface element 2024′ with a finger specifically wearing device 2010 (shown finger 232 wearing the device) may be for prompting the displaying of interface element 2026 (as shown in FIG. 20B finger 232 touching the touch-screen where interface element 232′ is displayed, and interface element 2026 being displayed by the touch-screen). It is made clear that as opposed to interface 2032a (FIG. 20A), in interface 2032b, touch-screen 2022 may be touched where interface element 232′ is displayed, for prompting the displaying of interface element 2026, only by a finger wearing device 2010.

Specifically shown in FIG. 20C is touch-screen 2022 displaying an interface 2032c in which there are displayed interface elements 2042, 2044 and 2046. Touch-screen 2022 may be touched where each of the interface elements is displayed, to execute a different function or prompt a different event. Additionally, touching the touch-screen at different combinations of locations simultaneously, in each of said locations there is displayed any of interface elements 2042, 2044 and 2046, may be for executing a different function or prompting a different event, as known in the art for “multi-touch” technology and interfaces (so accordingly, it is made clear that in some embodiments, touch-screen 2022 may sense simultaneous instances of touch, such as in two or more locations on the touch-screen, specifically by two of more fingers touching the touch-screen).

In some embodiments, simultaneously touching touch-screen 2022 where interface element 2042 is displayed and where interface element 2044 is displayed (shown finger 232 touching the touch-screen where interface element 2042 is displayed and finger 232′, at the same time, touching the touch-screen where interface element 2044 is displayed) may be for prompting the displaying of interface element 2026, whereas operating device 2010 while the touching of the interface elements is performed may be for browsing interface element 2026 as described above. In some embodiments, removing a finger touching touch-screen 2022, specifically where interface element 2042 is displayed, from touching the touch-screen (e.g. finger 232 as shown in FIG. 20C) or removing a finger touching the touch-screen where interface element 2044 is displayed from touching the touch-screen (e.g. finger 232′ as shown in the figure) may be for removing interface element 2026 from being displayed (e.g. hiding and/or disabling the interface element from any interaction) by touch-screen 2022.

In some embodiments, simultaneously touching (e.g. with fingers) touch-screen 2022 where interface element 2042 is displayed and where interface element 2046 is displayed (alternatively to the shown in FIG. 20B) may be for prompting the displaying of an interface element 2028 by touch-screen 2022 (note that in FIG. 20B no finger is touching the touch-screen where interface element 2046 is displayed, and interface element 2028 is illustrated by dashed lines, suggesting that interface element 2028 is not displayed by touch-screen 2022). Accordingly, and following the above, combinations of locations on touch-screen 2022, whereat there are displayed interface elements, may be touched simultaneously for prompting the displaying of interface elements which may be controlled by operating device 2010 (e.g. may be browsed according to directions corresponding to directions of operating the device).

Specifically shown in FIG. 20D is touch-screen 2022 displaying an interface 2032d. In interface 2032d there is displayed interface element 2024 so that similarly to the described for FIG. 20A, touch-screen 2022 may be touched where interface element 2024 is displayed for prompting the displaying of interface element 2026 (shown in the figure finger touching the touch-screen where interface element 2024 is displayed, and accordingly interface element 2026 being displayed).

In FIG. 20D there is further shown finger 232 touching touch-screen 2022 specifically where section 2026b of interface element 2026 is displayed. In some embodiments, touching section 2026b of interface element 2026 may be for prompting the displaying of an interface element 2060b by touch-screen 2022 (shown displayed in the figure by the touch-screen in the figure). When interface element 2060b is displayed, the interface element may be controlled by operating device 2010. For example, while finger 232′ is touching touch-screen 2022 where interface element 2024 is displayed and finger 232 is touching the touch-screen where section 2026b of interface element 2026 is displayed, device 2010 may be operated in any of two directions (e.g. rotated in any of said two directions, such as by thumb 234) for controlling interface element 2060b in any of two corresponding directions (two corresponding directions illustrated in FIG. 20D by dashed arrows below the interface element), such as in case interface element 2060b is a slider including a handle which can be moved in any of two opposite directions.

Similarly to the described for prompting the displaying of interface element 2060b, touching touch-screen 2022 where section 2026a of interface element 2026 may be for prompting the displaying of an interface element 2060a by touch-screen 2022 (illustrated in the figure by dashed lines, suggesting not displayed by the touch-screen as section 2026a is not touched in the figure). In some embodiments, interface element 2060a may be controlled by operating device 2010, similarly to the described for interface element 2060b.

Following the above, it is made clear that a finger-worn device of the invention may be operated in any of a plurality of directions (e.g. by a thumb touching a surface of said finger-worn device and sliding in any of two opposite directions) for

Specifically shown in FIG. 20E is touch-screen 2022 displaying an interface 2032e which may include an interface element 2042′ and an interface element 2044′ (shown displayed in the interface) similar to interface elements 2042 and 2044 (see ref. FIG. 20C). Further shown included in interface 2032e is an interface element 2070.

In some embodiments (or in some embodiments of interface 2032e), interface element 2070 may be displayed by touch-screen 2022, or specifically in interface 2032e, regardless of whether the touch-screen is touch where any of interface elements 2042′ and 2044′ are displayed. In other embodiments, interface element 2070 may be displayed by the touch-screen only when the touch-screen is being touched where any or both of interface elements 2042′ and 2044′ are displayed. In the figure, the touch-screen is shown being touched by finger 232 and by finger 232′ where interface elements 2042′ and 2044′ are displayed, respectively, whereas interface element 2070 is shown displayed by the touch-screen, specifically in interface 2032e.

In some embodiments, when touch-screen 2022 is touched where interface element 2042′ is located, the displaying of an interface element 2072a may be prompted, whereas when the touch-screen is touched where interface elements 2044′ is located, the displaying of an interface element 2072b may be prompted. Optionally, both interface elements 2072a,b may be displayed when the touch-screen is touched where interface elements 2042′ and 2044′ are displayed (as shown in FIG. 20E).

In some embodiments, when interface element 2072a is displayed by touch-screen 2022, controlling or influencing interface element 2072a may be facilitated by operating finger-worn device 2010, whereas when interface element 2072b is displayed, controlling or influencing interface element 2072b may be facilitated by operating a finger-worn device 2010′ similar to device 2010.

In some embodiments, interface element 2072a may correspond to a first property of interface element 2070, whereas interface element 2072b may correspond to a second property of interface element 2070. Accordingly and following the above, controlling or influencing properties of interface element 2070 (specifically said first property and said second property) may be facilitated by operating device 2010 and/of device 2010′. For example, interface element 2070 may be a graphic element including a size property which may correspond to interface element 2072a, and a transparency property which may correspond to interface element 2072b, so that the size of interface element 2070 may be controlled (e.g. increased or decreased) by touching touch-screen 2022 where interface element 2042′ is displayed and operating device 2010, whereas the transparency of interface element 2070 may be controlled by touching touch-screen 2022 where interface element 2044′ is displayed and operating device 2010′. For another example, interface element 2072a may correspond to the length of interface element 2070, whereas interface element 2072b may correspond to the width of interface element 2070, so that interface element 2070 may be stretched or shrunk in any of two axes (one relating to the length of the interface element and another to the width of the interface element) similarly to the described above.

In some embodiments, determining which interface element is prompted to be displayed by touching touch-screen 2022 where interface element 2042′ is displayed may be contextual to where else touch-screen 2022 is touched, such as specifically which interface element is displayed where another instance of touch is detected by the touch-screen. For example, as shown in FIG. 20E, when finger 232′ of hand 232′ is touching the touch-screen where interface element 2044′ is displayed, touching the touch-screen where interface element 2042′ is displayed (as shown in the figure for finger 232 of hand 230) may prompt the displaying of interface element 2072a, whereas when finger 232′ of hand 232′ is touching the touch-screen where an interface element 2046′ is displayed, touching the touch-screen where interface element 2042′ is displayed (by any finger other than finger 232′) may prompt the displaying of a different interface element (i.e. different than interface element 2046′, see e.g. interface element 2028 in FIG. 20C).

Note that similarly to the described above for operating device 2010 in certain directions for controlling an interface element (e.g. interface element 2060b in FIG. 20D) in corresponding directions, interface element 2072a,b may similarly be controlled in directions corresponding to directions in which devices 2010 and 2010′ may be operated, respectively.

Further note that whereas the described for FIGS. 20A through 20E may refer to prompting the displaying of interface elements, it is made clear that the described may similarly refer to any setting (or otherwise “changing”) of states or properties of interface elements, or any setting (or otherwise “changing”) function variables, such as substituting the described specifically for prompting the displaying of an interface element with activating of an interface element or with initializing a function. Accordingly, the described for prompting the displaying of interface elements may refer to setting a state of said interface elements to a “displayed” state, or to setting a transparency property of said interface elements to zero.

FIG. 20F shows a flowchart of a method 2080 of the invention, generally following the described for FIG. 20E.

At a step 2082, a touch-screen is touched at a first location.

In some methods, at a step 2084, consequently to step 2082 (e.g. by input being registered as result of step 2082), a first interface element may be displayed (preferably by the touch-screen mentioned for step 2082). Alternatively, at step 2084, the state of said first interface element may be changed from a first state to a second state, such as from a “hidden” state to a “displayed” state. Further alternatively, at step 2084, a property (or plurality thereof) of said first interface element may be changed.

In some methods, at a step 2086, consequently to step 2082, a first function may be associated with a first finger-worn device. Accordingly, said first function may be performed or controlled by operating said first finger-worn device.

In some methods, at a step 2088, consequently to step 2082, a second function may be associated with a second finger-worn device. Accordingly, said second function may be performed or controlled by operating said second finger-worn device.

In some methods, at a step 2090, the touch-screen mentioned for step 2082 is touched at a second location. Note that it is made clear that for steps described below, the first location on the touch-screen, as mentioned for step 2082, may still be touched while and/or after performing step 2090.

In some methods, at a step 2092, consequently to step 2090, the first interface element (mentioned for step 2084) may be hidden, or otherwise may stop being displayed. Alternatively, at step 2092, the state of the first interface element may be changed from the second state (mentioned for step 2084) back to the first state (mentioned for step 2084), such as from a “displayed” state to a “hidden” state. Further alternatively, at step 2092, a property (or plurality thereof) of the first interface element may be changed.

In some methods, at a step 2094, consequently to step 2090, a second interface element may be displayed. Alternatively, at step 2094, the state of said second interface element may be changed from a first state to a second state, such as from a “locked” state (e.g. a state wherein said second interface element may not be interacted with) to an “unlocked” state (e.g. a state wherein said second interface element may be interacted with, such as by touching the touch-screen mentioned for previous steps). Further alternatively, at step 2094, a property (or plurality thereof) of the second interface element may be changed.

In some methods, at a step 2096, consequently to step 2090, a third function may be associated with the first finger-worn device (mentioned for step 2086). Accordingly, said third function may be performed or controlled by operating the first finger-worn device.

In some methods, at a step 2096, consequently to step 2090, a fourth function may be associated with the second finger-worn device (mentioned for step 2088). Accordingly, said fourth function may be performed or controlled by operating the first finger-worn device.

Note that it is made clear that in some methods, by removing touch from any or both of the aforementioned first and second locations, reverse steps to steps described above, specifically to any of steps 2084, 2086, 2088, 2092, 2094, 2096 and 2098, may be performed. For example, by removing the first touch (mentioned for step 2082), the first interface element (mentioned for step 2084) may be hidden (as an exemplary reverse step to step 2084), while the second interface element (mentioned for step 2094) may still be displayed while the second touch (mentioned for step 2090) is maintained.

Following the above, it is made clear that in some methods of the invention May include steps of removing the aforementioned first touch and/or the aforementioned second touch, followed by reverse steps to any of steps 2084, 2086, 2088, 2092, 2094, 2096 and 2098.

FIGS. 21A and 21B show a system 2100 of the invention which may include a gesture recognition system 2120 (or simply “system”) and a finger-worn device 2110. Device 2110 is shown worn on finger 232 of hand 230. System 2120 may be any system which can facilitate visual (or otherwise “optical”) sensing and recognizing (or “identifying”) human gestures, specifically hand or fingers gestures, from said visual sensing (otherwise “optical sensing”), for registering input. Note that it is made clear that system 2120 can facilitate sensing of light, either visible or non-visible (e.g. infra-red, or IR), from which hand or fingers gestures may be recognized for registering input. As shown in FIG. 21A, system 2120 may include sensing means 2122a, which may be any means for sensing light, visible or non-visible, such as a camera capturing images, and recognition means 2122b, which may be any means for recognizing hand or fingers gestures, specifically from light sensed by sensing means 2122a, such as by including hardware and/or software which can process or analyze images of gestures and obtain information about said gestures for registering input. Note that in some embodiments, as known for some gesture recognition systems, system 2120 may further include illumination means, which can be any means for illuminating hands, such as with IR light.

In system 2100, system 2120 is shown coupled to a display 2124 which may be any means for displaying visuals, such as a screen or monitor. Display 2124 is shown in the figures displaying an interface 2132 in which there is an interface element 2126 similar to interface element 2026 (see ref. FIGS. 20A through 20D). Similarly to interface element 2026 including sections 2026a-d, interface element 2126 is shown including sections 2126a-d.

In some embodiments, device 2110 may be operated to change states, such as by thumb 234 of hand 230. In FIG. 21A device 2110 is specifically shown in a state 2110b whereas in FIG. 21B device 2110 is specifically shown in state 2110c. Preferably, sensing means 2122a of system 2120 may sense device 2110, whereas recognition means 2122b may recognize which state device 2110 is in at any given time. This is additionally to sensing means 2122a sensing light from a hands and recognition means 2122b recognizing hand or fingers gestures. For example, device 2110 may include an output unit (see e.g. output unit 406 of device 400 in FIGS. 4A and 413) which can output light, whereas said light may be indicative of which state device 2110 is at any given time. Additionally, system 2120 may sense light from hand 230 (e.g. light reflected from the hand) and light outputted from device 2110, for recognizing which gesture is performed by hand 230 and which state device 2110 is in. Note that in other examples, device 2110 may not include an output unit, yet may be in any state which can be sensed by sensing means 2122a, such as in case the device may be in any of multiple physical states which are visually distinct.

In some embodiments, selecting between section 2126a-d of interface element 2126 (or otherwise “browsing interface element 2126”) may be by operating device 2110 to change between states. Specifically, states of device 2110 may be sensed and recognized by system 2120 to register input which may determine which of sections 2126a-d is selected. For example, lights 2112b from hand 230 and from device 2110 being in state 2110b, as shown in FIG. 21A, may reach system 2120 whereat input may be registered correspondingly to state 2110b (optionally in addition to which gesture is performed by hand 230), so that as shown in the figure, said input may prompt the selection of section 2126b (shown selected in FIG. 21A) from among section 2126a-d of interface element 2126. Similarly, as shown in FIG. 21B, lights 2112c from hand 230 and from device 2110 being in state 2110c may reach system 2120 whereat input may be registered correspondingly to state 2110c, so that as shown in the figure, said input may prompt the selection of section 2126c (shown selected in FIG. 21B).

FIG. 21C shows a system 2140 of the invention which may include gesture recognition system 2120 coupled to display 2124, a communication unit 2128 also coupled to display 2124, and a finger-worn device 2144. Device 2144 can communicate with communication unit 2128, such as by device 2144 including a communication unit.

In some embodiments, device 2144, similarly to device 2110, may be operated to change between states. States of device 2144 may correspond to sections 2126a-d which are shown displayed on display 2124, specifically in interface 2132. Further similarly to the described for device 2110, by communicating which state device 2144 is in at any given time may facilitate selecting any of sections 2126a-d, specifically selecting the section which corresponds to a state in which device 2144 is in at said given time (in FIG. 21C, device 2144 is shown being in a state 2144d which may correspond to section 2126d which is suggested to be selected in the figure as it may correspond to state 2144d of device 2144). Further similarly to the described for device 2110, device 2144 may communicate which state device 2144 is in by outputting light (or “by generating light output”) which may be sensed and recognized by gesture recognition system 2120, specifically when device 2144 is in the field of vision of system 2120 (so that light from the device may be sensed by the system). Additionally or alternatively to the described for device 2110, device 2144 may indicate which state device 2144 is in by communicating with communication unit 2128, such as by sending radio-frequency signals to the communication unit (whereas said radio-frequency signals may correspond to which state the device is in). Indicating to communication unit 2128 which state device 2144 is in at any given time may facilitate selecting any of sections 2126a-d which corresponds to the state in which device 2144 is in at said given time (similarly to the described for light output from device 2110 being sensed and recognized, for selecting between sections 2126a-d). Note that it is made clear that device 2144 communicating with communication unit 2128 may be additionally or alternatively to device 2144 outputting light to be sensed and recognized by system 2120. Communicating with communication unit 2128 may be beneficial when device 2144 in not in the field of vision of system 2120, or otherwise when a line of sight between system 2120 and device 2144 cannot be established (in case an object may be obstructing the sensing of device 2144 by system 2120, such as when said object is positioned between the system and the device). In such cases, device 2144 cannot communicate with system 2120 by outputting light (which may be indicative of states of the device), so that other forms of communication are required, such as by device 2144 communicating with communication unit 2128.

In FIG. 21C, device 2144 is specifically shown being out of the field of vision of system 2120 (the system illustrated as facing the opposite direction) and communicating with communication unit 2128.

In some embodiments, device 2144 may toggle (or “switch”, or “change”) between communication forms (i.e. between communicating with communication unit 2128, outputting light, and outputting light in addition to communicating with the communication unit). Accordingly, device 2144 may be either communicating with communication unit 2128 or generating light output. Optionally, device 2144 may also be communicating with communication unit 2128 in addition to generating light output (such as for light output to indicate states of the device to a user, and communicating with the communication unit for indicating states of the device to facilitate selecting between sections 2126a-d, or otherwise to facilitate any type of interaction, or specifically any controlling of interface 2132).

In some embodiments, when system 2120 cannot sense light output from device 2144, device 2144 may be prompted (e.g. “commanded”) to change to a different communication form (i.e. to change from generating light output to any other communication form, or combination of communication forms), in accordance with the described above for changing between communication forms. Similarly, when system 2120 can senses light output from device 2144, device 2144 may be prompted to change to a different communication form, such as to stop communicating with communication unit 2128. For example, if system 2120 cannot sense light output from device 2144, the system may notify another element or section (e.g. a processor and/or program) of system 2140 that light output from device 2144 cannot be sensed, in which case system 2140 may command device 2144, such as by communication unit 2128 sending commands (e.g. signals encoding commands) to device 2144, to indicate which state the device is in to communication unit 2128, such as by sending radio-frequency signals which are indicative of which state the device is in. In some cases, device 2144 may still generate light output so that if system 2120 can later start sensing light output from device 2144 (e.g. a finger wearing the device may enter the field of vision of system 2120), system 2140 may command device 2144 to stop indicating which state the device is in to communication unit 2128 (e.g. stop generating radio-frequency signals which can be received by the communication unit).

The described for FIG. 21C may be beneficial for when device 2144 is utilized in system 2140 and whereas sometimes the device is not in the field of vision of system 2120, and other times the device is in the field of vision of system 2120.

FIG. 21D shows hand 230 simulating use of a finger-worn device, specifically in front of system 2120 which is described above. In other words, in FIG. 21D hand 230 may be performing hand gesture 2150 which include actions similar to operating a finger-worn device, yet the hand does not wear a finger-worn device on any of its fingers and is only mimicking (or “imitating”) operating a finger-worn device, specifically such that system 2120 can sense said hand gestures. For example, thumb 234 of hand 230 may perform a sliding motion on finger 232 of the hand, so that the thumb may appear as if it was rotating a finger-worn device, yet said sliding motion is not performed on any such finger-worn device.

In some embodiments, system 2120 may sense hand gestures similar to operating a finger-worn device (yet not performed on a finger-worn device) and recognize said hand gestures, for registering input similar or identical to input registered from system 2120 sensing light output from a finger-worn device which is indicative of said finger-worn device changing between states. Accordingly, by sensing hand 230 performing hand gesture 2150, which may be a hand gesture similar to a hand operating a finger-worn device, and by recognizing hand gesture 2150, system 2120 may register input which may prompt interface or program events, or may facilitate executing interface or program functions, which may be similar or identical to interface or program events or functions prompted or executed by the system registering input from sensing light from a finger-worn device. For example, in FIG. 21D there is shown an interface 2152 (displayed by display 2124, which may be coupled to system 2120), in which there is interface element 2126 which, following the described above for browsing interface element 2126, may be browsed either by system 2120 sensing changes in light from a finger-worn device (e.g. from device 2110, light being indicative to changes between states of the device) or by system 2120 sensing hand 230 performing hand gesture 2150 (illustrated in FIG. 21D adjacently to interface element 2126 in interface 2152 are dashed arrows which suggest browsing directions which may correspond to operating a finger-worn device in certain directions, and/or to performing a hand gesture in certain directions, such as sliding thumb 234 on finger 232 in any of the directions illustrated as dashed arrows extending from the thumb in the figure).

In some embodiments, by system 2120 sensing and recognizing hand gesture 2150, an interface element 2156 (shown displayed by displayed 2124 in FIG. 21D) may be displayed in interface 2152 and controlled correspondingly directions in which hand gesture 2150 are performed (in case the hand gesture is performed in certain directions, such as directions of sliding thumb 234 on finger 232). For example, as shown in FIG. 21D, interface element 2156 may be a visual representation (e.g. a graphic rendering in interface 2152) of a finger-worn device which may be displayed as rotating to a first direction when thumb 234 is sliding on finger 232 in a certain direction, and which may be displayed as rotating to a second direction when thumb 234 is sliding on finger 232 in an opposite direction.

FIG. 21E shown a system 2160 which may include two or more finger-worn devices and gesture recognition system 2120 coupled to a visual output unit (e.g. display 2124 in FIG. 21E). In FIG. 21E there is shown system 2160 specifically including a finger-worn device 2162a worn on a finger of hand 230, and a finger-worn device 2162b worn on a finger of a hand 2170. An image 2174a may be any image which includes hand 230 and device 2162a, whereas an image 2174b may be any image which includes hand 2170 and device 2162b. Note that it is made clear that images 2174a,b may form a single image which includes hands 230 and 2170 and devices 2162a,b. Further note that hand 230 and/or hand 2170 may be performing a gesture, similarly to the described above for hand gesture 2150.

In some embodiments, hand 230 wearing device 2162a and hand 2170 wearing device 2162b may facilitate system 2120 distinguishing between hand 230 and hand 2170, such as for registering separate input corresponding to each hand, specifically to a location, position and/or gesture of each hand. For example, display 2124 may display an interface 2172 which may be controlled by system 2120, such as by utilizing input registered from sensing and recognition by system 2120. In interface 2172 there may be an interface element 2176a which may correspond to hand 230, and an interface element 2176b which may correspond to hand 2170 (e.g. it may be desired that each interface element will react to its corresponding hand, such as for each hand to control its corresponding interface element). System 2120 may capture (or “sense”) images from in front of display 2124, so that images 2174a,b may be captured by the system, wherein hand 230 may be recognized by detecting (or “identifying”) device 2162a in image 2174a, and wherein hand 2170 may be recognized by detecting device 2162b in image 2174b, so that input may be registered independently for each hand. Accordingly, interface element 2176a may react to (or otherwise “may be influenced by”) hand 230, such as specifically to the location and gesture of the hand in any given time, whereas interface element 2176b may react to hand 2170. Optionally, interface elements 2176a and 2176b may react, additionally or alternatively to reacting to hands 230 and 2170 (respectively), to devices 2162a and 2162b (respectively), such as in case input registered by system 2120 sensing images 2174a,b may correspond to states of devices 2162a,b (see ref. FIGS. 21A through 21C). It is made clear that said input may additionally or alternatively correspond to locations, positions or gestures of hands 230 and 2170. Note that interface 2172 may have been preprogrammed such that in the interface, interface element 2174a may react to a hand wearing device 2162a, and interface element 2174b may react to a hand wearing device 2162b.

Following the above, distinguishing between multiple hands, such as for registering input independently from each hand (e.g. from sensing each hand), or otherwise different inputs such that each of said different inputs correspond to each of said multiple hands, may be facilitated by each hand wearing a finger-worn device. This may be beneficial when a single user is interacting with an interface by using two hands (e.g. input from sensing said two hands may be utilized for or in said interface), whereas it may be desired for each hand to correspond to a different interface element, function or event (e.g. for each hand to control a different object displayed in an interface, or for each hand to perform a different function in an interface). This may further be beneficial when a plurality of users may be interacting with an interface, whereas it may be desired for said interface to distinguish between a hand (or both hands) of each user, to register different inputs from each hand, or specifically to facilitate different interface elements, functions or events being influenced by a hand (or both hands) of different users. Accordingly, when sensing an image (or plurality thereof) wherein there is more than one hand, each hand may be differentiated from other hands (such as identified as belonging to a certain user, or such as associated with a different interface function) by wearing a finger-worn device which may be different from finger-worn devices worn on said other hands, or which may otherwise communicate different communications (e.g. transmit different signals or generate different light output) than finger-worn devices worn on said other hands. In addition to the above, this may further be beneficial when recognizing differences between hands may not be facilitated, in which case finger-worn devices worn on said hands may be serve as differences between said hands.

Further note it is known in the art that some gesture recognition systems may facilitate gesture recognition by sensing means which are not means for sensing light, and so it is made clear that such systems are also within the scope of the invention.

FIG. 22A shows an embodiment of a system 2210 of the invention which may include a finger-worn device 2200. Device 2200 is shown worn on finger 232 of hand 230, and shown including a control 2204, by which the device can be operated. Device 220 is further shown including a visual indicator 2206 (or simply “indicator”) by which the device can generate (or “output”) visual output. Control 2204 may be any element which can be operated (or interacted with), preferably for controlling visual output generated (or “produced”) by indicator 2206. Indicator 2206 may be any means for generating visual output, such as a light-emitting diode (LED). Preferably, visual output from indicator 2206 is distinct and can be easily identified. For example, indicator 2206 may be a multi-color LED which can emit light of different colors, and which can optionally flicker or blink at different rates. Accordingly, by operating control 2204, different visual outputs may be generated by indicator 2206, specifically different colors, optionally blinking at different rates.

In FIG. 22A there is further shown eye 2210 of a user which is preferably wearing (on hand 230) and operating device 2200. Eye 2210 represents the sight of said user, to depict that the user can see visual output from device 2200. Optionally, visual output from the device is indicative of operations performed on (or “with”) the device, so that the user, by seeing the device (specifically indicator 2006 of the device), can receive visual feedback from the device, whereas said visual feedback may be output which indicates how the device is being operated (supposedly by the aforementioned user). For example, control 2204 of device 2200 may be a button having two “pressing degrees” (see e.g. control 1804 of device 1800 in FIGS. 18A through 18D), whereas by pressing the control to a first degree may prompt visual indicator 2206 of device 2200 to emit light of a blue color, and whereas pressing the control to a second degree may prompt the visual indicator to emit light of a yellow color. For this example, a user watching device 2200 can know to which degree control 2204 is being pressed. In similar embodiments, visual indicator 2206 of device 2200 may visual indicate which state device 2200 is in, similarly to described herein for states of finger-worn devices of the invention.

In FIG. 22A there is further shown a visual-recognition system 2220 (see e.g. U.S. Pat. Nos. 4,917,500, 6,069,696, 5,111,516, 5,313,532, 7,298,899, 6,763,148, 4,414,635, 6,873,714 and 6,108,437) which can sense and recognize visual output from device 2200, specifically from indicator 2206, for registering input. System 2220 is shown in the figure, by way of example including a visual sensor 2222 which can facilitate visual sensing (e.g. sensing of visual light, or otherwise capturing images), and including a visual-recognition program 2224 which can process visuals sensed by the visual sensor. Following the above, because visual output from device 2200, which can be recognized by system 2220, is indicative of operations of the device (or of states of the device), input registered by system 2220 may correspond to operations performed on (or with) device 2200, specifically by operating control 2204. Accordingly, visual output from a finger-worn device of the invention may be utilized both as visual feedback indicating operations on (or with) said finger-worn device (otherwise “indicating how the finger-worn device is being operated”), and as means of indicating said operations to a visual-recognition system, or to a device which includes a visual-recognition system. In other words, visual output from a finger-worn device of the invention may indicate use of said finger-worn device to a human user and to a system which can recognize said visual output (to facilitate registering input corresponding to said use of said finger-worn device).

Following the above, it is made clear that a method of the invention may facilitate utilizing visual output from a finger-worn device to indicate use of the device to a user, and to indicate said use to another device.

Note that whereas the described above is for operating (or using) a finger-worn device which can generate visual output, it is made clear that the disclosed herein may refer to any device (not necessarily finger-worn). Accordingly, in some method of the invention, visual output from any device may be utilized as indication means for a user and communication means for registering input (correspondingly to light properties) at a separate device.

FIG. 22B shows a flowchart of a method 2240 for visual feedback being utilized for communicating input.

At a step 2242 of method 2240, a finger-worn device may be operated, such as by rotating a rotatable section of said finger-worn device, or such as by pressing a button of the finger-worn device.

At a step 2244, visual feedback is prompted from operating the finger-worn device (step 2242). For example, setting a rotatable section of the finger-worn device to a first input position (see “input positions” as described for a device 700 shown in FIGS. 7A and 7B) may prompt an LED of the device to emit a blue-colored light, whereas setting said rotatable section to a second input position may prompt said LED to emit a red-colored light. Optionally, pressing on the rotatable section (supposing the section can be pressed, and supposing pressing the section influences the LED) may prompt blinking of said blue-colored light when the rotatable section is at said first input position, whereas pressing on the rotatable section when it is at said second input position may prompt blinking of said red-colored light.

At a step 2246, visual feedback prompted at step 2244 may be sensed, such as by a camera or visual sensor. Detecting visual feedback prompted at step 2244 may be facilitated by any number of means known in the art for sensing visible light, such as by an active-pixel sensor (APS).

At a step 2248, visual feedback sensed at step 2246 may be identified (or “recognized”), such as by a visual-recognition system and/or program. Specifically, elements or properties of said visual feedback may be identified, such as colors (also “wavelengths of light”) in the visual output, and/or blinking rates. For example, identifying properties of visual output (at step 2248) may be measuring a rate at which light emitted from a finger-worn device is blinking, and/or obtaining the color of said light.

In some methods, at a step 2250, visual feedback sensed at step 2246 may be located. In other words, information about the location from which visual feedback is prompted (step 2246) may be obtained (at step 2250), and accordingly the location of the finger-worn device prompting said visual feedback deduced. In yet other words, at step 2250, sensed visual feedback may be processed or analyzed for deducing the location of a finger-worn device which prompted said visual feedback. Processing or analyzing visual feedback for deducing the location from which said visual feedback is prompted may be performed by any means known in the art which can locate the position (i.e. direction and distance) of a light source (see e.g. U.S. Pat. Nos. 5,914,783, 5,502,568 and 5,644,385). Deducing the location of a finger-worn device (by locating the location from which visual feedback is prompted by said finger-worn device) may be for tracking motion of a finger wearing said finger-worn device, such as for correspondingly controlling the location of an interface element (e.g. the location of a cursor in a GUI).

At a step 2252, input may be registered correspondingly to the sensed visual feedback (step 2246). Registering input may refer to converting the sensed visual feedback to code, or to prompting an interface or program event (also “reaction”) in an interface or program (e.g. executing a function). For example, the sensed visual feedback may be converted to a command in an interface of a device which senses and identifies the visual feedback.

In some methods, registered at step 2252 may be input which corresponds to the identification of visual feedback, or properties thereof, as performed at step 2248. For example, color (as an exemplary property of visual feedback) may be identified in visual feedback at step 2248, so that input corresponding to said color may be registered at step 2252.

In some methods, additionally or alternatively to input registered from identification, registered at step 2252 may be input which corresponds to the location from which visual feedback is prompted, as located at step 2250. For example, information about the location from which a finger-worn device prompts visual feedback may be utilized (as input) for determining the location of an interface element (e.g. a cursor), so that a user may move a finger wearing said finger-worn device for registering input which corresponds to the motion of said finger, for moving said interface element.

Following the above, it is made clear that method 2240 facilitates utilizing visual feedback (also “visual output”) from a finger-worn device as communication means for registering input which corresponds to the visual feedback, and accordingly to use of the device, and/or facilitates utilizing the same visual output for locating (also “tracking” or otherwise “detecting the position of”) the aforementioned finger-worn device being the source of the visual output.

FIG. 23A shows a method 2300 of the invention which may include a finger-worn device 2310 (shown worn on finger 232 of hand 230) and a device 2320. Device 2320 is shown including a touch-screen 2322 and processing means 2324. Touch-screen 2322 of device 2320 may be an “integrated sensing display” as known in the art (see e.g. U.S. Pat. No. 7,535,468). Accordingly, touch-screen 2322 may generate light output and may sense light as input, such as to facilitate touch-sensing or such as to capture images from in front of the touch-screen. Processing means 2324 may be any means for processing light generated by device 2310, such as for registering input according to light which was generated by device 2310 and sensed by touch-screen 2322.

FIG. 23B shows a close-up of device 2310. In FIG. 23B, device 2310 is shown as not worn on a finger, to facilitate depicting elements and sections of the device. Device 2310 may include a light generating unit 2312 (or simply “unit”) and a light sensing unit 2314 (or simply “unit”). Preferably, units 2312 and 2314 may be positioned facing an inner surface 2316 which comes in contact with a finger when device 2310 is worn (such as the surface which surrounds a cavity of the device, through which a finger may be inserted). Accordingly, light generating unit 2312 may generate light (e.g. a light output 2318a as shown in the figure) towards a finger wearing device 2310, whereas said light (or certain portions or certain wavelengths thereof) can preferably pass through said finger. Further accordingly, light sensing unit 2314 may sense light (e.g. a light 2318b originating from touch-screen 2322, as shown in the figure) passing through a finger wearing device 2310.

Following the above, a finger wearing device 2310 and touching touch-screen 2322, or being in close proximity to the touch-screen (such as according to a sensitivity range of the touch-screen), may pass light from device 2310 to touch-screen 2322 (e.g. light 2318a) and/or from touch-screen 2322 to device 2310 (e.g. light 2318b), for facilitating communication between the device and the touch-screen. Note that communication may also be facilitated by processing means 2324 processing light input sensed by touch-screen 2322, for specifically detecting or identifying light which originated from device 2310.

In some embodiments, system 2300 may include a plurality of finger-worn devices similar to device 2310, whereas each of said plurality of finger-worn devices may be worn on a different finger, either of the same hand or of other hands. By each of said plurality of finger-worn devices generating a different and distinct light, sensing a light from a specific finger-worn device by touch-screen 2322, specifically when a finger wearing said specific finger-worn device touches the touch-screen (or approaching the touch-screen for being in close proximity to it), may facilitate identifying which of said plurality of finger-worn devices is said specific finger-worn device, and accordingly may facilitate identifying said finger wearing said specific finger-worn device. Accordingly, sensing light from different finger-worn devices may facilitate distinguishing between each of said different finger-worn devices, such as for performing a function specifically associated with a specific finger-worn device yet not associated with any other finger-worn device, so that sensing light from said specific finger-worn device and identifying said finger-worn device may facilitate performing a function associated with said specific finger-worn device (see ref. system 2160 in FIG. 21E).

FIGS. 24A and 24B show an embodiment of the invention as a finger-worn device 2400 which may include two or more accelerometers. Device 2400 is shown in the figures to specifically include accelerometers 2404a,b which may be located in or on a section 2402.

In FIG. 24A there is specifically shown device 2400 moved to a certain direction (suggested direction illustrated in FIG. 24A by a dashed arrow pointing right), whereas in FIG. 24B there is specifically shown device 2400 rotated (suggested direction of rotation illustrated in FIG. 24B by curved dashed arrows).

FIG. 24C show hand 230 (specifically finger 232) wearing device 2400 and moving to a certain direction, respectively to the shown for device 2400 being moved in FIG. 24A.

FIG. 24D show hand 230 (specifically finger 232) wearing device 2400, whereas thumb 234 is shown rotating the device, respectively to the shown for device 2400 being rotated in FIG. 24B.

By including accelerometers 2404a,b in device 2400 and specifically locating them oppositely to each other (shown in FIGS. 24A and 24B located in generally opposite sides of section 2402), detecting whether device 2400 is moved in a certain direction (see ref. FIGS. 24A and 24C) or whether the device is rotated in a certain direction (see ref. FIGS. 24B and 24D) may be facilitated. Note that it may be required to align accelerometer 2404a,b so that they are positioned as pointing to the same general direction (in FIGS. 24A and 24B, a black circle is illustrated in each of accelerometers 2404a,b, and is shown positioned on the right side of each accelerometer, from the point of view of the figures, to suggest the same side in each of the accelerometer is pointing to the same direction, such as in case both of the accelerometers are identical). For example, when device 2400 is moved to the right (as suggested in FIGS. 24A and 24C), accelerometers 2404a,b may be influenced similarly or identically by the same acceleration forces (e.g. both accelerometers may register (e.g. sense and output) a positive gravity force). Similarly, when device 2400 is rotated counter-clockwise (as suggested in FIGS. 24B and 24D), accelerometers 2404a,b may be influenced differently, according to their locations (and positions relative to each other) in device 2400 (e.g. accelerometer 2404a may register a negative gravity force while accelerometer 2404b may register a positive gravity force).

Following the above, a finger-worn devices of the invention may include two or more accelerometer which are located and positioned so that they can detect absolute motion of said finger-worn device (such as when a finger wearing said finger-worn device moved) and rotation of said finger-worn device (such as when a thumb is rotating said finger-worn device), and so that distinguishing between absolute motion and rotation may be facilitated (such as by processing input registered from each of said two or more accelerometers). Note that whereas the described above may refer to rotating a finger-worn device (e.g. device 2400), it is made clear that it may similarly refer to rotating a section of said finger-worn device, in which (i.e. in said section) two or more accelerometers may be included. Further note that any or all of said two or more accelerometers may be single-axis accelerometers or multi-axis accelerometers, as known in the art. Further note that whereas the described for FIGS. 24A through 24D refers to a couple of accelerometers (accelerometers 2404a,b), it is made clear any number of accelerometers may be included in device 2400, for additional detection and distinguishing features. For example, after rotating device 2400, accelerometers 2404a,b may be positioned as pointing up or down, whereas in case the accelerometers are single-axis accelerometers, detecting right or left movement of the device may not be possible (as opposed to when the accelerometers are positioned as pointing left or right, as suggested in FIGS. 24A and 24B). In such cases, additional accelerometers may be included to facilitate sensing movement of device 2400 in any axis of space. Note that in some embodiments, device 2400 may include a gyroscope, to detect which direction accelerometers 2404a,b are pointing to at any given time, so that in case accelerometers 2404a,b are multi-axis accelerometers, knowing which axis of space the accelerometers are detecting motion in may be facilitated. This may be because after rotating device 2400, accelerometers 2404a,b may be positioned differently (relative to external objects, such as the ground) than before rotating the device.

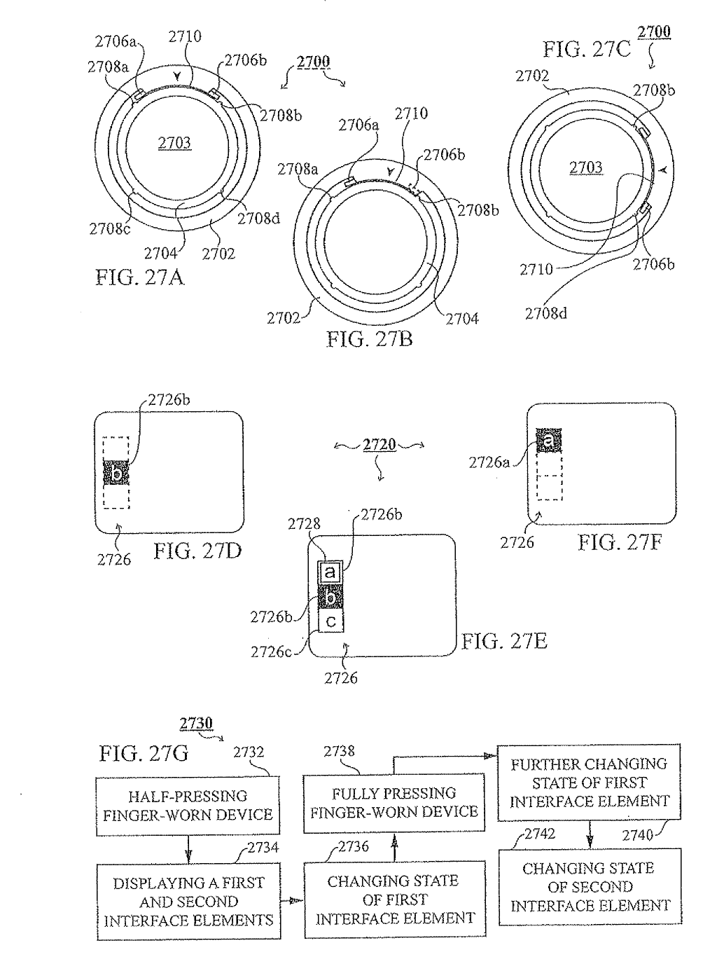

FIG. 25A shows an embodiment of the invention, from a cross-section point of view, as a finger-worn device 2500. Device 2500 is shown in the figure including a section 2504 through which a finger may be inserted (shown section 2504 having a cavity 2503 which facilitated mounting device 2500 on a finger), and a section 2502 which can be operated by a finger, such as a thumb. Specifically, section 2502 is shown including a grip 2512 (illustrated as bumps of the section in FIG. 25A) which may facilitate pushing, pulling and/or tilting section 2502 (e.g. to prevent a finger operating section 2502 from slipping on the surface of section 2502).

In some embodiments, section 2502 may be installed on a switch 2510 which can be manipulated to be in any of multiple states. Otherwise, in some embodiments, switch 2510 may be connected to section 2502 and to section 2504 such that when section 2502 is operated, switch 2510 is manipulated.

FIG. 25B specifically shows switch 2510 (from a perspective view). In FIG. 25B there are illustrated dashed arrows, suggesting directions in which switch 2510 may be manipulated (shown five suggested possible directions).

FIG. 25C shows (from a perspective view) section 2502 of device 2500 ready to be installed on section 2504, specifically on switch 2510 which is shown located on section 2504. Note that it is made clear that device 2500 may be constructed in any way so that operating section 2502 manipulates switch 2510.

In some embodiments, operating section 2502 in multiple directions may include two or more repositioning operations for each of said multiple directions. In other words, similarly to the described for control 1804 of device 1800 in FIGS. 18A through 18C, section 2502 may be repositioned to two or more positions in each direction (i.e. each direction the section may be repositioned in). Accordingly, section 2502 may be “half-pressed” (similarly to the described above for control 1804) and fully pressed in any of multiple directions. For example, section 2502 may be “half-pushed”, “half-pulled” or “half-tilted”.

FIG. 25D shows device 2500 from a perspective view. In the figure there are illustrated dashed arrows generally extending from the grip of section 2502 (e.g. grip 2512), suggesting directions in which section 2502 may be operated (or specifically repositioned, such as by being pushed or pulled by a thumb). For each direction (shown four directions) there are illustrated two dashed arrows, suggesting that section 2502 may have two specific positions to which the section may be repositioned, for each direction. For example, section 2502 may be pushed to a first position in a first direction and then be pushed to a second position in said first direction. Similarly, section 2502 may be pulled to a first position in an opposite direction (i.e. a direction opposite to said first direction) and then to a second position in said opposite direction. Further similarly, section 2502 may be tilted to a first position in an additional direction and then to a second position in said additional direction (e.g. perpendicularly to the aforementioned first direction).

Note that the described above for device 2500 may be beneficial for providing an appearance generally similar to a ring for a finger-worn input device, as opposed to some known finger-worn devices which include operable sections or controls which may not be comfortable to reposition, or which may not be visually attractive as they differ from a general common appearance of rings.

FIGS. 25E through 25G show an embodiment of the invention as an interface 2550. Interface 2550 is shown including an interface element 2556 which may be controlled or influenced by operating device 2500 (see ref. FIGS. 25A and 25D). In some cases, as specifically shown in FIGS. 25E and 250, interface element 2556 may not be displayed in interface 2550 (such as by a touch-screen displaying the interface) when device 2500 is not operated. Additionally, as specifically shown in FIG. 25F, interface element 2556, or any section thereof (shown and numbered in the figures are sections 2556a and 2556c), may be displayed in interface 2550 when device 2500 is being operated (device 2500 is shown being operated by thumb 234 of hand 230 in FIG. 25F). Alternatively, interface element 2556, or every section thereof, may not be displayed when device 2500 is operated, yet sections of the interface element may be selected (as described below) without being displayed.

In accordance with the described above for device 2500, section 2502 of the device may be “half-pushed” in a certain direction, for selecting section 2556a of interface element 2556 (section 2556a suggested to be selected in FIG. 25F by being illustrated as black), and optionally for indicating that section 2556a is selected, such as by a visual indication displayed by a display which may be displaying the interface and elements thereof. Similarly, section 2502 of device 2500 may be “half-pulled” in an opposite direction (to said certain direction), for selecting section 2556c (shown located generally oppositely to section 2556a in interface element 2556, such as in case pushing and pulling section 2502 in specific directions may correspond to locations or arrangements of sections of interface element 2556), and optionally for indicating that section 2556c is selected.

In some embodiments, “half-pushing” or “half-pulling” (or in any way repositioning) section 2502 of device 2500 may be for prompting the displaying of an interface element (or plurality thereof) which can be interacted with by touching a touch-screen which displays said interface element, while section 2502 is in a “half-pushed” position or “half-pulled” position (or in any other position). Optionally, releasing section 2502 from said “half-pushed” position” or said “half-pulled” position (or from any other position) may be for hiding or deleting said interface element. Further optionally, fully pushing or fully pulling section 2502 in the same direction (i.e. the same direction in which the section is “half-pushed.” or “half-pulled”) may be for changing the state of said interface element, or for prompting the displaying of a different interface element. For example, “half-pushing” section 2502 may be for displaying a virtual keyboard of English characters, whereas fully pushing the section in the same direction may be for displaying a virtual keyboard of punctuation marks. And whereas releasing section 2502 from either a “half-pushed” position or a fully pushed position may be for hiding any of said virtual keyboards.

In some embodiments, when any section of interface element 2556 is selected (such as when section 2502 of device 2500 is “half-pushed” or “half-pulled”, or otherwise in any way repositioned), touching a touch-screen which displays interface 2550 (or in other words “registering touch input”) may be for executing a specific function, or for prompting a specific interface event, alternatively to any other section of the interface element being selected. For example, as shown in FIG. 25F, while section 2556a of interface element 2556 is selected (such as while section 2502 is being “half-pushed” in a certain direction), finger 232 may touch a touch-screen (supposedly a touch-screen which is displaying interface 2550), for performing a function 2566a.

In some embodiments, when section 2502 of device 2500 is fully pushed or fully pulled in the same direction in which the section was “half-pushed” or “half-pulled” so that a specific function is executed, or a specific interface event is prompted, by touch input being registered, said function or said interface event may be approved or finalized. Alternatively, a result (or plurality thereof) from said function or said interface event may change between states (such as from a state in which said result was before section 2502 being fully pushed or fully pulled, to another state). Further alternatively, a result (or plurality thereof) from said function or said interface event may be prompted. For example, a result 2556b from function 2566a is shown in FIG. 250, suggesting that section 2502 of device 2500 has been fully pushed or fully pulled in the same direction in which the section was “half-pushed” or “half-pulled” to facilitate finger 232 touching a touch-screen for performing function 2556a. For a more specific example, “half-pushing” section 2502 of device 2500 in a specific direction may be for selecting a section of interface element 2556 which may correspond to a specific function for touch input, such as a drawing function, so that when the section is “half-pushed”, a finger touching a touch-screen which displays interface 2550 may prompt the execution of said specific function, such as prompt the displaying of an interface element (e.g. the drawing of a circle). Then, fully pushing section 2502 in said specific direction may be for finalizing said specific function, such as rendering a drawing performed by a drawing function, or for changing the state of an interface element which may be the result of said specific function, such as a drawn circle (e.g. said drawn circle may change between a state of being suggested to a user interacting with a touch-screen, to a state of being fully rendered). Note that it is made clear that a result of a function which corresponds to section 2502 being “half-pushed” or “half-pulled” in a certain direction, and which may be executed by touch input being registered (e.g. when a finger touches a touch-screen which displays interface 2550), may be an changed (or “altered”, or “modified”) or repositioned (or “moved”) interface element on which said function may have been performed (or “executed”), whereas said interface element may have existed before “half-pushing” or “half-pulling” section 2502. Alternatively, a result of a function which corresponds to section 2502 being “half-pushed” or “half-pulled”, and which may be executed by touch input being registered (e.g. when a finger touches a touch-screen which displays interface 2550), may be a new interface element which be generated (or “produced”) as a result of said function. Further note that fully pushing or fully pulling section 2502 in the aforementioned certain direction may be for changing the state of said changed or repositioned interface element, or of said new interface element.

In some embodiments, when section 2502 of device 2500 is released from being “half-pushed” or “half-pulled” (e.g. by removing a finger applying a pushing or pulling force on the section), without the section being fully pushed or fully pulled, a result (or plurality thereof) of a function being executed or an interface event being prompted while the section was “half-pushed.” or “half-pulled” (by registering touch input) may be canceled (or otherwise “deleted” or “removed”). Alternatively, a result (or plurality thereof) from said function or said interface event may change to a state other than a state to which it may have been changed in case section 2502 was fully pushed or fully pulled (in the same direction of being “half-pushed” or “half-pulled”). Further alternatively, no results may be prompted from said function or said interface event (being executed or prompted, respectively). For example, “half-pushing” section 2502 in a certain direction by a thumb may be for prompting the displaying of a virtual keyboard on a touch-screen which displays interface 2550, so that fingers touching said touch-screen may type on said virtual keyboard (as an exemplary function), while said thumb is holding section 2502 “half-pushed”. In case section 2502 is not fully pushed in said certain direction, after fingers typed on said virtual keyboard, anything typed by the typing of said fingers may be erased. Additionally and following the above, in case section 2502 is fully pushed in said certain direction, said anything typed by the typing may be approved, such as sent to a recipient of a chat session, or such as submitted to a so-called text-field. For another example, fingers may touch a touch-screen displaying a circle to change the size of said circle (as an exemplary function) while section 2502 is being “half-pulled” in a certain direction. In case section 2502 is fully is fully pulled in said certain direction, the resizing of said circle may be finalized (e.g. accepted by interface 2550 and/or rendered). In case section 2502 is released from being “half-pulled” without being fully pulled, said resizing of said circle may be cancelled, in which case said circle may return to its original size.

Note that whereas the described above for FIGS. 25E through 25G may refer to “half-pushing” and “half-pulling” section 2502 of device 2500, it is made clear that the section may be repositioned in any number of directions to two or more extent, such as in case the section may be “half-tilted” in addition to being able to be “half-pushed” and “half-pulled”.

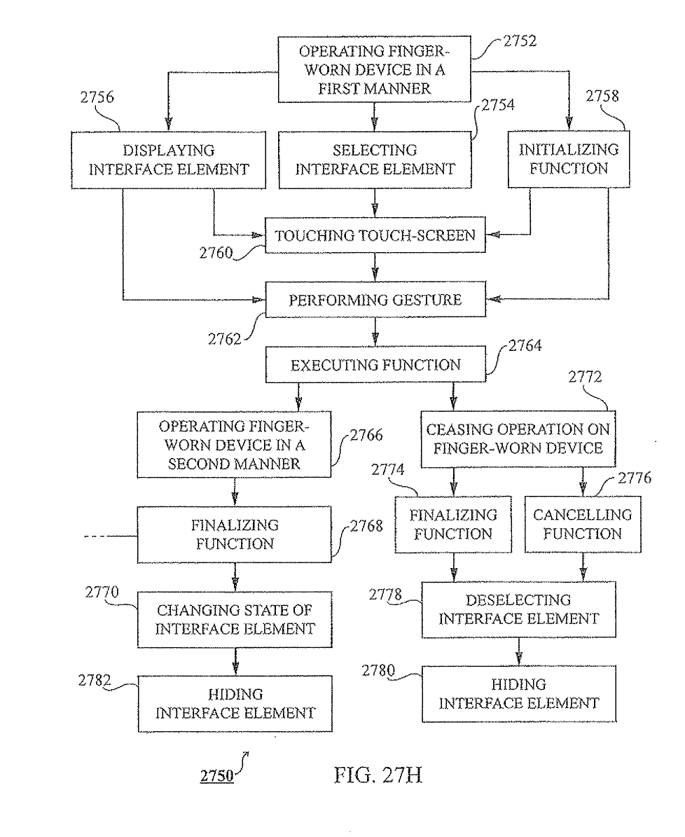

FIGS. 26A through 26C show an embodiment of the invention as a finger-worn device 2600 which may include an inner section 2604 (or simply “section”) and an outer section 2602 (or simply “section”) which can be operated. Device 2600 may further include a switch 2606 which may generally be located between section 2602 and section 2604. Switch 2606 may have two or more states, such as a state in which the switch is in a “half-pressed” position, and a state in which the switch is in a fully pressed position. Operating section 2602 may affect switch 2606, such as in case section 2602 is repositioned to change states of switch 2602.

FIG. 26A specifically shows section 2602 being in a default position, whereas FIG. 26B and FIG. 26C show section 2602 being in a second position and a third position, respectively. Accordingly, in FIG. 26A, switch 2606 may be in a default state, whereas in FIG. 26B and FIG. 26C switch 2606 may be in a second state and a third state, respectively. For example, section 2602 may be “half-pressed” in FIG. 26B, affecting switch 2606 to be in said second state, whereas section 2602 may be fully pressed in FIG. 26C, affecting switch 2606 to be in said third state.

Note that in some embodiments, device 2600 may include section 2602 and switch 2606, excluding section 2604. In such embodiments, switch 2606 may be manipulated by repositioning section 2602 relative to a finger wearing device 2600, such as by being pressed between section 2602 and said finger when section 2602 is pressed towards said finger.

FIG. 26D shows a switch 2660, similar to switch 2606, connected to a ring 2650. Ring 2650 may be any ring or jewelry which can be worn on a finger. Switch 2660 may be connected to an inner surface of ring 2650 (i.e. a surface which comes in contact with a finger when the ring is worn) so that it may be concealed when the ring is worn. Note that switch 2660 may generally be flat, such as by including miniaturized circuitry, so that it does not intrude on wearing ring 2650, or otherwise make wearing the ring uncomfortable. In some embodiments, switch 2660 may be padded by a flexible and/or comfortable material, for facilitating comfort when wearing ring 2650 while the switch is connected to it.

Preferably, when ring 2650 is worn on a finger while switch 2660 is connected to it, manipulating the ring, such as by pressing on it, may affect switch 2660 such that input may be registered. For example, pressing on an outer surface of ring 2650 (i.e. a surface which is exposed when the ring is worn on a finger), when switch 2660 is connected to an inner surface of the ring, may cause switch 2660 to be pressed (or “half-pressed”, as suggested for switch 2606 of device 2600), or otherwise to change states.

FIG. 26E shows switch 2660 not connected to a ring, and from a different point of view than shown in FIG. 26D. In FIG. 26E switch 2660 is shown including connection means 2664 for facilitating connecting the switch to a ring. Connection means 2664 may be any means by which switch 2660 can be connected to a ring, such as by being or including an epoxy which facilitates adhesion of the switch to a ring. Further shown in FIG. 26E is switch 2660 including a communication unit 2668. Communication unit 2668 may be any miniaturized means for sending transmissions or modulating signals, such as for registering input corresponding to states of switch 2660. When switch 2660 is affected by manipulating ring 2650, a finger wearing the ring may be close to a device which can communicate with the switch when the switch is in close range. Accordingly, communication unit 2668 of switch 2660 may facilitate communicating with said device. For example, a finger wearing ring 2650 may be interacting with a touch-screen device (i.e. a device which includes a touch-screen) which can generate original signals (e.g. by an RFID reader) which can be modulated by communication unit 2668 (such as in case communication unit 2668 may be an antenna for a so-called “passive” RFID circuitry of switch 2660), whereas modulated signals may be detected back in said touch-screen device (e.g. by an RFID reader which optionally generated said original signals).

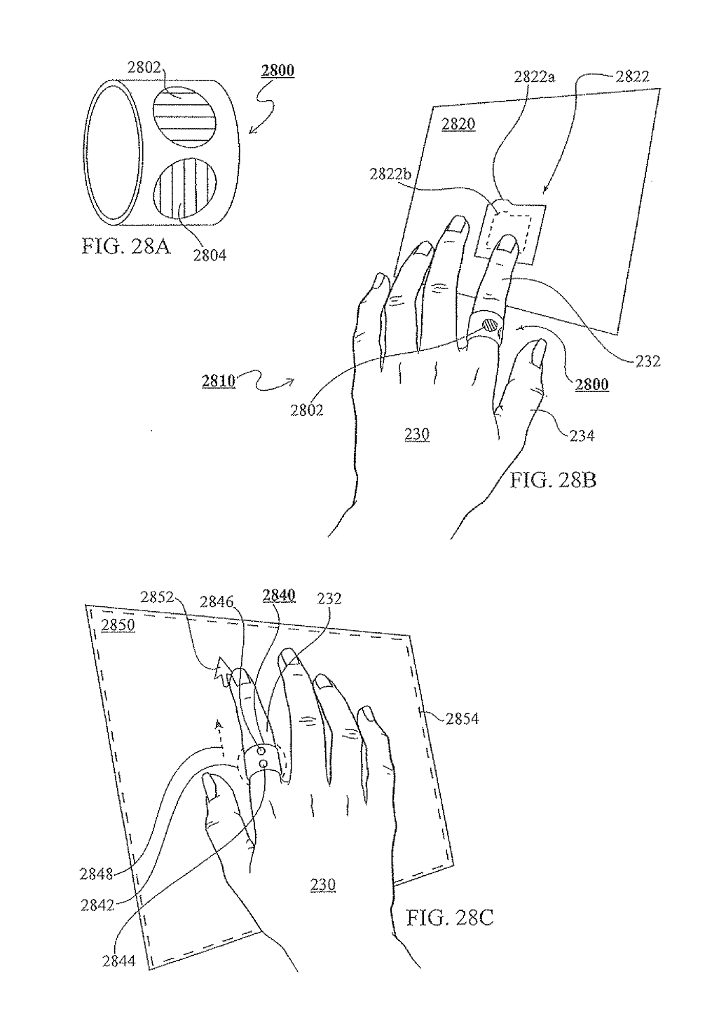

FIGS. 27A through 27C show, from a cross-section point of view, an embodiment of the invention as a finger-worn device 2700 which can be worn through a cavity 2703. Device 2700 is shown including a stationary section 2704 (in which there is cavity 2703) and a rotatable section 2702 (or simply “section”). Rotatable section 2702 may include switches 2706a,b, whereas stationary section 2704 may include bumps 2708a-d which may be any protuberance in the section, or otherwise any elements which may influence any of switches 2706a,b when section 2702 is rotated. Accordingly, in some cases, by rotating section 2702, any of switches 2706a,b may be influenced (e.g. activated) by any of bumps 2708a-d.

In FIG. 27A, section 2702 is specifically shown not rotated, whereas in FIG. 27B, section 2702 is shown rotated to a certain extent (e.g. slightly, as suggested by an arrow head illustrated in FIGS. 27A through 27C, whereas in FIG. 27B said arrow head is shown pointing to a slightly different direction than as shown in FIG. 27A). Additionally, switch 2706b is shown influences (e.g. pressed and/or activated) by bump 2708b, as a result of rotating section 2702 to the aforementioned certain extent. In FIG. 27C, section 2702 is shown further rotated (i.e. rotated to a larger extent than as shown in FIG. 27B, specifically clockwise from the point of view of FIGS. 27A through 27C), whereas in FIG. 27B neither switch 2706a nor switch 2706b are shown influences by any of bumps 2708a-d. Note that it is made clear that detecting rotated positions of section 2702 (or otherwise “registering input corresponding to a rotated position of section 2702”), specifically rotated positions in which neither switch 2706a nor switch 2706b are influenced, may be facilitated by any means known in the art. Optionally, detecting rotated positions of section 2702 in which any of switches 2706a,b are influenced may be by detecting influence on switches 2706a,b, such as detecting whether any of the switches is pressed and/or activated.

In some embodiments, section 2702 may be rotated to any number of positions (also “rotated positions”, or “input positions”) in which section 2702 may remain when not being operated, such as when a thumb does not apply force on the section or hold the section in any of said number of positions. Additionally or alternatively, section 2702 may be rotated to any number of positions from which section 2702 may return to a previous position (i.e. a position in which the section was before being rotated) when not being operated, such as when a thumb stops applying force on the section. For example, as shown in FIGS. 27A through 27C, section 2702 may include a bulge 2710 which may occupy gaps between any of bumps 2708a-d of stationary section 2704. Detecting which of said gaps bulge 2710 occupies at any given time may be facilitated by any means known in the art. Additionally, when section 2702 is not rotated or when force is not applied on the section, bulge 2710 may occupy any of said gaps and be positioned in the middle of that gap (bulge shown in the middle of a gap between bumps 2708a and 2708b in FIG. 27A, and shown in the middle of a gap between bumps 2708b and 2708d in FIG. 27C), such as by a mechanism of springs holding the bulge in a fixed position (when section 2702 is not operated). Further additionally, section 2702 may be rotated while bulge 2710 occupies any of the aforementioned gaps, in which case any of switches 2706a,b may be influenced (e.g. by any of the bumps between which the bulge is generally positioned). If section 2702 is rotated to a certain extent, bulge 2710 may remain between any of bumps 2708a-d, between which the bulge was positioned before section 2702 was rotated. When section 2702 is rotated to said certain extent and than a finger (e.g. a thumb) is removed from the section (so that no force is applied to the section), the section may return to a middle position in a gap which the bulge occupies, such as by a so-called “snap-back” feature. However, rotating section 2702 to a larger extent may cause bulge 2710 to occupy a different gap than the gap the bulge occupied before section 2702 was rotated, whereat the bulge may be positioned in the middle when a finger is removed from section 2702.

Following, section 2702 may be in any one of a specific number of rotated positions, whereas the section may be “half-pushed” or “half-pulled” (similarly to the described herein for “half-pressing”) from a rotated position (herein “original position”) to any of said specific number of rotated positions (herein “next position”), whereas then the section may be fully pushed to the “next” position (i.e. any of said specific number of rotated position which is next to any other of said specific number of rotated position in which section 2702 was at before being rotated, or which is next to said “original position”), or “snap-back” to said “original position”, such as when rotation of section 2702 is ceased, and no external force is applied on the section (e.g. by a thumb). Rotating section 2702 to any one of said specific number of rotated positions may be for registering corresponding input, whereas “half-pushing” or “half-pulling” section 2702 may additionally be for registering corresponding input (i.e. input corresponding to any “half-pushed” or “half-pulled” position of the section in which the section may be when said input is registered).

FIGS. 27D through 27F show an embodiment of the invention as an interface 2720. Interface 2720 may include an interface element 2726 which may include sections 2726a-c. In some embodiments, any of sections 2726a-c may be selected at any given time, such as in case interface element 2726 is a tool-bar and sections 2726a-c are tools, or such as in case the interface element is an options menu and the sections are options in said menu.

In some embodiments, interface element 2726 may be controlled or influenced by operating device 2700 (see ref. FIGS. 27A through 27C). Specifically, input registered by operating device 2700 may be utilized to influence or control interface element 2726, such as for selecting between sections 2726a-c of the interface element.

In FIG. 27D, section 2726b of interface element 2726 is displayed (e.g. by a display of a device “running” interface 2720) in interface 2720, indicating that the section is selected, whereas sections 2726a,c may not be displayed (dashed lines illustrated in the figure depicting sections of interface element 2726 which are not displayed). FIG. 27D may show interface 2720, and specifically interface element 2726, correspondingly to a rotated position of section 2702 of device 2700 as shown in FIG. 27A. Accordingly, when bulge 2710 occupies a gap between bumps 2708a and 2708b, section 2726b may be selected and displayed in interface 2720 (such as in case device 2700 is communicating with a device which includes a touch-screen which displays interface 2720). Alternatively, when bulge 2710 occupies a gap between bumps 2708a and 2708b, section 2726b may be selected but not displayed in interface 2720, in addition to the other sections of interface element 2726 not being displayed (yet not being selected, as opposed to section 2726b).

In FIG. 27E, sections 2726a-c may be displayed in interface 2720. Preferably, when sections 2726a-c are displayed in the interface, it may be indicated in the interface which section from sections 2726a-c is selected, such as by being visually enlarged, or such as by being marked visually. In FIG. 27E, section 2726b is shown as selected (illustrated as black, as opposed to the other sections), whereas the section may preferably be indicated to be selected. Further shown in FIG. 27E is section 2726a ready to be selected, whereas an indication 2728 is shown indicating that section 2726a is ready to be selected. Similarly to the described above for FIGS. 27D and 27A, FIG. 27E may show interface 2720, and specifically sections 2726a-c, correspondingly to a rotated position of section 2702 of device 2700 as shown in FIG. 27B. Accordingly, when section 2702 is rotated such that switch 2606b is influenced by bump 2708b, section 2726b may be selected (such as correspondingly to bulge 2710 occupying a gap between bumps 2708a and 2708b, similarly to the shown in FIG. 27A which also correspond to section 2726b being selected), whereas section 2726a may be in a specific state (herein “semi-selected” state) different than a selected state and an unselected state, and optionally be indicated to be ready to be selected (Or otherwise indicated to be n said “semi-selected” state). In other words, when section 2702 is “half-pushed” or “half-pulled” from a position shown in FIG. 27A to a position shown in FIG. 27B, section 2726b may be selected, whereas section 2726a may be in a “semi-selected” state and optionally indicated to be in said “semi-selected” state. Note that in some embodiments, alternatively to the shown in FIG. 27E, when section 2702 is “half-pushed” or “half-pulled” to a position shown in FIG. 27B, only sections 2726a,b may be displayed in interface 2720, whereas the rest of the sections of interface element 2726 (i.e. section 2726c) may not be displayed.

In FIG. 27F, section 2726a of interface element 2726 is displayed in interface 2720, indicating that the section is selected, whereas sections 2726b,c may not be displayed (dashed lines illustrated in the figure depicting sections of interface element 2726 which are not displayed). FIG. 27D may show interface 2720, and specifically interface element 2726, correspondingly to a rotated position of section 2702 of device 2700 as shown in FIG. 27C. Accordingly, when bulge 2710 occupies a gap between bumps 2708b and 2708d, section 2726a may be selected and displayed in interface 2720 (alternatively, as opposed to the shown in FIG. 27F, section 2726a may be selected but not displayed).

Following the above, a finger-worn device of the invention may be operated to select interface elements or sections thereof, and to “semi-select”, or prepare for selection, interface elements, or sections thereof. Otherwise, a finger-worn device of the invention may be operated to set interface elements, or sections thereof, to any of a selected state, and unselected state and any other state which is not said selected state or said unselected state. Note that it is made clear that such finger-worn devices may include a control which can be repositioned to any number of positions (e.g. a rotatable section which can be repositioned to any number of rotated positions), for facilitating setting states of any number of interface elements, or sections thereof, each of which may correspond to each of said any number of positions.

FIG. 27G shows a method 2730 of the invention, in accordance with the described for FIGS. 27A through 27F.

At a step 2732, a finger-worn device is “half-pressed”, which may refer to a finger-worn device, or a section thereof (e.g. a control), being operated (or specifically repositioned) to a limited extent (e.g. being “half-pushed”, “half-pulled” or “half-tilted”, as described above). Otherwise, said finger-worn device (or a section thereof) may be operated at step 2732 in any specific manner (also “way”). For example, a finger-worn device may include a touch surface (i.e. a surface which can sense touch, see ref. touch-surface 714 in FIGS. 7C through 7E) on which a thumb may slide in a certain direction (see e.g. gesture 730a in FIG. 7E).

In some methods, at a step 2734, consequently to step 2732 (e.g. by input being registered from an operation performed in step 2732), any of a first and second interface elements may be displayed. Otherwise, the displaying of any number of interface elements may be prompted at step 2734, as a result of step 2732. Note that it is made clear that in some methods, the displaying of any of said first and second interface elements and any other interface element may not be prompted.

In some methods, at a step 2736, consequently to step 2732, the state of the first interface element (as mentioned for step 2734) may be changed. In other words, a state in which the first interface element was in before step 2732 was performed may be changed to a different state.

In some methods, at a step 2738, the finger-worn device from step 2732 is fully pressed, which may refer to the finger-worn device, or a section thereof, being operated to a greater extent than the aforementioned limited extent mention for step 2732. Otherwise, the finger-worn device may be operated at step 2738 in any manner different from the specific manner mentioned for step 2732. For example, whereas at step 2732 a finger may slide on a touch surface of the finger-worn device in a specific direction, at step 2738 said finger may slide on said touch surface in an opposite direction.

In some methods, at a step 2740, consequently to step 2738, the state of the first interface element (mentioned for step 2736 and step 2734) may be further changed to another state. In other words, a state in which the first interface element was in before step 2740 was performed may be changed to a different state (which may also be different than the state the first interface element was in before step 2732 was performed). For example, the first interface element may be in a first state before the finger-worn device (mentioned for method 2730), or a section thereof, was operated, whereas by performing step 2732, the state of the first interface element may change to a second state, and whereas by performing step 2740, the state of the first interface element may change to a third state.

In some methods, at a step 2742, consequently to step 2738, the state of the second interface element (mentioned for step 2734) may be changed. In other words, a state in which the second interface element was in before step 2738 was performed may be changed to a different state. For example, the second interface element may have been in a “selected” state, before step 2738 was performed, whereas by performing step 2738, the state of the second interface element may change to an “unselected” state. Similarly and following the above, the first interface element may have been in an “unselected” state before step 2732 was performed, whereby performing step 2732, the state of the first interface element may change to a “semi-selected” state (as described above for FIGS. 27D through 27F). In some methods (for the same example), by performing step 2738, the state of the first interface element may change to a “selected” state.

FIG. 27H shows a method 2750 of the invention, generally in accordance to the described for FIGS. 27A through 27F and to the described for FIGS. 25E through 25G.

At a step 2752, a finger-worn device is operated in a first manner. Similarly to the described for finger-worn devices of the invention, operating said finger-worn device in said first manner may refer to operating (or specifically repositioning) said finger-worn device, or a section thereof, to a limited extent. Note that it is made clear that in some methods, said first manner may be any manner, not necessarily an operation to a limited extent.

In some methods, at a step 2754, consequently to step 2752, an interface element may be selected. Otherwise, the state of said interface element may be changed at step 2752 (e.g. from an “unselected” state to a “selected” state). Accordingly, note that selecting an interface element at step 2752 may refer to changing the state of said interface element, specifically from a state in which said interface element was before step 2752 was performed, to a different state. Said interface may be any interface or program element known in the art, such as an option in an options menu, or a file in a folder.

In some methods, at a step 2756, consequently to step 2752, an interface element (or any visual representation thereof) may be displayed, such as by a touch-screen or by any other display known in the art. Said interface element may be the interface element mentioned for step 2754 and/or any number of other elements (e.g. a tool-bar, or a section thereof, in which the interface element may be a tool). Optionally, at step 2756, an indication of the interface element mentioned for step 2754 being selected or changing between states, may be displayed, in addition to displaying the interface element (and/or any number of other elements).

Note that it is made clear that in some methods, an interface element may be displayed (step 2756) without said interface element, or any other element, being selected or changing between states (step 2754). For example, by performing step 2752, a virtual keyboard (as an exemplary interface element) may be displayed.

Further note that it is made clear that in some methods, an interface element may be selected, or the state of which may be changed, at step 2754, while additionally the same interface element, or a visual representation thereof, may be displayed (optionally in addition to any number of other interface elements) at step 2756. In some methods, an indication of said same interface element (or visual representation thereof) being selected to changing to a different state, may be displayed, in addition to displaying said same interface element.

In some methods, at a step 2758, consequently to step 2752, a function is initialized (or “activated”). Said function may be related to touch input or to gesture recognition (or input registered from gesture recognition). For example, said function may be applied to any interaction performed with a touch-screen. For another example, said function may be applied to any hand gesture performed (such as by a user of the finger-worn device mentioned for step 2752), sensed and recognized (such as by a gesture recognition system). For a more specific example, by said function being initialized (step 2758), touch input may be registered and/or processed correspondingly to said function, such as for facilitating a certain feature of said function. For another specific example, said function may be activated at step 2758, so that any input registered from performing hand gestures may be for executing said function correspondingly to variables obtained by said hand gestures being recognized.

In some methods, at a step 2760, a touch-screen may be touched (whereas the touching of said touch-screen may be detected by said touch-screen), or otherwise touch input may be registered. In other methods, at a step 2762, a hand or finger may be performing a gesture (whereas said gesture may be sensed, such as by a light sensor, or specifically camera), or otherwise input may be registered from gesture recognition (of a performed hand or finger gesture). Accordingly, method 2750 may pertain to touch interactions (i.e. operations performed on a touch-screen, specifically by touching a touch-screen) or to gesture recognition interactions (i.e. interactions facilitated by sensing and recognizing gestures, specifically hand or finger gestures).

In some methods, at a step 2764, the function mentioned for step 2758 (at which the function was initialized) may be executed, specifically corresponding to touch input from step 2760 or to gesture recognition (i.e. input from a gesture, or plurality thereof, being recognized) from step 2762. Otherwise, at step 2764, the function may be applied to touch input (step 2760) or to gesture recognition (step 2762). For example, the function may be set to an “active” state (or otherwise “may be activated”) at step 2758, so that any touch input or recognition of a gesture may provide variables for executing the function while it is activated (at step 2764). For a more specific example, a finger may be touching a touch-screen or performing a pointing gesture towards a gesture recognition system (see e.g. gesture recognition system 2100 in FIGS. 21A through 21E), whereas output (from said touch-screen or from said gesture recognition system) may be determined according to said touching or said pointing gesture, and according to features of the function which was initialized at step 2758.

In some methods, at a step 2772, operating of the finger-worn device (or section thereof), as described for step 2752, may cease (or “stop”). Otherwise, at step 2772, the finger worn device mentioned for step 2752 may be operated in a manner which is different from the first manner mentioned for step 2752 and from a second manner as described below for step 2766. For example, operating a finger-worn device at step 2752 may prompt said finger-worn device, or a section thereof, to be repositioned from a first position to a second position (e.g. from a default position to a “half-pressed” position), whereas at step 2772, said finger-worn device, or a section thereof, may be repositioned from said second position back to said first position (e.g. from a “half-pressed” position to a default position), therefore stopping an operation on said finger-worn device which was performed at step 2752. For another example, operating a finger-worn device in the first manner mentioned for step 2772 may be continuous, such as applying pressure (e.g. pushing) on a section of the finger-worn device, whereas at step 2772, the finger-worn device may stop being operated in the first manner, such as by removing pressure (e.g. not pushing) from said section.

Note that it is made clear that following the above, and referring to the described herein, operating a finger-worn device may be a continuous operation (e.g. holding pressure on a section of a finger-worn device) or any number of operation instances which result in said finger-worn device, or a section thereof, being in the same state (or specifically position) or in a different state (or specifically position) than before said finger-worn device was operated.

In some methods, at a step 2774, consequently to step 2772, the function mentioned for steps 2758 and 2764 may be finalized (as described below for a step 2768). In other methods, at a step 2776, consequently to step 2772, the function mentioned for steps 2758 and 2764 may be cancelled, such as by discarding (or “neglecting”, or “erasing”, or “deleting”) the result (or plurality thereof) of the function. For example, a process or interface event (as an exemplary execution of a function) performed at step 2764, optionally initiated by performing step 2752 and/or step 2758, and by performing step 2760, may be concluded by performing step 2772, whereas conclusion of said process or interface event may be either the stopping of and discarding the results of said process or interface event, or the finalizing of said process or interface event.

Note that it is made clear that consequently to step 2772, the function mentioned for steps 2758 and 2764 may simply be stopped, without being finalized or cancelled, such as at a step which may be included in some methods of the invention yet is not shown in FIG. 27H.

For an example which may refer to steps 2774 and 2776, a section of a finger-worn device may be “half-tilted” by a thumb and may be held in a “half-tilted” position by said thumb while a finger points towards an interface element displayed on a display, for executing a function which corresponds to said “half-tilted” position (in case appropriate input is registered by said section being “half-tilted” and held in said “half-tilted” position) and to a gesture of said finger pointing towards said interface element (in case appropriate input is registered by a gesture recognition system). For the same example, releasing said section from said “half-tilted” position, such as by a thumb being removed from contact with said section, for finalizing said function (step 2774) or for cancelling said function (step 2776).

In some methods, at a step 2778, consequently to step 2772, the interface element mentioned for step 2754 may be deselected. Otherwise, the state of the interface element may be changed at step 2778 from a state in which the interface element was before step 2772 was performed. For example, an interface element may be selected at step 2754, by performing step 2752, whereas selecting said interface element may be for initializing a function at step 2758 which corresponds to said interface element, such as in case said interface element is a tool and said function is a procedure of operations corresponding to said tool. While said interface is selected, said function may be executed when touch is detected or when a gesture is recognized. For the same example, said interface element may be deselected at step 2778, by performing step 2772, whereas deselecting said interface element may be for finalizing or canceling any results from said function being executed, and whereas optionally said function optionally cannot be executed until said interface element is selected again, such as by performing step 2752 again.

In some methods, at a step 2780, consequently to step 2772, the interface element (or any visual representation thereof) mentioned for step 2756 may be hidden, or similarly removed from a display, or stop being displayed. For example, performing step 2752 may be for displaying an interface element (step 2756) so that a user may interact with said interface element, such as by touching a touch-screen where said interface element is displayed), whereas it may be desired to hide said interface element when said user is not interacting with it, in which case step 2772 may be performed for hiding said interface element (which optionally may not be interacted with when hidden).

Note that it is made clear that in some methods, the interface element mentioned for steps 2756 and 2780 may be the same interface element mentioned for steps 2754 and 2778, so that selecting (step 2754) and deselecting (step 2778) the interface element (or otherwise changing states of the interface element, as described for steps 2754 and 2778) may be for displaying (step 2756) and hiding (step 2780) the interface element, or any visual representation thereof.

In some methods, at step 2780, additionally or alternatively to the described above for step 2780, and in accordance with the described for step 2756, in case the interface element mentioned for steps 2754 and 2778 is the same interface element as mentioned for steps 2756 and 2780, an indication of the interface element being deselected (step 2778), or otherwise changed from one step to another (as further described for step 2778), may be displayed. Said indication may optionally remain displayed until otherwise directed (such as by an interface), or alternatively remain displayed for a certain amount of time (preferably brief), so that a user may receive said indication yet said indication will not continue to intrude by being displayed and “taking up” display space.

In some methods, at step 2766, the finger-worn device (mentioned for step 2752) may be operated in a second manner (as opposed to the first manner mentioned for step 2752). Similarly to the described for finger-worn devices of the invention, operating said finger-worn device in said second manner may refer to operating (or specifically repositioning) said finger-worn device, or a section thereof, to a greater extent than the extent to which said finger-worn device (or a section thereof) may have been operated at step 2752 (at which said finger-worn device may have been operated to a limited extent, as an exemplary first manner mentioned for step 2752). Note that it is made clear that in some methods, said second manner may be any manner, not necessarily an operation to an extent greater than the aforementioned limited extent.

In some methods, at step 2768, the function mentioned for steps 2758 and 2764 may be finalized, such as approved or rendered (or otherwise “stopped” or “deactivated”). Otherwise, a result (or plurality thereof) from the function being executed (step 2764) may be set to a different state than the state in which said result was before step 2766 was performed (e.g. from a “temporary” state to an “approved” state). For example, the function may result in an interface element being temporarily or partly formed or created, such as a file (which may have a visual representation) or a graphic symbol, which may be displayed where a finger touches a touch-screen or where a finger is pointing to (in case said finger is pointing to a display). For the same example, if step 2766 is performed, said interface element may be permanently or completely formed or created, such as by changing to a different state, or such as by an interface (in which said interface element may be formed or created) performing an operation for completely or permanently integrate said interface element.

In other methods, by performing step 2766, the function mentioned for steps 2758 and 2764 may be cancelled, as described for step 2776, or otherwise stopped as described above. This may be alternatively to performing step 2768 consequently to step 2766. Accordingly, in some methods, stopping operating a finger-worn device (or operating a finger-worn device to return it, or a section thereof, to an original or default state or position) as described for step 2772, may be for finalizing the function, whereas changing how said finger-worn device is being operated (or specifically operating said finger-worn device to a greater extent than previously operated) may be for cancelling or stopping the function.

In some methods, consequently to step 2766 (and optionally after step 2768), any sequence of any number of steps similar to steps 2754, 2756, 2758, 2760, 2762, 2764, 2772, 2774, 2776, 2778 and 2778 may be performed, for other interface elements and/or for another function (than the described for steps 2754, 2756, 2758, 2764, 2774, 2776, 2778 and 2780). For example, by operating a finger-worn device in a first manner (step 2752), a first function may be initialized (step 2758) and executed (step 2764), such as correspondingly to touch on a touch-screen (step 2760), whereas by operating said finger-worn device in a second manner (step 2766), said first function may be finalized (step 2768) and a second function may be initialized (in a step similar to step 2758, yet referring to said second function), such as for being executed (in a step similar to step 2764, yet referring to said second function) by touch on a touch-screen (in a step similar to step 2760). For the same example, by operating said finger-worn device in a third manner (as described for step 2772), said second function may be finalized (in a step similar to step 2774, yet referring to said second function) or cancelled (in a step similar to step 2776, yet referring to said second function).

In some methods, at a step 2770, consequently to step 2766, the interface element mentioned for step 2754 may change between states (also “may change from one state to another”), such as from a state in which the interface element was after step 2752 was performed, to another state. Optionally, the interface element may be deselected at step 2770, such as by changing from a “selected” state (which may have been set at step 2654 which described the interface element being selected) to a “deselected state” (similarly to the descried for step 2778.

In some methods, at a step 2782, consequently to step 2766, the interface element mentioned for step 2756 may be hidden, or removed from a display, or stop being displayed, similarly to the described for step 2780. Further similarly to the described for step 2780, in case the interface element mentioned for step 2754 is the same interface element as mentioned for step 2756, an indication of the interface element being deselected (optionally at step 2770), or otherwise changed from one step to another (as further described for step 2770), alternatively or additionally to the interface element being hidden or removed from a display.

FIG. 28A shows an embodiment of the invention as a finger-worn device 2800. Device 2800 generally includes user-operated controls 2802 and 2804 (i.e. controls operable by a user). Controls 2802 and 2804 can be operated by a thumb of a hand, on a finger of which device 2800 is worn (see e.g. thumb 234 of hand 230 suggested to operate device 2800 as worn on finger 232, as shown in FIG. 28B). Additionally, controls 2802 and 2804 may be any elements of device 2800 which facilitate registering input. For example, controls 2802 and 2804 may be a couple of buttons, or switches that can be pressed to be activated and released to be deactivated.

FIG. 28B shows a system 2810 of the invention which may include device 2800 and a touch-screen 2820. In the figure, device 2800 is shown worn on finger 232 of hand 230, whereas hand 230, specifically finger 232 of the hand, is shown interacting with touch-screen 2820 on which an object 2822 is displayed.

Object 2822 may be an interface element, as described herein, such as a graphic symbol of a tool representing a function which can be executed by interacting with touch-screen 2820 where said graphic symbol is displayed, or such as a progress bar (e.g. a visual bar of progress of a files compression process), a so-called “window”, a cursor or a so-called “drop-down” menu. Note that it is made clear that object 2822 may be included in an interface displayed by touch-screen 2820, similarly to the described above for interface elements in interfaces. Further note that it is made clear that touch-screen 2820 may be included in a device, such as by being utilized as means for input and output for said device. For example, touch-screen 2820 may be included in a portable gaming console which utilizes touch-screen 2820 for interacting with games (as exemplary interfaces). For another example, touch-screen 2820 may be included in a portable digital assistant (PDA) which utilizes the touch-screen for interacting with content. For yet another example, touch-screen 2820 may be included in a mobile-phone which utilizes the touch-screen instead of keys.

Note that it is made clear that device 2800 can communicate with a device which includes touch-screen 2820. For example, device 2800 may include a communication unit (see e.g. communication unit 718 of device 710 in FIGS. 7C and 7D) which can communicate signals (e.g. communicate input or indications of which state device 2800 is in) to a communication unit included in a device which also includes touch-screen 2820. For another example, device 2800 may be sensed by sensing means (see e.g. sensing means 2122a of system 2120 in FIG. 21A) included by a device which also includes touch-screen 2820. For a more specific example, controls 2802 and 2804 may control (by being operated) a passive transponder (i.e. an apparatus which is not directly connected to a power source, yet which can modulate signals from an external source, such as a radio-frequency identification (RFID) circuitry or microcontroller) which can modulate signals generated by a unit of a device which includes touch-screen 2820, whereas modulated signals may be sensed by a sensor of said device, to obtain information about how controls 2802 and 2804 are being operated.

In some embodiments, a user (a user of which hand 230 is a hand of) can specifically interact with object 2822 by touching the object as it is displayed by touch-screen 2820 (i.e. touching a location on a surface of the touch-screen whereat the object is displayed). For example, a user may “drag” (as known for drag functions in user interfaces) the object from where it is displayed to another location by touching touch-screen 2820 with finger 232, specifically by touching where the object is displayed by the touch-screen and then by dragging the finger on the touch-screen (for a so-called “tap and drag” operation) to said another location.

In some embodiments, operating any or both of controls 2802 and 2804 may be for changing states of device 2800. Optionally, touching object 2822 (i.e. touching touch-screen 2820 where the object is displayed), may be for prompting a different interface or program event or executing a different interface or program function, depending on different states of device 2800. For example, thumb 234 may operate (e.g. click on) control 2802 while finger 232 may simultaneously touch touch-screen 2820 where object 2822 is displayed, for deleting (as an exemplary function or event) the object. Similarly, thumb 234 may operate control 2804 while finger 232 may simultaneously touch touch-screen 2820 where object 2822 is displayed, for initiating a program or folder which is represented by the object (or otherwise “which corresponds to the object”). Accordingly, controls 2802 and 2804 may be utilized for setting context for touch input in touch-screen 2820, or specifically context for touch input related to object 2822 (i.e. input registered by touching the touch-screen where the object is displayed). For example, controls 2802 and 2804 may be operated, for performing different interactions by touching the touch-screen. For a more specific example, controls 2802 and 2804 may serve as “Shift” and “Alt” keys or “Tab” and “Ctrl” keys, similarly to such keys on a keyboard which are commonly utilized in collaboration with using a computer mouse, such that clicking each of such keys while clicking on a computer mouse button, and/or while moving said computer mouse, may be for executing different functions (e.g. executing a so-called “shift-click” function when a computer mouse button is clicked while a “Shift” key is held clicked, and executing a so-called “alt-click” function where a computer mouse button is clicked while a “Shift” key is held clicked). For another specific example, operating control 2802 while touching object 2822 may be for “cutting” (referring to a common “cut” function of operating systems, similarly to clicking “Ctrl” and “X” keys on a keyboard) a file represented by the object, whereas operating control 2804 while touching another location on a display of touch-screen 2820 (i.e. a location where object 2822 is not displayed) may be for “pasting” a file (supposedly a file previously “cut”) to said location (similarly to a common “paste” function associated with a location of a mouse cursor and executed by clicking “Ctrl” and “V”).

In some embodiments, specific interface (or program) elements, or interface (or program) events (e.g. of an interface displayed by touch-screen 2820), may be assigned to any of controls 2802 and 2804 of device 2800, for determining which interface (or program) event is prompted, or which function is executing, when a touch-screen 2820 is touched, and/or for determining which interface (or program) element is controlled when touching the touch-screen. Accordingly, a user may choose which interface or program element, or which interface or program event, is associated with any of the controls. For example, a “copy-paste” function (the executing of which may be an exemplary interface or program event) may be assigned to control 2802 (such as by selecting a function from a list of functions to be assigned to the control), whereas when a finger (preferably the finger wearing device 2800) touches an object displayed on touch-screen 2820 while control 2802 is operated by thumb 234, said object may be copied, and whereas when said finger touches a different location on the touch-screen while the thumb is operating the control, said object may be pasted to said different location (supposing the object was previously copied). Similarly, a user may assign a different function (e.g. a “delete” function) to control 2802, so that when the aforementioned finger touches the aforementioned object while control 2802 is operated, said different function is performed on the object.

Following the above, controls of a finger-worn device of the invention may be associated with (otherwise “contextual to”) touch on a touch-screen, so that specific interface reactions (e.g. interface events), which correspond to operating said controls, may be prompted by operating said controls. This may be beneficial for interacting with a touch-screen without a keyboard and/or without a computer mouse, such as for simulating so-called “keys shortcuts”, as known in the art for combination of keys associated with specific functions. This may also be beneficial because a finger-worn device is readily accessible to fingers performing interactions with a touch-screen.

In some cases (e.g. in some interfaces, or in some states of an interface of the invention), controls 2802 and 2804 may be operated before touching touch-screen 2820, such as by clicking on one or both of the controls before touching touch-screen 2820, for setting context for input registered after operating the controls. Accordingly and following the above, a finger-worn device of the invention (e.g. device 2800) may have different states (e.g. input positions of a rotatable section, see e.g. rotated positions of section 702 of device 700, as previously described), whereas said finger-worn device may be set to a specific state before touching a touch-screen, so that when touching said touch-screen, input, which corresponds to said specific state, may be registered. For example, when operating device 700 (see ref. FIGS. 7A and 7B) in collaboration with touch-screen 2820, a user may rotate section 702 of device 700 to a first input position, so that any subsequent touch on the touch-screen may be for registering an input contextual to said first input position. Similarly, said user may rotate section 702 to a second input position, so that any subsequent touch may be for registering an input contextual to said second input position of the section.

In other cases, controls 2802 and 2804 may be operated while touching a touch-screen or after touching a touch-screen, such as operating while a finger is already touching said touch-screen. For example, a user may touch touch-screen 2820 and “drag” an object from a certain location to another location, and only then operate control 2802 or control 2804 (or both) for executing a certain function on said object, while still touching the touch-screen on the location where the object was dragged to. For another example, a user may touch touch-screen 2820 with finger 232 wearing device 2800, and then, without removing the touch of the finger on the touch-screen, click on control 2802 or control 2804 twice (also “double click”) with thumb 234 (in case the controls are buttons or keys), alternatively to tapping twice (also “double tap”) on the touch-screen with finger 232, so that finger 232 may remain in contact with the touch-screen during the “double clicking”. This may be beneficial when interacting with small touch-screens, wherein visuals displayed on a touch-screen might be very small and hard to interact with, so that when a finger is already “on” (i.e. touches) a certain displayed object, it may be preferable that said finger is not removed from the touch-screen while further interacting with anything displayed where the finger touches.

In FIG. 28B, object 2822 is shown having a size 2822a when finger 232 is touching touch-screen 2820 where the object is displayed. In some cases, when the touch-screen is not touched where object 2822 is displayed, object 2822 may have a size 2822b (illustrated in FIG. 28B by a dashed outline), which may be smaller than size 2822a. Accordingly, by touching touch-screen 2820 where the object is displayed, the object may be “magnified” to size 2822a from its original size, i.e. size 2822b (e.g. size 2822b being a default size for the object when not touched). Additionally, controls 2802 and 2804 may be operated while finger 232 is touching the touch-screen where object 2822 is displayed. Accordingly and following the above, different functions may be performed on object 2822 by operating any of the controls, while the object remains in size 2822a as the location where the object is displayed is touched by finger 232. Such interaction sessions (i.e. operating controls of a finger-worn device while touching an object as it is displayed on a touch-screen) may be beneficial for when it is preferred for a displayed object (e.g. object 2822) to remain in an enlarged size (e.g. 2822a). For example, a user may choose an application represented by object 2822 by touching touch-screen 2820 with finger 232 and dragging the finger (i.e. moving while touching) to where the object is displayed, whereat the object is “magnified” from its original size (i.e. size 2822b) to size 2822a when the finger reaches the location where it is displayed. The touch-screen may be a small touch-screen wherein displayed objects are also small and may be hard to touch with precision, and so touching specific objects may be facilitated by a “magnifying” function as described above for changing the size of object 2822. For another example, a user may wish to perform certain interactions with a chosen object (e.g. executing functions applied on a chosen object), whereas an object may be chosen only when touched. Accordingly, said user must not remove a finger touching said chosen object (i.e. touching where said chosen object is displayed) because then the object will not be chosen, whereas performing a certain interaction may be facilitated by the user operating device 2800 (e.g. by operating controls 2802 and 2804) while still touching the object. For a more specific example, a user may browse through a tool-bar (as an exemplary object) displayed on touch-screen 2820 without removing a finger from the surface of touch-screen 2820, by operating control 2802 with thumb 234 (e.g. sliding the thumb on the control, in case the control is sensitive to touch, such as by being a touch sensor) while still touching the touch-screen (preferably where said tool-bar is displayed) with said finger. Similarly, said user may close said toolbar by operating control 2804 with thumb 234 while still touching the touch-screen.

Following the above, a finger-worn of the invention may serve and an input device for interactions with touch-screens, whereas input associated with different locations in an interface may be registered from sensing touch (as opposed, for example, to navigating an interface with a computer mouse), and whereas input associated with different functions may be registered from operating said finger-worn device.

Note that similarly to the described herein for sizes of a displayed object (such as described for a “magnifying” function), any state of a displayed object (e.g. its colors, orientation, shape, etc.) can be set (otherwise “can be chosen from a plurality of possible states”) by operating a finger-worn device in collaboration with a touch-screen in methods described herein.

In some cases, touching touch-screen 2820 may substitute controlling a cursor (as known for computer mouse cursors) by any other means and/or methods (e.g. by operating a computer mouse). Accordingly, said cursor may be displayed on touch-screen 2820 wherever the touch-screen is touched by a finger. For example, touching an object displayed on a touch-screen (e.g. a link, or hyperlink in a web-page) may be for prompting a so-called “roll-over” reaction (similar to moving a mouse cursor over an object in some GUIs), such as to display information about said object (e.g. displaying a so-called “tool-tip”). In such cases, operating controls of a finger-worn device of the invention, while touching a touch-screen at a certain location, may be similar to operating controls of a computer mouse (e.g. buttons or a scroll-wheel) while a mouse cursor is at a certain location, such as for performing a so-called “right click”, “left click” or “click and hold” functions associated with said certain location on said touch-screen (i.e. where the touch-screen is touched). Accordingly, whereas operating a computer mouse may correspond to a location of a mouse cursor (on a display, or in a GUI), operating a finger-worn device may correspond to a location on which a touch-screen is being touched. For another example, a user may slide a finger on tools in a tool-bar (where it is displayed on a touch-screen), for displaying information about each tool, similarly to moving a cursor over a tool-icons and displaying “tool-tips”. Said user may wish to choose a specific tool, in which case said user may click twice on a control which is included in a finger-worn device, while still touching said specific tool (e.g. with a finger wearing said finger worn device). For yet another example, a user may wish to move a displayed object from a first location in an interface on a touch-screen, to a second location, without dragging a linger on said touch-screen. According, said user may touch said displayed object at said first location while touching a control of a finger-worn device (with another finger, e.g. a thumb of the same hand as a finger touching said displayed object), after which said user may remove touch from said touch-screen yet still hold touch on said control, for notifying the aforementioned interlace that further touch on said touch-screen is still associate with said displayed object. Then, said user may touch said second location and remove touch from said control, for “placing” said object at said second location.

Following the above, it is to be made clear that the disclosed herein describes how certain finger-worn devices may be used as input devices in collaboration with touch-screens, or in addition to interacting with touch-screens. Operating such finger-worn devices may be alternative to interactions that are known to be performed by touch on a touch-screen, and/or may enhance (or “improve”) certain interactions by being performed in addition to (or “collaboratively with”) interacting with touch-screens by touch.

Note that the described for operating a control, or plurality thereof, of a finger-worn device may also refer to operating said finger-worn device itself, such as in case said finger-worn device may be operated without including controls. For example, a finger-worn device may include a single section which can be rotated around a finger, without including any control (detection of rotation may be facilitated by a motion sensor located facing the finger wearing said finger-worn device, and sensing rotation relative to the finger).

Note that whereas the described for FIGS. 28A and 28B refers to a couple of controls (i.e. controls 2802 and 2804) which can be operated by a user wearing a finger-worn device of the invention (i.e. device 2800), it is made clear a finger-worn device of the invention may include any number of controls (also “input elements”). For example, a finger-worn device of the invention may include three buttons, alternatively to controls 2802 and 2804, each of the buttons acting similarly to so-called “keys shortcuts” on a keyboard, such as “Ctrl+C” (i.e. the simultaneous pressing of the keys “Ctrl” and “C” on a keyboard for a “copy” function). For another example, a finger-worn device of the invention may include a rotatable section in which four different rotated positions of said rotatable section (also “input positions”) substitute each of the following suggested states in device 2800: control 2802 activated, control 2804 activated, controls 2802 and 2804 both activated and controls 2802 and 2804 both deactivated.

FIG. 28C shows a system of the invention similar to system 2810. In FIG. 28C there is shown a finger-worn device as a device 2840 similar to device 2800, and a touch-screen 2850 similar to touch-screen 2820. Device 2840 is shown worn on finger 232 of hand 230, while it is made clear that finger 232 (and any other finger of hand 230) does not touch touch-screen 2850, yet is in close proximity to the touch-screen, or specifically to the surface of the touch-screen where visuals are displayed. In FIG. 28C, touch-screen 2850 can sense device 2840 when device 2840 is within a certain range (or “certain distance”, or “certain proximity”), such that when device 2840 is close to (or “near”) the touch-screen, the location of device 2840 along (or “relative to”) the touch-screen (illustrated a location 2842 as a dashed circle in the figure, for depiction purposes only) can be detected. Device 2840 can be sensed remotely (i.e. sensed while not in direct or indirect contact with touch-screen 2850) by any means known in the art for detecting positions (see e.g. U.S. Pat. No. 4,890,096), which may be included in a device which also includes touch-screen 2850, so that it is not required for the device to come in contact with the touch-screen for detecting the location of the device relative to the surface of the touch-screen (e.g. the location of the device along a two dimensional (2D) matrix mapping the surface of the touch-screen, and which corresponds to a GUI displayed by the touch-screen).

In some embodiments, additionally to detecting the location of device 2840 relative touch-screen 2850, the direction of device 2840 relative to the touch-screen (illustrated a direction 2848 by a dashed arrow in FIG. 28C) may be detected. The direction of the device may be generally the same direction as finger 232 when the device is worn on the finger and when the finger is straight (i.e. not folded or curled). Accordingly, detection of the direction of device 2840 at any given time may facilitate estimating the direction of a finger wearing the device (or otherwise “facilitate obtaining information about the direction of a finger wearing the device”). Detection of the location and direction (herein “position” for both values, i.e. for the location and direction) of device 2840 may be facilitated by any means known in the art (see e.g. U.S. Pat. No. 5,748,110).

In some embodiments, detecting the direction of device 2840 relative to touch-screen 2850 may be facilitates by device 2840 including indicators 2844 and 2846, each of which can indicate its location along touch-screen 2850, such as by actively generating signals (e.g. transmitting radio-frequency signals, or emitting light) or such as by being sensed (e.g. being passive RFID circuits). Indicators 2844 and 2846 may both be located along the length of device 2850, or otherwise along a virtual line crossing the device. Because it is well known that between two points there must be only one line, processing the locations of indicators 2844 and 2846 relative to each other (such as processing input register from each of the indicators indicating its location) may facilitate detecting (e.g. obtaining by geometric calculation processing) or estimating the general direction of device 2840. Processing of the locations of the indicators may process the locations as two points on a “virtual” line parallel to the length of device 2840. For example, an array of sensors may be included in a device which also includes touch-screen 2850, such as beneath a display mechanism of the touch-screen (e.g. an LCD panel), while indicators 2844 and 2846 may be included in device 2840, such that they are positioned in parallel to a finger wearing the device (i.e. located in such a way that a line may cross between them which is also aligned with the length of said finger). Accordingly, sensors of the aforementioned array of sensors can sense indicators 2844 and 2846 and detect their locations, so that the direction of the device can be calculated by computing said locations, and accordingly the general direction of a finger wearing device 2840 (supposing it is in a generally “straight” posture).

Note that detecting the general location of device 2840 relative to touch-screen 2850, and/or detecting the direction of device 2840 relative to the touch-screen (such as specifically by detecting the locations of indicators 2844 and 2846) may be facilitated by sensing means 2854 (illustrated by dashed lines in FIG. 28C) which may be included in the touch-screen, or in a device which also includes the touch-screen. Sensing means 2854 may be any sensing means known in the art which facilitate detecting locations, directions, and/or positions.

In some embodiments, supposing finger 232 (which may be wearing device 2840) is generally straight and spread-out horizontally “above” touch-screen 2850 (i.e. in front of the touch-screen and generally parallel the plane of the surface of the touch-screen), and provided the general length of finger 232 is known (together with the direction and location (or “position” for both direction and location) of device 2840, such as detected by means described above), an object (e.g. a cursor 2852 as shown in FIG. 28C) can be displayed by the touch-screen generally where the tip of finger 232 is located (i.e. on a display surface of the touch-screen, at a general area “above” which, or in front of which, the tip of the finger is located). In such cases, it is not required for finger 232 to touch touch-screen 2850 for cursor 2852 to be displayed on the touch-screen generally in front of where the tip of finger 232 is located. In FIG. 28C, cursor 2852 is shown displayed on touch-screen 2850 near the tip of finger 232 which is suggested to be position closely in front of the touch-screen but not touching the touch-screen. This may facilitated by estimating the general location of the tip of the finger relative to the touch-screen (e.g. calculated or estimated from detected values of the position of device 2840), in case the relevant values mentioned above (i.e. the length of finger 232 and the location and direction (also “position” for both values) of device 2840 relative to touch-screen 2850) are known, and supposing the finger is generally straight.

Following the above, it is to be made clear that the described herein discloses how by detecting the location and direction (or “position” for both location and direction) of a finger-worn device relative to a touch-screen (or specifically relative to the surface of said touch-screen), and by knowing the length of a finger on which said finger-worn device is worn, and supposing said finger is positioned as generally parallel and close to said touch-screen (or specifically to the surface of said touch-screen, and supposing said finger is generally straight, the general location of the tip of said finger can be estimated, such as for displaying an object (e.g. an interface element, or specifically a cursor) on said touch-screen generally near where said tip is located, without the finger required to actually touch the touch-screen. Accordingly, the hand of the aforementioned finger (or specifically the finger itself) can move along the aforementioned touch-screen and in front of the touch-screen without touching the touch-screen, while the aforementioned object (displayed generally near the tip of the finger) may move respectively to the movement of the tip of the finger. The tip of said finger may later touch the touch-screen (e.g. by slightly bending or curving towards the touch-screen) to interact with the aforementioned object, and/or with any interface element which may also be displayed where the tip of the finger is touching (in addition to the object, e.g. an interface element the object may be pointing to, such as in case the object is a cursor).

Note that any mentioning herein of a length of a finger wearing a finger-worn device of the invention refers to the general length (or “distance”) between said finger-worn device and the tip of said finger. In most of the figures described herein and showing a finger wearing a finger-worn device (except in FIG. 28I), said finger-worn device is shown worn on the “proximal phalanx” section of said finger (i.e. the section of the finger that is closest to the palm, or in other words the section that it is most common to wear a ring on). However, it is made clear that a finger-worn device may be worn on any other section of a finger (see e.g. device 2870 worn on the “intermediate phalanx” section, or “middle” section, of finger 232 in FIG. 28I) for similar results. It is also made clear that a length of a finger as described herein may refer to the length between a finger-worn device and the tip of a finger, even in case said finger-worn device is not worn on the farthest section of said finger from the tip of that finger (i.e. on the “proximal phalanx” section).

Further note that alternatively or additionally to an object (or plurality thereof) being displayed by a touch-screen at a location generally near where a tip of a finger wearing a finger-worn device is, it is made clear that any interface or program element, or any interface or program event, may be associated with said location, such as for executing functions correspondingly to the location, specifically on objects displayed at said location. More specifically, whereas the shown in FIG. 28C is a cursor (i.e. cursor 2852) displayed on touch-screen 2850 generally where the tip of finger 232 is located relative to the touch-screen, knowing the general location of the tip of the finger without the finger actually touching the touch-screen may facilitate other results and features. For example, objects displayed generally near the tip of finger 232, as the finger moves in front of and along touch-screen 2850 (i.e. very close to the surface of the touch-screen, passing in front of said objects when the finger moves), may be magnified, similarly to the described for object 2822 in FIG. 28B. Accordingly, by utilizing a finger-worn device of the invention as described above, a “magnifying” function may be facilitated, so that visuals displayed by a touch-screen may be magnified when the tip of a finger wearing said finger-worn device moves in front of their displayed location, or otherwise comes close to where they are displayed on a display surface of the touch-screen. The finger may then touch the touch-screen where said visuals are displayed, for interacting with said visuals as they are magnified.

Further note that it is made clear that by detecting the direction of a finger-worn device relative to a touch-screen (see e.g. direction 2848 of device 2840 in FIG. 28C), an object (or plurality thereof) displayed by said touch-screen, generally at a location where the tip of a finger wearing said finger-worn device is estimated to be, may be displayed in any desirable orientation relative to the direction of said finger-worn device, and accordingly relative to a general direction which said finger wearing said finger-worn device may be pointing to or directed towards. For example, by detecting the location of a finger-worn device along a touch-screen, and the direction of said finger-worn device worn on a finger of a certain length (which is preferably known), an arrow cursor may be displayed by said touch-screen, generally where the tip of said finger is estimated to be and pointing to the same direction of said finger-worn device and accordingly and generally of said finger. This may be facilitated by directing said arrow cursor (as an exemplary displayed object) to the same direction as said finger-worn device which, following the above, may be detected.

Further note that whereas the described herein for estimating the general location, relative to a touch-screen, of the tip of a finger wearing a finger-worn device of the invention, it is made clear that the general location of the tip of a finger wearing a finger-worn device relative to any device or system, or relative to a display thereof, may be obtained (or otherwise “estimated”) similarly to the described herein. For example, the general location of the tip of a finger wearing a finger-worn device relative to a display (which might not be able to sense touch) of another device may be estimated by said another device including sensing means 2854 (shown in FIG. 28C as optionally coupled to touch-screen 2850). Accordingly, a cursor may be displayed correspondingly to said general location (i.e. in a location on said display near where said tip is located), whereas interacting with displayed objects towards which said cursor is pointing may be by operating the aforementioned finger-worn device, alternatively to touching such objects as they are displayed on a touch-screen.

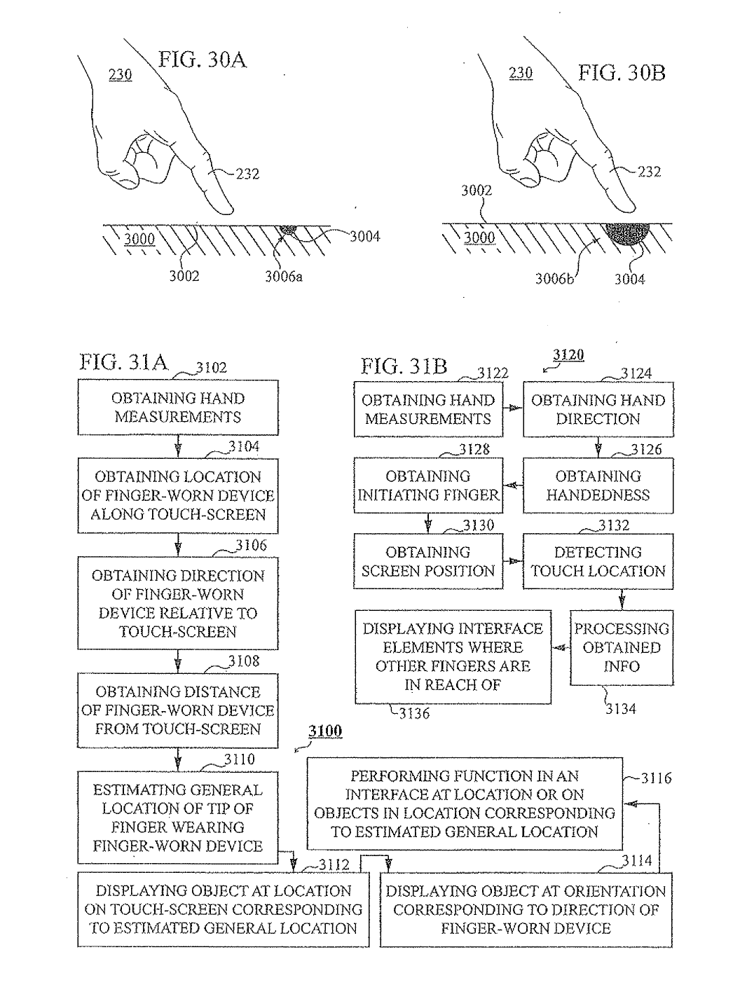

Following the above, any methods of the invention (see e.g. a method 3100 in FIG. 31A) described herein for obtaining (or otherwise “estimating”) and/or utilizing the general location of the tip of a finger wearing a finger-worn device relative to a touch-screen may additionally refer to such general location (i.e. general location of the tip) relative to any device or system which includes a display, specifically relative to said display.

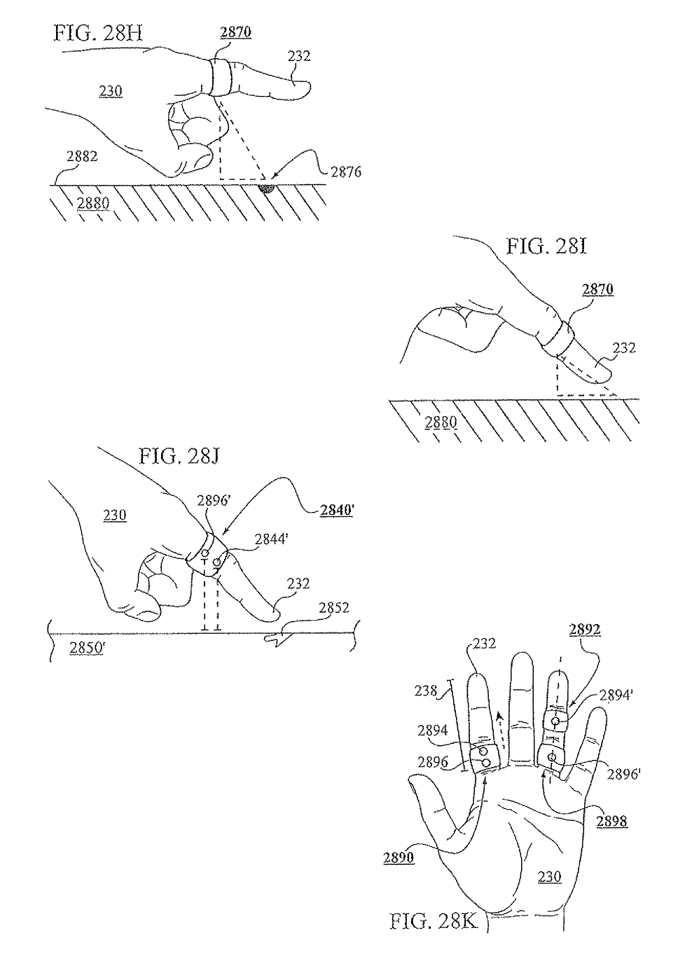

FIG. 28D shows a representation of a program 2860 by which a user can submit his/her hand (or specifically finger, or plurality thereof) measurements to a touch-screen device (i.e. to any device which includes a touch-screen), and/or certain preferences (see e.g. preferred direction of interaction as described for FIGS. 29A and 29B). Program 2860 may be a program (or “software”, or “application”), or otherwise a so-called “device-driver” or “hardware-driver”. Program 2860 may be utilizes for “calibrating” any interface displayed by a touch-screen according to the aforementioned measurements, and/or according to the aforementioned preferences, for facilitating results and features as described herein (e.g. as described for FIG. 28C). In other words, program 2860 may be utilized to obtain said measurements and said preferences so that said measurements and said preferences may be utilizes by any interface or program. In yet other words, submitting measurements of a hand (or specifically finger), and/or certain user preferences, to program 2860, may facilitate methods of the invention which require for such measurements (or values thereof) and/or such preferences to be known or obtained.

In FIG. 28D there is shown program 2860 including a hand outline 2862 which may be a visual element (or “displayed object”) which best represents the outline of a hand of a user, preferably the hand with which it is intended for said user to interact with an interface.

In some embodiments, a touch-screen on which outline 2862 is displayed (e.g. touch-screen 2850 shown in FIG. 28C) can sense and/or measure a hand of a user when said hand is placed on it, for obtaining measurement of said hand. Optionally, after said measurements have been obtained (by said touch-screen sensing said hand as it is placed on it, preferably where the outline is displayed), outline 2862 may be adjusted according to the obtained measurements of said hand, to best represent the outline of said hand (such as for visually indicating that measurements were measured properly). For example, a touch-screen may be able to detect touch by optical sensing means as known in the art (e.g. a camera may be positioned “behind” a display surface of said touch-screen), so that when a hand of a user is placed on said touch-screen where indicated by outline 2862, the touch-screen can process (also “analyze”) data from said optical sensing means (e.g. signals for a camera capturing images from “in front” of a display surface of the touch-screen) for obtaining the measurements of said hand (and optionally for adjusting outline 2862 according to the measurements). For another example, a touch-screen may include and utilize so-called “multi-touch” sensing means, such that when a hand is placed on a display surface of said touch-screen, said touch-screen can detect which areas of said display surface come in contact with said hand, and accordingly calculate (or “deduce”, or otherwise obtain by processing) the dimensional values (i.e. measurements) of said hand.

In some embodiments, a user may utilize an adjustment panel 2866 of program 2860 (as shown in FIG. 28D) for adjusting outline 2862 to best fit the measurements of a hand of said user. Adjusting outline 2862 may be by submitting measurements (also “dimensional values”) of said hand to program 2860, so that said measurements may be known to the program, and optionally to any interface or other program. For example, a user may interact with panel 2866 to enlarge outline 2862 to an outline 2864, as shown in the FIG. 28D (outline 2864 illustrated by a dashed outline). Panel 2866 may facilitate other adjustments to an outline, such as setting the measurements (or general size) of individual fingers, and/or browsing between different hand shapes (because different users may have different shapes of hands).

In some embodiments, a user may type, or submit by any other action (or by utilizing any other means) values (e.g. integers) of measurements of a hand of said user. For example, a program of the invention may include input “text fields” for receiving text (specifically digits) describing the length of each of the fingers of a hand. A user may “fill-out” said “text fields”, so that the lengths of the fingers are known for future interactions related to the fingers.

Note that whereas the described above for program 2860 generally refers to a hand of a user, it is made clear that the described may refer specifically to a finger, or plurality thereof, of a user. For example, it may be preferred for a device which includes a touch-screen, or for an interface thereof, to know the length of a finger of a user, with which it is intended for said user to interact with said touch-screen (whereas it might not be required to know any other measurement of a hand of said user), and so a program of the invention may be utilized, alternatively to utilizing program 2860 for obtaining an outline of an entire hand, for obtaining information only about the length of said finger.

Following the above, programs of the invention may be utilized by touch-screens to obtain measurements of a hand, or plurality thereof, or specifically of a finger, or plurality thereof, either by any sensing means, and/or by a user manually submitting said measurements. Information of measurements of hands or fingers (as obtained by any means or methods), may be utilized for interactions wherein it is required to know such information. Some such interactions are described herein. For example, as described above for displaying a cursor on a touch-screen without said touch-screen being touched (see e.g. cursor 2852 displayed on touch-screen 2850 shown in FIG. 28C), detecting the position of a finger-worn device (e.g. device 2840 as shown in FIG. 28C) at any given time may facilitate displaying a cursor generally where (or near where) the tip of a finger (which is wearing said finger-worn device) is located, while said finger is straight, only in case the length (as an exemplary measurement) of said finger is known to said touch-screen which displays said cursor, or known to an interface which includes said cursor. By knowing the position of said finger-worn device as it is worn on said finger, and by knowing the length of the finger, a device which includes said touch-screen can estimate where said cursor is to be displayed (i.e. generally where, or near where, the tip of said finger is at).

In some embodiments, a user may submit information to a program of the invention (e.g. program 2860) about a preferable hand and/or finger position and/or posture (also “pose”) to interact with a touch-screen (i.e. a position and/or posture by which said user prefers to interact with said touch-screen, see ref. the described for FIGS. 28E through 28G), so that estimating the general location of the tip of a finger relative to said touch-screen may be performed with a higher level of precision.

FIGS. 28E through 28G show a finger-worn device 2870 worn on finger 232 of hand 230, and a surface 2882 of a touch-screen 2880 (shown from a cross-section point of view) with which finger 232 may be interacting. Surface 2882 may be any surface of the touch-screen on which visuals may be displayed and which can be touched to interact with the touch-screen. Touch-screen 2880 may be similar to touch-screen 2850, so that the location and direction (or “position”, for both) of device 2870 relative to surface 2882 can be detected by the touch-screen (see e.g. FIG. 28C wherein touch-screen 2850 can detect the position of device 2840 by being coupled to sensing means 2854). Finger 232 is shown in FIGS. 28E through 28G not touching surface 2882 of touch-screen 2880, yet is in close proximity to it (otherwise “is positioned near it”). In addition to detecting the position of a device 2870, touch-screen 2880 can detect the general distance of device 2870 from display surface 2882 at any given time. Said distance may be detected by any means known in the art, for example by measuring the intensity of signals returned from a signals-modulator (or “transponder”) in the device, or signals reflected from the device. Said signals may originate from, or be generated by, any means included in touch-screen 2880 or in a device which includes the touch-screen. For example, device 2870 may emit signals or energy that can be detected by touch-screen 2880 (or by a detection unit coupled to the touch-screen) wherein said signals or energy can be processed for obtaining information about the distance of the device from display surface 2882.

In FIGS. 28E, 28F and 28G there are shown distances 2872a, 2872b and 2872c, respectively. Each of the distances is the general distance of device 2870 from display surface 2882, in accordance with each posture of hand 230 in each figure. Distances 2872a-c may be measured perpendicularly to surface 2882, as suggested from the cross-section point of view in the figures. In case the length of finger 232 is known (following the described above), a simple equation (e.g. utilizing the Pythagorean Theorem, wherein the square of the hypotenuse of a right triangle is equal to the sum of the squares of the other two sides) may utilize each of distances 2872a-c, and the length of the finger, for estimating the general location of the tip of the finger along surface 2882 in any of the figures (shown for example a location 2874 in FIG. 28E, for a general location near which the tip of finger 232 is, in accordance with the posture of hand 230 in the figure). For example, a program of a device which includes touch-screen 2880 may be able to compute an approximation of a “virtual” triangle (i.e. a triangle for the purpose of calculation) formed between finger 232 and surface 2882 (triangle illustrated by dashed lines in FIG. 28E), whereas the distance between the surface and device 2870 (worn on the finger), and the length of the finger, may be two sides of said “virtual” triangle (the of the finger length being the hypotenuse). Accordingly, supposing the tip of finger 232 is near the surface, said program may deduce (from known or obtained values, i.e. the length of the finger and the distance of device 2870 from surface 2882) the general location of the vertex (or “corner”) of the aforementioned “virtual” triangle, where the tip of finger 232 is generally at, or near. Said vertex is shown generally at (or near) location 2874 on surface 2882 in FIG. 28E. The above may not require finger 232 to touch touch-screen 2880 (or to touch surface 2882, specifically), yet it is preferable for the tip of the finger to be near the surface of the touch-screen. The nearer the tip is to the surface, the more accurate (or “precise”) the estimation of the general location of the tip may be. Similarly, the straighter the finger, the more accurate said estimation may be. Similarly, the move accurately the length of finger 232 is known, the more accurate said estimation may be.

Note that it is made clear that estimating the general location of the tip of finger 232 along surface 2882 (e.g. by deducing the general location of the vertex of the aforementioned “virtual” triangle) may require knowing the location and direction (see e.g. location 2842 and direction 2848 of device 2840 relative to touch-screen 2850, in FIG. 28C) of device 2870 (worn on the finger) relative to the surface, as described above, whereas knowing the distance of device 2870 from surface 2882 may facilitates estimating the general location of the tip of finger 2882 while hand 230 is in different postures, for reaching a higher level of precision. Knowing only the length of finger 232 and the location and direction of device 2870 may facilitate estimating the general location of the tip of the finger when the finger is parallel and straight relative to the plane of surface 2882 (as suggested for hand 230 and specifically finger 232 being straight and parallel to (otherwise “being spread out in front of”) touch-screen 2850, while device 2840 is worn on the finger, shown in FIG. 28C).

Following the above, in some embodiments, an object (e.g. a cursor 2852 as shown in FIG. 28C displayed by touch-screen 2850) can be displayed on surface 2882 near (or otherwise “in reach of”) the tip of finger 232 (e.g. at location 2874 in FIG. 28E), whereas the tip of the finger can optionally touch the surface where said object is displayed. Additionally, when finger 232 moves, device 2870 respectively moves with it, so that the aforementioned object can also move respectively (i.e. in accordance with, or corresponding to, the movement of the finger and device), provided the relevant values for estimating the general location of the tip of the finger are known (e.g. previously submitted and/or detected in real-time) at any given time during the motion (i.e. the movement of the finger). Similarly, a function (e.g. a “magnifying” function as described above) may be associated with the aforementioned general location of the tip of finger 232 (additionally or alternatively to displaying an object at said general location), so that said function may be performed on any object or interface element which may be displayed (by touch-screen 2880) generally near said general location.

In FIG. 28F, hand 230 is shown in a different posture than in FIG. 28E. In FIG. 28F, device 2870 is shown closer to surface 2882 (i.e. distance 2872b is shorter than distance 2872a). In both figures (i.e. FIGS. 28F and 28F) the tip of finger 232 is near the surface, so that in each figure, the location of the tip may somewhat accurately serve as a corner of a different “virtual” triangle for each figure and posture (for the purpose of estimating the general location of the tip). In FIG. 28D, the side (of a “virtual” triangle) which may correspond to the distance between device 2870 and surface 2882 (distance 2872b) is smaller than the equivalent side (of a “virtual” triangle) in FIG. 28E (distance 2872a).

Note that whereas the described herein for estimating the general location of the tip of a finger wearing a finger-worn device may refer to utilizing the Pythagorean Theorem and a “virtual” triangle, it is made clear that any method may be utilized for the same results.

Specifically shown in FIG. 28G is finger 232 slightly bent (also “folded”, or “curled”, or “curved”) so that estimating the general location of the tip of the finger may be somewhat erroneous (or “inaccurate”) because no “virtual” triangle (in which device 2870 serves as a corner) may be formed between the finger and surface 2882, because the finger cannot serve as a straight line. However, by straightening finger 232, the finger may reach an estimated general location of its tip (estimated by supposing the finger is straight), and so touch surface 2882 where said estimated general location is, for interacting with interface elements displayed thereof, of for initiating functions associated with said estimated general location. Accordingly, an object may “mistakenly” be displayed on the surface not near the tip of finger 232, as shown in FIG. 280 an object 2878 displayed on surface 2822 near where the tip of the finger is supposed to be in case the finger was not bent. However, the finger can still reach (i.e. approach and/or touch with its tip) said object (e.g. object 2878) by straightening. In such cases, the finger may be adjusted (e.g. straightened), preferably by a user, such that its tip is nearer to (or “above”, or “in front of”) an object displayed on surface 2822 in accordance with the described above for objects displayed generally where it is estimated for a tip of a finger to supposedly be. Accordingly, if finger 232 in FIG. 28G is to be straightened, while hand 230 generally does not move, the tip of the finger may reach object 2878.

In similar cases, as shown in FIG. 28H, hand 230 may have a posture and a position such that the tip of finger 232 is not near surface 2882 of touch-screen 2880, and optionally the tip does not point (or “is not directed”) towards the surface. Accordingly, no “virtual” triangle (or an approximation thereof) can be formed by knowing length of the finger, and obtaining the distance of device 2870 from the surface, when the device is worn on the finger. However, a program for estimation the general location of the tip of a finger wearing device 2870, being “unaware” of the posture of hand 230 and distance of the tip of finger 232 from surface 2882, may still compute such a “virtual” triangle (shown in the figure a triangle illustrated by dashed lines, formed from the vertical distance between the device and the surface, which acts as one side, and from the value of the length of the finger, which acts as the hypotenuse), or may utilize the same calculation methods, for estimating a location where the tip of finger 232 might have generally been if it was near the surface and pointing towards it, such as for displaying an object on surface 2882 generally where said location is (shown an object 2876 in FIG. 28H displayed where a corner of the aforementioned “virtual” triangle is generally at, suggesting the general location of the tip of the finger, had the tip been in near the surface). In such cases, the posture of hand 230 and/or finger 232 may be adjusted such that the tip of finger 232 will be near surface 2880, and so the tip will be positioned generally at (or near) object 2876, or may otherwise reach object 2876. For example, from the posture of hand 230 in FIG. 28H, a user may tilt the hand, and specifically finger 232, towards surface 2822, whereas the tip of the finger may eventually “meet” with object 2876 by touching it or coming in close proximity to it.

Note that whereas the described above is for a posture of hand 230 wherein the tip of finger 232 is not near a surface of a touch-screen and/or not pointing towards said surface, it is common for fingers to be near a display surface of a touch-screen while interacting with a touch-screen.

FIG. 28I shows device 2870 worn on the “intermediate phalanx” section (i.e. the “middle” section) of finger 232, alternatively to being worn on the “proximal phalanx” section as shown in FIGS. 28B through 28H. By wearing device 2870 on an “intermediate phalanx” section of a finger, estimating the general, location of the tip of finger 232, as described herein, may be more precise. This is because the range of error that may be caused by bending of the finger may be smaller. For example, in such cases, only the angle between the “distal phalanx” section (i.e. the section of the finger where its tip is) and the “intermediate phalanx” can distort a “virtual” triangle utilized for estimation of the general location of the tip of the finger (as an exemplary method of estimating where the tip of the finger generally is, from given values, in accordance with the described above). Additionally, said angle cannot be smaller than ninety degrees in most people, and so the range of error is further reduced compared to the alternative of wearing a finger-worn device on a “proximal phalanx” section of a finger). Further shown in FIG. 28H is a “virtual” triangle (illustrated by dashed lines) formed between finger 232 and touch-screen 2880, as a “virtual” triangle for estimating the general location of the tip of the finger. Such a triangle can only be distorted by bending of the tip of the finger, which by itself cannot be more than ninety degrees from a straight angle (in most people).

FIG. 28J shows an embodiment of a device 2840′ similar to device 2840 (see ref. FIG. 28C), in which indicators 2844′ and 2846′ can indicate their vertical distances from the surface of a touch-screen 2850′ (distances illustrated by dashed section from each indicator to the touch-screen), such as by being sensed by the touch-screen or by any sensing means coupled to the touch-screen. For example, each of the indicators may include a radio-frequency identification (RFID) circuit, the distance to which may be detected by an RFID reader (see e.g. U.S. Pat. No. 7,119,738).

Indicating vertical distanced may be addition or alternative to indicating the locations of the indicators along, or relative to, the surface of touch-screen 2850′ (i.e. the surface on which visuals may be displayed and which may be touched for registering input, whereas the surface is commonly a two dimensional plane). Obtaining the value of the vertical distance of each indicator may be for deducing the general direction in which device 2840′ is positioned (as it is worn on finger 232), not only in a plane that is parallel to the surface of the touch-screen, as described for indicators 2844 and 2846 of device 2840 in FIG. 28C, but also in an additional dimension. For example, the angles of a “virtual” triangle, which may be formed between finger 232 and the surface of touch-screen 2850′, can be calculated from processing the vertical distance of each of indicators 2844′ and 2846′ from the surface of the touch-screen, because each indicator may act as a point along the hypotenuse of said virtual triangle.

Following the above, the general direction of device 2840′ relative to the surface of touch-screen 2850′ may be known (e.g. obtained by computing a “virtual” triangle as described above) not only relative to the two dimensions of the surface of the touch-screen (as common in touch-screens), but also in an additional dimension of the space in front of the surface. Further accordingly, estimating the general location of the tip of finger 232 relative to touch-screen 2850′ (and specifically to its surface) may be more precise when the finger is wearing device 2840′ (alternatively to wearing device 2840 and interacting with touch-screen 2850, wherein the direction of the device relative to the surface of the touch-screen may be known only for two dimensions corresponding to the two dimensions of the surface).

In FIG. 28J there is shown cursor 2852 (see ref. FIG. 28C) displayed by touch-screen 2850′ generally where the tip of finger 232 is (whereas the finger may optionally be pointing at the cursor). The displaying of the cursor may be facilitated by any methods and means described above.

FIG. 28K shows another embodiment of a finger-worn device as a device 2890 similar to device 2840′ by including two indicators (shown indicators 2894 and 2896 in the figure). Device 2890 is shown worn on finger 232 of hand 230, whereas the finger is shown having a length 238 (illustrated as a section corresponding to the length of the finger) and a direction illustrated as a dashed arrow. Optionally, hand 230 is being used to perform gestures as input for a gestures-recognition system as known in the art, or with any system which can sense (or capture) visuals to register input (see e.g. system 2100 in FIGS. 21A and 21B). Accordingly, indicators 2894 and 2896 may be visual indicators, for indicating the direction of finger 232 at any given time (as described above), optionally in addition to the general location of the finger, to a system which can sense and process visuals, such as a system already capturing images of hand 230 for recognizing gestures performed by the hand. Following the above, by knowing the length of finger 232 (i.e. length 238 as shown in FIG. 28K), such as by the value of the length previously submitted to a program 2860, or such as by calculating the length from captured imaged of hand 230, a system (either the same system sensing visuals or otherwise) may estimate the location of the tip of the finger. This may be beneficial for when sensing of other visuals (i.e. visuals other than visual indications from indicators 2894 and 2896) is limited or impaired, such as in dark environments, or otherwise low lighting conditions. In similar cases, a finger-worn device of the invention may include a light source for illuminating a finger and/or a hand (on which it is worn). Illuminating a finger and/or hand may facilitate sensing of said finger and/or hand, such as sensing performed by a visual-recognition system, for inputting hand and/or finger gestures. A light source of a finger-worn device may preferably be directed towards the finger and/or hand which is intended to be sensed, such as a light-emitting-diode (LED) positioned in said finger-worn device such that it can illuminate the finger and/or hand. Note that accordingly—a finger-worn device of the invention may include a light source for illuminating a finger and/or hand on which said finger-worn device is worn. Accordingly, it is made clear that a finger-worn device of the invention may include a light source, whereby illuminating a finger and/or hand on which said finger-worn device is worn (by utilizing said light source), optically sensing said finger and/or hand may be facilitated.

In some embodiments, in addition to indicating the location and/or direction of finger 232 (by indicating their own locations), indicators 2894 and 2896 may indicate states of device 2890. For example, the intensity of light emitted by the indicators may facilitate distinguishing between them (for obtaining their location, arrangement and/or distance from a light sensor), whereas the color of said light may be indicative of use of device 2890, such as of operating a control of the device for changing between states of the device.

In FIG. 28K there is further shown devices 2892 and 2898 including indicators 2894′ and 2896′, respectively. The devices are shown worn on a so-called ring finger of hand 230. Each indicator is included in each device, both acting as a couple of indicators for indicating the location and/or direction of said ring finger, similarly to the described for indicators 2894 and 2896 of device 2890 indicating the direction and optionally location of finger 232. The general direction of said ring finger is illustrated by a dashed line crossing the ring finger, suggesting the only line which can pass between the indicators (in case the indicators are regarded as two points through which only one line can pass). Accordingly, the locations of indicators 2843 and 2898, and the arrangement of the indicators, provided they are distinguishable (i.e. different to a degree that can be detected), may be indicated by the indicators, to facilitate deducing the direction of the ring finger (supposing the finger is in a generally straight posture).

FIG. 29A shows hand 230 interacting with a touch-screen 2920 which may be a so-called “multi-touch” touch-screen device (i.e. can detect multiple touch instances simultaneously, specifically on a surface displaying visual output). It is made clear that for the described herein, touch-screen 2920 may refer to a device which includes a “multi-touch” touch-screen.

In FIG. 29A, finger 232 of hand 230 is shown touching the touch-screen at a location 2912 (illustrated by a dashed circle in the figure). In case it is known from which direction a user (i.e. a user of hand 230) is interacting with the touch-screen (a direction 2938 of hand 230 approaching the touch-screen is illustrated in the figure as a straight dashed arrow), and also measurements of hand 230 are known (see e.g. FIG. 28D for a program for obtaining hand measurements, i.e. program 2860), and provided it is known which of the finger of hand 230 is touching the touch-screen, an approximation of where thumb 234 of hand 230 is generally located may be estimated. Accordingly, objects may be displayed (e.g. objects 2922a-c as shown displayed on the touch-screen in the figure) approximately where thumb 234 is, specifically displayed such that thumb 234 of hand 230 can reach any of them and touch the touch-screen where they are displayed, while finger 232 is still touching the touch-screen at location 2912. Similarly, an approximation of where a finger 236 of band 230 is generally located may be estimated. Further accordingly, objects 2926a-c may be displayed on touch-screen 2920 approximately where finger 236 (shown as the middle finger of hand 230) can reach any of them while finger 232 remains at the same position (and touching the touch-screen). Accordingly, thumb 234 can touch the touch-screen where any of objects 2922a-c is displayed, and/or finger 236 may touch the touch-screen where any of objects 2926a-c is displayed, without finger 232 being removed from the touch-screen (i.e. without having the finger stop touching touch-screen 2920 at location 2912. For example, by knowing measurements and shape of a hand interacting with the touch-screen, the maximal distance between the tip of finger 232 and the tip of thumb 234 (i.e. the farthest distance between the tips when hand 230 is stretched out as far as possible) may be deduced, whereas by additionally deducing from which direction thumb 234 is positioned relative to finger 232 (by knowing from which direction hand 230 is interacting with the touch-screen (e.g. direction 2938 as shown in FIG. 29A)), displaying objects 2922a-c at any distance from location 2912 (whereat finger 232 is touching) that is smaller than the aforementioned maximal distance, and in the direction of thumb 234 (as deduced by knowing from which direction hand 230 is interacting with the touch-screen), may facilitate the thumb reaching any of the objects. For another example, touch-screen 2920 may be a portable gaming console or a mobile-phone (suggested to include a “multi-touch” touch-screen apparatus), which may be held at a certain position by a hand (other than hand 230) of a user, so that hand 230 (of said user) may approach the touch-screen from a side 2920a of the touch-screen (side 2920a shown in FIG. 29A as one of four sides 2920a-d of touch-screen 2920). It may be most convenient for hand 230 to interact with touch-screen 2920 from side 2920a when the touch-screen is held at the aforementioned certain position by another hand.

Note that it is made clear that the size, measurements and/or shape (or values thereof) of a hand interacting with a touch-screen (which has “multi-touch” features), and a preferred direction to approach said touch-screen from, may be preprogrammed, such as submitted by a user to a program of the touch-screen, in accordance with the described for FIG. 28D. Additionally or alternatively, some or all of the values specified above (i.e. measurements and shape and posture and preferred direction to approach) may be detected by any means known in the art. By knowing relevant information about a hand, estimating (or “approximating”) the general locations of fingers of said hand, or estimating locations on a touch-screen (or specifically on a surface thereof) which can be reached by said fingers, is facilitated when a specific finger of the hand is touching said touch-screen, provided it is known which of the fingers is said specific finger that is touching the touch-screen.

Following the above, in some cases, the size and shape of hand 230, the direction from which hand 230 to approaches and interacts with touch-screen 2920 (e.g. from side 1020a, optionally deduced by knowing the position at which the touch-screen is held or positioned), and which of the fingers of the hands (e.g. finger 232 as shown in FIG. 29A) is interacting with the touch-screen, may have previously been submitted to the touch-screen, or to an interface thereof (e.g. by utilizing program 2860, see ref. FIG. 28D), for facilitating higher accuracy (also “precision”) of approximating the general location of thumb 234. Approximating said general location of the thumb may, accordingly, utilize values of measurements of hand 230, and any other information about the hand (e.g. posture and preferred direction for interaction), for reaching said higher accuracy. Said approximation of may facilitate displaying objects 2922a-c on touch-screen 2920, generally near where the thumb is located, such that the thumb can reach and touch the objects (as they are displayed by the touch-screen).

In some embodiments, touch-screen 2920 may include means for sensing the position at which the touch-screen is held, such as known in the art (e.g. by utilizing a gyroscope). For example, touch-screen 2920 may include a gyroscope which detects the position at which it is held or placed (such as specifically detecting the direction and/or tilt of the touch-screen relative to a user holding the touch-screen), so that the direction from which the touch-screen is interacted with (or “approached”) by hand 230 may be deduced (as touch-screens are commonly interacted with from a side closest to a user who interacts with them). By detecting the location of touch of finger 232, and by knowing the direction of interaction (i.e. the aforementioned direction from which the touch-screen is interacted with, as obtained from detecting the position of the touch-screen), and by knowing measurements (or values thereat) of hand 230, touch-screen 2920 can approximate the general location of finger 236 (while the touch-screen is touched by finger 232), and can display objects 2926a-c generally near where finger 236 is approximated to be, such that finger 236 can reach and touch any of the objects as they are displayed.

Note that whereas the approximation of the location of fingers (e.g. thumb 234 and finger 236 for the described for FIG. 29A) other than a finger touching a touch-screen (e.g. finger 232 in FIG. 29A) may not be precise (or “accurate”), a user may adjust the position of the interacting hand (e.g. hand 230 in FIG. 29A), and/or the position of fingers of the interacting hand which do not touch said touch-screen, so that these fingers may reach objects displayed on the touch-screen near where it is approximated for these fingers to be. Such an adjustment does not require the touching finger (i.e. the finger touching the touch-screen) to move from its touching location on the touch-screen, because in at least one position of the hand and fingers, a finger not touching the touch-screen may reach the aforementioned objects.

In some cases, displaying “reachable” objects (i.e. objects displayed on a touch-screen such that they can be reached by fingers of a hand interacting with said touch-screen, wherein specifically one finger of said hand is touching the touch-screen) may not require knowing measurements or shape of a hand interacting with said touch-screen. However, it is preferable to know the direction from which a hand approached or interacts with said touch-screen. It is well known that tips of adjacent fingers (excluding thumbs) may be positioned adjacently to each other by stretching of bending any of said adjacent fingers. The tip of one of the adjacent fingers may remain at the same location, while tips of the other fingers may be moved (by bending or stretching of the other fingers) to a location adjacent to the aforementioned tip of one of the adjacent fingers (i.e. to the tip which remains at the same location). Accordingly and following the above, displaying objects on a touch-screen which is touched by one finger of a hand, so that said objects are in reach of tips of fingers other than said one finger, may be facilitated by detecting the location at which the one finger touches said touch-screen, and by knowing the direction at which said hand is positioned relative to said touch-screen. The aforementioned objects are to be displayed adjacently to the location where said one finger touches said touch-screen. Note that it must be known which of the fingers of a hand is touching the touch-screen. It must also be known which hand of a user is performing the touching (i.e. left or right hand). For example, in accordance with the shown in FIG. 29A, finger 232 may touch touch-screen 2920 at location 2912, whereas in case it is known that finger 232 is an index finger, and in case it is known that hand 230 is positioned relative to the touch-screen from, direction 2938, objects 2926a-c may be displayed adjacently to location 2912, so that finger 236, being the middle finger of hand 230, can reach the objects. The objects may be displayed generally to the left of the location, as hand 230 is shown in FIG. 29A to be a left hand, and as finger 236 is the middle finger of hand 230, and so that it can be deduces that the tip of finger 236 is generally to the left of the tip of finger 232, provided it is known that hand 230 is a left hand (in FIG. 29A and FIG. 2913, not necessarily in other figures) and that finger 232 is the index finger. For another example, as shown in FIG. 29B, finger 236 may touch touch-screen 2920 at a location 2916 (see ref. FIG. 29B), whereas in case it is known that the touching finger (i.e. finger 236) is a middle finger, and in case it is known that hand 230 is a left hand (refers only to FIGS. 29A and 29B) and that hand 230 is approaching the touch-screen from direction 238, objects 2928a-c may be displayed to the right of location 2916, and generally adjacently to location 2916 (as shown in FIG. 29B), so that the objects can be reached by the tip of finger 232.

Note that whereas the described above for FIG. 28A refers to interactions (or initiated by touch of an index finger (i.e. finger 232 of hand 230), it is made clear that the described may refer to any interactions initiated by any other finger, provided it is known with which finger a user initiates such interactions (by touch on a touch-screen by that finger and by said touch being detected). In such interactions, a certain finger of a hand first touches a touch-screen for initiating an interaction, whereas objects may consequently be displayed by the touch-screen specifically in reach of other fingers of said hand. For example, an interaction of a method of the invention may be initiated by touch of finger 232 on touch-screen 2920, wherein the displaying of objects 2922a-c and objects 2926a-c may then be prompted so that thumb 234 and finger 236 can touch the touch-screen where any of objects 1022a-c and 1026a-c, respectively, are displayed. Following the above, a user may notify (e.g. submit information to a program of the touch-screen) with which finger such interactions are to be initiated, so that said user can then use that finger to initiate such interaction. Accordingly, it is made clear that any combination of fingers, wherein one finger touches a touch-screen for displaying objects on the touch-screen generally near where any of the other fingers are located (otherwise “generally in reach of any of the other fingers”), is facilitated by the invention.

Further note that in some cases, a user may submit a preferred direction from which objects are to be displayed on a touch-screen adjacently to a location where touch is detected by said touch-screen. In such cases, it might not be required for the direction of a hand interacting with the touch-screen to be known, and it might not be required to known which hand of a user said hand is (i.e. whether it is a left hand or right hand), and it might not be required to know which finger is touching the touch-screen where touch is detected. Such information may be known to the aforementioned user (as opposed to known by the touch-screen, or by an interface thereof or program thereof, or by a device which includes the touch-screen), so that by submitting a preferred direction (e.g. to a program similar to program 2860, see ref. FIG. 28D), said user already performed proper calculations (consciously or otherwise) to facilitate reaching objects displayed adjacently to a location at which one of the fingers of said user is touching.

Continuing the above, a user may interact with touch-screen 2920 after touching it with a finger, by touching it with other fingers without removing the finger which originally touched the touch-screen. As specifically shown in FIG. 29A, objects 2922a-c may form a generally “curved” tool-bar or a generally “curved” options menu along the “freedom of motion” of thumb 234 (i.e. along an area which the thumb is free to move in while finger 232 is touching location 2912, suggested by illustrated curved dashed arrow, for a possible motion of the thumb along its “freedom of motion”), so that the thumb may touch the touch-screen on any of the objects, for choosing a tool or for selection an option (from the aforementioned “curved” tool-bar or “curved” options menu, respectively). Said tool or option may be associated with touch input from finger 232 touching the touch-screen, such as in case choosing a specific tool or option may be for executing a specific function on an interface element displayed where finger 232 is touching touch-screen 2920 (i.e. location 2912). Similarly, finger 236 may bend slightly or stretch slightly to touch the touch-screen on any of objects 2926a-c, which are displayed in reach of finger 236 (as shown in FIG. 29A, finger 236 must bend slightly to touch object 2926a with its tip and must stretch slightly to touch object 2926c with its tip).

FIG. 29B shows touch-screen 2920 and hand 230 interacting with the touch-screen. Specifically, finger 236 is shown touching the touch-screen at location 2916. In some cases it may have been notified to a program of touch-screen 2920 that finger 236 is to initiate touch interactions similar to the described for FIG. 29A. Accordingly, by touching the touch-screen, it may be “assumed” by said program that the touch is made by finger 236, so that said program may consequently prompt the displaying of objects in reach of other fingers of hand 230. In FIG. 29B, the touch of finger 236 at location 2916 may prompt a display of an object 2932 generally where thumb 234 is approximated to be located (when finger 236 is touching the touch-screen at location 2916), in accordance with the described above for FIG. 29A. Object 2932 is shown in FIG. 29B enclosed by a relocation-frame 2934. By touching touch-screen 2920 with thumb 234 where relocation-frame 2934 is displayed and then “dragging” the touch on the touch-screen, the relocation-frame, and respectively with it object 2934, can be relocated on the touch-screen to another location (specifically to where the “dragging” is performed), so that the thumb can interact with the object (specifically touch touch-screen 2920 where the object is displayed after said “dragging”). For example, thumb 234 may touch the touch-screen where the display of the relocation-frame is prompted (consequently to touching the touch-screen at location 2916 by finger 236), such as by slightly moving or bending to come in contact with the surface of touch-screen 2920 where the relocation-frame is displayed, and then the thumb may drag itself while touching the touch-screen, for relocating object 2932 (similarly to common “tap and drag” operations). This may be done so that object 2932 is more comfortably accessible to the thumb. This may be beneficial if the approximated general location of thumb 234 (by the detection of the location of touch of finger 236) may not be accurate, and the displaying of the object (which is prompted after the touch of finger 236) cannot be reached by the thumb, or that it is not comfortable for the thumb to interact with it (by touching the touch-screen where it is displayed). Accordingly, the thumb may touch and drag the relocation-frame to adjust (or “relocate”) the displaying of the object, while finger 236 still touches the touch-screen at location 2916.

In some embodiments, interactions (or methods) as described above for FIG. 29A and FIG. 29B may be initiated by other touch actions than touch of a finger. For example, the prompting of a display of object 2932 on touch-screen 2920 generally where thumb 234 is may be prompted by both fingers 232 and 236 touching the touch-screen simultaneously while themselves being pressed together (to each other). In such cases, individual touch of finger 232 or finger 236 as detected by the touch-screen may prompt a different interface reaction (or “interface event”) other than prompting a display of object 2932. This may be facilitated by “multi-touch” features of touch-screen 2920, as the touch-screen may distinguish between touch of one finger and touch of multiple fingers simultaneously. For another example, objects 2926a-c (see ref. FIG. 29A) may be displayed on the touch-screen generally near finger 236 (i.e. where it is estimated for the finger to be located and/or where it is able to reach), by finger 232 “double clicking” on the touch-screen and holding the second click of the “double click” action (i.e. not removing the finger from the touch-screen after finger 232 touches the touch-screen the second time, which is sometimes commonly referred to as a one and a half clicks).

FIGS. 30A and 30B show a touch-screen 3000 (from a cross-section point of view) which can sense touch and/or proximity of a human finger (i.e. the location of touch and/or proximity of a human finger to a location along a surface 3002 of the touch-screen). In FIGS. 30A and 30B there is shown object 3004 displayed on surface 3002 of touch-screen 3000. Object 3004 has a default state 3006a, as shown in FIG. 30A object 3004 being in default state 3006a.

Note that known in the art are touch-screens which can sense touch and/or proximity to a surface on which visuals are displayed.

In some embodiments, when touch-screen 3000 senses proximity of finger 232 (specifically of the tip of the finger) to object 3004 (i.e. proximity to a location along surface 3002 where the object is displayed), the object may switch to a state 3006b different from default state 3006a, as shown in FIG. 30B finger 232 being in proximity to object 3004 while the object is in state 3006b. For example, default state 3006a may be a first size of object 3004, whereas state 3006b may be a second size (shown a larger size in the figures) of the object. Accordingly, by moving finger 232 along surface 3002 (not necessarily touching the display surface), the size of object 3004 may change (such as magnified, as previously described).

Note that similar interactions may be facilitated by estimating the general location of the tip of finger 232, alternatively to sensing the proximity of the tip of the finger, similarly to the described above for estimating the general location of the tip of a finger wearing a finger-worn device (see ref. FIGS. 28C through 28J). Further note that other interactions may be facilitated by sensing the proximity of the tip of a finger, specifically interactions associated with a location to which proximity of the tip is sensed.

In some embodiments, by detecting proximity of a finger (or specifically the tip of the finger) to a location along a surface of a touch-screen may facilitate displaying objects at said location, similarly to the described above for displaying objects generally where the tip of a finger wearing a finger-worn device is estimated to be (see ref. FIGS. 28C through 28J).

Note that the described above for estimating or approximating the location of fingers, and specifically of tips of fingers wearing finger-worn device, may be beneficial when interacting with interfaces which include generally large interface element, in which case precision may not be necessary, and a general estimation or approximation may be sufficient for such interactions.

FIG. 31A shows a flowchart of a method 3100 of the invention, following the described for FIGS. 28A through 28J.

Note that the described below for “obtaining” in certain steps may refer to obtaining information relevant for each of said certain steps (in accordance with the described for each step), or facilitating the knowing of what is described to be obtained in each step. Otherwise, “obtaining” may refer to registering input which corresponds to information relevant for each step.

Further note that the described for method 3100 for a finger-worn device in certain steps may refer to the same finger-worn device in all of said certain steps. Similarly, the described for method 3100 for a touch-screen in certain steps, may refer to the same touch-screen in all of said certain steps.

In some methods, at a step 3102, hand measurements, or specifically measurements of a finger wearing a finger-worn device, may be obtained. Otherwise, at step 3102, input which includes or corresponds to dimensional values (or “measurements information”) of a hand, or specifically of said finger wearing said finger-worn device, may be registered. For example, the length (Or “information about the length”) of said finger wearing said finger-worn device may be submitted to a program (see e.g. program 2860 in FIG. 28D), or measured by any sensing means.

In some methods, at a step 3104, the location of the finger-worn device mentioned for step 3102, relative to a touch-screen (or “along a surface plane parallel to the surface of said touch-screen”), may be obtained. Otherwise, input which includes or corresponds to the location of the finger-worn device, specifically relative to said touch-screen, may be registered at step 3104.

In some methods, at a step 3106, the direction of the finger-worn device mentioned for step 3102, relative to a touch-screen, may be obtained. Otherwise, input which includes or corresponds to the direction of the finger-worn device, specifically relative to said touch-screen, may be registered at step 3106. Note that in some embodiments of the finger-worn device, the direction may refer to a direction in a plane parallel to the surface of said touch-screen (see e.g. finger-worn device 2840 in FIG. 28C), whereas in other embodiments of the finger-worn device, the direction may refer to a direction in a three dimensional space in front of said touch-screen (see e.g. finger-worn device 2840′ in FIG. 28J).

In some methods, at a step 3108, the distance of the finger-worn device mentioned for step 3102, relative to a touch-screen (or “from the surface of said touch-screen”), may be obtained. Otherwise, input which includes or corresponds to the distance of the finger-worn device from the surface of said touch-screen may be registered at step 3108.

In some methods, at a step 3110, the general location of the tip of a finger wearing the finger-worn device which was mentioned for step 3102 (and which may be the same finger-word device as mentioned for steps 3104, 3106 and 3108) may be estimated. Estimating the general location of the tip of said finger may be facilitated by results from any of steps 3102, 3104, 3106 and 3108. For example, by obtaining the length of said finger (step 3102), the location of the finger-worn device along a touch-screen, the direction of the finger-worn device relative to said touch-screen, and/or the distance of the finger-worn device from said touch-screen, may facilitate deducing approximately where the tip of said finger may generally be at.

In some methods, at a step 3112, an object (or a plurality thereof) may be displayed at a location on the aforementioned touch-screen which corresponds to the general location of the tip (mentioned for step 3110). Optionally, said location whereat said object may be displayed may be a location on the touch-screen which is closest to where the tip is estimated to be (i.e. closest to the general location of the tip as estimated at step 3110). Said object may be displayed in an interface which is displayed by the touch-screen, whereas said object may represent an interface element which may be associated with said location on the touch-screen, or to a corresponding location in said interface.

In some methods, at a step 3114, the object mentioned for step 3112 may receive an orientation which corresponds to the direction of the finger-worn device (as obtained at step 3106). In other words, the object may be directed in any direction associated with the direction of the finger-worn device, or relative to the direction of the finger-worn device. For example, it may be desired that the object is displayed on the touch-screen as being directed to an opposite direction than the direction of the finger-worn device, in which case the direction of the finger-worn device may be processed to provide the object with an opposite orientation.

In some methods, at a step 3116, a function may be performed in (or “at”, or “on”) a location in the interface mentioned for step 3112, whereas said location may correspond to the closest location on the touch-screen (as described for step 3112) to where the tip of a finger wearing the finger-worn device is estimated to be, and/or may correspond to the general location of the tip as estimated at step 3110. Additionally or alternatively, a function may be performed on an object (or plurality thereof) displayed at said location (which may correspond to the aforementioned closest location on the touch-screen, and/or to the general location of the tip as estimated at step 3110) in the interface.

FIG. 31B shows a flowchart of a method 3120 of the invention, following the described for FIGS. 29A and 29B and for FIGS. 30A and 3013.

Note that similarly to the described for method 3100, “obtaining” may refer to obtaining relevant information for each step, or facilitating the knowing of what is described to be obtained in each step.

Further note that similarly to the described for method 3100, mentioning of a hand in certain steps of method 3120 may refer to the same hand, whereas mentioning of a touch-screen in certain steps of method 3120 may refer to the same touch-screen.

In some methods, at a step 3122, measurements (or “measurements information”, or “dimensional values”) of a hand may be obtained.

In some methods, at a step 3124, the general direction of the hand mentioned for step 3122 may be obtained, specifically the general direction relative to a touch-screen.

In some methods, at a step 3126, handedness of a user (to which the hand mentioned for step 3122 may belong) may be obtained. Otherwise, at step 3126, knowing which of the hands of a user (i.e. whether the left or the right hand) is intended or preferred for interacting with a touch-screen may be facilitated.

In some methods, at a step 3128, information about which finger is preferred or intended to initiate the displaying described for a step 3134 (see below) may be obtained. In other words, at step 3128, knowing which finger of the hand mentioned for previous steps is intended or preferred to initiate the displaying (see ref. step 3134) may be facilitated.

In some methods, at a step 3130, the position of a touch-screen, on which the displaying which is described for step 3134 may be performed, may be obtained. Said position may be absolute (e.g. relative to the ground) or may be relative to the hand mentioned for previous steps.

In some methods, at a step 3132, a location where the touch-screen, which is mentioned for previous steps, is touched may be detected.

In some methods, information obtained in any of steps 3122, 3124, 3126, 3128 and 3130, and detected in step 3132, may be processed at a step 3134, for approximating locations on the touch-screen (mentioned for previous steps) where fingers (other than the finger touching the touch-screen at a location detected at step 3132) of the hand (mentioned for previous steps) are in reach of.

In some methods, consequently to step 3134 and/or facilitated by performing step 3134, the displaying of interface elements on the touch-screen (mentioned for previous steps) in reach of fingers of the hand (mentioned for previous steps) other than the finger touching the touch-screen, may be prompted, so that said finger of the hand may reach and touch the touch-screen at locations which were approximated at step 3134.

Note that it is made clear that the described herein for interacting with a touch-screen may similarly describe interacting with a gesture recognition system (preferably coupled to or including a display), such as by substituting touch input with pointing gestures (see e.g. hand 230, or specifically finger 232, performing a pointing gesture towards interface element 909b in FIG. 9A). For example, the described for detecting the location of touch of a finger on a touch-screen may be substituted by obtaining (such as deducing during recognition) where a pointing gesture is pointed towards, specifically towards which interface element said pointing gesture is directed towards, in an interface displayed by a display.

Further note that it is made clear that the described herein for interacting with a gesture recognition system may similarly describe interacting with a touch-screen, such as by substituting the direction to which a pointing gesture is directed (preferably towards a screen displaying an interface) with a location on a touch-screen where a finger is detected to touch.

Further note that it is made clear that finger-worn devices of the invention, as described herein, may include any component or element necessary for their operation, specifically for features or results described herein, which may not specifically be mentioned herein. For example, several finger-worn devices described herein may require a power-source (e.g. a battery) for supplying power to electric components of such devices. Accordingly, whereas a power source is not mentioned to be included in some of said finger-worn devices, it is made clear that such a component or element (e.g. said power source) is expected to be included in these finger-worn devices. This may similarly apply to other components or elements which are naturally expected to be included in input devices, by a person skilled in the art, or which are trivial in the field, such as communication units, connecting circuitries (i.e. circuitries connecting between components or elements), actuators for mechanically dynamic sections, etc.

Further note that the described herein for sections of finger-worn devices may similarly refer to components, elements, parts or units.

Further note that the described herein for objects being displayed may similarly refer to interface elements, or may refer to visual representation of interface or program elements.

Further note that the described herein for interface elements may refer to a visual and/or non-visual (or “not-displayed”) element (e.g. to an element in an interface, whereas said element may include visual and/or non-visual sections).

Further note that hand 230 may be shown in some figures as a left hand and in other figures as a right hand, whereas this is due to illustration limitation and is not to suggest handedness (except for the described for FIGS. 29A and 29B).

Further note that the described herein for interface or program events may refer to results of a function being performed or executed.

Further note that the described herein for commands may refer to functions which may be associated with certain input, or which may correspond to certain input.

Further note that referring to “some embodiments” when an interface is described herein may refer to some variations of a described interface, or to some states of the described interface.

Further note that whereas described herein are speech recognition systems and voice recognition systems, each term may refer to systems having any or all features known in the art for speech recognition and voice recognition, or otherwise to systems which may facilitate any processing of information about voice and/or speech.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. An adapter for physically connecting a finger-worn device to another device, said adapter comprising a section which can fit into a cavity of said finger-worn device.

2. A finger-worn device including means for connecting to another device, said finger-worn device operable while connected to said another device and while worn on a finger.

3. The finger-worn device of claim 2, wherein operating said finger-worn device while connected to said another device and while worn on a finger is for registering input in said another device.

4. A device comprising a section which can fit into a cavity of a finger-worn device, said section comprising means for connecting said finger-worn device to said device.

5. A system comprising:
(a) a finger-worn device; and
(b) a stylus,
wherein at least one of said finger-worn device and said stylus has means for connecting to the other.

6. A system comprising:
(a) a finger-worn device having means for distorting sound of voice; and
(b) means for sensing sound of voice distorted by said means for distorting sound of voice; and
(c) means for registering sound of voice as input.

7. The system of claim 6, further comprising means for distinguishing between sound of voice and sound of voice distorted by said means for distorting sound of voice

8. A method for registering input comprising the steps of:
(a) finger-worn device distorting sound of voice spoken generally near mouth; and
(b) sensing sound of voice distorted by said finger-worn device; and
(c) identifying distortion in sensed sound of voice.

9. The method of claim 8, further comprising the step of operating said finger-worn device.

10. A method for selecting an interface item comprising the steps of
(a) touching a first object displayed on a touch-screen; and
(b) touching a second object displayed on said touch-screen; and
(c) operating a finger-worn device.

11. A method for adjusting a value in an interface comprising the steps of:
(a) detecting touch on an object displayed on a touch-screen; and
(b) displaying a menu on said touch-screen; and
(c) detecting touch on an item of said menu; and
(d) operating a finger-worn device.

12. A method for executing a command in an interface comprising the steps of
(a) setting context for input from a finger-worn, device; and
(b) sensing operation of said finger-worn device; and
(c) recognizing operation of said finger-worn device; and
(d) registering input corresponding to said operation.

13. The method of claim 12, further comprising the step of providing a tactile indication for said context for input.

14. A method for performing a function in an interface of a touch-screen comprising the steps of
(a) changing a state of an item of said interface by operating a finger-worn device in a first manner; and
(b) interacting with said item by touching said touch-screen; and
(c) changing a state of said item by operating said finger-worn device in a second manner.

15. A method for estimating the location of a tip of a finger comprising the steps of
(a) detecting the location of a finger-worn device worn on said finger; and
(b) detecting the direction of said finger-worn device.
